(19) United States
(12) Patent Application Publication
(10) Pub. No.: US 2005/0208441 A1
(43) Pub. Date: Sep. 22, 2005

(54) Photothermographic material and image forming method utilizing the same

(75) Inventors: Takayoshi Oyamada, Kanagawa (JP); Keiichi Suzuki, Kanagawa (JP); Yasuhiro Yoshioka, Kanagawa (JP); Kazutaka Takahashi, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/080,781

(22) Filed: Mar. 16, 2005

(30) Foreign Application Priority Data
Mar. 19, 2004 (JP) 2004-081600
Mar. 25, 2004 (JP) 2004-090234

(51) Int. Cl. G03C 1/00

(52) U.S. Cl. 430/619

(57) ABSTRACT

The invention provides a photothermographic material having, at least on a surface of a substrate, an image forming layer including a photosensitive silver halide, a non-photosensitive organic silver salt, a reducing agent, and a binder, and adapted to be exposed with an X-ray intensifying screen, the material including a non-photosensitive intermediate layer A on a surface of the substrate at the side having the image forming layer and between an outermost layer farthest from the substrate and the image forming layer, wherein a binder of the non-photosensitive intermediate layer A includes a hydrophobic polymer by 50 mass % or more, or a photothermographic material in which the photosensitive silver halide has a silver iodide content of 40 to 100 mol. %, and an image forming method for such photothermographic materials.

### CROSS-REFERENCE TO RELATED APPLICATION

This application claims priority under 35 U.S.C. 119 from Japanese Patent Application Nos. 2004-081600 and 2004-090234, the disclosures of which are incorporated by reference herein.

### BACKGROUND OF THE INVENTION

1. Field of the Invention

The present invention relates to a photothermographic material and an image forming method utilizing the same.

2. Description of the Related Art

In recent years, it is strongly desired in the medical field to reduce the amount of used processing liquids in consideration of environmental conservation and space saving. For this reason, there is desired a technology regarding a photothermographic material for medical diagnosis and for photographic applications, capable of efficient exposure with a laser image setter or a laser imager and of forming a sharp black image with a high resolution and a high sharpness. Such photothermographic material can eliminate use of processing chemicals in solutions and can provide users with a thermal development system which is simpler and does not contaminate the environment.

Although similar requirements are present for ordinary image forming materials, an image for medical use requires a particularly high image quality excellent in sharpness and granularity because a delicate image presentation is necessitated. Also there is preferred an image of cold black tone in consideration of ease of diagnosis. Currently various hard copy systems utilizing pigments or dyes, such as an ink jet printer and an electrophotographic system, are available as ordinary image forming systems, but no such system yet is satisfactory as an output system for the image for medical use.

Thermal image forming systems utilizing organic silver salt are disclosed in various references. More specifically, a photothermographic material generally has an image forming layer in which a photocatalyst (for example silver halide) of a catalytically active amount, a reducing agent, and a reducible silver salt (for example organic silver salt), and optionally a toning agent for regulating the color of silver, are dispersed in a matrix binder. The photothermographic material is heated, after an imagewise exposure, to a high temperature (for example 80° C. or higher) whereby a black silver image is formed by a redox reaction between the silver halide or reducible silver salt (acting as an oxidizing agent) and the reducing agent. The redox reaction is accelerated by a catalytic effect of a latent image in silver halide, formed by the exposure to light. Therefore, the black silver image is formed in an exposed area. As a medical image forming system based on a photothermographic material utilizing such principle, there has been commercialized Fuji Medical Dry Imager FM-DP L.

The photothermographic material, containing the aforementioned components all of which remain even after the development, is associated with various drawbacks relating to storage stability. Methods that have frequently been investigated for resolving such drawbacks include a change in a composition contained in an image forming layer and an addition of a new compound thereto. For example, there have been investigated a method changing the silver halide to that of a high silver iodide content for improving the print out property (for example cf. Japanese Patent Application Laid-Open (JP-A) No. 8-297345 and Japanese Patent No. 2785129), a method of adding a polyhalogen compound for suppressing a fog generation (for example cf. JP-A No. 2001-312027), and a method of increasing the content of silver behenate in a non-photosensitive organic silver salt (for example cf. JP-A No. 2000-7683), with certain results. In particular, a photothermographic material containing silver halide of a high silver iodide content has an extremely excellent printout property, and a technology of fully exploiting such effect is desired. However, since silver iodide shows a specific absorption different from those of other silver halides, it is doubtful whether additives and the like which are effective in the photosensitive materials of the prior systems can also be effective in the silver halide system of a high iodide content, and new technologies suitable for the silver halide system of a high iodide content are desired.

As an image forming layer is a portion directly related to image formation, it is extremely important to investigate the composition in the image forming layer as explained above, in order to improve the storage stability. However, since such compositions are present in a mixture in the image forming layer, there is observed a tendency that an improvement in the storage stability tends to decrease the sensitivity and the image density and a fog reduction tends to decrease the image density. It is thus extremely difficult to simultaneously satisfy mutually contradicting properties such as a storage stability and a high sensitivity or a high image density, or a fog reduction and an image density.

As explained above, the photothermographic material is prepared by fully balancing the advantages of the respective compositions, and it is difficult to improve the storage stability by a change or merely an addition of a composition. Therefore, a technology capable of improving the storage stability without deteriorating the advantages of the respective compositions is currently desired.

On the other hand, it has been proposed to apply the aforementioned photothermographic material to a photosensitive material for photograph taking. Such photosensitive material for photograph taking is not for writing image information by a scan exposure with a laser beam or the like, but is for recording an image by a planar exposure. Such method has been commonly employed in the field of photosensitive materials of wet processing type, for example those for medical application such as a direct or indirect X-ray film or a mammography film, various lithographic films for printing application, industrial recording films and photographing films for ordinary cameras. For example, a patent reference discloses a double-sided X-ray photothermographic material utilizing a blue fluorescent intemsifying screen (cf. Japanese Patent No. 3229344), a photothermographic material employing silver iodobromide tabular grains (cf. JP-A No. 59-142539), and a medical photosensitive material having a substrate whose sides are coated with tabular grains of a high silver chloride content having a (100) principal plane (cf. JP-A No.10-282602). A double-sided photothermographic material is also described in other patent references (cf. JP-A Nos. 2000-227642, 2001-22027, 2001-109101 and 2002-90941). In these known examples, however, fine silver halide grains of 0.1 μm or smaller do not aggravate the haze level but result in a low sensitivity unacceptable for photographing purpose, while silver halide grains of 0.3 μm or larger result in an aggravation of haze by the remaining silver halide and a marked deterioration of image quality resulting from a deteriorated print-out property and are not practically acceptable.

Also in medical diagnostic field, the photosensitive material is not exposed and developed in a large amount by an automatic transport system but is often handled one by one. Thus there is required a handling entirely different from that for the prior photothermographic materials, leading to new difficulties. For example, the photothermographic material is often touched by hands and also is often exposed to the external air, thus being susceptible to the influences by the external environment. Such situation is undesirable for the storage of an image, and an improvement in the image storability is strongly desired. In order to be usable as a photosensitive material for photographing purpose, properties of an even higher level are required such as a higher sensitivity, an improvement in the image haze and a superior image storability.

Thus, there is a need for a photothermographic material having excellent image storability after exposure, and an image forming method therefor.

There is also a need for a photothermographic material with little density unevenness in the image and an image forming method therefor.

### SUMMARY OF THE INVENTION

A first need of the present invention has been attained by a photothermographic material of a first aspect and an image forming method of a second aspect.

A first aspect of the present invention provides a photothermographic material having, at least on a surface of a substrate, an image forming layer including a photosensitive silver halide, a non-photosensitive organic silver salt, a reducing agent, and a binder, and configured to be exposed with an X-ray intensifying screen, the material having: a non-photosensitive intermediate layer A on a surface of the substrate at the side having the image forming layer and between an outermost layer farthest from the substrate and the image forming layer; wherein a binder of the non-photosensitive intermediate layer A includes a hydrophobic polymer by 50 mass % or more.

A second aspect of the present invention provides an image forming method for a photothermographic material including: obtaining an image forming assembly by positioning the photothermographic material described above between a pair of X-ray intensifying screens; positioning an inspected object between the image forming assembly and an X-ray source; irradiating the inspected object with an X-ray of an energy level from 25 to 125 kVp; extracting the photothermographic material from the image forming assembly; and heating the extracted photothermographic material within a temperature of 90 to 180° C.

In order to improve the image storability, there is usually investigated a change in the composition of the image forming layer. However, a change in the composition of the image forming layer requires an extremely cumbersome adjustment with other compositions, and the application of a newly developed composition in the image forming layer necessitates reinvestigation of all the compositions.

On the other hand, an outermost layer is a portion which comes in direct contact with the exterior during development, in a transporting operation and in storage, and requires consideration of requirements other than the image quality. For example, in order to improve scratch resistance, transporting property (sliding property) and the like, the outermost layer (or a layer adjacent thereto) contains a matting agent and a lubricant. A change in the composition of the outermost layer results in changes of these physical properties and a major change in the composition is therefore difficult.

Also in the field of medical diagnosis, the photothermographic material is often handled one by one and susceptible to external conditions, and therefore encounters various difficulties. Among these, a situation of a white spot formation on the image is serious and may lead to an erroneous diagnosis. An urgent necessity for an improvement of the photosensitive material against such white spot formation in the image has been identified for the first time in the course of development of the present invention.

An investigation on the white spot formation in the image has clarified that a white spot often occurs in a portion of the photosensitive material where sweat or grease is stuck in a trace of a finger contact. The photosensitive material for medical use often bears traces of finger contact as it is directly handled with hands.

In the course of further development, the inventors of the invention have considered the non-photosensitive intermediate layer positioned between the image forming layer and the outermost layer. As a result, it was found important to form a hydrophobic layer in any of the layers positioned outside the image forming layer and the present invention has thus been made.

It is also found effective, for further improving the storability, to employ a binder of extremely strong hydrophobicity in a non-photosensitive intermediate layer which is “adjacent to” the image forming layer. Then, in an investigation regarding the binder of strong hydrophobicity, a binder containing, by 80 mass % or more, a polymer (or a latex thereof) formed by copolymerizing a monomer represented by formula (M) is found to provide an extremely satisfactory image storability.

Although a mechanism for such phenomenon has not been clarified, the inventors infer that an intrusion of sweat at a fingerprint contact induces a color change. Chlorine ions in the sweat may react with silver ions in the non-photosensitive organic silver salt, thereby gradually forming silver halide. It is infered that thus formed silver halide, which is photosensitive, induces a color change. It is infered that formation of a strongly hydrophobic layer outside the image forming layer, as in the present invention, efficiently inhibits intrusion of sweat, salts, moisture and the like into the image forming layer from the exterior, thereby preventing formation of silver halide. It is also found that, among the hydrophobic polymers, a polymer formed by copolymerizing the monomer represented by formula (M) significantly improves the image storability.

On the other hand, a hydrophobic binder does not have a setting property and has therefore difficulty in coating. The setting property means a phenomenon that a coating liquid is gelled and loses fluidity when the temperature is lowered. Based on such setting property, a coated layer can be prevented from flowing, by coating a warmed coating liquid on a substrate and then cooling the resultant coating. Therefore, when a coating liquid having such setting property is used, an unevenness does not easily occur by a drying air and a uniform coated surface can be obtained. In the invention, in order to improve the state of the coated surface and the coating efficiency, a layer containing a water-soluble polymer derived from an animal protein (such as gelatin) is provided in any of layers positioned farther from the substrate than a nonhotosensitive intermediate layer A containing the hydrophobic binder. Such layer configuration eliminates fluidity of the surface of the image forming layer, thereby providing a uniform coated surface. In a photothermographic material, which is not subjected to a swelling in the processing with a developing solution, even a slight unevenness on the coated surface at the manufacture may result in a density unevenness or a haze, thus perturbing the diagnostic performance. In the photothermographic material, the uniformity of the coated film is one of most important characteristics.

Furthermore, a photothermographic material of a composition enabling a rapid thermal development process is more susceptible to the influences of external environments. A photosensitive composition for rapid processing is characterized, for example, by (1) use of a reducing agent of a high activity, (2) addition of a development accelerator, (3) use of a specified antifoggant, and/or (4) addition of a specified color toning agent. Even in such photothermographic material for rapid processing, the aforementioned layer configuration allows obtaining a photothermographic material of excellent image storability.

As to a second need, the inventors, as a result of detailed investigation on the photothermographic material of a high silver iodide content which provides an extremely satisfactory image storability, find that an unevenness occurs in the image density in a photosensitive material of which composition is optimized for a high silver iodide content. Such situation is found to arise from a decrease in the amount of polyhalogen, used as an antifoggant, in the optimization of the composition. An increase in the amount of polyhalogen is a commonly employed method for avoiding a density unevenness. However, such method is not desired as the sensitivity is significantly lowered by an increase in polyhalogen. This is because the photothermographic material of high silver iodide content, having specific absorption characteristics, shows an extremely low sensitivity in comparison with the prior photosensitive materials based on silver bromide or silver iodobromide.

In order to improve the density unevenness, a change in the composition of the image forming layer is usually conducted. However, a change in the composition of the image forming layer requires an extremely cumbersome adjustment with other compositions, and the application of a newly developed composition in the image forming layer necessitates reinvestigation on all the compositions. Also, an outermost layer is a portion coming in direct contact with the exterior in a development, in a transporting operation and in a storage, and requires consideration on requirements other than the image quality. For example, in order to improve a scratch resistance, a transporting property (sliding property) and the like, the outermost layer (or a layer adjacent thereto) contains a matting agent and a lubricant. A change in the composition of the outermost layer results in changes of these physical properties and a major change in the composition is therefore difficult.

In the course of further development, the inventors have made a consideration on the non-photosensitive intermediate layer positioned between the image forming layer and the outermost layer. As a result, it is found important to form a hydrophobic layer in any of the layers positioned outside the image forming layer and the present invention has thus been made.

It is also found, for suppressing unevenness in the image density, to employ a binder of extremely strong hydrophobicity in a non-photosensitive intermediate layer which is “adjacent to” the image forming layer. Then, in an investigation on the binder of strong hydrophobicity, a binder containing, by 80 mass % or more, a polymer (or a latex thereof) formed by copolymerizing a monomer represented by the formula (M) is found to provide an extremely satisfactory density evenness. The density unevenness is a phenomenon caused by a susceptibility to the external environments such as temperature and humidity, and the non-photosensitive intermediate layer of the invention suppresses the influence of the external environments, thereby avoiding the density unevenness. In this manner the present invention, achieved by an improvement in a portion other than the image forming layer, does not deteriorate the sensitivity and can simultaneously improve the sensitivity and the density unevenness which are in a mutually conflicting relationship.

Furthermore, in order to avoid a low sensitivity peculiar to the photosensitive material of a high silver iodide content and to attain a required maximum density at the same time, the grain size of silver halide is an important factor. In the invention, the silver halide grains have a size preferably within a range of 0.001 to 0.15 μm.

On the other hand, a hydrophobic binder does not have a setting property and has therefore difficulty in coating, as explained above. In the invention, in order to improve the state of the coated surface and the coating efficiency, a layer containing a water-soluble polymer derived from an animal protein (such as gelatin) is provided in any of layers positioned farther from the substrate than a non-photosensitive intermediate layer A containing the binder of strong hydrophobicity. Such layer configuration eliminates fluidity of the surface of the image forming layer, thereby providing a uniform coated surface.

Furthermore, even in a photothermographic material of a composition enabling a rapid thermal development process, the aforementioned layer configuration suppresses the density unevenness in the image.

Based on these findings, the second need is attained by a thermographic material of the third aspect of the invention and image forming methods of the fourth to sixth aspects of the invention.

The third aspect of the invention provides a photothermographic material having, at least on a surface of a substrate, an image forming layer including a photosensitive silver halide, a non-photosensitive organic silver salt, a reducing agent, and a binder, the material having: a silver iodide content in the photosensitive silver halide of 40 to 100 mol %; and a non-photosensitive intermediate layer A on a surface of the substrate at a side having the image forming layer and between an outermost layer farthest from the substrate and the image forming layer; wherein a binder of the non-photosensitive intermediate layer A includes a hydrophobic polymer by 50 mass % or more.

The fourth aspect of the invention provides an image forming method for a photothermographic material comprising an exposure step and a thermal development step, wherein: in the exposure step, an image is formed on the photothermographic material according to the third aspect, by a semiconductor laser having a light emission peak intensity within a wavelength range of 350 to 450 nm.

The fifth aspect of the invention provides an image forming method for a photothermographic material comprising an exposure step and a thermal development step, wherein: in the thermal development step, the photothermographic material according to the third aspect is heated for 16 seconds or less.

The sixth aspect of the invention provides an image forming method for a photothermographic material comprising an exposure step and a thermal development step, wherein: in the thermal development step, the photothermographic material according to the third aspect is transported at a speed of 23 mm/sec or higher.

### BRIEF DESCRIPTION OF THE DRAWINGS

FIG. 1 is a view showing a schematic configuration of a thermal development recording apparatus of the invention;

FIG. 2 is a view showing a schematic configuration of a thermal development recording apparatus equipped with a laser recording apparatus; and

FIG. 3 is a view showing a schematic configuration of a transport portion for conveying a sheet-shaped photothermographic material and a scanning exposure portion in the laser recording apparatus.

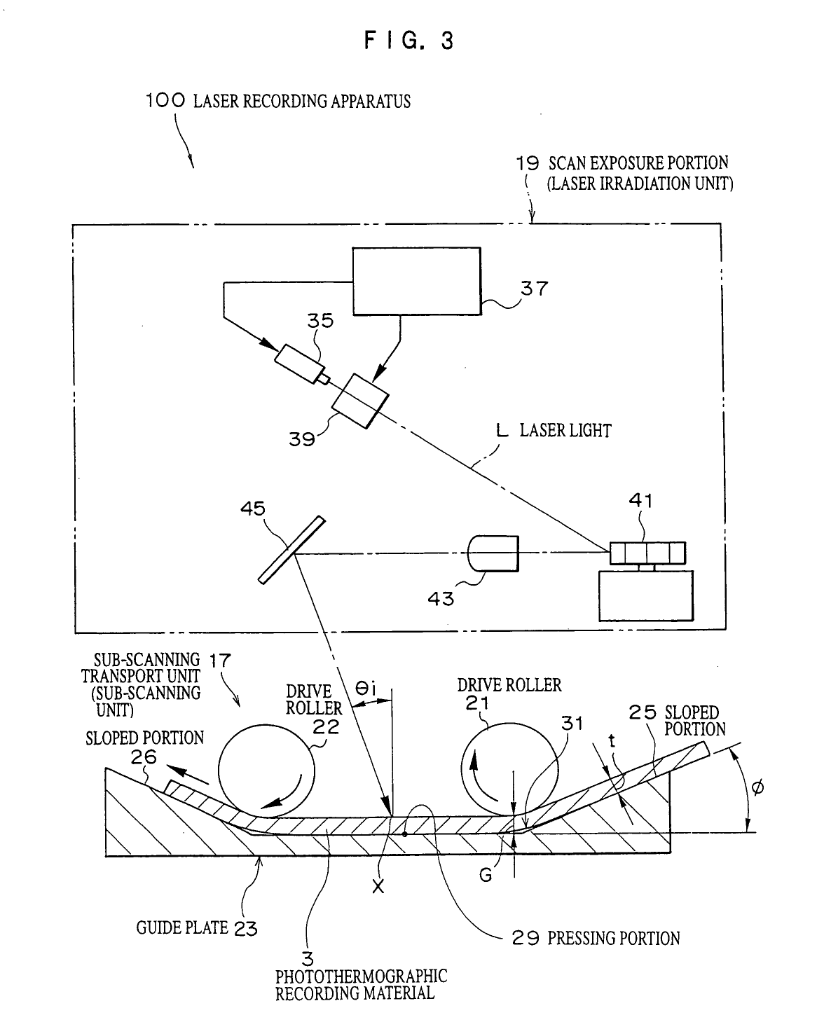

### DETAILED DESCRIPTION OF THE INVENTION

The photothermographic material of the invention has an image forming layer on at least a surface of a substrate, and the image forming layer includes a photosensitive silver halide, a non-photosensitive organic acid silver salt, a reducing agent and a binder. The photothermographic material also has a non-photosensitive intermediate layer A on a surface of the substrate at the side having the image forming layer and between an outermost layer farthest from the substrate and the image forming layer. The binder of the non-photosensitive intermediate layer A includes a hydrophobic polymer by 50 mass % or more. The photosensitive material of such configuration, when employed as a medical photosensitive material used with an X-ray intensirying screen, is extremely effective for preventing a white spot formation in the image.

In the following, there will be explained a layer configuration of the photothermographic material of the invention, and then constituents of the respective layers.

1. Layer Configuration

The photothermographic material of the invention includes at least an image forming layer, and a non-photosensitive intermediate layer A between an outermost layer and the image forming layer. The binder of the non-photosensitive intermediate layer A contains a hydrophobic polymer by 50 mass % or more.

Thus, essential layers for the layer configuration are, from the substrate side, (1) an image forming layer, (2) a non-photosensitive intermediate layer A and (3) an outermost layer. A non-photosensitive intermediate layer B may be provided between (2) the non-photosensitive intermediate layer A and (3) the outermost layer. In at least one of the outermost layer and the non-photosensitive intermediate layer B, the binder preferably includes a hydrophilic polymer derived from an animal protein by 50 mass % or more. The image forming layer and the non-photosensitive intermediate layer A are preferably provided adjacently.

The outermost layer usually serves to improve a transporting property and a scratch resistance, and to avoid sticking of the image forming layer. For this purpose, the outermost layer often includes, in addition to a binder, additives such as a matting agent, a lubricant and a surfactant. One or plural surface protective layers may be provided in addition to the outermost layer. The surface protective layer is described in JP-A No. 11-65021, paragraphs 0119 - 0120 and JP-A No. 2000-171936.

An intermediate layer is usually provided as an interfacial layer between the image forming layer and the outermost layer, and is principally constituted of a binder. The intermediate layer may also include various additives.

In the following, preferred layer configurations (preferred binder) of the non-photosensitive intermediate layer and the outermost layer are shown, but such examples are not restrictive.

In the following description, a polymer formed by copolymerizing a monomer represented by formula (M) is called “polymer of formula (M)”. Also a hydrophobic polymer (not limited to the polymer formed by copolymerizing the monomer represented by formula (M)) is called “hydrophobic polymer”, also a hydrophilic polymer derived from an animal protein (for example gelatin) is called “hydrophilic polymer 1”, and a polymer containing a hydrophilic polymer not derived from an animal protein (for example polyvinyl alcohol (PVA)) by 50 mass % or more is called “hydrophilic polymer 2”.

TABLE 1

| | type of binder | | | | | |
|---|---|---|---|---|---|---|
| | layer | layer | layer | layer | layer | layer |
| | configuration | configuration | configuration | configuration | configuration | configuration |
| | example 1 | example 2 | example 3 | example 4 | example 5 | example 6 |
| outermost | hydrophilic | hydrophobic | hydrophilic | hydrophilic | hydrophobic | hydrophobic |
| layer | polymer 1 | polymer | polymer 1 | polymer 1 | polymer | polymer/ |
| | contained by | | contained by | contained by | | hydrophilic |
| | 50 mass % or | | 50 mass % or | 50 mass % or | | polymer 1 |
| | more | | more | more | | |
| non- | hydrophilic | hydrophilic | hydrophilic | hydrophilic | hydrophilic | hydrophilic |
| photosensitive | polymer 2 | polymer 1 or | polymer 1 or | polymer 1 | polymer 1 | polymer 1 |
| intermediate | contained by | 2 contained | 2 contained | contained by | contained by | contained by |
| layer B | 50 mass % or | by 50 mass % | by 50 mass % | 50 mass % or | 50 mass % or | 50 mass % or |
| | more | or more | or more | more | more | more |
| | | | | hydrophilic | hydrophilic | hydrophilic |
| | | | | polymer 2 | polymer 2 | polymer 2 |
| | | | | contained by | contained by | contained by |
| | | | | 50 mass % or | 50 mass % or | 50 mass % or |
| | | | | more | more | more |
| non- | hydrophobic | hydrophobic | hydrophobic | hydrophobic | hydrophobic | hydrophobic |
| photosensitive | polymer | polymer | polymer | polymer | polymer | polymer |
| intermediate | contained by | contained by | contained by | contained by | contained by | contained by |
| layer A | 50 mass % or | 50 mass % or | 50 mass % or | 50 mass % or | 50 mass % or | 50 mass % or |
| | more | more | more | more | more | more |

In the invention, a layer including a binder containing the hydrophilic polymer 1 by 50 mass % or more is preferably provided at a side farther from the substrate than the non-photosensitive intermediate layer A.

In the outermost layer, in consideration of the coating property, a binder preferably contains a hydrophilic polymer 1 such as gelatin by 50 mass % or more, and preferably contains a hydrophobic polymer in consideration of sticking or image storability against fingerprints.

In any of the layer configuration examples 3, 4 and 6, the hydrophilic polymer 1 in the outermost layer may be replaced by a hydrophilic polymer 2. Such polymer is preferably employed particularly in the case where the non-photosensitive intermediate layer B contains gelatin and the outermost layer contains a hydrophobic polymer, in order to suppress coagulation by a contact with the hydrophobic polymer in the outermost layer.

The non-photosensitive intermediate layer B, in consideration of the coating property, preferably includes a binder containing a hydrophilic polymer 1 by 50 mass % or more, and, for suppressing a coagulation by a contact between a gelatin-containing layer and a hydrophobic polymer-containing layer, it is preferably formed as two subayers including a subayer containing a hydrophilic polymer 2 such as PVA by 50 mass % or more.

In the following, there will be explained a preferred combination of the binder of the outermost layer and the binder of the non-photosensitive intermediate layer B.

(i) Case where the binder of the outermost layer does not contain the hydrophilic polymer 1 by 50 mass % or more:

In the case where the binder of the outermost layer does not contain a hydrophilic polymer 1 by 50 mass % or more, the binder of the non-photosensitive intermediate layer B preferably contains a hydrophilic polymer 1 by 50 mass % or more. In such case, the binder of the outermost layer may be a hydrophilic polymer or a hydrophobic polymer. In the case where the binder of the outermost layer contains a hydrophilic polymer, such hydrophilic polymer may be a hydrophilic polymer 1 or a hydrophilic polymer 2. In consideration of the setting property, it is preferable that the binder of the outermost layer contains a hydrophilic polymer 1 by 50 mass % or more, or that a gelling agent is added to the hydrophilic polymer 2. Also there is preferred a layer configuration employing a hydrophobic polymer in the outermost layer, since such configuration allows suppression of a fingerprint sticking or stickiness. Two or more of the hydrophilic polymers or the hydrophobic polymer may be used in combination.

(ii) Case where the binder of the outermost layer contains the hydrophilic polymer 1 by 50 mass % or more:

In the case where the binder of the outermost layer contains a hydrophilic polymer 1 by 50 mass % or more, the binder of the non-photosensitive intermediate layer B is not particularly restricted, but is preferably a binder containing a hydrophilic polymer 1 by 50 mass % or more, or a binder containing a hydrophilic polymer 2 by 50 mass % or more. The outermost layer, in consideration of the transporting property and the scratch resistance, often contains additives such as a matting agent and a surfactant, and therefore the amount of the binder of the outer most layer is often restricted. It is therefore also a preferred embodiment, in the case the outermost layer employs a binder containing a hydrophilic polymer 1 by 50 mass % or more, to employ a binder containing a hydrophilic polymer 1 by 50 mass % or more in the non-photosensitive intermediate layer B, thereby improving the coating property. There is more preferred a configuration of providing two or more non-photosensitive intermediate layers B, in which a binder of a non-photosensitive intermediate layer B closer to the non-photosensitive intermediate layer A contains a hydrophilic polymer 2 by 50 mass % or more and a binder of a non-photosensitive intermediate layer B closer to the outermost layer contains a hydrophilic polymer 1 by 50 mass % or more. Presence of the non-photosensitive intermediate layer B containing a hydrophilic polymer 2 by 50 mass % or more allows suppression of a coagulation resulting from a contact of a gelatin layer and a hydrophobic layer.

The photothermographic material is further provided, as other non-photosensitive layers, with an undercoat layer provided between the image forming layer and the substrate, a back layer provided at a side of the substrate opposite to the image forming layer, and a back surface protective layer farther from the substrate than the back layer. These layers may be each independently constituted of a single layer or plural layers.

Also a layer functioning as an optical filter may be provided, usually as an outermost layer or an intermediate layer. An antihalation layer is provided in the photosensitive material as an undercoat layer or a back layer.

The photothermographic material of the invention may be of a single-sided type having an image forming layer only on a surface of the substrate, or a double-sided type having an image forming layer on each surface of the substrate. In the case of the double-sided type, the aforementioned layer configuration is realized on at least one surface, and the configuration on the other surface is not particularly restricted.

In a configuration of a multi-color photothermographic material, a combination of these two layers may be included for each color, or, as described in U.S. Pat. No. 4,708,928, all the components may be included within a single layer. In the case of a multi-dye, multi-color photothermographic material, emulsion layers are generally maintained in a separate state, as described in U.S. Pat. No. 4,460,681, by employing a functional or nonfunctional barrier layer between the photosensitive layers.

2. Constituent Components of Layers

In the following, there will be given a detailed explanation on the non-photosensitive intermediate layer A containing a binder which includes a hydrophobic polymer by 50 mass % or more. Then there will be explained a layer containing a hydrophilic polymer 1 employable in the non-photosensitive intermediate layer B or the outermost layer by 50 mass % or more (hereinafter called “hydrophilic polymer-1 containing layer”) and a layer containing a hydrophilic polymer 2 by 50 mass % or more (hereinafter called “hydrophilic polymer-2 containing layer”). The hydrophobic polymer employable in the outermost layer or the intermediate layer B is the same as that employable in the non-photosensitive intermediate layer A.

(1) Non-photosensitive Intermediate Layer A

1) Binder

In the invention, the binder of the non-photosensitive intermediate layer A contains a hydrophobic polymer by 50 mass % or more, preferably 80 to 100 mass %, and more preferably 90 to 100 mass %. A content less than 50 mass % is undesirable because of a limited improvement on the image storability.

In the invention, the hydrophobic polymer is preferably contained in a coating solution as an aqueous dispersion. Such aqueous dispersion can be a latex in which fine particles of a water-insoluble hydrophobic polymer are dispersed in an aqueous solvent or a dispersion in which polymer molecules are dispersed in a molecular state, or are dispersed and form micelles, however particles dispersed as a latex are more preferable. The dispersed particles generally have an average particle size of 1 to 50,000 nm, preferably 5 to 1,000 nm, more preferably 10 to 500 nm and still more preferably 50 to 200 nm. A particle size distribution of the dispersed particles is not particularly limited, and can be a wide particle size distribution or a mono-dispersed particle size distribution. In order to control physical properties of the coating liquid, it is also preferable to use two or more dispersions, each having a mono-dispersed particle size distribution, as a mixture.

The hydrophobic polymer employable in the invention is not particularly restricted, and there can be preferably employed a hydrophobic polymer such as acrylic polymer, polyester, rubber (such as SBR resin), polyurethane, polyvinyl chloride, polyvinyl acetate, polyvinylidene chloride or a polyolefin. Such polymer can be a linear, branched or crossinked polymer, or can be so-called a homopolymer formed by polymerizing a single monomer or a copolymer formed by polymerizing two or more monomers. In the case of a copolymer, it can be a random copolymer or a block copolymer. Such polymer has a number-averaged molecular weight of 5,000 to 1,000,000, preferably 10,000 to 200,000. An excessively small molecular weight results in an insufficient mechanical strength of the image forming layer, while an excessively large molecular weight results in an undesirably inferior film forming property. A crosskinking polymer latex is particularly preferably employed.

The hydrophobic polymer of the invention preferably has a glass transition Tg within a range from −30 to 70° C., more preferably −20 to 35° C., still more preferably −10 to 35° C. and most preferably 0 to 35° C. A Tg lower than −30° C. provides a good film forming property but results in a film of low heat resistance, and a Tg higher than 70° C. provides a good heat resistance of the polymer but results in an insufficient film forming property. However, such desired Tg may be attained by employing two or more polymers. Thus, even polymers having Tg outside the aforementioned range may be used in such a manner that a weight-averaged Tg falls within the aforementioned range.

The hydrophobic polymer preferably has an I/O value from 0.025 to 0.5, more preferably 0.05 to 0.3. The I/O value means a value obtained by dividing an inorganic value by an organic value based on an organic property chart. An I/O value lower than 0.025 results in a poor affinity to an aqueous solvent, whereby a coating with an aqueous coating liquid becomes difficult, while an I/O value higher than 0.5 leads to hydrophilicity in a completed film, thus influencing photographic properties to humidity and undesirably deteriorating the photographic performance. The I/O value can be determined according to a method described in Yukio Koda, Yuki-Gainen-Zu, Kiso to Ouyou (published by Sankyo Shuppan, 1984).

In the organic property chart, properties of a compound are divided into an organic value indicating a property by covalent bond and an inorganic value indicating a property by ionic bond, and each organic compound is represented by a point on an orthogonal coodinate system defined by an organic axis and an inorganic axis. An inorganic value indicates an inorganic property, namely a magnitude of influence of each substituent on the boiling point, taking a hydroxyl group as a reference. An influence of a hydroxyl group is defined as a value 100, since a distance between a boiling point curve for linear alcohols and a boiling point curve for linear paraffins is about 100° C. at about 5 carbon atoms. On the other hand, an organic value, indicating an organic property, is considered to be measurable, taking methylene groups in a molecule as a unit, by a number of carbon atoms constituting such methylene groups. A basic value for a carbon atom is defined as 20, taking an average increase in the boiling point of 20° C. by an addition of a carbon atom to a linear compound of 5 to 10 carbon atoms. Such inorganic value and organic value constitute 1-to-1 correlation on the chart. The I/O value is calculated from these values.

As the binder for the non-photosensitive intermediate layer A of the invention, a polymer formed by copolymerizing a monomer represented by formula (M) is more preferable.

In the binder of the non-photosensitive intermediate layer, the content of the polymer formed by copolymerizing the monomer represented by formula (M) is preferably 80 mass % or higher, more preferably 85 mass % to 100 mass %, and still more preferably 90 to 100 mass %.
CH₂═CR⁰¹—CR⁰²═CH₂ Formula (M)

In the formula, R⁰¹ and R⁰² each independently represents a group selected from a hydrogen atom, an alkyl group with 1 to 6 carbon atoms, a halogen atom, and a cyano group.

The alkyl group preferred for R⁰¹ and R⁰² is an alkyl group with 1 to 4 carbon atoms, more preferably an alkyl group with 1 to 2 carbon atoms. As the halogen atom, a fluorine atom, a chlorine atom or a bromine atom is preferred, and a chlorine atom is more preferred.

Particularly preferably, R⁰¹ and R⁰² are both hydrogen atoms, or one of them is a hydrogen atom and the other is a methyl group or a chlorine atom.

Specific examples of the monomer represented by formula (M) include 1,3-butadiene, 2-ethyl-1,3-butadiene, 2-n-propyl-1,3-butadiene, 2,3-dimethyl-1,3butadiene, 2-methyl-1,3-butadiene, 2-chloro-1,3-butadiene, 1-bromo-1,3-butadiene, 2-fluoro-1,3-butadiene, 2,3-dichloro-1,3-butadiene, and 2-cyano-1,3-butadiene.

In the invention, other monomer(s) that can be copolymerized with the monomer represented by formula (M) is not particularly restricted, and there can be advantageously employed any monomer that can be polymerized by an ordinary radical or ionic polymerization method.

The monomer employable preferably can be selected in an independent and arbitrary combination from following monomer groups (a) to (j):

Monomer Groups (a)-(j)
(a) conjugate dienes: such as 1,3-butadiene, 1,3-pentadiene, 1-phenyl-1,3butadiene, 1-naphthyl-1,3-butadiene, 1-β-naphthyl-1,3-butadiene, 1-bromo-1,3-butadiene, 1-chloro-1,3-butadiene, 1,1,2-trichloro-1,3-butadiene, and cyclopentadiene;
(b) olefins: such as ethylene, propylene, vinyl chloride, vinylidene chloride, 6-hydroxy-1-hexene, 4-pentenic acid, methyl 8-noneate, vinylsulfonic acid, trimethylvinylsilane, trimethoxyvinylsilane, 1,4-divinylcyclohexane, and 1,2,5-trivinylcyclohexane;
(c) α,β-unsaturated carboxylic acids and salts thereof: such as acrylic acid, methacrylic acid, itaconic acid, maleic acid, sodium acrylate, ammonium methacrylate, and potassium itaconate;
(d) α,β-unsaturated carboxylic acid esters: such as alkyl acrylate (such as methyl acrylate, ethyl acrylate, butyl acrylate, cyclohexyl acrylate, 2-ethylhexyl acrylate, and dodecyl acrylate), substituted alkyl acrylate (such as 2-chloroethyl acrylate, benzyl acrylate, and 2-cyanoethyl acrylate), alkyl methacrylate (such as methyl methacrylate, butyl methacrylate, 2-ethylhexyl methacrylate, and dodecyl methacrylate), substituted alkyl methacrylate (such as 2-hydroxyethyl methacrylate, glycidyl methacrylate, glycerin monomethacrylate, 2-acetoxyethyl methacrylate, tetrahydrofurfuryl methacrylate, 2-methoxyethyl methacrylate, polypropylene glycol monomethacrylate (with 2 to 100 moles of polyoxypropylene added), 3-N,N-dimethylaminopropyl methacrylate, chloro-3-N,N,N-trimethylammoniopropyl methacrylate, 2-carboxyethyl methacrylate, 3-sulfopropyl methacrylate, 4-oxysulfobutyl methacrylate, 3-trimethyoxysilylpropyl methacrylate, aryl methacrylate, and 2-isocyanatethyl methacrylate), an unsaturated dicarboxylic acid derivative (such as monobutyl maleate, dimethyl maleate, monomethyl itaconate and dibutyl itaconate), and a polyfunctional ester (such as ethylene glycol diacrylate, ethylene glycol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerythritol hexacrylate and 1,2,4-cyclohexane tetramethacrylate);
(e) amides of β-unsaturated carboxylic acids: such as acrylamide, methacrylamide, N-methylacrylamide, N,N-dimethylacrylamide, N-methyl-N-hydroxyethylmethacrylamide, N-tert-butylacrylamide, N-tert-octylmethacrylamide, N-cyclohexylacrylamide, N-phenylacrylamide, N-(2-acetacetoxyethyl) acrylamide, N-acryloylmorpholine, diacetone acrylamide, itaconic diamide, N-methylmaleimide, 2-acrylamide-methylpropane sulfonic acid, methylenebisacrylamide, and dimethacryloyl piperadine;
(f) unsaturated nitriles: such as acrylonitrile, and methacrylonitrile;
(g) styrene and derivatives thereof: such as styrene, vinyltoluene, p-tert-butylstyrene, vinylbenzoic acid, methyl vinylbenzoate, α-methylstyrene, p-chloromethylstyrene, vinylnaphthalene, p-hydroxymethylstyrene, sodium p-styrenesulfonate, potassium p-styrenesulfinate, p-aminomethylstyrene, and 1,4-divinylbenzene;
(h) vinyl ethers: such as methyl vinyl ether, butyl vinyl ether, and methoxyethyl vinyl ether;
(i) vinyl esters: such as vinyl acetate, vinyl propionate, vinyl benzoate, vinyl salicylate, and vinyl chloroacetate; and
(j) other polymerizable monomers: such as N-vinylinidazole, 4-vinylpyridine, N-vinylpyrrolidone, 2-vinyloxazoline, 2-isopropenyloxazoline, and divinylsulfon.

There is preferred a copolymerization with styrene, acrylic acid and/or an acrylate ester. A more preferred copolymer includes styrene and acrylic acid as a monomer unit, because the obtained hydrophobic polymer can be used as an aqueous dispersion of satisfactory dispersion stability.

A copolymerization ratio of the monomer represented by formula (M) and other monomer is not particularly restricted, but the copolymerization is preferably executed with the monomer represented by formula (M) in an amount of 10 to 70 mass %, more preferably 15 to 65 mass %, and still more preferably 20 to 60 mass %.

Specific examples of the preferable hydrophobic polymer include those listed in the following. Following examples are represented by monomers used as the raw material, with a parenthesized number indicating mass % and a molecular weight represented by a number-averaged molecular weight. In an example employing a polyfunctional monomer, since the concept of molecular weight is not applicable because of its crosslinked structure, it is represented as crosslinking and the description of the molecular weight is omitted. Tg indicates a glass transition temperature:
LPA-1: latex of -MMA(55)-EA(42)-MAA(3)-(Tg of 39° C., and I/O value of 0.636)
LPA-2: latex of -MMA(47)-EA(50)-MAA(3)-(Tg of 29° C., and I/O value of 0.636)
LPA-3: latex of -MMA(17)-EA(80)-MAA(3)-(Tg of −4° C., amd I/O value of 0.636)
LPA-4: latex of -EA(97)-MMA(3) (Tg of −20° C., and I/O value of 0.636)
LPA-5: latex of -EA(97)-AA(3) (Tg of −21° C., and I/O value of 0.648)
LPA-6: latex of -EA(90)-AA(10) (Tg of −15° C., and I/O value of 0.761)
LPA-7: latex of -MMA(50)-2EHA(35)-St(10)-AA(5)- (Tg of 34° C., and I/O value of 0.461)
LPA-8: latex of -MMA(30)-2EHA(55)-St(10)-AA(5)- (Tg of 3° C., and I/O value of 0.398)
LPA-9: latex of -MMA(10)-2EHA(75)-St(10)-AA(5)-(Tg of −23° C., and I/O value of 0.339)
LPA-10: latex of -MMA(60)-BA(36)-AA(4)-(Tg of 29° C., and I/O value of 0.581)
LPA-11: latex of -MMA(40)-BA(56)-AA(4)-(Tg of −2° C., and I/O value of 0.545)
LPA-12: latex of -MMA(25)-BA(7l)-AA(4)-(Tg of −22° C., and I/O value of 0.519)
LPA-13: latex of -MMA(42)-BA(56)-AA(2)-(molecular weight of 540,000, Tg of −4° C., and I/O value of 0.530)
LPA-14: latex of -St(40)-BA(55)-AA(5)-(Tg of −2° C., and I/O value of 0.319)
LPA-15: latex of -St(25)-BA(70)-AA(5)-(Tg of −21° C., and I/O value of 0.377)
LPA-16: latex of -MMA(58)-St(8)-BA(32)-AA(2)-(Tg of 34° C., and I/O value of 0.515)
LPA-17: latex of -MMA(50)-St(8)-BA(35)-HEMA(5)-AA(2)- (Tg of 27° C., and I/O value of 0.542)
LPA-18: latex of -MMA(42)-St(8)-BA(43)-HEMA(5)-AA(2)- (Tg of 14° C., and I/O value of 0.528)
LPA-19: latex of -MMA(24)-St(8)-BA(61)-HEMA(5)-AA(2)- (Tg of −12° C., and I/O value of 0.498)
LPA-20: latex of -MMA(48)-St(8)-BA(27)-HEMA(15)-AA(2)-(Tg of 39° C., and I/O value of 0.619)
LPA-21: latex of -EA(96)-AA(4)-(Tg of −21° C., and I/O value of 0.664)
LPA-22: latex of -EA(46)-MA(50)-AA(4)-(Tg of −4° C., and I/O value of 0.739)
LPA-23: latex of -EA(80)-HEMA(16)-AA(4)-(Tg of −9° C., and I/O value of 0.775)
LPA-24: latex of -EA(86)-HEMA(10)-AA(4)-(Tg of −13° C., and I/O value of 0.733)
LPA-25: latex of -St(45)-Bu(52)-MAA(3)-(Tg of −26° C., and I/O value of 0.990)
LPA-26: latex of -St(55)-Bu(42)-MAA(3)-(Tg of −9° C., and I/O value of 0.105)
LPA-27: latex of -St(60)-Bu(37)-MAA(3)-(Tg of 1° C., and I/O value of 0.109)
LPA-28: latex of -St(68)-Bu(29)-MAA(3)-(Tg of 17° C., and I/O value of 0.114)
LPA-29: latex of -St(75)-Bu(22)-MAA(3)-(Tg of 34° C., and I/O value of 0.119)
LPA-30: latex of -St(40)-BA(58)-AA(2)-(Tg of −8.1° C., and I/O value of 0.293)
LPA-31: latex of -St(40)-BA(58)-MAA(2)-(Tg of −7.1° C., and I/O value of 0.287)
LPA-32: latex of -St(57.2)-BA(27.7)-MMA(8.7)-HEMA(4.8)-AA(1.6)-(Tg of 37.8° C., and I/O value of 0.269)
LPA-33: latex of -St(49.6)-BA(40)-MMA(4)-HEMA(4.8)-AA(1.6)-(Tg of 16.7° C., and I/O value of 0.289)
LPA-34: latex of -St(80)-2EHA(18)-AA(2)-(Tg of 59.7° C., and I/O value of 0.148)
LPA-35: latex of -St(70)-2EHA(28)-AA(2)-(Tg of 40.9° C., and I/O value of 0.164)
LPA-36: latex of -St(10)-2EHA(38)-MMA(50)-AA(2)-(Tg of25.6° C., and I/O value of 0.427)
LPA-37: latex of -St(10)-2EHA(58)-MMA(30)-AA(2)-(Tg of −3.9° C., and I/O value of 0.365)
LPA-38: latex of -St(10)-2EHA(78)-MMA(10)-AA(2)-(Tg of −28.1° C., and I/O value of 0.308)
LPA-39: latex of -St(20)-2EHA(68)-MMA(10)-AA(2)-(Tg of −16.8° C., and I/O value of 0.285)
LPA-40: latex of -St(30)-2EHA(58)-MMA(10)-AA(2)-(Tg of −4.4° C., and I/O value of 0.263)
LPA-41: latex of -MMA(45)-BA(52)-itaconic acid(3)-(Tg of 4° C., and I/O value of 0.560)
LPA-42: latex of -St(62)-Bu(35)-MAA(3)-(crosslinking, Tg of 5° C.)
LPA-43: latex of -St(68)-Bu(29)-AA(3)-(crosslinking, Tg of 17° C.)
LPA-44: latex of -St(71)-Bu(26)-AA(3)-(crosslinking, Tg of 24° C.)
LPA-45: latex of -St(70)-Bu(27)-IA(3)-(crosslinking, Tg of 23° C.)
LPA-46: latex of -St(75)-Bu(24)-AA(1)-(crosslinking, Tg of 29° C.)
LPA-47: latex of -St(60)-Bu(35)-DVB(3)-MAA(2)-(crosslinking, Tg of 6° C.)
LPA-48: latex of -St(70)-Bu(25)-DVB(2)-AA(3)-(crosslinking, Tg of 26° C.)
LPA-49: latex of -St(70.5)-Bu(26.5)-AA(3)-(crosslinking, Tg of 23° C.)
LPA-50: latex of -St(69.5)-Bu(27.5)-AA(3)-(crosslinking, Tg of 20.5° C.)
LPA-51, latex of -St(61.3)-isoprene(35.5)-AA(3)-(crosslinking, Tg of 17° C.)
LPA-52, latex of -St(67)-isoprene(28)-Bu(2)-AA(3)- (crosslinking, Tg of 27° C.).

In the foregoing, the abbreviations represent following monomers: MMA: methyl methacrylate, EA: ethyl acrylate, MA: methyl acrylate, MMA: methacrylic acid, 2EHA: 2-ethylhexyl acrylate, HEMA: hydroxyethyl methacrylate, St: styrene, Bu: butadiene, AA: acrylic acid, DVB: divinylbenzene, and IA: itaconic acid.

Aqueous dispersions of the hydrophobic polymers mentioned above are commercially available, and following ones can be utilized. Examples of acrylic polymer include CEBIEN A-4635, 4718, and 4601 (manufactured by Daicel Chemical Industries, Ltd.), and NIPOL Lx 811, 814, 821, 820, and 857 (manufactured by Zeon Corp.); examples of polyester include FINETEX ES 650, 611, 675, and 850 (manufactured by Dainippon Ink and Chemicals Inc.), and WD-size, and WMS (manufactured by Eastman Chemical Co.); examples of polyurethane include HYDRAN AP 10, 20, 30, and 40 (manufactured by Dainippon Ink and Chemicals Inc.); examples of rubber include LACSTAR 7310K, 3307B, 4700H, and 7132C (manufactured by Dainippon Ink and Chemicals Inc.), and NIPOL Lx 416, 410, 438C., and 2507 (manufactured by Zeon Corp.); examples of polyvinyl chloride include G351, and G576 (manufactured by Zeon Corp.); examples of polyvinylidene chloride include L502, and L513 (manufactured by Asahi Chemical Industries Ltd.); and examples of polyolefin include CHEMIPAR S120, and SA100 (manufactured by Mitsui Chemical Co.).

A latex of a styrene-butadiene copolymer preferably employable in the invention can be LP-42-LP-50 mentioned above or commercially available LACSTAR-3307B, and 7132C (manufactured by Dainippon Ink and Chemicals Inc.), or NIPOL Lx 416 (manufactured by Zeon Corp.).

Also a latex of a styrene-isoprene copolymer can be LP-51 or LP-52 mentioned above.

These aqueous dispersions of the hydrophobic polymer may be employed alone or in a blend of two or more kinds according to the necessity.

The non-photosensitive intermediate layer A of the invention may contain a hydrophilic polymer such as gelatin, polyvinyl alcohol, methyl cellulose, hydroxypropyl cellulose or carboxymethyl cellulose, if necessary.

The content of the hydrophobic polymer in the entire coating liquid for the non-photosensitive intermediate layer A is preferably within a range from 5 to 50 mass %, and more preferably 10 to 40 mass %.

A coating amount of the hydrophobic polymer in the non-photosensitive intermediate layer A is preferably 0.1 to 10 g/m², more preferably 0.3 to 7 g/m² and most preferably 0.5 to 5 g/m².
2) Auxiliary Film Forming Agent

An auxiliary film forming agent may be added to the aqueous dispersion of the hydrophobic polymer in order to control a minimum film forming temperature of the aqueous dispersion. The auxiliary film forming agent is also called a temporary plasticizer and is an organic compound (usually an organic solvent) which reduces the minimum film forming temperature of a polymer latex, and is described in Chemistry of Synthetic Latex (Soichi Muroi, published by Kobunshi Kankokai, 1970). Preferred examples of the auxiliary film forming agent are shown below, but the compound employable in the present invention is not limited to such examples:
Z-1: benzyl alcohol
Z-2: 2,2,2,4-tetramethylpentanediol-1,3-monoisobutyrate
Z-3: 2-dimethylaminoethanol
Z-4: diethylene glycol.
3) Thickener

To the coating liquid for forming the non-photosensitive intermediate layer A, a thickener is preferably added. An addition of a thickener is preferable as it can form a hydrophobic layer of a uniform thickness. The thickener can be, for example, polyvinyl alcohol, hydroxyethyl cellulose or an alkali metal salt of carboxymethyl cellulose, but a thickener having a thixotropic property is preferable in consideration of ease of handling. For this reason, there is employed hydroxyethyl cellulose, sodium hydroxymethylcarboxylate or carboxymethyl-hydroxyethyl cellulose.

Also the coating liquid for the non-photosensitive intermediate layer A containing the thickener preferably has a viscosity at 40° C. within a range of 1 to 200 mPa·s, more preferably 10 to 100 mPa·s, and still more preferably 15 to 60 mPa·s.
4) Other Additives

The non-photosensitive intermediate layer A can contain not only the binder, but also various additives, such as a surfactant, a pH regulating agent, an antiseptic and/or an antimold agent.
5) Providing Position

The non-photosensitive intermediate layer A can be provided in any position at the side of the image forming layer and farther from the substrate than the image forming layer. It is preferably provided at a side farther from the substrate than the image forming layer and adjacent to the image forming layer.

(2) Hydrophilic Polymer-1 Containing Layer

1) Binder

In the invention, the hydrophilic polymer-1 containing layer means a layer which contains the hydrophilic polymer 1 by 50 mass % or more. Regardless of whether the hydrophilic polymer-1 containing layer is an outermost layer or a non-photosensitive intermediate layer B, the content of the hydrophilic polymer 1 is preferably from 50 to 100 mass %, and more preferably 60 to 100 mass %. When the content of the hydrophilic polymer not derived from an animal protein is less than 50 mass %, a setting property deteriorates at the time of coating and drying operations, thereby eventually causing unevenness in the obtained surface.

In the invention, the hydrophilic polymer 1 (hydrophilic polymer derived from an animal protein) means a natural or chemically modified water-soluble polymer such as glue, casein, gelatin or egg white.

It is preferably gelatin, which is classified into an acid-processed gelatin and an alkali-processed gelatin (such as lime-processed gelatin) according to the synthesizing method, both of which can be employed advantageously. It is preferable to employ gelatin of a molecular weight of 10,000 to 1,000,000. There can also be utilized modified gelatin which is modified utilizing an amino group or a carboxyl group of gelatin (such as phthalated gelatin). It is possible to utilize inert gelatin (for example, Nitta gelatin 750), or phthalated gelatin (for example, Nitta gelatin 801) as the gelatin.

An aqueous solution of gelatin assumes a sol state when heated to a temperature of 30° C. or higher, and shifts to a gel state and thereby loses fluidity when cooled to a lower temperature. Since such sol-gel change takes place reversibly by temperature, the aqueous gelatin solution serving as a coating solution has a setting property of losing fluidity when it is cooled to a temperature lower than 30° C.

The hydrophilic polymer 1 may be used in combination with the hydrophilic polymer 2 (hydrophilic polymer not derived from an animal protein) and/or the hydrophobic polymer. In the case where the hydrophilic polymer-1 containing layer is used as the outermost layer, the binder preferably contains the hydrophilic polymer 1 and a hydrophobic polymer. In such case, a preferred ratio of the hydrophilic polymer 1 used to the hydrophobic polymer used is 50:50 to 99:1, more preferably 50:50 to 80:20. The hydrophobic polymer usable in combination can be the same as that usable in the non-photosensitive intermediate layer A.

The content of the hydrophilic polymer 1 in the coating liquid is, regardless of which the layer is an outermost layer or a non-photosensitive intermediate layer B, 1 to 20 mass % with respect to the entire coating liquid, and preferably 2 to 12 mass %.
2) Crosslinking Agent

The hydrophilic polymer-1 containing layer preferably contains a crosslinking agent. An addition of a crosslinking agent improves hydrophobicity and water resistance of the non-photosensitive intermediate layer A, thereby providing an excellent photothermographic material.

The crosslinking agent may contain, within the molecule, plural groups capable of reacting with an amino group or a carboxyl group, and the type thereof is not particularly restricted. Examples of the crosslinking agent are described in T. H. James, “The Theory of the Photographic Process Fourth Edition” (Macmillan Publishing Co. Inc., 1977) pp. 77-87, and, both an inorganic crosslinking agent (such as chromium alum) and an organic crosslinking agent may be preferably employed as such, but an organic crosslinking agent is more preferable.

Also a crosslinking agent for a hydrophobic polymer containing layer such as the non-photosensitive intermediate layer A may contain, within the molecule, plural groups capable of reacting with a carboxyl group, and the type thereof is not particularly restricted.

Typical examples of the organic crosslinking agent include a carboxylic acid derivative, a carbamic acid derivative, a sulfonate ester, a sulfonyl compound, an epoxy compound, an azilidine compound, an isocyanate compound, a carbodiimide compound, and an oxazoline compound. It is more preferably an epoxy compound, an isocyanate compound, a carbodiimide compound or an oxazoline compound. These crosslinking agents may be employed alone or in a combination of two or more kinds.

Specific examples thereof are shown below, but the present invention is not limited to such examples.

Carbodiimide Compound

There is preferred a water-soluble or water-dispersible carbodiimide compound, for example polycarbodiimide derived from isophorone diisocyanate as described in JP-A No. 59-187029 and Japanese Patent Publication (JP-B) No. 5-27450, a carbodiimide compound derived from tetramethylxylilene disocyanate described in JP-A No. 7-330849, a branched carbodiimide compound described in JP-A No. 10-30024 and a carbodiimide compound derived from dicyclohexylmethane diisocyanate described in JP-A No. 2000-7642.

Oxazoline Compound

There is preferred a water-soluble or water-dispersible oxazoline compound, for example an oxazoline compound as described in JP-A No. 2001-215653.

Isocyanate Compound

As it is reactive with water, there is preferred a water-dispersible isocyanate compound in consideration of a pot life, particularly a compound of self-emulsifiable property. Examples thereof include water-dispersible isocyanate compounds described in JP-A Nos. 7-304841, 8-277315, 10-45866, 9-71720, 9-328654, 9-104814, 2000-194045, 2000-194237 and 2003-64149.

Epoxy Compound

There is preferred a water-soluble or water-dispersible epoxy compound, for example water-dispersible epoxy compounds described in JP-A Nos. 6-329877 and 7-309954.

Specific examples of the crosslinking agent employable in the invention are shown below, but the invention is not limited to such examples.

Epoxy Compound:

Trade name: DICFINE EM-60 (Dainippon Ink and Chemicals Inc.)

Isocyanate Compound:

Trade name:
DURANATE WB40-100 (Asahi Kasei Co.)
DURANATE WB40-80D (Asahi Kasei Co.)
DURANATE WT20-100 (Asahi Kasei Co.)
DURANATE WT30-100 (Asahi Kasei Co.)
CR-60N (Dainippon Ink and Chemicals Inc.)
   Carbodiimide Compound
   Trade name:
CARBODILITE V-02 (Nisshinbo Industries Inc.)
CARBODILITE V-02-L2 (Nisshinbo Industries Inc.)
CARBODILITE V-04 (Nisshinbo Industries Inc.)
CARBODILITE V-06 (Nisshinbo Industries Inc.)
CARBODILITE E-01 (Nisshinbo Industries Inc.)
CARBODILITE E-02 (Nisshinbo Industries Inc.)
   Oxazoline Compound
   Trade name:
EPOCROSS K-1010E (Nippon Shokubai Co.)
EPOCROSS K-1020E (Nippon Shokubai Co.)
EPOCROSS K-1030E (Nippon Shokubai Co.)
EPOCROSS K-2010E (Nippon Shokubai Co.)
EPOCROSS K-2020E (Nippon Shokubai Co.)
EPOCROSS K-2030E (Nippon Shokubai Co.)
EPOCROSS WS-500 (Nippon Shokubai Co.)
EPOCROSS WS-700 (Nippon Shokubai Co.).

The crosslinking agent employed in the invention may be added to a layer forming system in the form of a mixture in which it has been applied to a binder solution, or may be added thereto at last in a process for preparing a coating liquid, or immediately before coating.

The crosslinking agent in the invention is preferably employed in an amount of 0.5 to 200 parts by mass with respect to 100 parts by mass of the binder of the layer in which the crosslinking agent is contained, more preferably 2 to 100 parts by mass and still more preferably 3 to 50 parts by mass.
3) Other Additives

The hydrophilic polymer-1 containing layer may further include a surfactant, a pH regulating agent, an antiseptic, an antimold agent, a dye, a pigment, a color toning agent and the like.
4) Providing Position

The hydrophilic polymer-1 containing layer may be provided in any position, but it is preferably provided at the side of the image forming layer and in a position farther from the substrate than the image forming layer, and more preferably in any position farther from the substrate than the non-photosensitive layer A. In consideration of the setting property, the hydrophilic polymer-1 containing layer is preferably provided as an outermost layer, and, in consideration of water resistance and prevention of fingerprint attaching, it is preferably provided between the outermost layer and the non-photosensitive layer A.

(3) Hydrophilic Polymer-2 Containing Layer

1) Binder

In the invention, the hydrophilic polymer-2 containing layer means a layer which contains the hydrophilic polymer 2 by 50 mass % or more. Regardless of whether the hydrophilic polymer-2 containing layer is an outermost layer or a non-photosensitive intermediate layer B, the content of the hydrophilic polymer 2 is preferably from 50 to 100 mass %, and more preferably 60 to 100 mass % with respect to the total binder in the hydrophilic polymer-2 containing layer. In the case where the hydrophilic polymer-2 containing layer is positioned between a gelatin-containing layer and the non-photosensitive intermediate layer A and in the case where the content of the hydrophilic polymer not derived from an animal protein is less than 50 mass %, an effect of preventing coagulation is reduced.

The hydrophilic polymer 2 may be used in combination with the hydrophilic polymer 1 and/or the hydrophobic polymer. The hydrophobic polymer usable in combination can be the same as that usable in the non-photosensitive intermediate layer A. The hydrophilic polymer 1 usable in combination can be the same as that usable in the hydrophilic polymer-1 containing layer.

The hydrophilic polymer not derived from an animal protein means a natural polymer (polysaccharide-type, microorganism-type or animal-type one) other than an animal protein such as gelatin, a semi-synthetic polymer (cellulose, starch or alginate) or a synthetic polymer (vinyl polymer and other polymer), and includes synthetic polymers including polyvinyl alcohol and natural or semi-synthetic polymers made of, for example, cellulose derived from a vegetable, which are shown later. It is preferably a polyvinyl alcohol and/or an acrylic acid-vinyl alcohol copolymer.

The hydrophilic polymer not derived from an animal protein does not have a setting property, but shows a setting property when used in combination with a gelling agent, thereby improving the coating property.

The hydrophilic polymer not derived from animal protein in the invention is preferably polyvinyl alcohol. The polyvinyl alcohol (PVA) preferably employable in the invention includes various types differing in a saponification degree, a polymerization degree, and a neutralization degree, modified substances and copolymers with various monomers.

A completely saponified material can be selected for example from PVA-105 [polyvinyl alcohol (PVA) content of 94.0 mass % or higher, saponification degree of 98.5±0.5 mol. %, sodium acetate content of 1.5 mass % or less, volatile component content of 5.0 mass % or less, and viscosity (4 mass %, 20° C.) of 5.6±0.4 CPS], PVA-110 [PVA content of 94.0 mass %, saponification degree of 98.5 ±0.5 mol. %, sodium acetate content of 1.5 mass %, volatile component content of 5.0 mass %, and viscosity (4 mass %, 20° C.) of 11.0±0.8 CPS], PVA-117 [PVA content of 94.0 mass %, saponification degree of 98.5±0.5 mol. %, sodium acetate content of 1.0 mass %, volatile component content of 5.0 mass %, and viscosity (4 mass %, 20° C.) of 28.0±3.0 CPS], PVA-117H [PVA content of 93.5 mass %, saponification degree of 99.6±0.3 mol. %, sodium acetate content of 1.85 mass %, volatile component of 5.0 mass %, and viscosity (4 mass %, 20° C.) of 29.0±3.0 CPS], PVA-120 [PVA content of 94.0 mass %, saponification degree of 98.5±0.5 mol. %, sodium acetate content of 1.0 mass %, volatile component content of 5.0 mass %, and viscosity (4 mass %, 20° C.) of 39.5±4.5 CPS], PVA-124 [PVA content of 94.0 mass %, saponification degree of 98.5±0.5 mol. %, sodium acetate content of 1.0 mass %, volatile component content of 5.0 mass %, and viscosity (4 mass %, 20° C.) of 60.0±6.0 CPS], PVA-124H [PVA content of 93.5 mass %, saponification degree of 99.6±0.3 mol. %, sodium acetate content of 1.85 mass %, volatile component content of 5.0 mass %, and viscosity (4 mass %, 20° C.) of 61.0±6.0 CPS], PVA-CS [PVA content of 94.0 mass %, saponification degree of 97.5±0.5 mol. %, sodium acetate content of 1.0 mass %, volatile component content of 5.0 mass %, and viscosity (4 mass %, 20° C.) of 27.5±3.0 CPS], PVA-CST [PVA content of 94.0 mass %, saponification degree of 96.5±0.5 mol. %, sodium acetate content of 1.0 mass %, volatile component content of 5.0 mass %, and viscosity (4 mass %, 20° C.) of 27.0±3.0 CPS], and PVA-HC [PVA content of 90.0 mass %, saponification degree of 99.85 mol. % or higher, sodium acetate content of 2.5 mass %, volatile component content of 8.5 mass %, and viscosity (4 mass %, 20° C.) of 25.0±3.5 CPS] (trade names of Kuraray Co.).

Also a partially saponified material can be selected for example from PVA-203 [PVA content of 94.0 mass %, saponification degree of 88.0±1.5 mol. %, sodium acetate content of 1.0 mass %, volatile component content of 5.0 mass %, and viscosity (4 mass %, 20° C.) of 3.4±0.2 CPS], PVA-204 [PVA content of 94.0 mass %, saponification degree of 88.0±1.5 mol. %, sodium acetate content of 1.0 mass %, volatile component content of 5.0 mass %, and viscosity (4 mass %, 20° C.) of 3.9±0.3 CPS], PVA-205 [PVA content of 94.0 mass %, saponification degree of 88.0±1.5 mol. %, sodium acetate content of 1.0 mass %, volatile component content of 5.0 mass %, and viscosity (4 mass %, 20° C.) of 5.0±0.4 CPS], PVA-210 [PVA content of 94.0 mass %, saponification degree of 88.0±1.0 mol. %, sodium acetate content of 1.0 mass %, volatile component content of 5.0 mass %, and viscosity (4 mass %, 20° C.) of 9.0±1.0 CPS], PVA-217 [PVA content of 94.0 mass %, saponification degree of 88.0±1.0 mol. %, sodium acetate content of 1.0 mass %, volatile component content of 5.0 mass %, and viscosity (4 mass %, 20° C.) of 22.5±2.0CPS],PVA-220 [PVA content of 94.0 mass %, saponification degree of 88.0±1.0 mol. %, sodium acetate content of 1.0 mass %, volatile component content of 5.0 mass %, and viscosity (4 mass %, 20° C.) of 30.0±3.0 CPS], PVA-224 [PVA content of 94.0 mass %, saponification degree of 88.0±1.5 mol. %, sodium acetate content of 1.0 mass %, volatile component content of 5.0 mass %, and viscosity (4 mass %, 20° C.) of 44.0±4.0 CPS], PVA-228 [PVA content of 94.0 mass %, saponification degree of 88.0±1.5 mol. %, sodium acetate content of 1.0 mass %, volatile component content of 5.0 mass %, and viscosity (4 mass %, 20° C.) 65.0±5.0 CPS], PVA-235 [PVA content of 94.0 mass %, saponification degree of 88.0±1.5 mol. %, sodium acetate content of 1.0 mass %, volatile component content of 5.0 mass %, and viscosity (4 mass %, 20° C.) of 95.0±15.0 CPS], PVA-217EE [PVA content of 94.0 mass %, saponification degree of 88.0±1.0 mol. %, sodium acetate content of 1.0 mass %, volatile component content of 5.0 mass %, and viscosity (4 mass %, 20° C.) of 23.0±3.0 CPS], PVA-217E [PVA content of 94.0 mass %, saponification degree of 88.0±1.0 mol. %, sodium acetate content of 1.0 mass %, volatile component content of 5.0 mass %, and viscosity (4 mass %, 20° C.) of 23.0±3.0 CPS], PVA-220E [PVA content of 94.0 mass %, saponification degree of 88.0±1.0 mol. %, sodium acetate content of 1.0 mass %, volatile component content of 5.0 mass %, and viscosity (4 mass %, 20° C.) of 31.0±4.0 CPS], PVA-224E [PVA content of 94.0 mass %, saponification degree of 88.0±1.0 mol. %, sodium acetate content of 1.0 mass %, volatile component content of 5.0 mass %, and viscosity (4 mass %, 20° C.) of 45.0±5.0 CPS], PVA-403 [PVA content of 94.0 mass %, saponification degree of 80.0±1.5 mol. %, sodium acetate content of 1.0 mass %, volatile component content of 5.0 mass %, and viscosity (4 mass %, 20° C.) of 3.1±0.3 CPS], PVA-405 [PVA content of 94.0 mass %, saponification degree of 81.5±1.5 mol. %, sodium acetate content of 1.0 mass %, volatile component content of 5.0 mass %, and viscosity (4 mass %, 20° C.) of 4.8±0.4 CPS], PVA-420 [PVA content of 94.0 mass %, saponification degree of 79.5±1.5 mol. %, sodium acetate content of 1.0 mass %, and volatile component content of 5.0 mass %], PVA-613 [PVA content of 94.0 mass %, saponification degree of 93.5±1.0 mol. %, sodium acetate content of 1.0 mass %, volatile component content of 5.0 mass %, and viscosity (4 mass %, 20° C.) of 16.5±2.0 CPS], and L-8 [PVA content of 96.0 mass %, saponification degree of 71.0±1.5 mol. %, sodium acetate content of 1.0 mass % (ash), volatile component of 3.0 mass %, and viscosity (4 mass %, 20° C.) of 5.4±0.4 CPS] (trade names of Kuraray Co.).

The foregoing values are measured according to JIS K-6726-1977.

A modified polyvinyl alcohol can be selected from materials modified with a cation, an anion, an —SH compound, an alkylthio compound and a silanol. In addition, there can be employed a modified polyvinyl alcohol described in “Poval”, Koichi Nagano et al., published by Kobunshi Kankokai.

Examples of such modified polyvinyl alcohol (modified PVA) includes C-polymers such as C-118, C-318, C-318-2A, and C-506 (trade names of Kuraray Co.), HL-polymers such as HL-12E, and HL-1203 (trade names of Kuraray Co.), HM-polymers such as HM-03, and HM-N-03 (trade names of Kuraray Co.), K-polymers such as KL-118, KL-318, KL-506, KM-118T and KM-618 (trade names of Kuraray Co.), M-polymers such as M-115 (trade name of Kuraray Co.), MP-polymers such as MP-102, MP-202 and MP-203 (trade names of Kuraray Co.), MPK-polymers such as MPK-1, MPK-2, MPK-3, MPK-4, MPK-5 and MPK-6 (trade names of Kuraray Co.), R-polymers such as R-1130, R-2105 and R-2130 (trade names of Kuraray Co.), and V-polymer such as V-2250 (trade name of Kuraray Co.).

The viscosity of polyvinyl alcohol can be adjusted or stabilized by adding a trace amount of a solvent or an inorganic salt to an aqueous solution of polyvinyl alcohol, and there can be employed compounds described in the aforementioned reference “Poval”, Koichi Nagano et al., published by Kobunshi Kankokai, p. 144-154. For example, a coated surface property can be improved by an addition of boric acid. The amount of boric acid added is preferably 0.01 to 40 mass % with respect to polyvinyl alcohol.

The aforementioned reference “Poval” also describes that polyvinyl alcohol shows an increase in crystallinity and an increase in water resistance by a heating process, and among water-soluble polymers, polyvinyl alcohol is particularly preferable in the invention since water resistance can be improved by heating polyvinyl alcohol at the time of coating and/or drying step or by additionally heating polyvinyl alcohol after drying.

In order to further improve water resistance, the hydrophilic polymer 2 containing layer preferably contains a water-proofing agent as described in the aforementioned reference, pages 256-261, for example, an aldehyde, a methylol compound (such as N-methylolurea or N-methylolmelamine), an activated vinyl compound (such as divinylsulfone or a derivative thereof), bis(β-hydroxyethylsulfone), an epoxy compound (such as epichlorhydrin or a derivative thereof), a polyvalent carboxylic acid (such as a dicarboxylic acid, a polycarboxylic acid such as polyacrylic acid, a methyl vinyl ether-maleic acid copolymer, or an isobutylene-maleic anhydride copolymer), a diisocyanate, or an inorganic crosslinking agent (such as a compound of Cu, B, Al, Ti, Zr, Sn, V or Cr).

A water-proofing agent preferred in the invention can be an inorganic crosslinking agent. Boric acid or a derivative thereof is more preferable and boric acid is particularly preferable. In the following, specific examples of boric acid derivatives are shown.

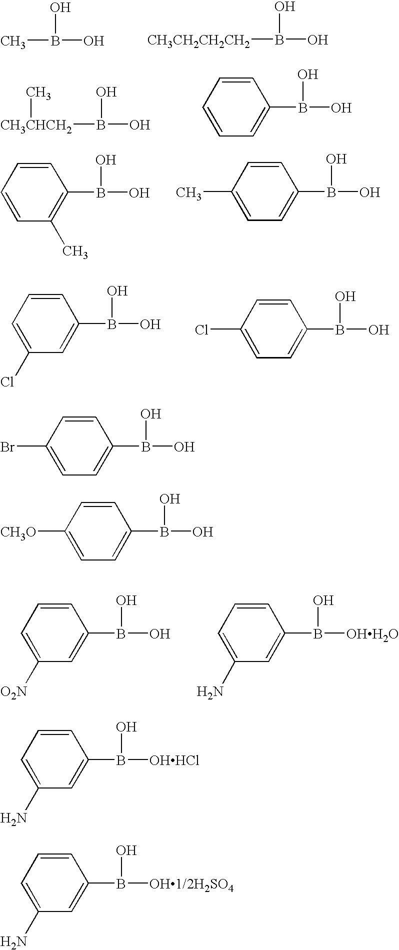

Such water-proofing agent is preferably employed in an amount of 0.01 to 40 mass % with respect to polyvinyl alcohol.

Examples of the hydrophilic polymer 2 in the invention include, in addition to polyvinyl alcohol, following compounds.

Other examples include vegetable-derived polysaccharides such as gum arabic, κ-carrageenan, ι-carrageenan, λ-carrageenan, guar gum (such as Supercol manufactured by Squalon), locust bean gum, pectin, tragacanth, corn starch (such as Purity-21 manufactured by National Starch & Chemical Co.), and phosphoric acid-processed starch (such as National 78-1898 manufactured by National Starch & Chemical Co.).

Microorganism-derived polysaccharides can be used as the hydrophilic polymer 2 and examples thereof include xanthane gum (such as KELTROL T manufactured by Kelco), and dextrin (such as NADEX 360 manufactured by National Starch & Chemical Co.). Animal-derived polysaccharides can also be used as the hydrophilic polymer 2 and examples thereof include sodium chondroitinsulfurate (such as CROMOIST CS manufactured by Croda).

Cellulose polymers can also be used as the hydrophilic polymer 2 and examples thereof include ethyl cellulose (such as CELLOFAS WLD manufactured by I.C.I.), carboxymethyl cellulose (such as CMC manufactured by Daicel), hydroxyethyl cellulose (such as HEC manufactured by Daicel), hydroxypropyl cellulose (such as KLUCEL manufactured by Aqualon), methyl cellulose (such as VISCONTRAN manufactured by Henkel), nitrocellulose (such as ISOPROPYL WET manufactured by Hercules), and cationized cellulose (such as CRODACEL QM manufactured by Croda). Alginate compounds can also be used the hydrophilic polymer 2 and examples thereof include sodium alginate (such as KELTONE manufactured by Kelco), and propylene glycol alginate. Other examples of the hydrophilic polymer 2 include cationized guar gum (such as HI-CARE 1000 manufactured by Alcolac), and sodium hyaluronate (such as HYALURE manufactured by Lifecare Biomedial Inc.).

Still other examples include agar, furcelleran, guar gum, karaya gum, larch gum, guar seed gum, psyllium seed gum, quince seed gum, tamarind gum, gellan gum and tara gum. Among these, a substance having a high water-solubility is preferable, and a substance capable of forming an aqueous solution showing a sol-gel change within 24 hours within a temperature range of 5 to 95° C. is employed preferably.

Examples of synthetic polymers include acrylic polymers such as sodium polyacrylate, polyacrylic acid copolymer, polyacrylamide, and polyacrylamide copolymer; vinyl polymers such as polyvinylpyrrolidone, and polyvinylpyrrolidone copolymer; and other polymers such as polyethylene glycol, polypropylene glycol, polyvinyl ether, polyethylenimine, polystylenesulfonic acid and copolymers thereof, polyvinylsulfonic acid and copolymers thereof, polyacrylic acid and copolymers thereof, acrylic acid and copolymers thereof, maleic acid copolymers, maleic acid monoester copolymers, and acryloylmethylpropane sulfonicacid and copolymers thereof.

There can also be employed a high water-absorbing polymer described in U.S. Pat. No.4,960,681 and JP-A No. 62-245260, namely a homopolymer of a vinyl monomer having —COOM or —SO₃M (M being a hydrogen atom or an alkali metal), or a copolymer of such monomers or a copolymer of at least one of such monomers and another vinyl monomer (such as sodium methacrylate, ammonium methacrylate or SUMICAGEL L-5H manufactured by Sumitomo Chemical Co.).

Among these, the water-soluble polymer preferably employable is SUMICAGEL L-5H manufactured by Sumitomo Chemical Co.

The hydrophilic polymer 2 is employed in a coating amount (per m² of substrate) preferably of 0.1 to 10 g/m², and more preferably 0.3 to 3 g/m².

A concentration of the hydrophilic polymer 2 in the coating liquid is preferably so adjusted that the viscosity at the time of addition becomes suitable for a simultaneous superposed coating, but is not particularly restricted. In general, the concentration in the liquid is preferably 5 to 20 mass %, more preferably 7 to 15 mass %, and still more preferably 8 to 13 mass %.

A polymer dispersible in an aqueous solvent may be used in combination with the hydrophilic polymer 2.

A preferred polymer dispersible in an aqueous solvent is a synthetic resin, a polymer, a copolymer or a film-forming medium, for example cellulose acetates, cellulose acetate butyrates, polymethylmethacrylic acids, polyvinyl chlorides, polymethacrylic acids, styrene-maleic anhydride copolymers, styrene-acrylonitrile copolymers, styrene-butadiene copolymers, polyvinylacetals (such as polyvinylformal or polyvinylbutyral), polyesters, polyurethanes, phenoxy resins, polyvinylidene chlorides, polyepoxides, polycarbonates, polyvinyl acetates, polyolefins, cellulose esters and polyamides.

A preferred latex usable in combination with the hydrophilic polymer 2 is, for example, a latex usable in the non-photosensitive intermediate layer A, or a latex of polyacrylate, polyurethane, polymethacrylate or a copolymer containing the same.

In the following, specific examples of the preferred latex employable in combination with the hydrophilic polymer 2 are shown.
LP-1: latex of -MMA(70)-EA(27)-MAA(3)-(molecular weight of 37,000, and Tg of 61° C.)
LP-2: latex of -MMA(70)-2EHA(20)-St(5)-AA(5)-(molecular weight of 40,000, and Tg of 59° C.)
LP-3: latex of -VC(50)-MMA(20)-EA(20)-AN(5)-AA(5)-(molecular weight of 80,000)
LP-4: latex of -VDC(85)-MMA(5)-EA(5)-MAA(5)-(molecular weight of 67,000)
LP-5: latex of -Et(90)-MMA(10)-(molecular weight of 12,000)
LP-6: latex of -MMA(42)-BA(56)-AA(2)-(molecular weight of 540,000, and Tg of −4° C.)
LP-7: latex of -MMA(63)-EA(35)-AA(2)-(molecular weight of 33,000, and Tg of 47° C.)
LP-8: latex of -St(70.5)-Bu(26.5)-AA(3)-(crosslinking, Tg of 23° C.)
LP-9: latex of -St(69.5)-Bu(27.5)-AA(3)-(crosslinking, Tg of 20.5° C.)
LP-10: latex of -St(70)-2EHA(27)-AA(3)-(molecular weight of 130,000, and Tg of 43° C.).

In the foregoing, the abbreviations represent following monomers: MMA: methyl methacrylate, EA: ethyl acrylate, MMA: methacrylic acid, 2EHA: 2-ethylhexyl acrylate, St: styrene, Bu: butadiene, AA: acrylic acid, DVB: divinylbenzene, VC: vinyl chloride, AN: acrylonitrile, VDC: vinylidene chloride, Et: ethylene, and IA: itaconic acid.

In addition, various commercially available water-soluble resins can be used as the water-soluble polymer or polymer latex in the invention. Examples of the commercially available water-soluble resins include, but are not limited to, water-dispersible or water-soluble acrylic resins such as ACRISET (manufactured by Nippon Shokubai Co.) and AROLON (manufactured by Nippon Shokubai Co.); aqueous polyurethanes such as HYDRAN (manufactured by Dai-Nippon Ink and Chemicals Ltd.), BONDIC (manufactured by Dai-Nippon Ink and Chemicals Ltd.), POISE (manufactured by Kao Corp.), SUPERFLEX (manufactured by Dai-ichi Kogyo Seiyaku Co.), and NEOLETS (manufactured by Zeneca Ltd.); aqueous polyesters such as BIRONAL (manufactured by Toyobo Co.), and FINETEX (manufactured by Dai-Nippon Ink and Chemicals Ltd.); water-dispersible, water-dilutable or water-soluble alkyd resins such as HOLS (manufactured by Kansai Paint Co.); water-dispersible, water-dilutable or water-soluble polyolefins resin such as ISOBAN (manufactured by Kuraray Isoprene Chemical Co.), PRIMACOL (manufactured by Dow Chemical Co.), and HITEC (manufactured by Toho Chemical Industry Co.); water-dispersible epoxy resins such as EPICLON (manufactured by Dai-Nippon Ink and Chemicals Ltd.); vinyl chloride emulsions; and water-dispersible or water-soluble acrylic resins such as JURYMER, JUNLON, RHEOGIC and ARONVIS (manufactured by Nippon Junyaku Co.).

Specific examples thereof include water-dispersible or water-soluble acrylic resins such as ACRISET 19E, 210E, 260E, and 288E and AROLON 453 (manufactured by Nippon Shokubai Co.), CEBIEN A-4635, 4718, and 4601 (manufactured by Daicel Chemical Industries, Ltd.), and NIPOL Lx 811, 814, 821, 820, and 857 (manufactured by Zeon Corp.); water-dispersible polyurethane resins such as SOFLANATE AE-10, and AE-40 (manufactured by Soflan CO.), HYDRAN AP 10, 20, 30, and 40, HW-110, HW-131, HW-135, HW-320, ECOS-3000, BONDIC 2250 and 72070 (manufactured by Dainippon Ink and Chemicals Inc.), POISE 710 and 720 (manufactured by Kao Corp.), MERCIE 525, 585, 414, and 455 (manufactured by Toyo Polymer Co.); water-dispersible polyesters resin such as BYRONAL MD 1200,1400, and 1930 (manufactured by Toyobo Co.), WD-size, WMS, WD3652, and WJL6342 (manufactured by Eastman Chemical Co.), and FINETEX ES 650, 611, 675, and 850 (manufactured by Dainippon Ink and Chemicals Inc.); water-soluble, water-dilutable or water-dispersible polyolefins resin such as ISOBAN-10, 06, and 04 (manufactured by Kuraray Isoprene Chemical Co.), PRIMACOL 5981, 5983, 5990 and 5991 (manufactured by Dow Chemical Co.), and CHEMIPAR S120, and SA100 (manufactured by Mitsui Petrochemical Co.); water-dispersible or water-soluble acrylic resins such as JURYMER AC-103, 10S, AT-510, ET-410, SEK-301, FC-60, SP-50TF, SPO-602, and AC-70N (manufactured by Nippon Junyaku Co.); water-dispersible rubbers such as LACSTAR 7310K, 3307B, 4700H, and 7132C (manufactured by Dainippon Ink and Chemicals Inc.), NIPOL Lx 416, 410, 438C., and 2507 (manufactured by Zeon Corp.); water-dispersible polyvinyl chlorides such as G351, and G576 (manufactured by Zeon Corp.); and polyvinylidene chlorides such as L502, and L513 (manufactured by Asahi Chemical Industries Ltd.).
2) Coating Liquid

In consideration of the coating property, the hydrophilic polymer-2 containing layer preferably becomes gel by a temperature decrease. Such gelling eliminates the fluidity of a layer formed by coating, whereby the surface of the image forming layer is less influenced by a drying air in a drying step after the coating step, thereby providing a photothermographic material with a uniform coated surface. In order to obtain a coating liquid which gels by a temperature decrease, the coating liquid for the hydrophilic polymer-2 containing layer preferably contains a gelling agent.

It is important that the coating liquid is not gelled at the time of coating operation. In consideration of ease of operation, the coating liquid is fluid at the time of coating operation and becomes gel and thereby loses fluidity prior to the drying step after the coating step. The coating liquid for the hydrophilic polymer-2 containing layer preferably has a viscosity, at the time of coating operation, of 5 to 200 mPa·s and more preferably 10 to 100 mPa·s.

In the invention, the solvent of the coating liquid is an aqueous solvent. The aqueous solvent means water or a mixture of water and 70 mass % or less of a watermiscible organic solvent. Examples of the water-miscible organic solvent include alcohols such as methyl alcohol, ethyl alcohol and propyl alcohol, cellosolves such as methyl cellosolve, ethyl cellosolve and butyl cellosolve, ethyl acetate and dimethylformamide.

The viscosity of a formed layer before the drying step after the coating (the layer has gelled at this time) is difficult to measure, but is estimated generally as 200 to 5,000 mPa·s, and preferably 500 to 5,000 mPa·s.

The gelling temperature is not particularly restricted, but is preferably in the vicinity of room temperature, in consideration of work efficiency of the coating. Such temperature allows easy increasing the fluidity of the coating liquid for facilitating the coating operation, also maintaining such fluidity (namely raised temperature being easily maintained), and allows easy cooling for eliminating the fluidity of the formed layer after the coating. More specifically, the gelling temperature is preferably within a range of 0 to 40° C., and more preferably 0 to 35° C.

A temperature of the coating liquid at the time of coating operation is not particularly restricted as long as it is higher than the gelling temperature. A cooling temperature after the coating and before the drying is not particularly restricted, as long as it is lower than the gelling temperature. However, in the case where a difference between the temperature of the coating liquid and the cooling temperature is small, gellation may start even in the course of the coating operation, thereby hindering a uniform coating. On the other hand, in the case where the temperature of the coating liquid is excessively high in order to increase such temperature difference, the solvent of the coating liquid evaporates, whereby the viscosity of the coating liquid changes. Therefore, the temperature difference is preferably in the range of 5 to 50° C., and more preferably 10 to 40° C.
3) Gelling Agent

A gelling agent in the invention is a substance which, when added to an aqueous solution of the hydrophilic polymer not derived from the animal protein or a latex aqueous solution of the hydrophobic polymer, causes gelation of the solution when the solution is cooled, or causes such gelation when used in combination with a gelling accelerating substance. Such gelation significantly reduces the fluidity of the solution.

The gelling agent is at least a water-soluble polysaccharide selected from agar, κ-carrageenan, ι-carrageenan, alginic acid, an alginic acid salt, agarose, furcelleran, gellan gum, gluconodeltalactone, azotobacter vinerandii gum, xanthane gum, pectin, guar gum, locust bean gum, tara gum, casia gum, glucomannan, tragacanth gum, karaya gum, purlan, gum arabic, arabinogalactan, dextran, carboxymethyl cellulose sodium salt, methyl cellulose, psyllium seed gum, starch, chitin, chitosan, and curdlan.

A substance which is dissolved under heating and gels under cooling can be, for example, agar, carrageenan, and/or gellan gum.

Among these gelling agents, more preferred are κ-carrageenan (K-9F manufactured by Taito Co., or K-15, K-21-24, I-3, manufactured by Nitta Gelatin Co.), ι-carrageenan and/or agar, and particularly prefererred is κ-carrageenan.

The gelling agent is employed in an amount of 0.01 to 10.0 mass % with respect to the binder polymer, preferably 0.02 to 5.0 mass %, and more preferably 0.05 to 2.0 mass %.
3) Gelling Accelerator

The gelling agent is preferably employed in combination with a gelling accelerator. The gelling accelerator in the invention is a substance capable of accelerating gelation by contact with the gelling agent, and exhibits its function by a specific combination with the gelling agent. In the invention, following combinations of the gelling agent and the gelling accelerator may be employed:
(1) A combination of an alkali metal ion such as a potassium ion or an alkali earth metal ion such as calcium or magnesium ion as the gelling accelerator; and carrageenan, an alginatic acid salt, gellan gum, azotobacter vinelandii gum, pectin or carboxymethyl cellulose sodium salt as the gelling agent;
(2) A combination of boric acid or other boron compound as the gelling accelerator; and guar gum, locust bean gum, tara gum or cassia gum as the gelling agent;
(3) A combination of an acid or an alkali as the gelling accelerator; and an alginatic acid salt, glucomannnan, pectin, chitin, chitoxan or curdlan as the gelling agent;
(4) A case emplying a water-soluble polysaccharide capable of forming gel when reacting with a gelling agent, as the gelling accelerator: namely a combination of xanthane gum as the gelling agent and cassia gum as the gelling accelerator or a combination of carrageenan as the gelling agent and locust bean gum as the gelling accelerator.

Specific examples a) to g) of the combinations of such gelling agent and the gelling accelerator are shown below:
a) a combination of κ-carrageenan and potassium;
b) a combination of ι-carrageenan and calcium;
c) a combination of low methoxyl pectin and calcium;
d) a combination of sodium alginate and calcium;
e) a combination of gellan gum and calcium;
f) a combination of gellan gum and an acid; and
g) a combination of locust bean gum and xanthane gum.

These combinations can be used in combination.

The gelling accelerator and the gelling agent may be contained in the same layer, but are preferably contained in different layers. It is more preferable that the gelling accelerator is contained in a layer which is not directly adjacent to the layer containing the gelling agent. It is thus more preferable that a layer which does not contain the gelling agent nor the gelling accelerator is present between a layer containing the gelling agent and a layer containing the gelling accelerator.

The gelling accelerator is employed in an amount of 0.1 to 200 mass % with respect to the gelling agent, and preferably 1.0 to 100 mass %.
5) Other Additives

The hydrophilic polymer-2 containing layer may contain any other additive such as a surfactant, a pH regulating agent, an antiseptic, an antimold agent, a dye, a pigment and/or a color toning agent.
6) Providing Position

The hydrophilic polymer-2 containing layer may be provided as an outermost layer or an intermediate layer. It is preferably provided between the non-photosensitive layer A containing a hydrophobic polymer and the hydrophilic polymer-1 containing layer. The positioning between these layers allows prevention of coagulation of polymers.

(4) Outermost Layer

The outermost layer in the invention may be a hydrophilic polymer-1 containing layer, a hydrophilic polymer-2 containing layer or a hydrophobic polymer containing layer described in the foregoing. Since the outermost layer is directly influenced by the external environment at the time of transport, storage or development, it preferably contains the following additives. The additives may be contained in a layer other than the outermost layer, such as a non-outermost surface protective layer, an intermediate layer, a back layer and/or a back protective layer.
1) Matting Agent

In the invention, it is preferable to add a matting agent to the outermost layer to improve a transporting property. The matting agent is described in JP-A No. 11-65021, paragraphs 0126-0127. A coating amount of the matting agent per m² of the photosensitive material is preferably 1 to 400 mg/m², and more preferably 5 to 300 mg/m².

In the invention, the matting agent may have a regular or irregular shape, however it is preferably of a refular shape and a spherical shape is employed preferably.

The matting agent employed in an emulsion surface preferably has a volume-weighted average sphere-corresponding size of 0.3 to 15 μm, more preferably 0.3 to 10 μm, still more preferably 0.5 to 9 μm and most preferably 0.5 to 7 μm. A fluctuation factor of the size distribution of the matting agent is preferably 5 to 80%, and more preferably 20% to 80%. The fluctuation factor is represented by (standard deviation of particle size)/(average of particle size) x 100. It is also possible to use two or more matting agents of different average particle size in the emulstion surface, and, in such case, a difference between a largest average particle size of the matting agents and a smallest average particle size of the matting agents is preferably 2 to 8 μm, and more preferably 2 to 6 μm.

In the back surface, the matting agent used therein preferably has a volume-weighted average sphere-corresponding size of 1 to 15 μm, and more preferably 3 to 10 μm. A fluctuation factor of the size distribution of the matting agent is preferably 3 to 50%, and more preferably 5 to 30%. It is also possible to use two or more matting agents of different average particle size in the back surface. In such case, a difference between a largest average particle size of the matting agents and a smallest average particle size of the matting agents is preferably 2 to 14 μm, and more preferably 2 to 9 μm.

A matting degree of the emulsion surface may be arbitrarily selected as long as so-called stardust failures are not caused. However, Beck's smoothness thereof is preferably 30 to 2000 seconds, and more preferably 40 to 1500 seconds. The Beck's smoothness can be easily determined in accordance with JIS P8119 “Smoothness testing method with Beck's tester for paper and board”, and TAPPI standard method T479.

In the invention, as for a matting degree of the back layer, Beck's smoothness thereof is preferably 1200 to 10 seconds, more preferably 800 to 20 seconds and still more preferably 500 to 40 seconds.

In the invention, the matting agent is preferably included in an outermost layer of the photosensitive material, or a layer functioning as a surface protective layer, or a layer close to the outermost layer.
2) Lubricant

In order to improve a handling property at the time of manufacture or scratch resistance in a thermal development, a lubricant such as liquid paraffin, a long-chain fatty acid, a fatty acid amide or a fatty acid ester is preferably employed. In particular there is preferred a liquid paraffin from which low-boiling components have been eliminated, or a fatty acid ester of a branched structure having a molecular weight of 1,000 or larger.

The preferred lubricants are compounds described JP-A No. 11-65021, paragraph 0117, JP-A No. 2000-5137, Japanese Patent Applications Nos. 2003-8015, 2003-8071 and 2003-132815.

The lubricant is employed in an amount within a range of 1 to 200 mg/m², preferably 10 to 150 mg/m², and more preferably 20 to 100 mg/m².

The lubricant may be contained in any of an image forming layer and a non-photosensitive layer, but is preferably contained in the outermost layer for the purpose of improving transporting property and scratch resistance.
3) Surfactant

A surfactant employable in the invention is described in JP-A No. 11-65021, paragraph 0132. This reference describes a solvent in paragraph 0133, a substrate in paragraph 0134, an antistatic or conductive layer in paragraph 0135, and a method for obtaining a color image in paragraph 0136. A lubricant is described in JP-A No. 11-84573, paragraphs 0061-0064 and JP-A No. 2001-83679, paragraphs 0049-0062.

In the invention, it is preferred to employ a fluorinated surfactant. Preferred specific examples of the fluorinated surfactant include compounds described in JP-A Nos. 10-197985, 2000-19680 and 2000-214554. There can also be preferably employed a fluorinated polymer surfactant described in JP-A No.9-281636. In the photothermographic material of the invention, it is particularly preferable to employ a fluorinated surfactant described in JP-A Nos. 2002-82411, 2003-057780 or 2003-149766. In particular, a fluorinated surfactant described in JP-A No. 2003-057780 or Japanese Patent Application No. 2001-264110 is most preferable from the viewpoints of charge regulating ability, stability of a coated surface and lubricating ability when coating of an aqueous coating liquid is conducted, and a fluorinated surfactant described in Japanese Patent Application No. 2002-074564 is most preferable in that it has a high charge adjusting ability and it can be used in a small amount.

In the photothermographic material of the invention, it is preferable to use, as a surfactant, a fluorinated compound including a fluorinated alkyl group having two or more carbon atoms and 13 or less fluorine atoms (hereinafter an alkyl group substituted with at least one fluorine atom being represented as “Rf”). Such fluorinated compound may have two or more Rfs.

Specific examples of Rf are shown below, but such examples are not exhaustive:
—C₂F₅, —C₃F₇, —C₄F₉, —C₅F₁₁, —CH₂—C₄F₉, —C₄F₈—H, —C₂H₄—C₄F₉, —C₄H₈—H, —C₂H₄—C₄F₉, —C₆H₁₂—C₄F₉, —C₈H₁₆—C₄F₉, —C₄H₈C₂F₅, —C₄H₈—C₃F₇, —C₄H₈—C₅F₁₁, —C₈H₁₆—C₂F₅, —C₂H₄—C₄F₈—H, —C₄H₈—C₄F₈—H, —C₆H₁₂—C₄F₈—H, —C₆H₁₂—C₂F₄—H, —C₈H₁₆—C₂F₄—H, —C₆H₁₂—C₄F₈—CH₃, —C₂H₄—C₃F₇, —C₂H₄—C₅F₁₂, —C₄H₈—CF(CF₃)₂, —CH₃—CF₃, —C₄H₈—CH(C₂F₅)₂, —C₄H₈—CH(CF₃)₂, —C₄H₈—C(CF₃)₃, —CH₂—C₄F₈—H, —CH₂C₆F₁₂—H, —CH₂—C₆F₁₃, —C₂H₄—C₆F₁₃, —C₄H₈—C₆F₁₃, —C₆H₁₂—C₆F₁₃, and —C₈H₁₆—C₆F₁₃ groups.

The Rf contains 13 or less fluorine atoms, preferably 12 or less, more preferably 3 to 11 and further preferably 5 to 9. Also it contains two or more carbon atoms, preferably 4 to 16 and more preferably 5 to 12.

The structure of Rf is not particularly restricted, as long as it has 2 or more carbon atoms and 13 or less fluorine atoms, but is preferably a group represented by formula (A):
-Rc-Re-W Formula (A)

The fluorinated compound of the invention more preferably has two or more of the fluorinated alkyl group represented by formula (A).

In formula (A), Rc represents an alkylene group with 1 to 4 carbon atoms, preferably 1 to 3 carbon atoms and more preferably 1 to 2 carbon atoms. The alkylene group represented by Rc may be linear or branched.

Re represents a perfluoroalkylene group with 2 to 6 carbon atoms, preferably 2 to 4 carbon atoms. The perfluoroalkylene group means an alkylene group in which all the hydrogen atoms have been substituted by fluorine atoms. The perfluoroalkylene group may be linear or branched, or may have a cyclic structure.

W represents a hydrogen atom, a fluorine atom or an alkyl group, preferably a hydrogen atom or a fluorine atom, and more preferably a fluorine atom.

The fluorinated compound may have a cationic hydrophilic group.

The cationic hydrophilic group means a group capable of forming an cation when dissolved in water. Specific examples thereof include a quaternary ammonium, alkyl pyridium, alkyl imidazolinium and primary to tertiary aliphatic amines.

A cation is preferably an organic cationic substituent, more preferably an organic cationic group containing a nitrogen atom or a phosphor atom, and still more preferably a pyridinium cation or an ammonium cation.

An anion of the salt may be an inorganic anion or an organic anion. The inorganic anion is preferably an iodide ion, a bromide ion, or a chloride ion, and the organic anion is preferably a p-toluenesulfonate ion, a benzenesulfonate ion, a methanesulfonate ion or a trifluoromethansulfonate ion.

The cationic fluorinated compound preferred in the invention is represented by formula (1).

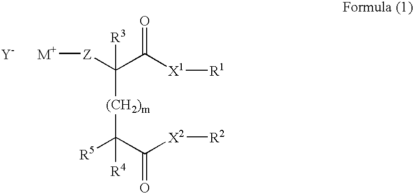

In the formula, R¹ and R² each independently represents a substituted or unsubstituted alkyl group, and at least one of R¹ and R² is the aforementioned fluorinated alkyl group (Rf). There is preferred a case where R¹ and R² are both Rfs. R³, R⁴ and R⁵ each independently represents a hydrogen atom or a substituent, X¹, X² and Z each independently represents a divalent connecting group or a single bond, and M⁺ represents a cationic substituent. Y⁻ represents a counter anion and may not exist when the charge becomes 0 within the molecule without Y⁻. m represents 0 or 1.

In formula (1), in the case where R¹ and R² each independently represents a substituted or unsubstituted alkyl group other than Rf, such alkyl group has one or more carbon atoms and may be linear, branched or cyclic. The substituent can be a halogen atom, an alkenyl group, an aryl group, an alkoxyl group, a halogen atom other than a fluorine atom, a carboxylic acid ester group, a carbonamide group, a carbamoyl group, an oxycarbonyl group or a phosphoric ester group.

In the case where R¹ or R² represents an alkyl group other Rf, namely an alkyl group not substituted with a fluorine atom, such an alkyl group can be a substituted or unsubstituted alkyl group with 1 to 24 carbon atoms, and is preferably a substituted or unsubstituted alkyl group with 6 to 24 carbon atoms. Preferred examples of the unsubstituted alkyl group with 6 to 24 carbon atoms include a n-hexyl group, a n-heptyl group, a n-octyl group, a tert-octyl group, a 2-ethylhexyl group, a n-nonyl group, a 1,1,3-trimethylhexyl group, a n-decyl group, a n-dodecyl group, a cetyl group, a hexadecyl group, a 2-hexyldecyl group, an octadecyl group, an eicosyl group, a 2-octyldodecyl group, a docosyl group, a tetracosyl group, a 2-decyltetradecyl group, a tricosyl group, a cyclohexyl group, and cycloheptyl group. Also preferred examples of the substituted alkyl group with 6 to 24 total carbon atoms include a 2-hexenyl group, an oleyl group, a linoleyl group, a linolenyl group, a benzyl group, a β-phenetyl group, a 2-methoxyethyl group, a 4-phenylbutyl group, a 4-acetoxyethyl group, a 6-phenoxyhexyl group, a 12-phenyldodecyl group, a 18-phenyloctadecyl group, a 12-(p-chlorophenyl) dodecyl group, and a 2-(diphenyl phosphoric)ethyl group.

An alkyl group other than Rf, independently represented by R¹ or R², is more preferably a substituted or unsubstituted alkyl group with 6 to 18 carbon atoms. Preferred examples of the unsubstituted alkyl group with 6 to 18 carbon atoms include a n-hexyl group, a cycylohexyl group, a n-heptyl group, a n-octyl group, a 2-ethylhexyl group, a n-nonyl group, a 1,1,3-trimethylhexyl group, a n-decyl group, a n-dodecyl group, a cetyl group, a hexadecyl group, a 2-hexyldecyl group, an octadecyl group, and a 4-tert-butylcyclohexyl group. Also preferred examples of the substituted alkyl group with 6 to 18 total carbon atoms include a phenetyl group, a 6-phenoxylhexyl group, a 12-phenyldodecyl group, an oleyl group, a linoleyl group and a linolenyl group.

An alkyl group other than Rf, independently represented by R¹ or R², is particularly preferably a n-hexyl group, a cyclohexyl group, a n-heptyl group, a n-octyl group, a 2-ethylhexyl group, a n-nonyl group, a 1,1,3-trimethylhexyl group, a n-decyl group, a n-dodecyl group, a cetyl group, a hexadecyl group, a 2-hexyldecyl group, an octadecyl group, an oleyl group, a linoleyl group or a linolenyl group, and most preferably a linear, cyclic or branched unsubstituted alkyl group with 8 to 16 carbon atoms.

In formula (1), R³, R⁴ and R⁵ each independently represents a hydrogen atom or a substituent. The substituent can be, for example, an alkyl group (preferably with 1 to 20 carbon atoms, more preferably 1 to 12 carbon atoms and particularly preferably 1 to 8 carbon atoms, such as a methyl group, an ethyl group, an isopropyl group, a tertbutyl group, an n-octyl group, an n-decyl group, an n-hexadecyl group, a cyclopropyl group, a cyclopentyl group or a cyclohexyl group), an alkenyl group (preferably with 2 to 20 carbon atoms, more preferably 2 to 12 carbon atoms and particularly preferably 2 to 8 carbon atoms, such as a vinyl group, an allyl group, a 2-butenyl group or 3-pentenyl group), an alkynyl group (preferably with 2 to 20 carbon atoms, more preferably 2 to 12 carbon atoms and particularly preferably 2 to 8 carbon atoms, such as a propalgyl group, or a 3-pentynyl group), an aryl group (preferably with 6 to 30 carbon atoms, more preferably 6 to 20 carbon atoms and particularly preferably 6 to 12 carbon atoms, such as a phenyl group, a p-methylphenyl group or a naphthyl group), a substituted or unsubstituted amino group (preferably with 0 to 20 carbon atoms, more preferably 0 to 10 carbon atoms and particularly preferably 0 to 6 carbon atoms, such as an unsubstituted amino group, a methylamino group, a dimethylamino group, diethylamino group or a dibenzylamino group), an alkoxy group (preferably with 1 to 20 carbon atoms, more preferably 1 to 12 carbon atoms and particularly preferably 1 to 8 carbon atoms, such as a methoxy group, an ethoxy group, or a butoxy group), an aryloxy group (preferably with 6 to 20 carbon atoms, more preferably 6 to 16 carbon atoms and particularly preferably 6 to 12 carbon atoms, such as a phenyloxy group or a 2-naphthyloxy group), an acyl group (preferably with 1 to 20 carbon atoms, more preferably 1 to 16 carbon atoms and particularly preferably 1 to 12 carbon atoms, such as an acetyl group, a benzoyl group, a formyl group or a pivaloyl group), an alkoxycarbonyl group (preferably with 2 to 20 carbon atoms, more preferably 2 to 16 carbon atoms and particularly preferably 2 to 12 carbon atoms, such as a methoxycarbonyl group or an ethoxycarbonyl group), an aryloxycarbonyl group (preferably with 7 to 20 carbon atoms, more preferably 7 to 16 carbon atoms and particularly preferably 7 to 10 carbon atoms, such as a phenyloxycarbonyl group), an acyloxy group (preferably with 2 to 20 carbon atoms, more preferably 2 to 16 carbon atoms and particularly preferably 2 to 10 carbon atoms, such as an acetoxy group or a benzoyloxy group), an acylamino group (preferably with 2 to 20 carbon atoms, more preferably 2 to 16 carbon atoms and particularly preferably 2 to 10 carbon atoms, such as an acetylamino group or a benzoylamino group), an alkoxycarbonylamino group (preferably with 2 to 20 carbon atoms, more preferably 2 to 16 carbon atoms and particularly preferably 2 to 12 carbon atoms, such as a methoxycarbonylamino group), an aryloxycarbonylamino group (preferably with 7 to 20 carbon atoms, more preferably 7 to 16 carbon atoms and particularly preferably 7 to 12 carbon atoms, such as a phenyloxycarbonylamino group), a sulfonylamino group (preferably with 1 to 20 carbon atoms, more preferably 1 to 16 carbon atoms and particularly preferably 1 to 12 carbon atoms, such as a methanesulfonylamino group or a benzenesulfonylamino group), a sulfamoyl group (preferably with 0 to 20 carbon atoms, more preferably 0 to 16 carbon atoms and particularly preferably 0 to 12 carbon atoms, such as a sulfamoyl group, a methylsulfamoyl group, a dimethylsulfamoyl group or a phenylsulfamoyl group), a carbamoyl group (preferably with 1 to 20 carbon atoms, more preferably 1 to 16 carbon atoms and particularly preferably 1 to 12 carbon atoms, such as an unsubstituted carbamoyl group, a methylcarbamoyl group, diethylcarbamoyl group or a phenylcarbamoyl group), an alkylthio group (preferably with 1 to 20 carbon atoms, more preferably 1 to 16 carbon atoms and particularly preferably 1 to 12 carbon atoms, such as a methylthio group or an ethylthio group), an arylthio group (preferably with 6 to 20 carbon atoms, more preferably 6 to 16 carbon atoms and particularly preferably 6 to 12 carbon atoms, such as a phenylthio group), a sulfonyl group (preferably with 1 to 20 carbon atoms, more preferably 1 to 16 carbon atoms and particularly preferably 1 to 12 carbon atoms, such as a mesyl group or a tosyl group), a sulfinyl group (preferably with 1 to 20 carbon atoms, more preferably 1 to 16 carbon atoms and particularly preferably 1 to 12 carbon atoms, such as a methanesulfinyl group or a benzenesulfinyl group), an ureido group (preferably with 1 to 20 carbon atoms, more preferably 1 to 16 carbon atoms and particularly preferably 1 to 12 carbon atoms, such as an unsubstituted ureido group, a methylureido group or a phenylureido group), a phosphoric amide group (preferably with 1 to 20 carbon atoms, more preferably 1 to 16 carbon atoms and particularly preferably 1 to 12 carbon atoms, such as a diethylphosphoric amide group, or a phenylphosphoric amide group), a hydroxyl group, a mercapto group, a halogen atom (such as a fluorine atom, a chlorine atom, a bromine atom or an iodine atom), a cyano group, a sulfo group, a carboxyl group, a nitro group, a hydroxamate group, a sulfino group, a hydrazino group, an imino group, a heterocyclic group (preferably with 1 to 30 carbon atoms, and more preferably 1 to 12 carbon, for example a heterocyclic group including a hetero atom such as a nitrogen atom, an oxygen atom, or a sulfur atom, such as an imidazolyl group, a pyridyl group, a quinolyl group, a furyl group, a piperidyl group, a morpholino group, a penzooxazolyl group, a benzimidazolyl group, or a benzothiazolyl group), and a silyl group (preferably with 3 to 40 carbon atoms, more preferably 3 to 30 carbon atoms and particularly preferably 3 to 24 carbon atoms, such as a trimethylsilyl group or a tripheylsilyl group). Such substituent may be further substituted. Also in the case two or more substituents are present, they may be the same or different. Also, if possible, they may bond to each other to form a ring.

R³, R⁴ or R⁵ is preferably an alkyl group or a hydrogen atom, and more preferably a hydrogen atom.

In the foregoing formula, X¹ and X² each independently represents a divalent connecting group or a single bond. The divalent connecting group is not particularly restricted, but is preferably an arylene group, —O—, —S— or —NR³¹ (R³¹ representing a hydrogen atom or a substituent, the substituent being the same as that represented by each of R³, R⁴ and R⁵, and R³¹ being preferably an alkyl group, an Rf group mentioned above or a hydrogen atom, and more preferably a hydrogen atom). These may be used alone or in combination. X¹ and X² are more preferably —O—, —S— or —NR³¹—. X¹ and X² are still more preferably —O— or —NR³¹—, still more preferably —O— or —NH—, and most preferably —O—.

In the foregoing formula, Z represents a divalent connecting group or a single bond. The divalent connecting group is not particularly restricted, but is preferably an alkylene group, an arylene group, —C(═O)—, —O—, —S—, —S(═O)—, —S(═O)₂— or —NR³²— (R³² representing a hydrogen atom or a substituent, the substituent being the same as that represented by each of R³, R⁴ and R⁵, and R³² being preferably an alkyl group or a hydrogen atom, more preferably a hydrogen atom). These may be used alone or incombination. Z is more preferably an alkylene group with 1 to 12 carbon atoms, an arylene group with 6 to 12 carbon atoms, —C(═O)—, —O—, —S—, —S(═O)—, —S(═O)₂— or —NR³²— or a combination thereof. Z is more preferably an alkylene group with 1 to 8 carbon atoms, —C(═O)—, —O—, —S—, —S(═O)—, —S(═O)₂— or —NR³²— or a combination thereof. For exampe, Z may be one of the following compounds.

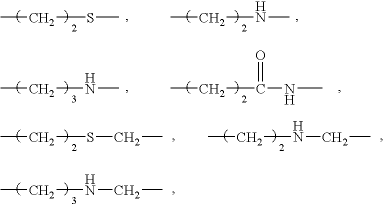

In the foregoing formula, M⁺ represents a cationic substituent, and is preferably an organic cationic substituent, and more preferably an organic cationic group including a nitrogen atom or a phosphor atom. It is more preferably a pyridinium cation or an ammonium cation, and still more preferably a trialkylammonium cation represented by formula (2).

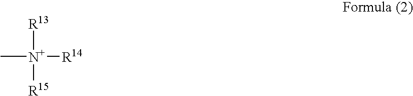

In the foregoing formula, R¹³, R¹⁴ and R¹⁵ each independently represents a substituted or unsubstituted alkyl group. The substituent can be the same as that represented by R³, R⁴ or R⁵. R¹³, R¹⁴ and R¹⁵ may bond to each other to form a ring, if possible. R¹³, R¹⁴ and R¹⁵ each is preferably an alkyl group with 1 to 12 carbon atoms, more preferably an alkyl group with 1 to 6 carbon atoms, still more preferably a methyl group, an ethyl group or a methylcarboxyl group, and most preferably a methyl group.

In the formula, Y⁻ represents a counter anion, and can be an inorganic anion or an organic anion, and may not exist when the charge becomes 0 within the molecule without Y⁻. The inorganic anion is preferably an iodide ion, a bromide ion, or a chloride ion, and the organic anion is preferably a p-toluenesulfonate ion, a benzenesulfonate ion, a methanesulfonate ion or a trifluoromethansulfonate ion. Y⁻ is more preferably an iodide ion, p-toluenesulfonate ion, or a benzenesulfonate ion, and still more preferably a p-toluenesulfonate ion.

In the formula, m represents 0 or 1, preferably 0.

Among the compounds represented by formula (1), a compound represented by formula (1-a) is preferable.

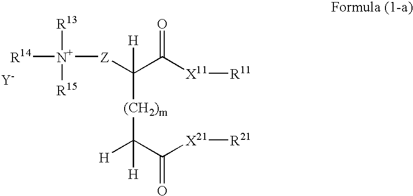

In the formula, R¹¹ and R²¹ each independently represents a substituted or unsubstituted alkyl group, and at least one of R¹¹ and R²¹ is Rf, with a total number of carbon atoms of R¹¹ and R²¹ equal to or less than 19. R¹³, R¹⁴ and R¹⁵ each independently represents a substituted or unsubstituted alkyl group, and may bond to each other to form a ring. X¹¹ and X²¹ each independently represents —O—, —S— or —NR³¹—; R³¹ represents a hydrogen atom or a substituent; and Z represents a divalent connecting group or a single bond. Y⁻ represents a counter anion and may not exist with when the charge becomes 0 within the molecule without Y⁻.

m represents 0 or 1. In the foregoing formula, Z and Y⁻ each independently have the same meanings as in formula (1), and preferable examples thereof are the same as in formula (1). R¹³, R¹⁴, R¹⁵ and m each have the same meanings as in formula (1) and preferable examples thereof are the same as in formula (1).

In the formula, X¹¹ and X¹² each independently represents —O—, —S— or —NR³¹— in which R³¹ represents a hydrogen atom or a substituent, and the substituent is the same as that represented by each of R¹³, R¹⁴ and R¹⁵. R³¹ is preferably an alkyl group, an Rf group mentioned above or a hydrogen atom, and more preferably a hydrogen atom. X¹¹ or X¹² is preferably —O— or —NH—, and more preferably —O—.

In the formula, R¹¹ and R²¹ respectively have the same meanings as those of R¹ and R² in formula (1) and preferable examples thereof are the same as those of R¹ and R². However, R¹¹ and R²¹ have a total number of carbon atoms of 19 or less. m represents 0 or 1.

In the following, specific examples of the compound represented by formula (1) are shown, but the invention is not limited to these examples. In the illustrated structures of the following exemplified compounds, an alkyl group or a perfluoroalkyl group has a linear structure unless specified otherwise. Also In the formula, 2EH represents 2-ethylhexyl.

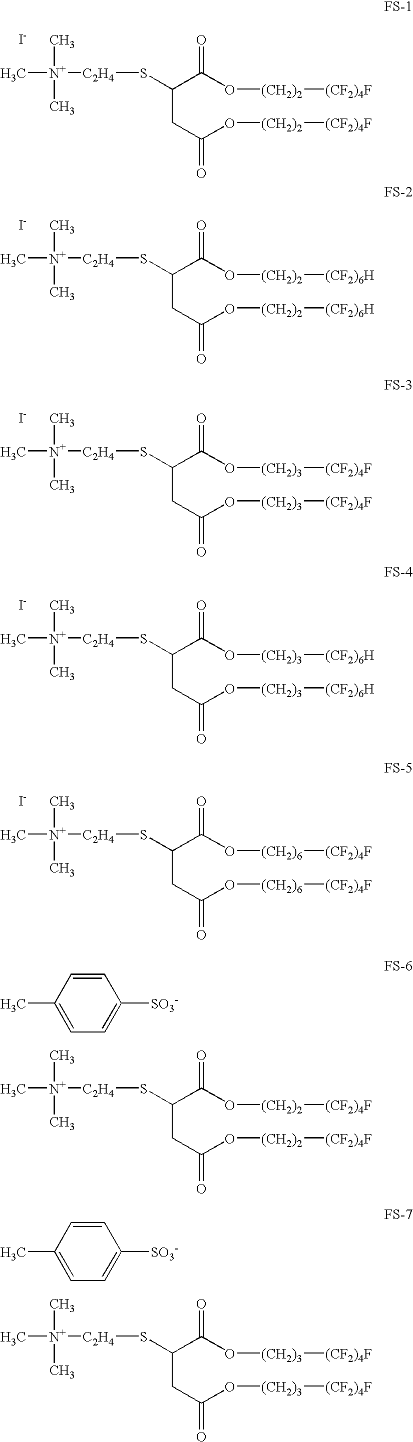

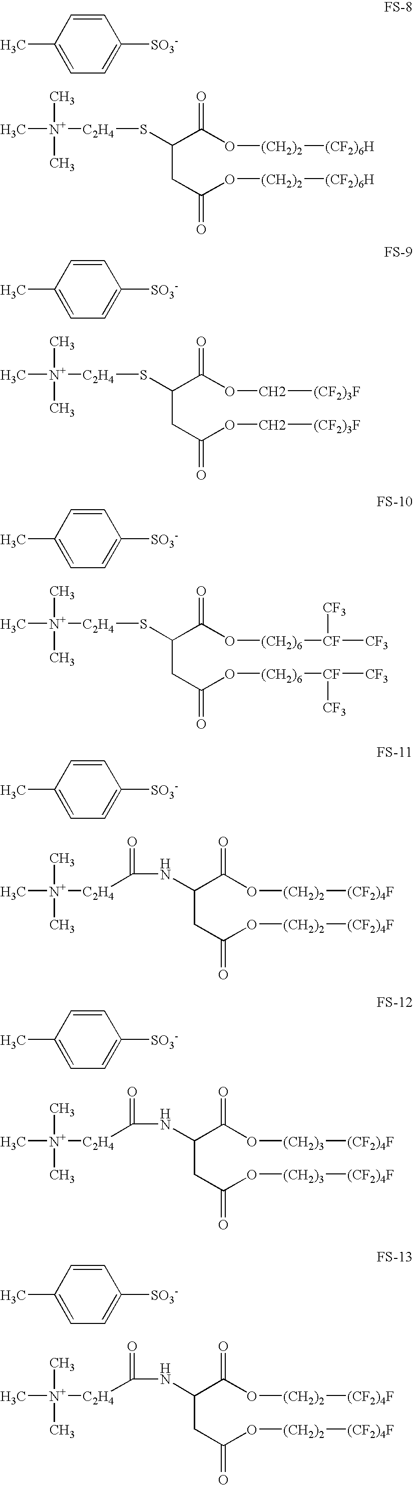

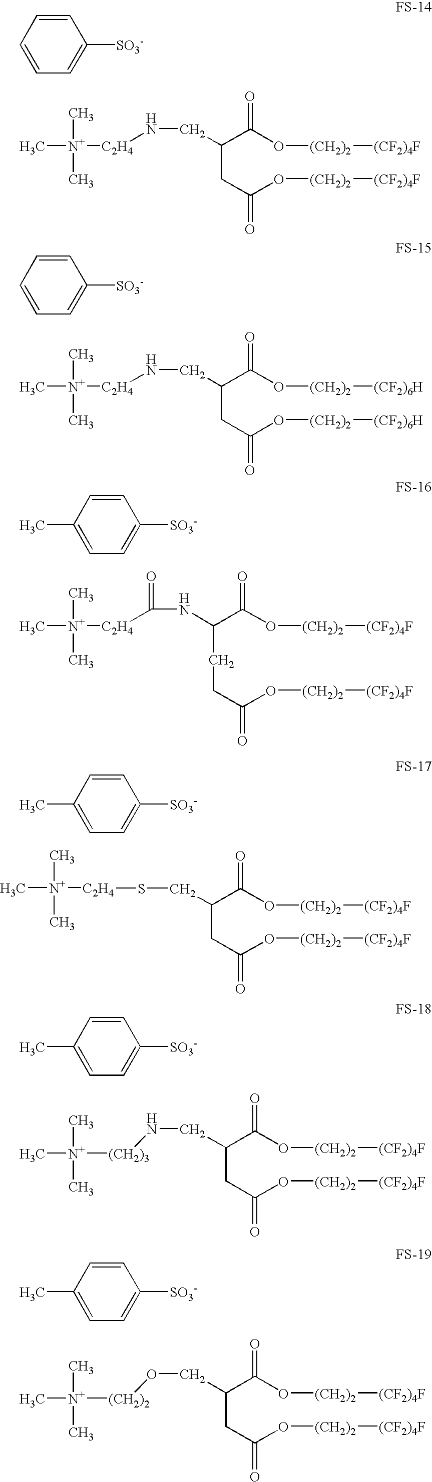

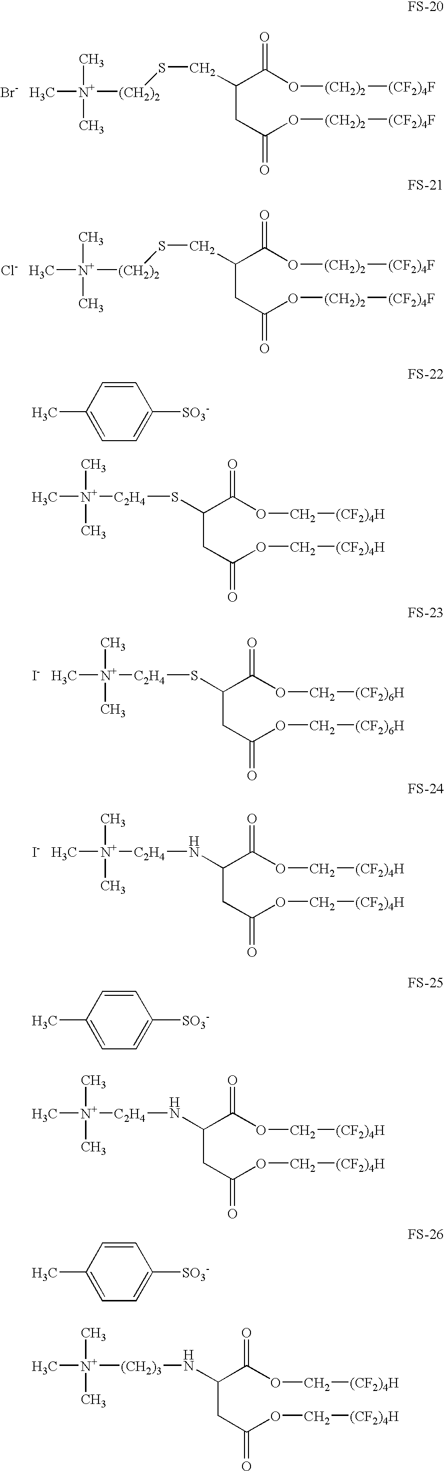

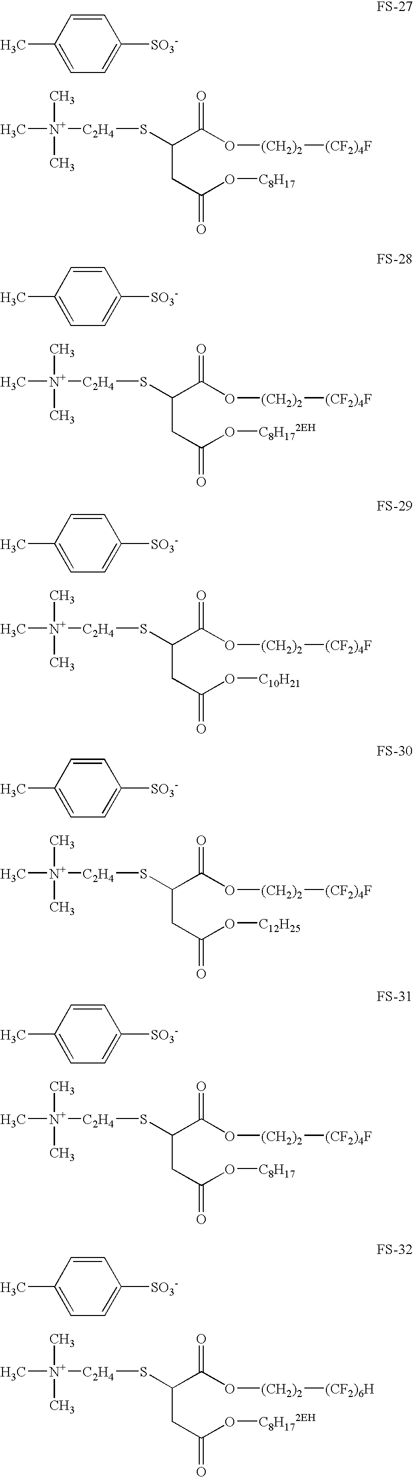

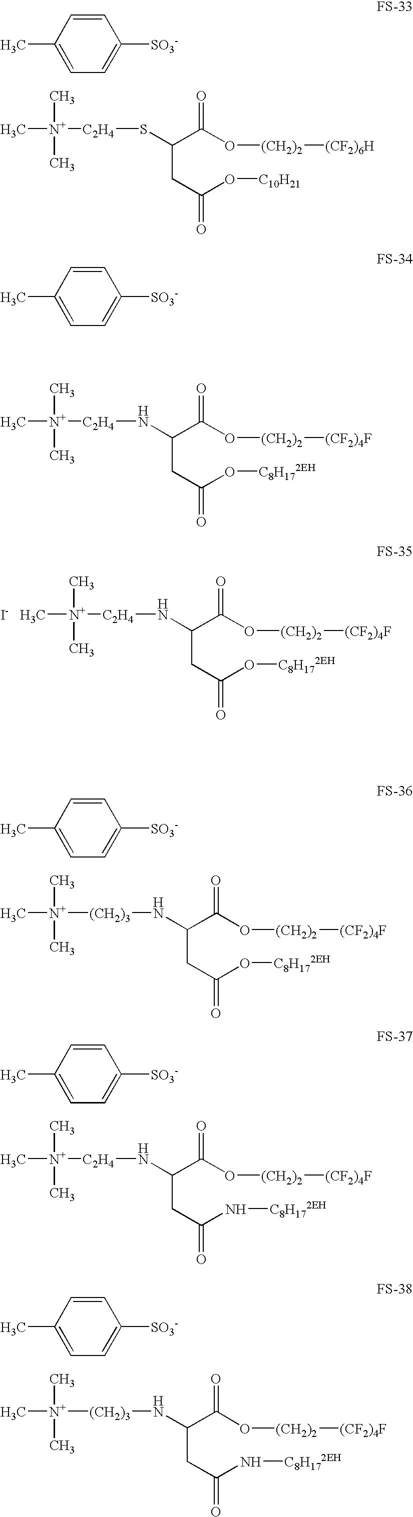

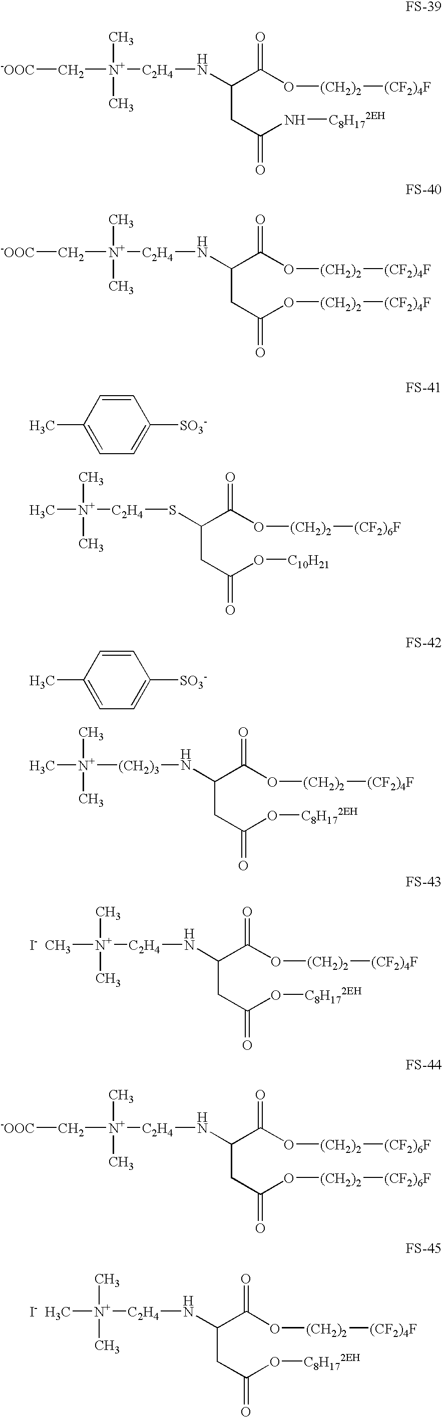

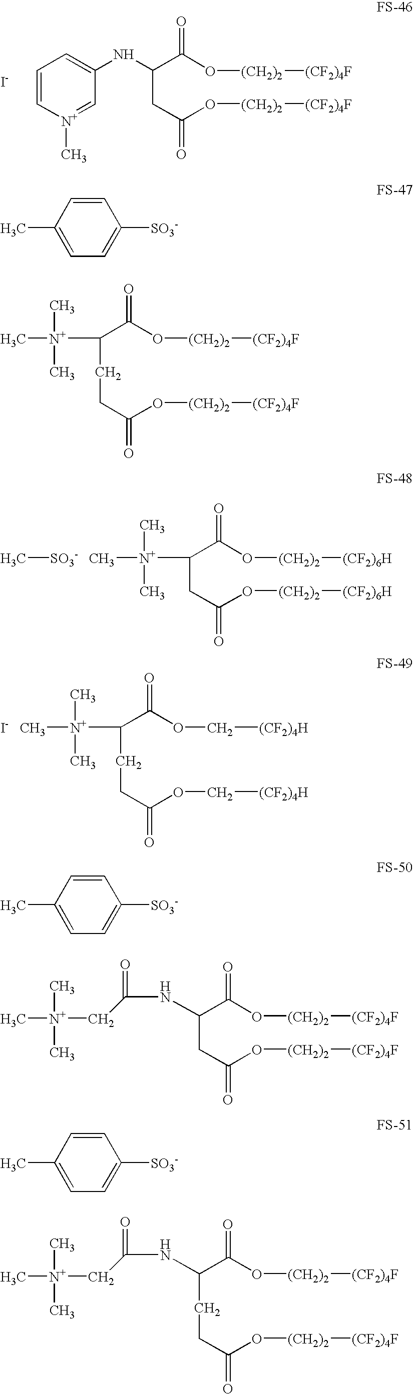

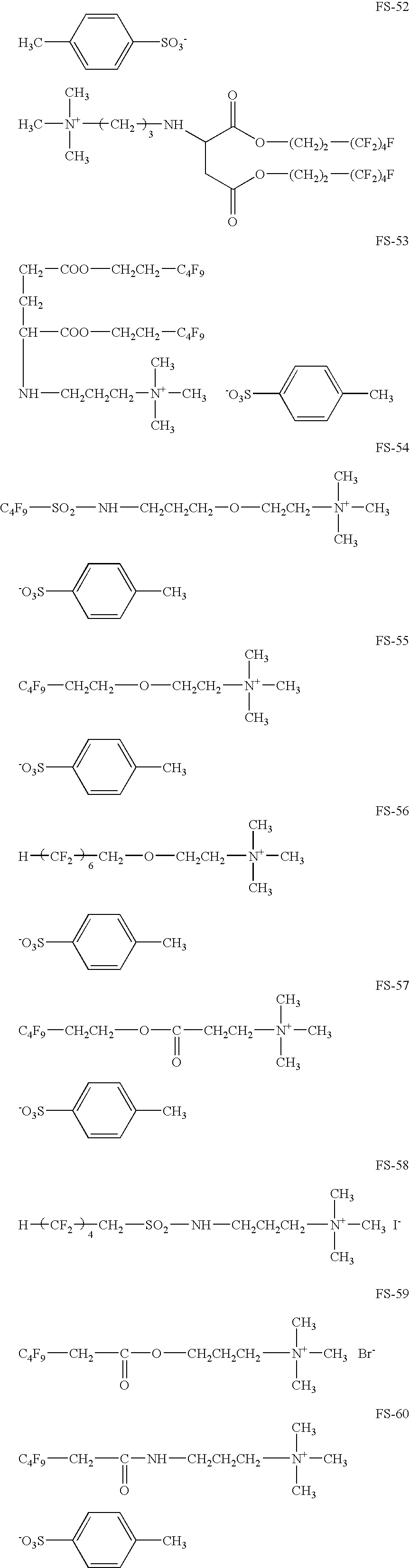

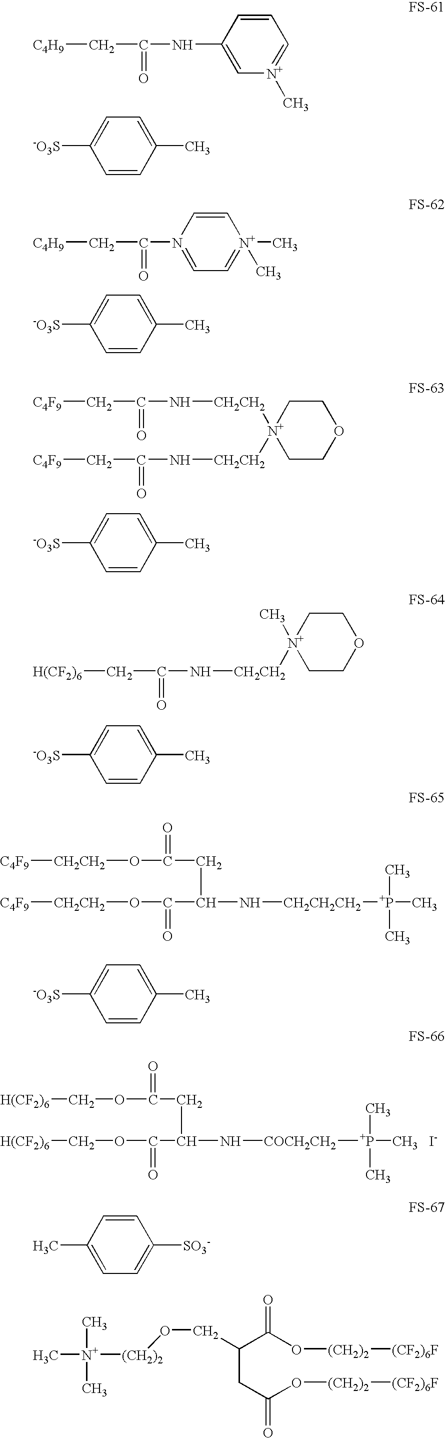

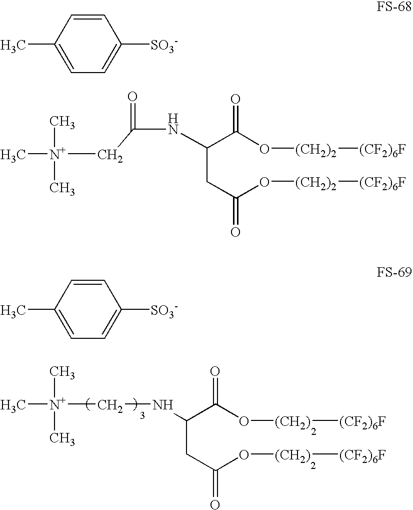

In the following, there will be shown an example of a general synthesizing method for the compound represented by formula (1) or (1-a), but the invention is not limited to such an example.

Such a compound can be synthesized from a fumaric acid derivative, a maleic acid derivative, an itaconic acid derivative, a glutamic acid derivative or an aspartic acid derivative. For example, in the case of a synthesis from a fumaric acid derivative, a maleic acid derivative or an itaconic acid derivative, it can be synthesized by coneucting a Michael addition reaction using a nucleophilic agent to a double bond of such a derivative and by executing cationization of the resultant with an alkylating agent.

The fluorinated compound may also have an anionic hydrophilic group.

The anionic hydrophilic group means an acidic group with a pKa value of 7 or less, or an alkali metal salt or an ammonium salt thereof. More specifically, it can be a sulfo group, a carboxyl group, a phosphonate group, a carbamoyl group, a sulfamoyl group, a sulfamoylsulfamoyl group, an acylsulfamoyl group or a salt thereof. Among these, a sulfo group, a carboxyl group, a phosphonate group or a salt thereof is preferable, and a sulfo group or a salt thereof is more preferable. A cation of the salt can be lithium, sodium, potassium, cesium, ammonium, tetramethylammonium, tetrabutylammonium, or methylpyridinium, and is preferably lithium, sodium, potassium or ammonium.

In the invention, a preferred fluorinated compound having an anionic hyhdrophilic group is represented by formula (3):

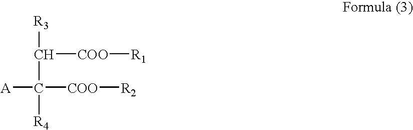

In the formula, R¹ and R² each independently represents an alkyl group, and at least one of R¹ and R² is Rf. In the case where R¹ or R² represents an alkyl group other than a fluorinated alkyl group, such alkyl group preferably has 2 to 18 carbon atoms, and more preferably 4 to 12 carbon atoms. R³ and R⁴ each independently represents a hydrogen atom or a substituted or unsubstituted alkyl group.

Specific examples of the fluorinated alkyl group represented by R¹ or R² are the same as the aforementioned fluorinated alkyl groups, and the preferred structure is a structure represented by the aforementioned formula (A). The more preferred structure is the same as those for the fluorinated alkyl group described before. Both the alkyl groups represented by R¹ and R² are preferably fluorinated alkyl groups mentioned before.

The substituted or unsubstituted alkyl group represented by R³ or R⁴ may be linear, branched or cyclic. The substituent is not particularly restricted, but is preferably an alkenyl group, an aryl group, an alkoxy group, a halogen atom (particularly Cl), a carboxylic ester group, a carbonamide group, a carbamoyl group, an oxycarbonyl group, or a phosphoric ester group.

A represents -L_{b}—SO₃M, and M represents a cation. The cation represented by M is preferably an alkali metal ion (such as a lithium ion, a sodium ion or a potassium ion), an alkaline earth metal ion (such as a barium ion, or a calcium ion), or an ammonium ion. Among these, a lithium ion, a sodium ion, a potassium ion or an ammonium ion is more preferable, and a lithium, ion, a sodium ion or a potassium ion is still more preferable, and it can be suitably selected according to the number of total carbon atoms and the substituent of the compound of formula (3), and a degree of branching of the alkyl group. In the case where R¹, R², R³ and R⁴ have a total number of carbon atoms of 16 or larger, and a lithium ion is selected as M, excellent solubility (particularly in water) and an antistatic ability or a coating uniformity can be obtained.

L_{b} represents a single bond or a substituted or unsubstituted alkylene group. The substituent is preferably the same as that described for R³. In the case where L_{b} is an alkylene group, it preferably has two or less carbon atoms. L_{b} is preferably a single bond or a —CH₂— group, and more preferably a —CH₂— group.

In formula (3), it is more preferable to combine the respective preferable examples described above.

In the following, specific examples of the fluorinated compound having an anionic hydrophilic group are shown, but the invention is not limited to such examples.

In the expressions of the following exemplified compounds, an alkyl group or a perfluoroalkyl group has a linear structure unless otherwise specified.

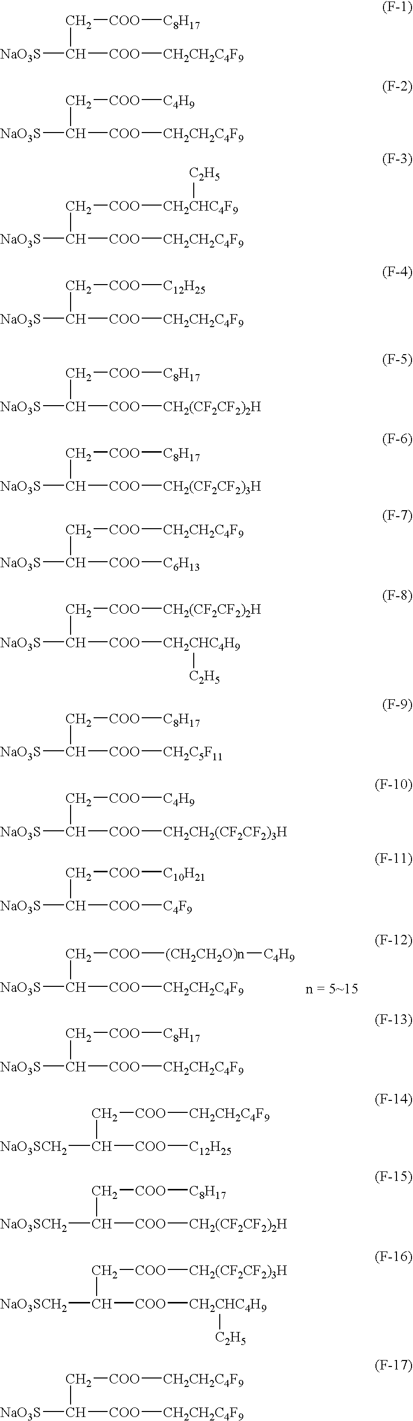

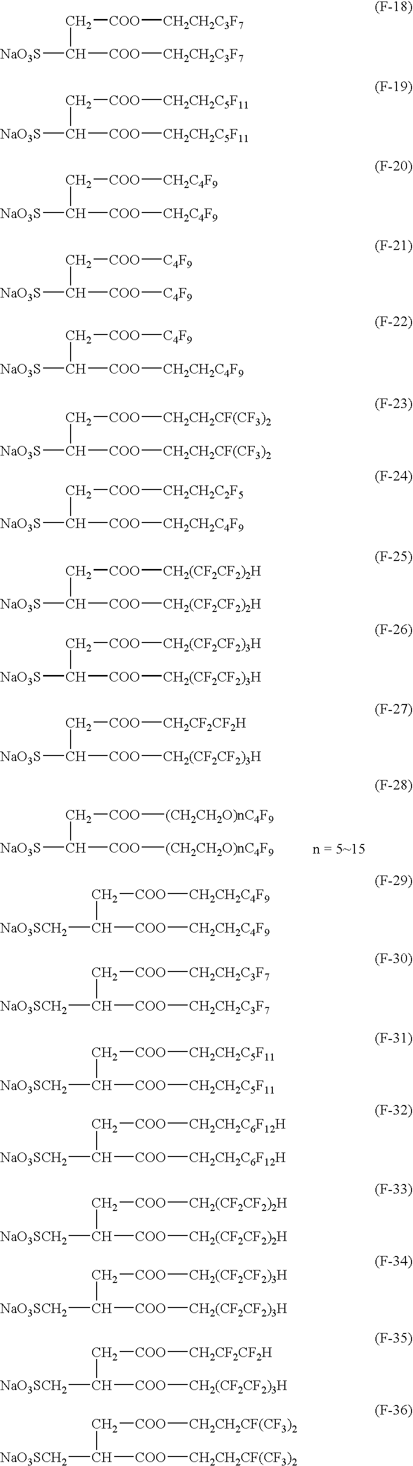

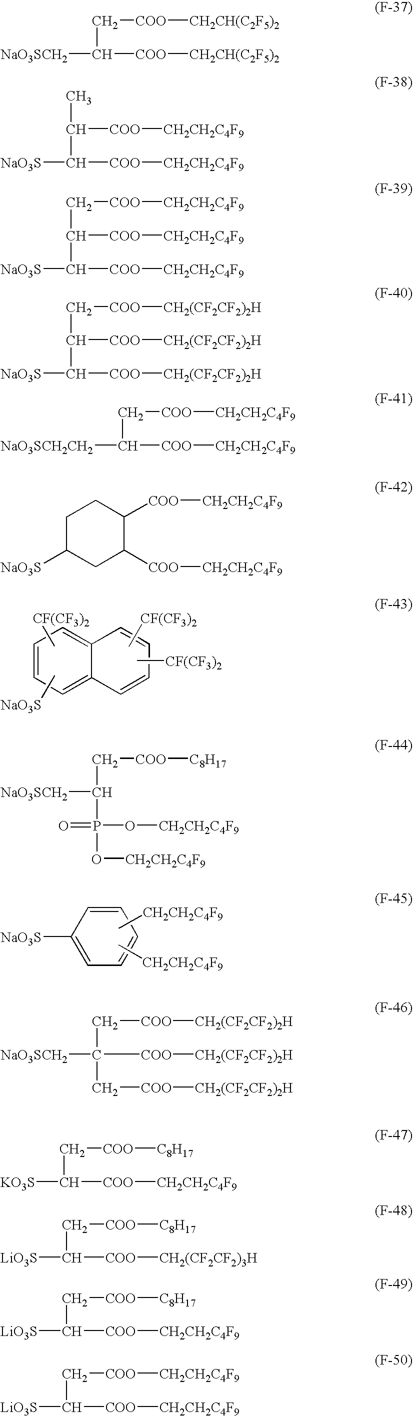

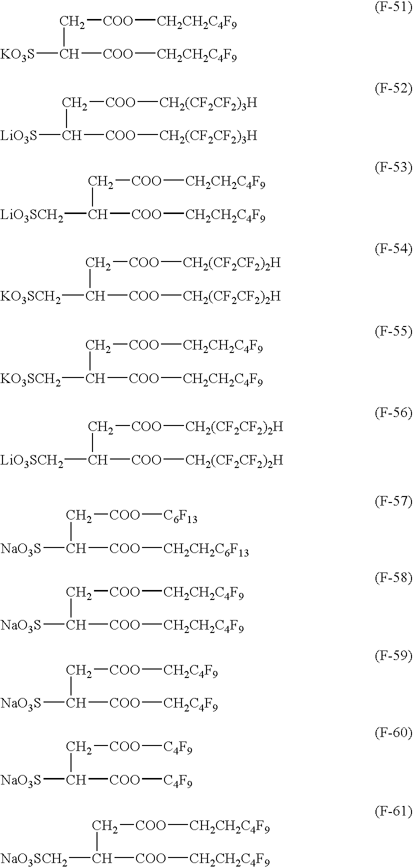

The fluorinated compound may also have a nonionic hydrophilic group.

The nonionic hydrophilic group means a group which can be dissolved in water without dissociating into ions. More specifically, it can be poly(oxyethylene)alkyl ether or a polyhydric alcohol, but such examples are not restrictive.

In the invention, a preferred fluorinated compound having a nonionic hyhdrophilic group is represented by formula (4):
Rf-X-((CH₂)ₙ—O—)ₘ—R Formula (4)

In the formula (4), Rf is the aforementioned fluorinated alkyl group, of which specific examples are those explained before, and a preferred structure is also that represented by formula (A), the preferred structure is the same as that described for Rf in the foregoing.

In formula (4), X represents a divalent connecting group, which is not particularly restricted but can be selected from the following groups.

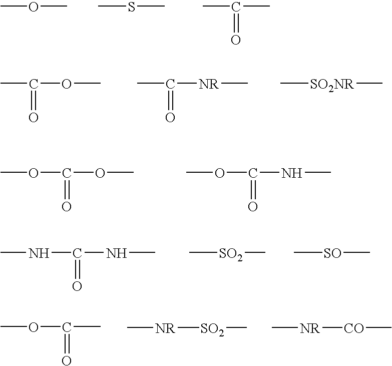

In formula (4), n represents 2 or 3; m represents an integer of 1 to 30; and R represents a hydrogen atom, an alkyl group, an aryl group, a heterocyclic group, Rf or a group having at least one Rf as a substituent.

In the following, specific examples of the fluorinated compound having a nonionic hydrophilic group are shown, but the invention is not limited to such examples.

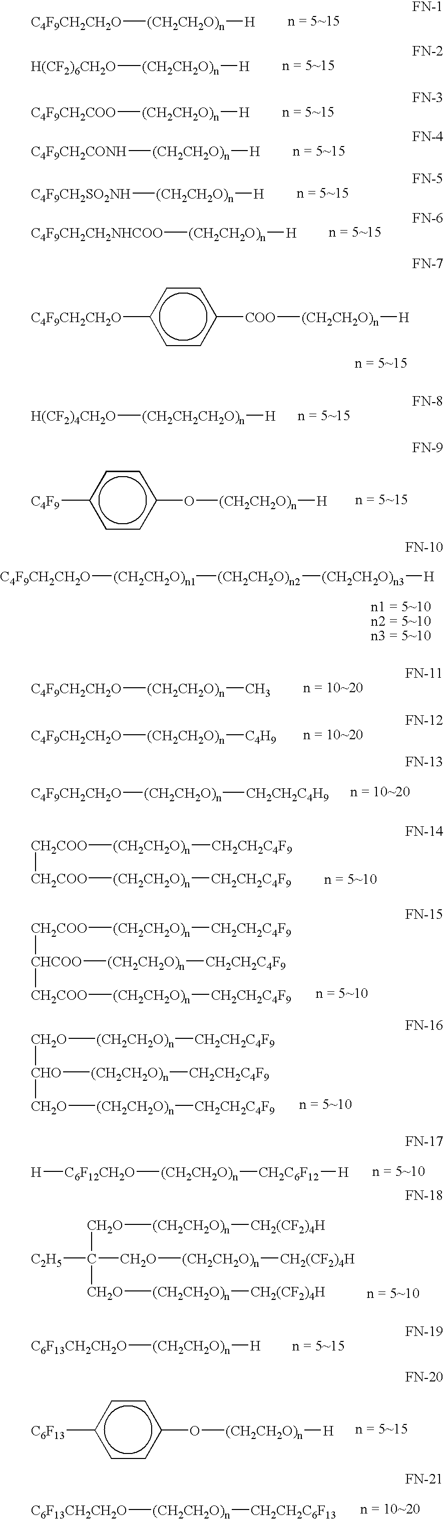

In the invention, the fluorinated surfactant may be contained in an emulsion surface and a back surface, and is preferably contained in both surfaces.

The compound having a specified fluorinated alkyl group employable in the invention is preferably contained as a surfactant in coating compositions for forming layers of the photosensitive material (particularly a protective layer, an undercoat layer or a back layer). It is particularly preferably contained in a coating composition for forming an outermost layer of the photosensitive material, since effective antistatic ability and coating uniformity can be obtained. It has found that the structure of the invention is effective in improving storage stability and environmental dependence which are objectives of the invention. In order to obtain such effects, the fluorinated compound is preferably contained in an outermost layer of the image forming layer side or the back side. Also a similar effect can be obtained, when it is contained in an undercoat layer.

The preferred amount of the fluorinated surfactant on the emulsion side or the back side is within a range of 0.1 to 100 mg/m², more preferably 0.3 to 30 mg/m², and stil more preferably 1 to 10 mg/m². In particularly, a fluorinated surfactant described in Japanese Patent Application No. 2001-264110 has a strong effect, and is preferably contained in an amount of 0.01 to 10 mg/m², and more preferably 0.1 to 5 mg/m².

In the invention, the amount of the aforementioned specified fluorinated compound is not particularly restricted, and can be arbitrarily determined according to the structure of the fluorinated compound to be contained, a position of use thereof, and kinds and amounts of other materials contained in the composition. For example, when it is contained in a coating liquid for an outermost layer of a photothermographic material, the coating amount of the fluorinated compound in the coating composition is preferably 0.1 to 100 mg/m², and more preferably 0.5 to 20 mg/m².

In the invention, the aforementioned specified fluorinated compounds may be contained alone or as a mixture of two or more kinds.

In the invention, the fluorinated surfactant is particularly preferably used in combination with a conductive layer containing the following metal oxide. In this case, sufficient performance can be obtained even when the amount of the surfactant on the conductive layer side is reduced.

(5) Image Forming Layer

Explanations Regarding Organic Silver Salt

1) Composition

The organic silver salt employable in the invention is a silver salt that is relatively stable to light but functions as a silver ion supplying substance when heated to a temperature of 80° C. or higher in the presence of exposed photosensitive silver halide and a reducing agent, and thereby forms a silver image. The organic silver salt can be any organic substance that can be reduced by the reducing agent and can supply a silver ion. Such a non-photosensitive organic silver salt is described for example in JP-A No. 10-62899, paragraphs 0048-0049, EP-A No. 0803764A1, page 18, line 24 to page 19, line 37, EP-A No. 0962812A1, and JP-A Nos. 11-349591, 2000-7683 and 2000-72711. There is preferred a silver salt of an organic acid, particularly a silver salt of a long-chain aliphatic carboxylic acid (with 10 to 30 carbon atoms, preferably 15 to 28 carbon atoms). Preferred examples of the aliphatic acid silver salt include silver lignoserate, silver behenate, silver arachidate, silver stearate, silver oleate, silver laurate, silver caproate, silver myristate, silver palmitate, silver erucate and a mixture thereof. In the invention, it is preferred, among these aliphatic acid silver salts, to use an aliphatic acid silver salt having a silver behenate content of 50 to 100 mol. %, more preferably 85 to 100 mol. % and still more preferably 90 to 100 mol. %.

It is also preferable to use an aliphatic acid silver salt having a silver erucate content of 2 mol. % or less, more preferably 1 mol. % or less and still more preferably 0.1 mol. % or less.

It is also preferable that a silver stearate content is 1 mol. % or less. A silver stearate content of 1 mol. % or less allows obtaining an organic acid silver salt having a low Dmin, a high sensitivity and excellent image storability. The silver stearate content is more preferably 0.5 mol. % or less and it is particularly preferable that silver stearate is substantially absent.

In the case where the silver salt of organic acid includes silver arachidate, it is preferable that the silver arachidate content is 6 mol. % or less so as to obtain an organic acid silver salt providing a low Dmin and excellent image storability. The content is more preferably 3 mol. % or less.
2) Shape

A shape of the organic silver salt employable in the invention is not particularly restricted, and may be a needle-like shape, a rod shape, a tabular shape or a scale shape.

In the invention, an organic silver salt of scale shape is preferable. There is also advantageously employed a grain of a short needle-like shape with the ratio of a longer axis to a shorter axis not exceeding 5, a rectangular parallelepiped shape, a cubic shape or a potato-like irregular shape. These organic silver grains have an advantage of a lower fog level at thermal development than a grain of a long needle-like having a ratio of a longer axis to a shorter axis of 5 or more. In particular, a grain with the ratio of a longer axis to a shorter axis of 3 or less is preferable because of improved mechanical stability of the coated film. In this specification, an organic silver salt of a scale shape is defined as follows. The organic silver salt grain is observed under an electron microscope, and the grain shape is approximated to rectangular parallelepiped having sides having length a, b and c (a is the shortest, b is the next shortest, and c may be equal to b), and x is obtained from the values a and b and the following equation.
x=b/a
x of each of about 200 grains is calculated, and the average value x(average) is obtained, and grains having a relation of x(average)≧1.5 are defined as those having a scale shape. The grains preferably has a relation of 30≧x(average)≧1.5, and more preferably a relation of 15≧x(average)≧1.5. For reference, a needle-like shape has a relation of 1≦x(average)≦1.5.

In the scale-shaped grain, the value a can be regarded as a thickness of a tabular grain having a principal plane defined by sides having lengths of b and c. The average of the value a is preferably within a range from 0.01 to 0.3 μm, and more preferably from 0.1 to 0.23 μm. The average of c/b is preferably within a range from 1 to 9, more preferably 1 to 6, still more preferably from 1 to 4, and most preferably from 1 to 3.

A sphere-corresponding diameter maintained within a range from 0.05 to 1 μm hinders coagulation in the photosensitive material and provides satisfactory image storability. The sphere-corresponding diameter is preferably 0.1 to 1 μm. In the invention, the sphere-corresponding diameter can be determined by taking a photograph of a sample by an electron microscope and then executing an image processing for the negative film.

In the aforementioned scale-shaped grains, the ratio of sphere-corresponding diameter/a of the grain is defined as an aspect ratio. The aspect ratio of the scale-shaped grain is preferably within a range from 1.1 to 30 in view of hindering coagulation in the photosensitive material and improving the image storability, and more preferably from 1.1 to 15.

The grain size distribution of the organic silver salt is preferably mono-disperse. The mono-disperse means that a percentage obtained by dividing the standard deviation of a shorter axis (or a longer axis) by the shorter axis (or the longer axis) is preferably 100% or less, more preferably 80% or less and still more preferably 50% or less. The shape of the organic silver salt can be determined from a transmission electron photomicrograph of an organic silver salt dispersion. The mono-disperse property can also be measured by determining a percentage (variation factor) of a value which is obtained by deviding the standard deviation of a volume-weighted average diameter of the organic silver salt by the volume-weighted average diameter is preferably 100% or less, more preferably 80% or less and still more preferably 50% or less. It can be determined from a particle size (volume-weighted average diameter) obtained by irradiating the organic silver salt, for examples dispersed in a liquid, with a laser light and determining a self-correlation function of a fluctuation of the scattered light to time change.
3) Preparation

For manufacturing and dispersing methods of the organic silver salt to be employed in the invention, known methods can be employed. For example, JP-A No. 10-62899, EP-A Nos. 0803763A1 and 0962812A1, JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870 and 2002-107868 can be seen.

Since the presence of a photosensitive silver salt at the time of dispersion of the organic silver salt increases fog level and significantly decreases sensitivity, it is preferable that the photosensitive silver salt is substantially absent at the time of dispersion. In the invention, the amount of the photosensitive silver salt in an aqueous dispersion in which the photosensitive silver salt is dispersed is preferably 1 mol. % or less per mole of the organic silver salt in the dispersion, more preferably 0.1 mol. % or less, and still more preferably no positive addition of photosensitive silver salt is executed.

In the invention, an aqueous dispersion of the organic silver salt and an aqueous dispersion of the photosensitive silver salt are mixed in preparing the photosensitive material. The mixing ratio of the organic silver salt to the photosensitive silver salt can be selected according to the purpose, however a proportion of the photosensitive silver salt to the organic silver salt is preferably within a range of 1 to 30 mol. %, more preferably 2 to 20 mol. %, and most preferably 3 to 15 mol. %. In order to regulate the photographic characteristics, it is preferable to mix two or more aqueous dispersions of the organic silver salt and two or more aqueous dispersions of the photosensitive silver salt.
4) Amount of Addition

The organic silver salt in the invention may be contained in a desired amount, however a total coated silver amount including silver halide is preferably within a range of 0.1 to 5.0 g/m², more preferably 0.3 to 3.0 g/m², still more preferably 0.5 to 2.5 g/m², and most preferably 0.5 to 2.0 g/m². In particular, to improve image storability, a total coated silver amount is preferably 2.2 g/m² or less, more preferably 2.0 g/m² or less, still more preferably 1.8 g/m² or less, still more preferably 1.6 g/m² or less and most preferably 1.3 g/m² or less. A reducing agent preferred in the present invention allows obtaining a sufficient image density even at such a low silver amount.

Explanations Regarding Antifogging Agent

An anti-fogging agent, a stabilizer and a stabilizer precursor employable in the invention can be compounds described in JP-A No. 10-62899, paragraph 0070, EP-A No. 0803764A1, page 20, line 57 to page 21, line 7, JP-A Nos. 9-281637 and 9-329864, U.S. Pat. Nos. 6,083,681, and European Patent No. 1048975.

Explanations Regarding Polyhalogen Compound

In the following, an organic polyhalogen compound which is an anti-fogging agent preferred in the invention will be explained in detail. In the invention, a polyhalogen compound represented by formula (H) is particularly preferable in improving image storability of an unexposed photosensitive material (raw stock storability), particularly in suppressing fog increase during storage in a dark place at a high temperature:
Q-(Y)n-C(Z₁)(Z₂)X Formula (H)

In formula (H), Q represents an alkyl group, an aryl group or a heterocyclic group; Y represents a divalent connecting group; n represents 0 or 1; Z₁ and Z₂ each represents a halogen atom; and X represents a hydrogen atom or an electron-attractive group.

In formula (H), Q is preferably an alkyl group with 1 to 6 carbon atoms, an aryl group with 6 to 12 carbon atoms or a heterocyclic group containing at least one nitrogen atom (a pyridin group or a quinoline group).

In the case where Q is an aryl group in formula (H), Q preferably represents a phenyl group substituted with an electronttractive group of which Hammett's substituent constant σp is a positive value. As to the Hammett's substituent constant, for example to Journal of Medicinal Chemistry, 1973, Vol. 16, No. 11, 1207-1216 can be seen. Such an electron-attractive group can be, for example, a halogen atom, an alkyl group substituted with an electron-attractive group, an aryl group substituted with an electron-attractive group, a heterocyclic group, an alkyl- or arylsulfonyl group, an acyl group, an alkoxycarbonyl group, a carbamoyl group or a sulfamoyl group. The electron-attractive group is preferably a halogen atom, a carbamoyl group or an arylsulfonyl group, and more preferably a carbamoyl group.

X is preferably an electron-attractive group. A preferable electron-attractive group is a halogen atom, an aliphatic, aryl or heterocyclic sulfonyl group, an aliphatic, aryl or heterocyclic acyl group, an aliphatic, aryl or heterocyclic oxycarbonyl group, a carbamoyl group or a sulfamoyl group, more preferably a halogen atom or a carbamoyl group and particularly preferably a bromine atom.

Z₁ and Z₂ each is preferably a bromine atom or an iodine atom, and more preferably a bromine atom.

Y is preferably —C(═O)—, —SO—, —SO₂—, —C(═O)N(R)— or —SO₂N(R)—, more preferably —C(═O)—, —SO₂— or —C(═O)N(R)—, and particularly preferably —SO₂— or —C(═O)N(R)—. R herein represents a hydrogen atom, an aryl group or an alkyl group, more preferably a hydrogen atom or an alkyl group, and particularly preferably a hydrogen atom.

n represents 0 or 1, and is preferably 1.

In the case where Q represents an alkyl group in formula (H), preferred Y is —C(═O)N(R)—, and, in the case where Q represents an aryl or heterocyclic group in formula (H), preferred Y is —SO₂—.

In formula (H), there can also be advantageously employed a form in which residues, formed by eliminating a hydrogen atom from the aforementioned compound, bond to each other (generally called bis, tris or tetrakis form).

In formula (H), it is also preferable that the substituent has a dissociable group (such as a COOH group or a salt thereof, a SO₃H group or a salt thereof, or a PO₃H group or a salt thereof), a group containing a quaternary nitrogen cation (such as an ammonium group or a pyridinium group), a polyethyleneoxy group or a hydroxyl group.

In the following, specific examples of the compound of formula (H) are shown.

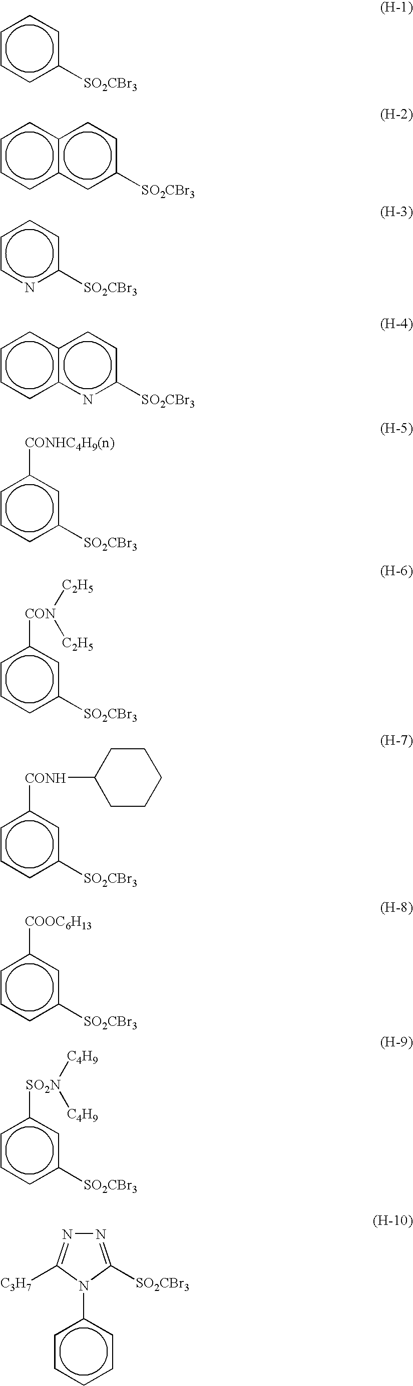

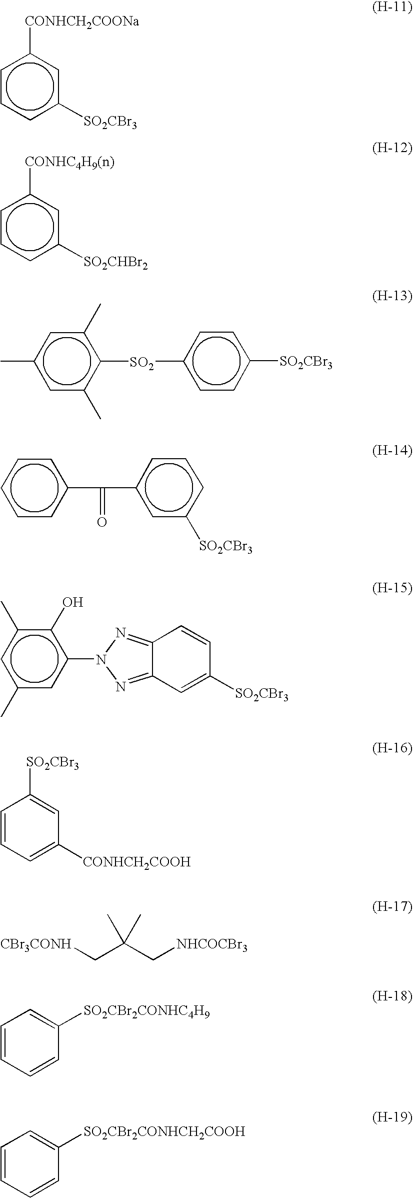

A combined use of two or more compounds represented by formula (H) is preferable in improving raw stock storability of an unexposed photosensitive material, image storability after exposure and thermal development, particularly suppressing a fog increase caused by elapse of time during storage in an unprocessed state. In this case, a combination of the compounds is so selected that a mixture containing these compounds in respective contents has a melting temperature in the range of from a temperature lower than the thermal developing temperature by 10° C. to a temperature higher than the thermal developing temperatrue by 50° C. When the thermal developing temperature is 120° C., specific preferable combinations of the compounds represented by formula (H) include (H-5) and (H-1) (the melting temperature of the mixture of 129° C., and the difference between thermal development temperatures of 9° C.), (H-2) and (H-5) (the melting temperature of the mixture of 154° C., and the difference between thermal development temperatures of 34° C.), (H-1) and (H-4) (the melting temperature of the mixture of 122° C., and the difference between thermal development temperatures of 2° C.), (H-2) and (H-4) (the melting temperature of the mixture of 132° C., and the difference between thermal development temperatures of 12° C.), and (H-4) and (H-5) (the melting temperature of the mixture of 129° C., and the difference between thermal development temperatures of 9° C.), but such examples are not restrictive.

In the case where two or more compounds represented by formula (H) are used in combination, the total coating amount of the two or more compounds per m² of the photothermographic material is preferably within a range of 1×10⁻⁶ to 1×10⁻² mol/m², more preferably 1×10⁻⁵ to 5×10⁻³ mol/m², and still more preferably 2×10⁻⁵ to 2×10⁻³ mol/m². In the combination of the compounds represented by formula (H), a proportion (molar ratio) is not particularly restricted. However, when two compounds represented by formula (H) are used, there can be employed an arbitrary proportion within a range of 0.5:99.5 to 99.5:0.5. In the case where three or more compounds represented by formula (H) are used, a total molar ratio of two compounds represented by formula (H) which do not have a highest molar ratio can be 0.5% or higher.

Other preferable polyhalogen compounds employable in the invention are described in U.S. Pat. Nos. 3,874,946, 4,756,999, 5,340,712, 5,369,000, 5,464,737, 6,506,548, JP-A Nos. 50-137126, 50-89020, 50-119624, 59-57234, 7-2781, 7-5621, 9-160164, 9-244177, 9-244178, 9-160167, 9-319022, 9-258367, 9-265150, 9-319022, 10-197988, 10-197989, 11-242304, 2000-2963, 2000-112070, 2000-284410, 2000-284412, 2001-33911, 2001-31644, 2001-312027, and 2003-50441, but compounds specifically described in JP-A Nos. 7-2781, 2001-33911 and 2001-312027 are particularly preferable.

In the invention, the polyhalogen compound is preferably used in an amount of 10⁻⁴ to 1 mole per mole of the non-photosensitive silver salt, more preferably 10⁻³ to 0.5 moles, and still more preferably 1×10² to 0.2 moles.

In the invention, the anti-fogging agent can be included in the photosensitive material by a method which is the same as the aforementioned method for including the reducing agent, and it is preferable to add the organic polyhalogen compound in the form of a solid particle dispersion.
2) Other Anti-fogging Agents

As other anti-fogging agent, there may be employed a mercury (II) salt described in JP-A No. 11-65021, paragraph 0113, a benzoic acid described in JP-A No. 11-65021, paragraph 0114, a salicylic acid derivative described in JP-A No. 2000-206642, a formalin scavenger compound represented by formula (S) in JP-A No. 2000-221634, a triazine compound described in claim 9 of JP-A No.11-352624, a compound represented by formula (III) in JP-A No. 6-11791, and 4-hydroxy-6-methyl-1,3,3a,7-tetrazaindene.

The photothermographic material of the invention may include an azolium salt for the purpose of fog prevention. The azolium salt can be a compound represented by formula (XI) in JP-A No. 59-193447, a compound described in JP-B No. 55-12581, or a compound represented by formula (II) in JP-A No. 60-153039. The azolium salt may be contained in any portion of the photosensitive material, but preferably contained in a layer on a side having the image forming layer and more preferably contained in the image forming layer. The azolium salt may be added to a composition in any step of preparation of the coating liquid. When it is to be contained in the image forming layer, it can be added within a period from the end of preparation of the organic silver salt to a time during preparation of the coating liquid, but preferably within a period from the end of the preparation of the organic silver salt to a time immediately before coating. The azolium salt may be added in any form, such as powder, a solution or a dispersion of fine particles. Also it may be added as a mixed solution with another additive such as a sensitizing dye, a reducing agent or a color toning agent. In the invention, the azolium salt may be added in any amount, but the amount is preferably from 1×10⁻⁶ to 2 moles per mole of silver, and more preferably from 1×10⁻³ to 0.5 moles.

Explanations Regarding Reducing Agent

The photothermographic material of the invention preferably includes a reducing agent for the organic silver salt. The reducing agent for the organic silver salt can be an arbitrary substance (preferably organic substance) capable of reducing a silver ion into metallic silver. Examples of such reducing agent are described in JP-A No. 11-65021, paragraphs 0043-0045 and EP-A No. 0803764A 1, page 7, line 34 to page 18, line 12.

A reducing agent employed in the invention is preferably a bisphenol reducing agent or a so-called hindered phenol reducing agent having a substituent in an ortho-position with respect to a phenolic hydroxyl group, and more preferably a compound represented by formula (R):

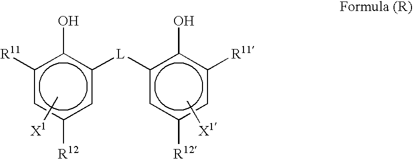

In formula (R), R¹¹ and R^{11′} each independently represents an alkyl group with 1 to 20 carbon atoms; R¹² and R^{12′} each independently represents a hydrogen atom or a substituent substitutable on a benzene ring; L represents —S— or —CHR¹³—; R¹³ represents a hydrogen atom or an alkyl group with 1 to 20 carbon atoms; and X¹ and X^{1′} each independently represents a hydrogen atom or a group substitutable on a benzene ring.

In the following, there will be given a detailed explanation regarding formula (R).

In the following, an alkyl group contains a cycloalkyl group unless otherwise indicated.
1) R¹¹ and R^{11′}

R¹¹ and R^{11′} each independently represents a substituted or unsubstituted alkyl group with 1 to 20 carbon atoms. A substituent on the substituted alkyl group is not particularly limited, but is preferably an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group, an ureido group, an urethane group or a halogen atom.
2) R¹² and R^{12′}, X¹ and X^{1′}

R¹² and R^{12′} each independently represents a hydrogen atom or a group substitutable on a benzene ring, and X¹ and X^{1′} each independently represents a hydrogen atom or a group substitutable on a benzene ring. Each of groups substitutable on a benzene ring is preferably an alkyl group, an aryl group, a halogen atom, an alkoxy group or an acylamino group.
3) L

L represents an —S— group or a —CHR¹³— group. R¹³ represents a hydrogen atom or an alkyl group with 1 to 20 carbon atoms, and the alkyl group may have a substituent. Specific examples of the unsubstituted alkyl group as R¹³ include a methyl group, an ethyl group, a propyl group, a butyl group, a heptyl group, an undecyl group, an isopropyl group, a 1-ethylpentyl group, a 2,4,4-trimethylpentyl group, a cyclohexyl group, a 2,4-dimethyl-3-cyclohexenyl group and a 3,5-dimethyl-3-cyclohexenyl group. Examples of the substituent of the substituted alkyl group are the same as those for R¹¹, and include a halogen atom, an alkoxy group, an alkylthio group, an aryloxy group, an arylthio group, an acylamino group, a sulfonamide group, a sulfonyl group, a phosphoryl group, an oxycarbonyl group, a carbamoyl group and a sulfamoyl group.
4) Preferred Substituent

Each of R¹¹ and R^{11′} is preferably a primary, secondary or tertiary alkyl group with 1 to 15 carbon atoms, and can specifically be a methyl group, an isopropyl group, a tbutyl group, a t-amyl group, a t-octyl group, a cyclohexyl group, a cyclopentyl group, a 1-methylcyclohexyl group or a 1-methylcyclopropyl group. Each of R¹¹ and R^{11′} is more preferably an alkyl group with 1 to 4 carbon atoms, and still more preferably a methyl group, a tbutyl group, a t-amyl group or a 1-methylcyclohexyl group and most preferably a methyl group or a t-butyl group.

Each of R¹² and R^{12′} is preferably an alkyl group with 1 to 20 carbon atoms, and can specifically be a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, or a methoxyethyl group, more preferably a methyl group, an ethyl group, a propyl group, an isopropyl group or a tbutyl group, and particularly preferably a methyl group or an ethyl group.

Each of X¹ and X^{1′} is preferably a hydrogen atom, a halogen atom, or an alkyl group, and more preferably a hydrogen atom.

L is preferably a —CHR¹³— group.

R¹³ is preferably a hydrogen atom or an alkyl group with 1 to 15 carbon atoms, and the alkyl group is preferably linear or cyclic. An alkyl group having a C═C bond can also be employed advantageously. Such an alkyl group can be, for example, a methyl group, an ethyl group, a propyl group, an isopropyl group, a 2,4,4-trimethylpentyl group, a cyclohexyl group, a 2,4-dimethyl-3-cyclohexenyl group or a 3,5-dimethyl-3-cyclohexenyl group. R¹³ is particularly preferably a hydrogen atom, a methyl group, an ethyl group, a propyl group or an isopropyl group, or a 2,4-dimethyl-3-cyclohexenyl group.

In the case where R¹¹ and R^{11′} are tertiary alkyl groups and R¹² and R^{12′} are methyl groups, R¹³ is preferably a primary or secondary alkyl group with 1 to 8 carbon atoms (such as a methyl group, an ethyl group, a propyl group, an isopropyl group, or a 2,4-dimethyl-3-cyclohexenyl group).

In the case where R¹¹ and R^{11′} are tertiary alkyl groups and R¹² and R^{12′} are alkyl groups other than a methyl group, R¹³ is preferably a hydrogen atom.

In the case where R¹¹ and R^{11′} are not tertiary alkyl groups, R¹³ is preferably a hydrogen atom or a secondary alkyl group, and particularly preferably a secondary alkyl group. The secondary alkyl group as R¹³ is preferably an isopropyl group or a 2,4-dimethyl-3-cyclohexenyl group.

Themal development property of the aforementioned reducing agent and the color of developed silver depend on combinations of R¹¹, R^{11′}, R¹², R^{12′} and R¹³. These properties can be regulated by employing two or more reducing agents in various mixing ratios, and it may be preferable to employ two or more reducing agents in some cases.

In the invention, among the reducing agents represented by formula (R), a reducing agent represented by formula (R1) is more preferable.

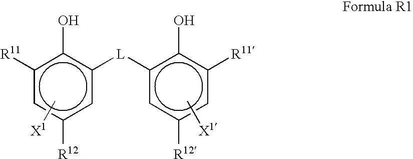

Formula (R1) has definitions for R¹¹ and R^{11′} different from those in formula (R). R¹¹ and R^{11′} each independently represents a secondary or tertiary alkyl group with 1 to 15 carbon atoms. R¹², R^{12′}, L, X¹ and X^{1′} are same as those in formula (R).

In the following, specific examples of the reducing agent used in the invention, including the compounds represented by formula (R), are shown, but the invention is not limited by such examples.

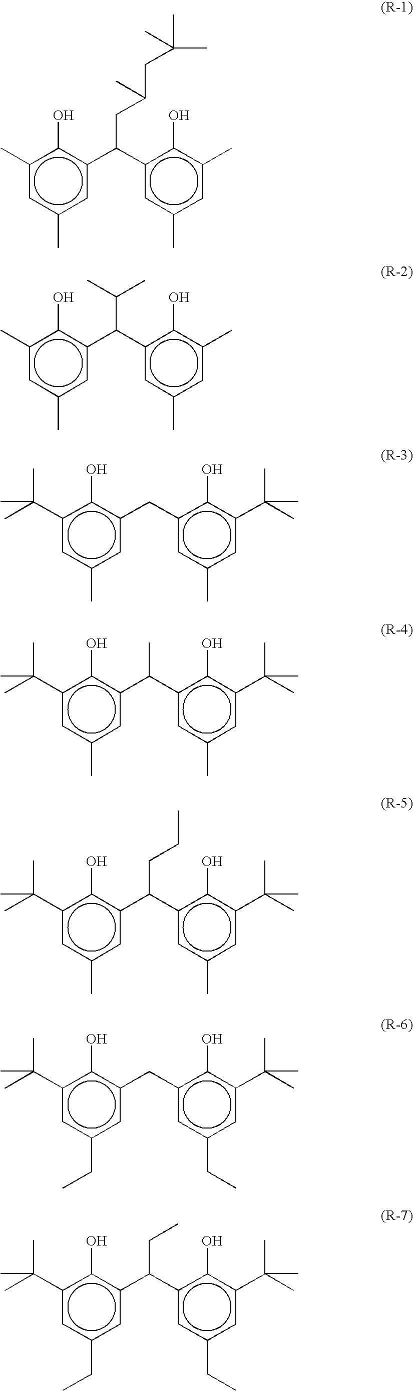

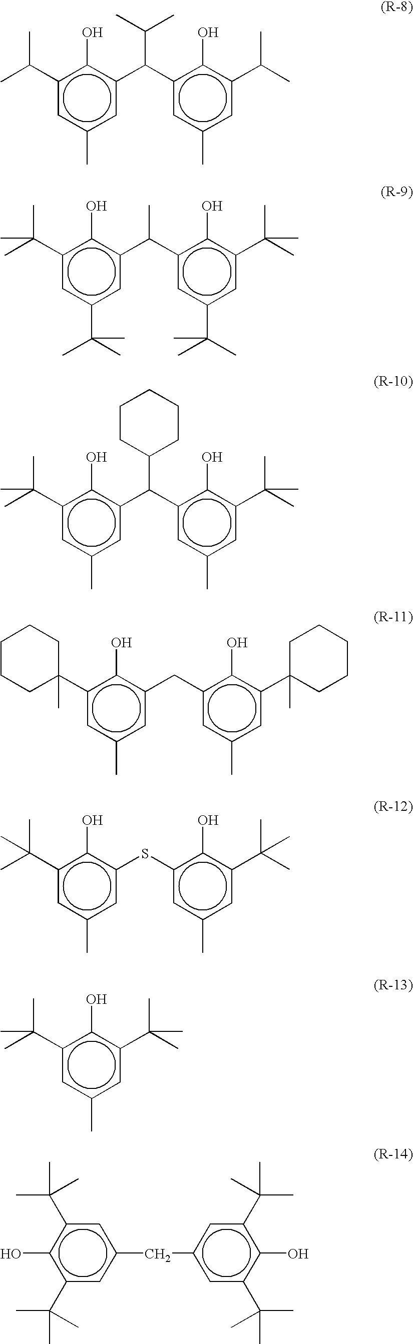

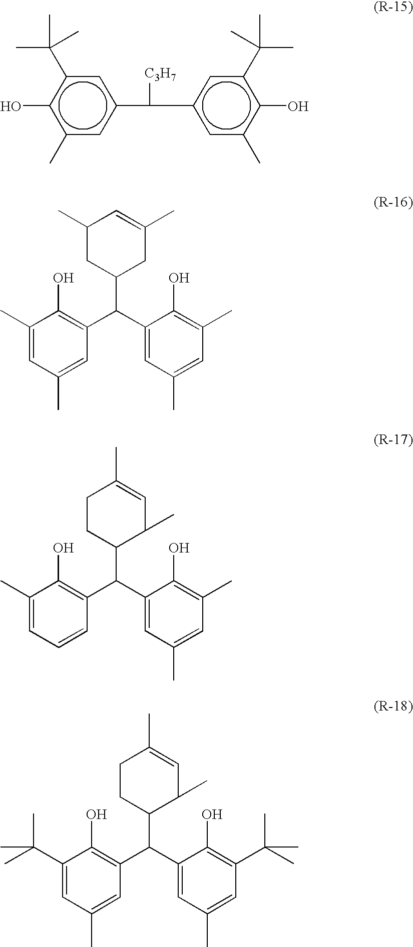

Other preferred examples of the reducing agent used in the invention are compounds described in JP-A Nos. 2001-188314, 2001-209145, 2001-350235 and 2002-156727, and EP No. 1278101A2.

In the invention, the reducing agent is preferably added in an amount of 0.1 to 3.0 g/m², more preferably 0.2 to 2.0 g/m², and still more preferably 0.3 to 1.0 g/m² in the entire of the photothermographic material. It is preferably included in an amount of 5 to 50 mol. % per mole of silver on the surface having the image forming layer, more preferably 8 to 30 mol. %, and still more preferably 10 to 20 mol. %.

The reducing agent may be contained in the coating liquid and in the photosensitive material in any form, such as a solution, an emulsified dispersion or a dispersion of fine solid particles.

In a well known method for preparing an emulsified dispersion, the reducing agent is dissolved in oil such as dibutyl phthalate, tricresyl phosphate, dioctyl sebacate or tri(2-ethylhexyl) phosphate or an auxiliary solvent such as ethyl acetate or cyclohexanone, adding a surfactant such as sodium dodecylbenzenesulfonate, sodium oleyl-N-methyltaurinate, or sodium di(2-ethylhexyl) sulfosuccinate to the resultant and mechanically mixing it to prepare an emulsified dispersion. In this operation, it is also preferable to add a polymer such as an α-methylstyrene oligomer or poly(t-butylacrylamide) for the purpose of regulating the viscosity or refractive index of oil droplets.

In order to disperse solid particles, there can be employed a method of dispersing powder of a reducing agent in a suitable solvent such as water with a ball mill, a colloid mill, a vibrating ball mill, a sand mill, a jet mill, a roller mill or an ultrasonic wave to thereby obtain a solid dispersion. In such method, there may be employed a protective colloid (such as polyvinyl alcohol) or a surfactant (for example, an anionic surfactant such as sodium triisopropylnaphthalenesulfonate (a mixture of compounds with different substituting positions of three isopropyl groups). In the above-mentioned mills, beads such as zirconia beads are usually employed as a dispersion medium, and the dispersion may be contaminated with zirconium or the like dissolving out of such beads. Its content depends on dispersing conditions, but is usually within a range of 1 to 1000 ppm. A content in the photosensitive material of 0.5 mg or less per g of silver is at practically acceptable level.

The aqueous dispersion preferably includes an antiseptic (such as sodium benzoisothiazolinone).

A particularly preferred method is a method of dispersing fine solid particles of the reducing agent, and the agent is added in a state of fine particles preferably having an average particle size of 0.01 to 10 μm, more preferably 0.05 to 5 μm, and still more preferably 0.1 to 2 μm. In the invention, it is preferable to adjust the particle sizes of other solid dispersions to such a range.

Explanations Regarding Development Accelerator

In the invention, a development accelerator is preferably employed.

As the development accelerator to be employed in the photothermographic material of the invention, there is preferably employed a sulfonamidephenol compound represented by formula (A) in JP-A Nos. 2000-267222 and 2000-330234, a hindered phenol compound represented by formula (II) in JP-A No. 2001-92075, a hydrazine compound disclosed in JP-A No. 10-62895 and represented by formula (I) of JP-A No. 11-15116, by formula (D) in JP-A No. 2002-156727 and by formula (1) in JP-A No. 2002-278017, or a phenol or naphthol compound represented by formula (2) in JP-A No. 2001-264929. There is also preferred a phenol compound described in JP-A Nos. 2002-311533 and 2002-341484. A naphthol compound described in JP-A No. 2003-66558 is particularly preferable.

In the invention, the development accelerator is preferably used in an amount of 0.1 to 20 mol. % with respect to the reducing agent, more preferably 0.5 to 10 mol. % and still more preferably 1 to 5 mol. %.

It can be introduced into the photosensitive material by a method similar to amethod for introducing the reducing agent into the material, and it is particularly preferably added as a solid dispersion or an emulsified dispersion. In the case where it is added as an emulsified dispersion, an emulsified dispersion in which the development accelerator is dispersed in a high-boiling solvent, which is solid at ordinary temperature, and a low-boiling auxiliary solvent, or so-called oilless emulsified dispersion prepared without the high-boiling solvent is preferably added.

In the invention, among the aforementioned development accelerators, a hydrazine compound described in JP-A Nos. 2002-156727 and 2002-278017, and a naphthol compound described in JP-A No. 2003-66558 are more preferable.

In the invention, a particularly preferred development accelerator is a compound represented by formula (A-1) or (A-2).
Q₁-NHNH₂ Formula (A-1)

In the formula, Q₁ represents an aromatic group having a carbon atom bonded to —NHNH-Q₂, or a heterocyclic group; and Q₂ represents a carbamoyl group, an acyl group, an alkoxycarbonyl group, an aryloxycarbonyl group, a sulfonyl group or a sulfamoyl group.

In formula (A-1), the aromatic group or the heterocyclic group represented by Q₁ is preferably a 5- to 7-membered unsaturated ring. Preferred examples thereof include a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isooxazole ring and a thiophene ring, and there are also preferred condensed rings formed by mutual condensation of these rings.

These rings may have a substituent, and, in the case where the rings have two or more substituents, these substituents may be the same or different. Examples of the substituent include a halogen atom, an alkyl group, an aryl group, a carbonamide group, an alkylsulfonamide group, an arylsulfonamide group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group and an acyl group. In the case where such substituent is a substitutable group, it may further have a substituent, and examples of preferred substituent include a halogen atom, an alkyl group, an aryl group, a carbonamide group, an alkylsulfonamide group, an arylsulfonamide group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group and an acyloxy group.

The carbamoyl group represented by Q₂ preferably has 1 to 50 carbon atoms, and more preferably 6 to 40 carbon atoms, and can be, for example, an unsubstituted carbamoyl, methylcarbamoyl, N-ethylcarbamoyl, N-propylcarbamoyl, N-secbutylcarbamoyl, N-octylcarbamoyl, N-cyclohexylcarbamoyl, N-tert-butylcarbamoyl, N-dodecylcarbamoyl, N-(3-dodecyloxypropyl) carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl) carbamoyl, N-(2-chloro-5-dodecyloxylcarbonylphenyl)carbamoyl, N-naphthylcarbamoyl, N-3-pyridylcarbamoyl, or N-benzylcarbamoyl group.

The acyl group represented by Q₂ preferably has 1 to 50 carbon atoms, and more preferably 6 to 40 carbon atoms, and can be, for example, a formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, or 2-hydroxymethylbenzoyl group. The alkoxycarbonyl group represented by Q₂ preferably has 2 to 50 carbon atoms, and more preferably 6 to 40 carbon atoms, and can be, for example, a methoxycarbonyl, ethoxycarbonyl, isobutyloxycarbonyl, cyclohexyloxycarbonyl, dodecyloxycarbonyl or benzyloxycarbonyl group.

The aryloxycarbonyl group represented by Q₂ preferably has 7 to 50 carbon atoms, and more preferably 7 to 40 carbon atoms, and can be, for example, a phenoxycarbonyl, 4-octyloxyphenoxycarbonyl, 2-hydroxymethylphenoxycarbonyl, or 4-dodecyloxyphenoxycarbonyl group. The sulfonyl group represented by Q₂ preferably has 1 to 50 carbon atoms, and more preferably 6 to 40 carbon atoms, and can be, for example, a methylsulfonyl, butylsulfonyl, octylsulfonyl, 2-hexadecylsulfonyl, 3-dodecyloxypropylsulfonyl, 2-octyloxy-5-tert-octylphenylsulfonyl or 4-dodecyloxyphenylsulfonyl group.

The sulfamoyl group represented by Q₂ preferably has 0 to 50 carbon atoms, and more preferably 6 to 40 carbon atoms, and can be, for example, an unsubstituted sulfamoyl, N-ethylsulfamoyl, N-(2-ethylhexyl)sulfamoyl, N-decylsulfamoyl, N-hexadecylsulfamoyl, N-{3-(2-ethylhexyloxy) propyl}sulfamoyl, N-(2-chloro-5-dodecyloxycarbonylphenyl)sulfamoyl, or N-(2-tetradecyloxyphenyl) sulfamoyl group. The group represented by Q₂ may further have, in a substitutable position, at least one of the groups which are exemplified before as examples the substituent group for the 5-to 7membered unsaturated ring represented by Q₁, and, in the case where the group has two or more substituents, they may be the same or different.

In the following, there will be explained a preferred examples of the compound represented by the formula (A-1). For Q₁, there is preferred a 5- or 6-membered unsaturated ring, and more preferred is a benzene ring, a pyrimidine ring, a 1,2,3-triazole ring, a 1 ,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring, an isooxazole ring or rings formed by condensation of the aforementioned ring with a benzene ring or an unsaturated hetero ring. Q₂ is preferably a carbamoyl group, and more preferably a carbamoyl group having a hydrogen atom on a nitrogen atom.

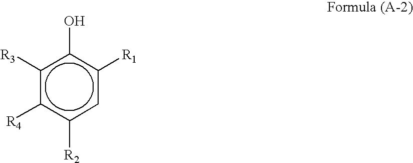

In formula (A-2), R₁ represents an alkyl group, an acyl group, an acylamino group, a sulfonamide group, an alkoxycarbonyl group, or a carbamoyl group. R₂ represents a hydrogen atom, a halogen atom, an alkyl group, an alkoxy group, an aryloxy group, an alkylthio group, an arylthio group, an acyloxy group or a carbonic ester group. R₃ and R₄ each represents a group substitutable on the benzene ring, whose examples are the same as those of the substituent in formula (A-1). R₃ and R₄ may bond to each other to form a condensed ring.

R₁ is preferably an alkyl group with 1 to 20 carbon atoms (such as a methyl group, an ethyl group, an isopropyl group, a butyl group, a tert-octyl group, or a cyclohexyl group), an acylamino group (such as an acetylamino group, a benzoylamino group, a methylureido group or a 4-cyanophenylureido group), or a carbamoyl group (such as an n-butylcarbamoyl group, an N,N-diethylcarbamoyl group, a phenylcarbamoyl group, a 2-chlorophenylcarbamoyl group, or a 2,4-dichlorophenylcarbamoyl group), and more preferably an acylamino group (including an ureido group and an urethane group). R₂ is preferably a halogen atom (more preferably a chlorine atom or a bromine atom), an alkoxy group (such as a methoxy group, a butoxy group, an n-hexyloxy group, a n-decyloxy group, a cyclohexyloxy group, or a benzyloxy group), or an aryloxy group (such as a phenoxy group or a naphthoxy group).

R₃ is preferably a hydrogen atom, a halogen atom or an alkyl group with 1 to 20 carbon atoms, and a halogen atom is most preferable. R₄ is preferably a hydrogen atom, an alkyl group, or an acylamino group, and an alkyl group or an acylamino group is more preferable. Preferred examples of such substituents are similar to those for RI. In the case where R₄ is an acylamino group, it is preferable that R₄ bonds to R₃ to form a carbostyryl ring.

In formula (A-2), in the case where R₃ and R₄ bond to each other to form a condensed ring, a naphthalene ring is particularly preferable as such a condensed ring. The naphthalene ring may have a substituent of which examples are the same as those of the substituent in formula (A-1). In the case where formula (A-2) represents a naphthol compound, R₁ is preferably a carbamoyl group, and particularly a benzoyl group. R₂ is preferably an alkoxy group or an aryloxy group, and more preferably an alkoxy group.

In the following, specific preferred examples of the development accelerator are shown, but the invention is not limited by such examples. 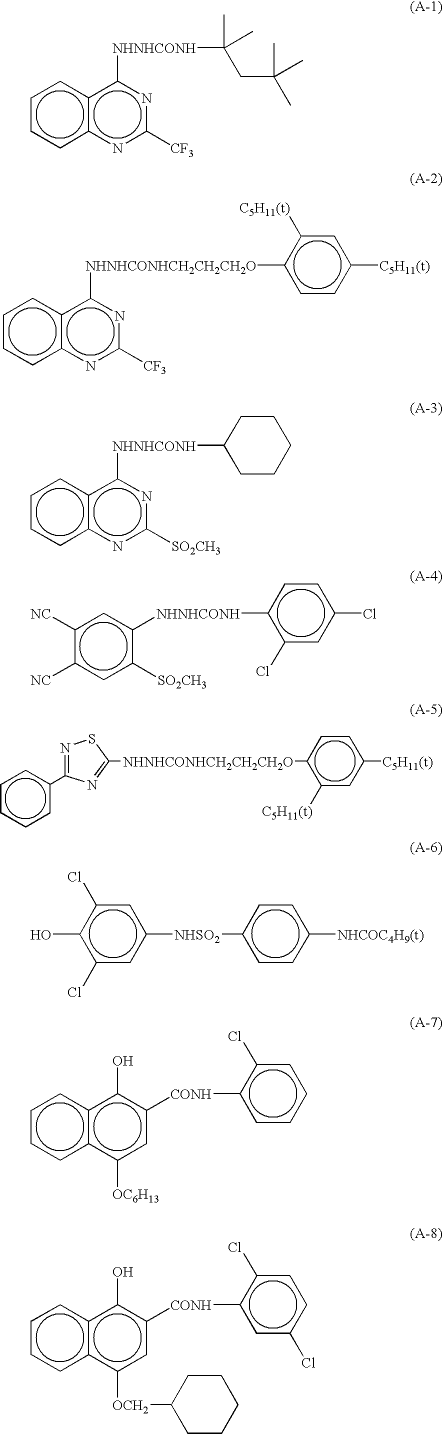 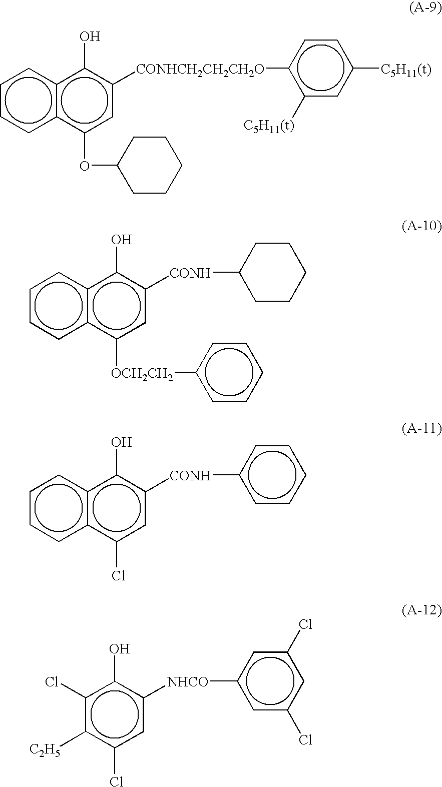
Explanations Regarding Hydrogen Bonding Compound

In the invention, in the case where the reducing agent has an aromatic hydroxyl group (—OH) or an amino group (—NHR, R being a hydrogen atom or an alkyl group), particularly in the case where it is the aforementioned bisphenol, it is preferable to employ a non-reducing compound having a group capable of forming a hydrogen bond with such a group.

A group capable of forming a hydrogen bond with the hydroxyl group or the amino group can be, for example, a phosphoryl group, a sulfoxide group, a sulfonyl group, a carbonyl group, an amide group, an ester group, an urethane group, an ureido group, a tertiary amino group or a nitrogen-containing aromatic group. Among these, a compound having a phosphoryl group, a sulfoxide group, an amide group (however not including >N—H but blocked in the form of >N—Ra (Ra being a substituent other than H)), an urethane group (however not including >N—H but blocked in the form of >N—Ra (Ra being a substituent other than H)), or an ureido group (however not including >N—H but blocked in the form of >N—Ra (Ra being a substituent other than H)) is preferable.

In the invention, a particularly preferred hydrogen bonding compound is represented by formula (D):

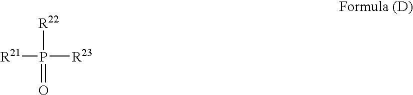

In formula (D), R²¹ to R²³ each independently represents an alkyl group, an aryl group, an alkoxy group, an aryloxy group, an amino group or a heterocyclic group, which may be unsubstituted or may have a substituent.

In the case where any of R²¹ to R²³ has a substituent, the substituent can be a halogen atom, an alkyl group, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group or a phosphoryl group. Among there, an alkyl group or an aryl group such as a methyl group, an ethyl group, an isopropyl group, a t-butyl group, a t-octyl group, a phenyl group, a 4-alkoxyphenyl group or a 4-acyloxylphenyl group is preferable.

Specific examples of the alkyl group serving as R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenetyl group, and a 2-phenoxypropyl group.

Specific examples of the aryl group include a phenyl group, a cresyl group, a xylyl group, a naphthyl group, a 4-t-butylphenyl group, a 4-t-octylphenyl group, a 4-anisidyl group and a 3,5-dichlorophenyl group.

Specific examples of the alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group and a benzyloxy group.

Specific examples of the aryloxy group include a phenoxy group, a cresyloxy group, an isopropylphenoxy group, a 4-t-butylphenoxy group, a naphthoxy group and a biphenyloxy group.

Specific examples of the amino group include a dimethylamino group, a diethylamino group, a dibutylamino group, a dioctylamino group, an N-methyl-N-hexylamino group, a dicyclohexylamino group, a diphenylamino group and an N-methyl-N-phenylamino group.

Each of R²¹ to R²³ is preferably an alkyl group, an aryl group, an alkoxy group, or an aryloxy group. From the viewpoint of the effect of the invention, it is preferable that at least one of R²¹ to R²³ is an alkyl group or an aryl group. It is more preferable that two or more of R²¹ to R²³ each are an alkyl group or an aryl group. It is also preferred that R²¹ to R²³ are the same groups, in consideration of inexpensive availability.

In the following, specific examples of the hydrogen bonding compound, including the compound of formula (D), are shown, but the invention is not limited by such examples.

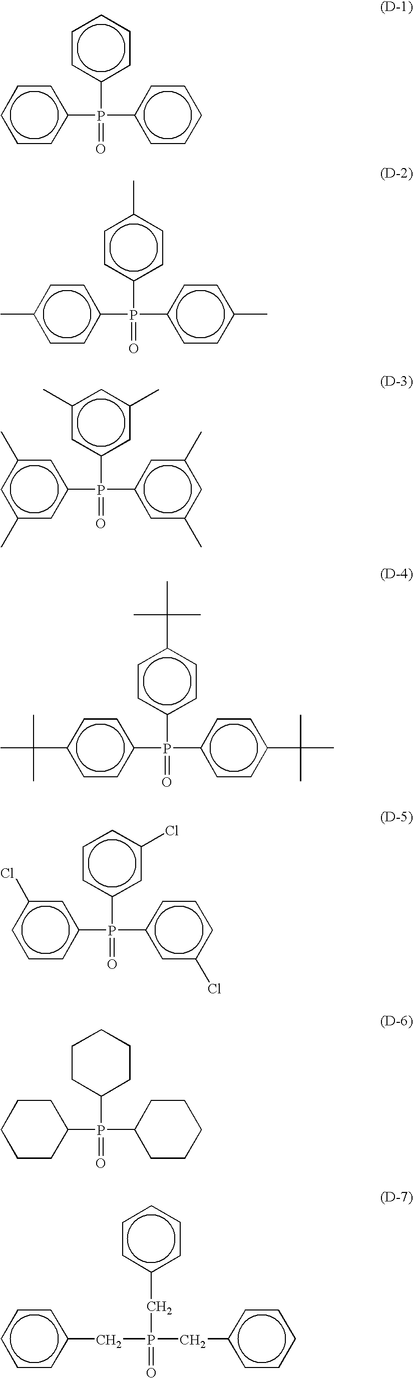

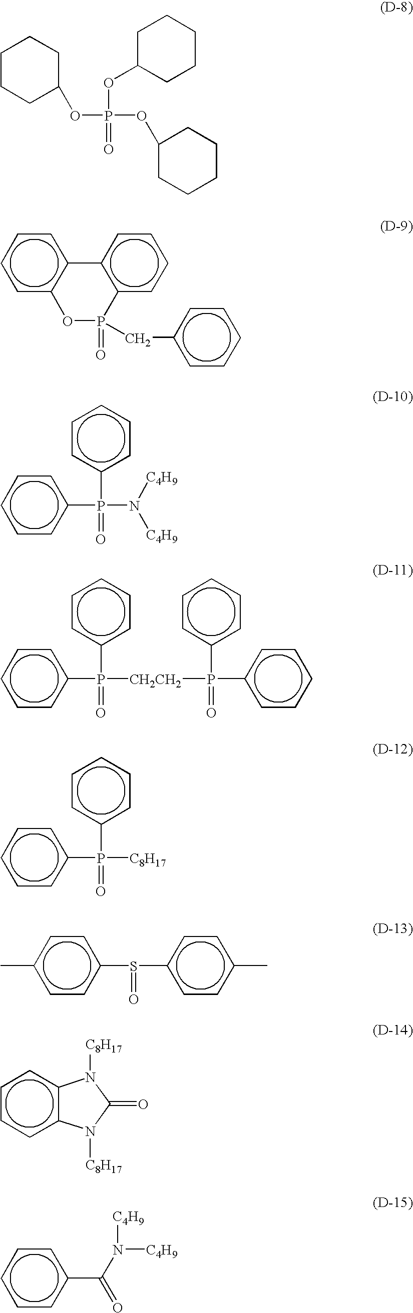

Specific examples of the hydrogen bonding compound, other than those in the foregoing, are described in European Patent No. 1096310, JP-A Nos. 2002-156727 and 202-318431.

As in the reducing agent, the compound of formula (D) may be contained in the coating liquid and used in the photosensitive material for example in a form of a solution, an emulsified dispersion or a dispersion of fine solid particles, however is preferably used as a solid dispersion. The compound forms, in the solution, a complex by a hydrogen bonding with a compound having a phenolic hydroxyl group or an amino group, and the crystal of the complex may be isolated depending on a combination of the reducing agent and the compound of formula (D).

In order to obtain a stable performance, it is particularly preferable to use the isolated crystalline powder in a dispersion of fine solid particles. There is also preferably employed a method of mixing the reducing agent and the compound of formula (D) in a powder state, and forming a complex at the time of dispersion in a sand grinder mill with a suitable dispersant.

The compound of formula (D) is preferably contained in an amount of 1 to 200 mol. % with respect to the reducing agent, more preferably in an amount of 10 to 150 mol. % and still more preferably in an amount of 20 to 100 mol. %.

Explanations Regarding Silver Halide

1) Halogen Composition

The halogen composition of a photosensitive silver halide to be employed in the first and second aspects of the invention is not particularly restricted, and the photosensitive silver halide can be silver chloride, silver chlorobromide, silver bromide, silver iodobromide, silver iodochlorobromide, or silver iodide. Among these, silver bromide, silver iodobromide or silver iodide is preferable.

In a photosensitive silver halide to be employed in the third to sixth aspects of the invention, it is important that the silver iodide content is high and is 40 to 100 mol. %. The remainder is not particularly restricted, and can be selected from silver chloride, silver bromide or an organic silver salt such as silver thiocyanate or silver phosphate, but is preferably silver bromide or silver chloride. The silver halide of a composition with such a high silver iodide content allows designing a preferable photothermographic material having excellent image storability after development, particularly very little fog increase which is caused by light irradiation.

The silver iodide content is preferably 80 to 100 mol. %, more preferably 85 to 100 mol. %, and still more preferably 90 to 100 mol. %, in view of image storability after processing which is caused by light irradiation.

The halogen composition within a grain may be uniform, or show a stepwise change or a continuous change. There may also be preferably employed a silver halide grain having a core/shell structure. A core/shell grain preferably has a 2- to 5-layered structure, and more preferably a 2- to 4-layered structure. In the third to sixth aspects, there can be also preferably employed grains whose core has a high silver iodide content, or grains whose shell has a high silver iodide content. It is also possible to advantageously employ a technique of localizing silver chloride, silver bromide or silver iodide as an epitaxial portion on the surfaces of grains of silver chloride, silver bromide or silver chlorobromide.

In the photothermographic material of the first and second aspet of the invention to be exposed with an X-ray fluorescent screen, in consideration of image storability with respect to light irradiation after processing, it is preferable to employ silver halide of a high silver iodide content. The silver iodide content in silver halide is preferably 40 to 100 mol. %, more preferably 70 to 100 mol. %, still more preferably 80 to 100 mol. % and most preferably 90 to 100 mol. %.
2) Grain Forming Method

A method for forming photosensitive silver halide grains is well known in the related art, and there can be utilized, for example, methods described in Research Disclosure 17029, June 1978 and U.S. Pat. No. 3,700,458. More specifically, there is employed a method in which a silver supplying compound and a halogen supplying compound are added to a solution of gelatin or other polymer to thereby prepare a photosensitive silver halide, and the phorosensitive silver halide is mixed with an organic silver salt. There are also known a method described in JP-A No. 11-119374, paragraphs 0217 to 0224, and methods described in JP-A No. 11-352627, and Japanese Patent Application Nos. 2000-42336 and 2000-347335.
3) Grain Size

In the photothermographic material of the first aspect of the invention to be exposed with an X-ray fluorescent screen, a sufficiently large grain size of the photosensitive silver halide to attain a high sensitivity can be selected. In particular, a photothermographic material having image forming layers on both sides requires increased sensitivity. In such a case, the silver halide preferably has an average sphere-corresponding diameter of 0.3 to 5.0 μm, and more preferably 0.35 to 3.0 μm. The sphere-corresponding diameter mentioned above means a diameter of a circle having the same area as the projected area of a silver halide grain (projected area of a principal plane in the case of a tabular grain).

In the silver halide of a high silver iodide content to be employed in the third to sixth aspects of the invention, the grain size is particularly important. A larger size of silver halide increases a coating amount of silver halide needed to attain a necessary maximum density. The inventors have found that, when employed in an increased coating amount, the silver halide of composition with a high silver iodide content employed preferably in the invention significantly suppresses development, resulting in a low sensitivity and deteriorated stability of density with respect to developing time and, when the grain size exceeds a certain value, making it imposibble to obtain a maximum density at a predetermined developing time. On the other hand, it has also found that sufficient developability can be attained, even when silver iodide is used, if the amount thereof is limited.

Thus, in the case of a high silver iodide content, it is necessary that the size of the silver halide grains re sufficiently smaller than that of silver bromide or silver iodobromide of a low iodine content, which is conventionally used, in order to attain a sufficient maximum optical density. The grain size of silver halide is preferably 0.001 to 0.15 μm, more preferably 0.01 to 0.10 μm, and still more preferably 0.02 to 0.04 μm.
4) Grain Shape

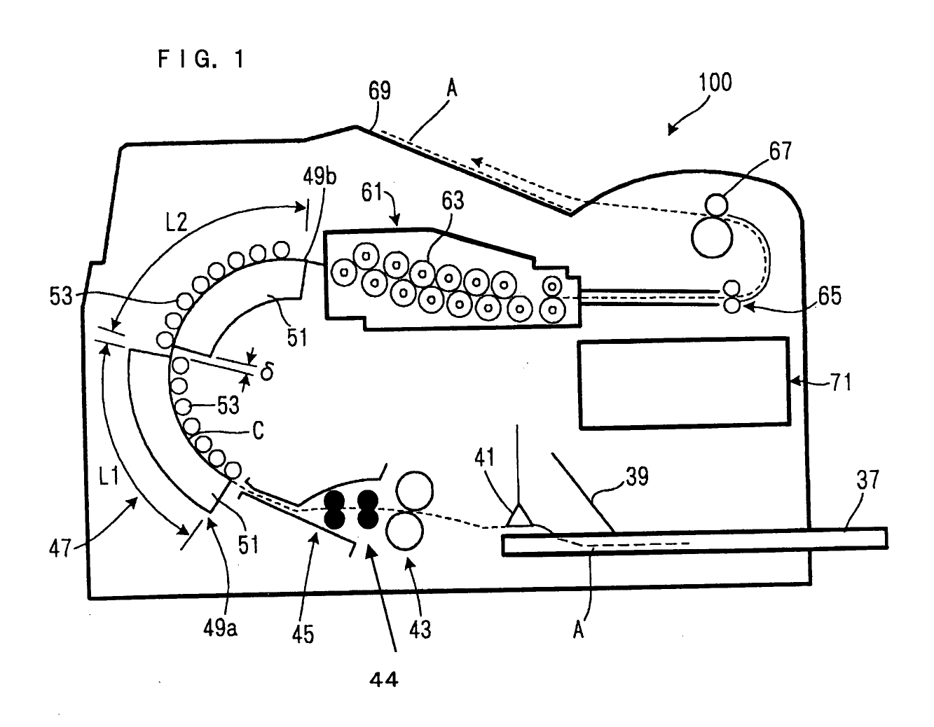

In the first and second aspects, silver halide grains can have a cubic shape, an octahedral shape, a tabular shape, a spherical shape, a rod shape, or a potato-like shape, and the silver halide of a high silver iodide content preferably employed in the photothermographic material of the invention to be exposed with an X-ray fluorescent screen, can have a complex shape. A preferred shape can, for example, be a jointed grain, as shown in R. L. Jenkins et al., J. of Phot. Sci., Vol. 28(1980), p. 164, FIG. 1. A tabular grain as shown in the FIG. 1 can also be employed preferably.

In the third to sixth aspects of the invention, silver halide grains can have a cubic shape, an octahedral shape, a dodecahedral shape, a tetradecahedral shape, a tabular shape, a spherical shape, a rod shape, or a potato-like shape, but a dodecahedral shape, a tetradecahedral shape or a spherical shape is preferred in the invention. The dodecahedral grain is a grain having (001), {1(−1)0} and {101} planes, and the tetradecahedral grain is a grain having (001), {100} and {101} planes. {100} indicates a group of planes having a plane index equivalent to that of a (100) plane.

Silver iodide in the invention can have any contents of β-phase and γ-phase. β-phase indicates a high silver iodide content structure having a hexagonal wurtzite structure, and γ-phase indicates a high silver iodide content structure having a cubic zinc blend structure.

An average γ-phase content is determined by a method proposed by C. R. Berry. This method is based on a peak ratio, in powder X-ray diffractometry, of silver iodide β-phase (100), (101) and (002) and γ-phase (111). As to the details, for example, Physical Review, Vol. 161, No. 3, pages 848-851 (1967) can be seen.

Regarding forming tabular grains of silver iodide, there can be advantageously employed methods described in JP-A Nos. 59-119350 and 59-119344. Dodecahedral, tetradecahedral and octahedral grains can be prepared based on Japanese Patent Application Nos. 2002-081020, 2002-87955 and 2002-91756.

Silver halide of a high silver iodide content preferably employed in the invention can have a complex shape, but a preferred shape can, for example, be a jointed grain, as shown in R. L. Jenkins et al., J. of Phot. Sci., Vol. 28 (1980), p. 164, FIG. 1. A tabular grain as shown in the FIG. 1 mentioned above can also be employed preferably. There can also be advantageously employed silver halide grains of which corners are rounded. The plane index (Miller's index) of the external surface of the photosensitive silver halide grains are not particularly restricted. However, it is preferable that a [100] plane, which has a high spectral sensitization efficiency in adsorbing a spectral sensitizing dye, has a high proportion. The proportion is preferably 50% or higher, more preferably 65% or higher, and still more preferably 80% or higher. The Miller's index or a proportion of the [100] plane can be determined by a method described in T. Tani; J. Imaging Sci., 29, 165 (1985), utilizing adsorption dependences of [111] and [100] planes in adsorving a sensitizing dye.
5) Heavy Metal

The photosensitive silver halide grains of the invention may include a metal or a metal complex of Groups 3 to 13 of the periodic table having Groups 1 to 18. A metal or the central metal of a metal complex belonging to Groups 8 to 10 of the periodic table is preferably rhodium, ruthenium or iridium. Such metal complex may be used alone, or in a combination of two or more complexes of the same metal or different metals. The preferred content is within a range of 1×10⁻⁹ to 1×10⁻³ moles per mole of silver. Such heavy metals, complexes thereof and method of addition thereof are described in JP-A Nos. 7-225449, 11-65021, paragraphs 0018 to 0024, and 11-119374, paragraphs 0227 to 0240.

In the invention, there are preferred silver halide grains in which a hexacyano metal complex is present at the outermost surface of the grains. Examples of the hexacyano metal complex include [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. In the invention, a hexacyano Fe complex is preferred.

A counter cation is not important since the hexacyano metal complex is present in an ionic state in an aqueous solution. However, it is preferable to employ an ion that is easily miscible with water and is adapted to a precipitating operation of silver halide emulsion, for example an alkali metal ion such as a sodium ion, a potassium ion, a rubidium ion, a cesium ion or a lithium ion, an ammonium ion or an alkylammonium ion (such as a tetramethylammonium ion, a tetraethylammonium ion, a tetrapropylammonium ion or a tetra(n-butyl)ammonium ion).

The hexacyano metal complex can be added to the system in a form of a solution obtained by mixing it with water or a mixed solvent of water and a suitable watermiscible organic solvent (for example alcohol, ether, glycol, ketone, ester or amide), or added with gelatin to the system.

The amount of the hexacyano metal complex is preferably 1×10⁻⁵ to 1×10⁻² moles per mole of silver, and more preferably 1×10⁻⁴ to 1×10⁻³ moles.

In order to localize the hexacyano metal complex at the outermost surface of silver halide grains, the hexacyano metal complex is directly added to the system within a period from the end of an addition of an aqueous silver nitrate solution for grain formation to the starting of a chemical sensitization step for a sulfur sensitization, a chalcogen sensitization such as selenium sensitization or tellurium sensitization, or a precious metal sensitization such as gold sensitization, namely before the end of a charging step, during a rinsing step or a dispersing step, or before a chemical sensitization step. In order not to cause a growth of the silver halide fine grains, it is preferable to add the hexacyano metal complex promptly after the grain formation, thus executing the addition before the end of the charging step.

The addition of the hexacyano metal complex may be started after 96 mass % of the total silver nitrate for grain formation is added, preferably after 98 mass % of the total silver nitrate is added and particularly preferably after 99 mass % of the total silver nitrate is added.

When the hexacyano metal complex is added after the addition of aqueous silver nitrate solution but immediately before the completion of grain formation, it can be adsorbed on the outermost surface of silver halide grains, and most portion thereof and silver ions on the surface of the grains form a salt which is hardly dissolved. Silver salt of hexacyano iron (II), which is less soluble than AgI, can avoid re-dissolution of small grains, thereby enabling production of fine silver halide grains of a smaller grain size.

The metal atom (for example [Fe(CN)₆]⁴⁻) that can be included in the silver halide grains to be employed in the invention, a desalting method and a chemical sensitizing method of the silver halide emulsion are described in JP-A Nos. 11-84574, paragraphs 0046-0050, 11-65021, paragraphs 0025-0031, and 11-119374, paragraphs 0242-0250.
6) Gelatin

Any gelatin can be contained in the photosensitive silver halide emulsion to be employed in the invention. It is necessary to maintain a satisfactory dispersion state of the photosensitive silver halide emulsion in a coating liquid containing an organic silver salt, and it is preferable to use gelatin having a molecular weight of 10,000 to 1,000,000 for that purpose. It is also preferable to execute phthalation of the substituent of gelatin. The gelatin may be used at the time of grain formation or at the time of dispersion after desalting process, however it is preferably used at the time of grain formation.
7) Sensitizing Dye

For use in the invention, there can be advantageously selected a sensitizing dye that can spectrally sensitize the silver halide grains in a desired wavelength region when adsorbed on the grains and has a spectral sensitivity matching the spectral characteristics of an exposure light source. Examples of the sensitizing dye and a method of addition thereof include those of JP-A No.11-65021, paragraphs 0103-0109, a compound represented by formula (II) in JP-A No. 10-186572, a dye represented by formula (I) and those of paragraph 0106 in JP-A No. 11-119374, those in U.S. Pat. No. 5,510,236, a dye described in Example 5 of U.S. Pat. No. 3,871,887, dyes disclosed in JP-A Nos. 2-96131 and 59-48753, and those in EP-A No. 0803764A1, page 19, line 38 to page 20, line 35, and JP-A Nos. 2001-272747, 2001-290238 and 2002-23306. These sensitizing dyes may be used alone or in combination of two or more kinds. In the invention, the sensitizing dye is added to the silver halide emulsion preferably in a period from the end of a desalting process to coating, and more preferably in a period from the end of the desalting process to the end of a chemical ripening process.

The amount of the sensitizing dye in the invention can be selected according to a desired sensitivity or a desired fog level, however it is preferably within a range of 10⁻⁶ to 1 mole per mole of silver halide in the image forming layer, and preferably 10⁻⁴ to x 10⁻¹ moles.

In the invention, in order to improve spectral sensitizing efficiency, there may be employed a super-sensitizer. Examples of the super-sensitizer employable in the invention include compounds described in EP-A No. 587,338, U.S. Pat. Nos. 3,877,943 and 4,873,184 and JP-A Nos. 5-341432, 11-109547 and 10-111543.
8) Chemical Sensitization

The photosensitive silver halide grains to be employed in the invention are preferably chemically sensitized in accordance with a sulfur sensitizing method, a selenium sensitizing method or a tellurium sensitizing method. For the sulfur sensitization, the selenium sensitization and the tellurium sensitization, a known compound can be advantageously employed such as one described in JP-A No. 7-128768. In the invention, the tellurium sensitization is preferable, and a compound described in JP-A No. 11-65021, paragraph 0030 and those represented by formulas (II), (III) and (IV) in JP-A No. 5-313284 are more preferable.

The photosensitive silver halide grains used in the invention are preferably chemically sensitized in accordance with a gold sensitization method alone or with a combination of the gold sensitization method the chalcogen sensitization. A gold sensitizer with monovalent or trivalent gold is preferable, and is preferably an ordinarily employed gold sensitizer. Typical examples thereof include chloroauric acid, bromoauric acid, potassium chloroaurate, potassium bromoaurate, auric trichloride, potassium aurithiocyanate, potassium iodoaurate, tetracyanoauric acid, ammonium aurothiocyanate, and pyridyl trichlorogold. In addition, there may also be advantageously employed a gold sensitizer described in U.S. Pat. No. 5,858,637 or JP-A No. 2002-278016.

In the invention, the chemical sensitization may be executed after grain formation and before coating, and can be executed, after desalting, (1) before spectral sensitization, (2) during spectral sensitization, (3) after spectral sensitization, or (4) immediately before coating.

The amount of the sulfur, selenium or tellurium sensitizer employed in the invention depends on the type of the silver halide grains to be used and chemical ripening conditions, but is within a range of 10⁻⁸ to 10⁻² moles per mole of silver halide, and preferably 10⁻⁷ to 10⁻³ moles.

The amount of the gold sensitizer depends on various conditions, however it is generally within a range of 10⁻⁷ to 10⁻³ moles per mole of silver halide, and preferably 10⁻⁶ to 5×10⁻⁴ moles.

The conditions of the chemical sensitization in the invention are not particularly restricted. However, in general, the pH is 5 to 8, the pAg value is 6 to 11 and the temperature is 40 to 95° C.

To the silver halide emulsion to be employed in the invention, a thiosulfonic acid compound may be added in accordance with a method described in EP-A No. 293,917.

In the photosensitive silver halide grains of the invention, a reducing agent is preferably contained. As a specific compound for the reduction sensitization, ascorbic acid or aminoiminomethane sulfinic acid is preferable, and there may also be advantageously employed stannous chloride, a hydrazine derivative, a borane compound, a silane compound, or a polyamine compound. The reduction sensitizer may be added in any step in the photosensitive emulsion preparing process from a grain growing step to an adjusting step immediately before coating. It is also preferred to execute the reduction sensitization by ripening the emulsion at a pH value of 7 or higher or at a pAg value of 8.3 or lower, or by introducing a single addition portion of silver ions in the course of grain formation.
9) Compound Capable of Undergoing One-electron Oxidation to Form One-electron Oxidant that Can Release One or More Electrons

The photothermographic material of the invention preferably includes a compound capable of undergoing one-electron oxidation to form a one-electron oxidant that can release one or more electrons. Such a compound is employed either alone or in combination with any of the aforementioned chemical sensitizers and can cause an increase in sensitivity of silver halide.

The compound capable of undergoing one-electron oxidation to form a one-electron oxidant that can release one or more electrons and which is to be included in the photothermographic material of the invention is a compound selected from the following types 1 and 2.

Type 1

A compound capable of undergoing one-electron oxidation to form a one-electron oxidant that can cause a bond cleaving reaction to further release one or more electrons.

Type 2

A compound capable of undergoing one-electron oxidation to form a one-electron oxidant that, after a bond forming process, can further release one or more electrons.

At first, a compound of type 1 will be explained.

Examples of a compound of type 1 capable of undergoing one-electron oxidation to form a one-electron oxidant that can cause a bond cleaving reaction to further release one electron include compounds described as “1-photon 2-electron sensitizer” or “deprotonated electron donating sensitizer” in JP-A No. 9-211769 (compounds PMT-1 to S-37 described in Tables E and F on pages 28 to 32), JP-A No. 9-211774, JP-A No. 11-95355 (compounds INV1-INV36), JP-T No. 2001-500996 (compound 1-74, 80-87, 92-122), U.S. Pat. Nos. 5,747,235 and 5,747,236, EP No. 786692A1 (compounds INV1-INV35), EP No. 893732A1, U.S. Pat. Nos. 6,054,260 and 5,994,051. Preferred examples of these compounds are the same as those described in the cited patent references.

Examples of a compound of type 1 of which one electron oxidant formed by one electron oxidation is capable of causing a bond cleaving reaction to further release one or more electrons include compounds represented by formula (1) (the same as formula (1) in JP-A No. 2003-114487), formula (2) (the same as formula (2) in JP-A No.2003-114487), formula (3) (the same as formula (1) in JP-A No. 2003-114488), formula (4) (the same as formula (2) in JP-A No. 2003-114488), formula (5) (the same as formula (3) in JP-A No. 2003-114488), formula (6) (the same as formula (1) in JP-A No. 2003-75950), formula (7) (the same as formula (2) in JP-A No. 2003-75950), formula (8) (the same as formula (1) in Japanese Patent Application No. 2003-25886), and formula (9) (the same as formula (3) in Japanese Patent Application No. 2003-33446) among compounds capable of inducing a reaction represented by the chemical reaction formula (1) (the same as the chemical reaction formula (3) in Japanese Patent Application No. 2003-33446). Preferable examples of these compounds are the same as those described in the cited patent references.

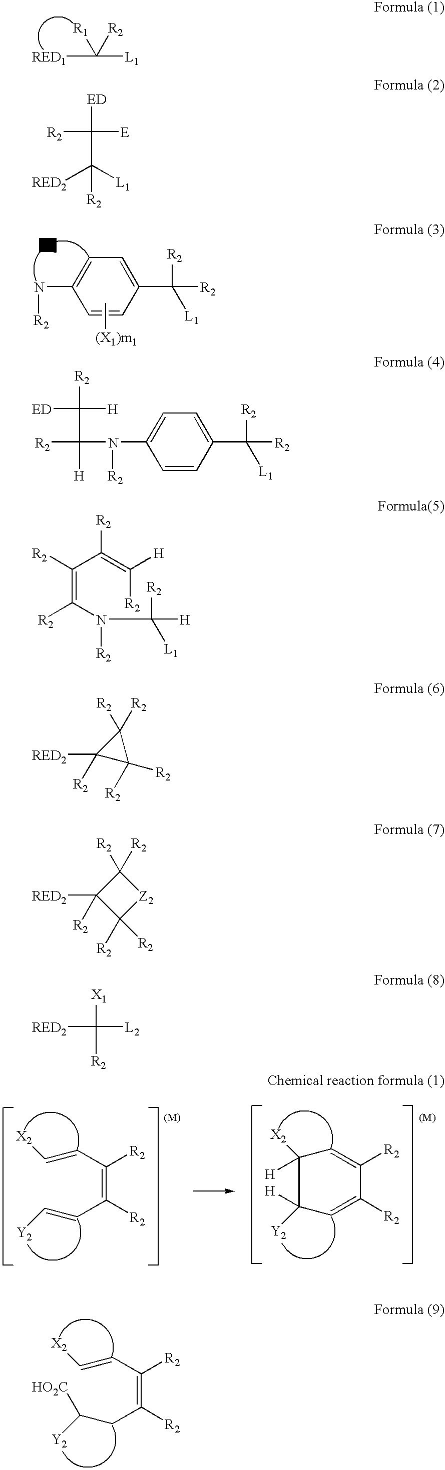

In the formulas, RED₁ and RED₂ each represent a reducing group; R₁ represents a non-metal atomic group capable of forming, together with a carbon atom (C) and RED₁, a cyclic structure corresponding to a tetrahydro structure or an octahydro structure of a 5- or 6-membered aromatic ring (including an aromatic heterocycle). R₂ represents a hydrogen atom or a substituent. In the case where plural R₂s are present within the same molecule, they may be the same or different. L₁ represents a leaving group. ED represents an electron donating group. Z₁ represents an atomic group capable of forming a 6-membered ring together with a nitrogen atom and two carbon atoms of the benzene ring. X₁ represents a substituent, and m₁ represents an integer from 0 to 3. Z₂ represents —CR₁₁R₁₂—, —NR₁₃— or —O—. R₁₁ and R₁₂ each independently represent a hydrogen atom or a substituent. R₁₃ represents a hydrogen atom, an alkyl group, an aryl group, or a heterocyclic group. X₁ represents an alkoxy group, an aryloxy group, a heterocyclic oxy group, an alkylthio group, an arylthio group, a heterocyclic thio group, an alkylamino group, an arylamino group or a heterocyclic amino group. L₂ represents a carboxy group or a salt thereof or a hydrogen atom. X₂ represents a group which forms a 5-membered heterocycle together with C═C. Y₂ represents a group which forms a 5- or 6-membered aryl or heterocyclic group together with C═C. M represents a radical, a radical cation or a cation.

In the following, the compound of type 2 will be explained.

Examples of a compound capable of undergoing one-electron oxidation to form a one-electron oxidant that can cause a bond forming reaction to further release one or more electrons include compounds represented by formula (10) (the same as formula (1) in JP-A No. 2003-140287), and formula (11) (the same as formula (1) in Japanese Patent Application No. 2003-33446) among compounds capable of inducing a reaction represented by the chemical reaction formula (1) (the same as the chemical reaction formula (1) in Japanese Patent Application No. 2003-33446). Preferable examples of these compounds are the same as those described in the cited patent references.

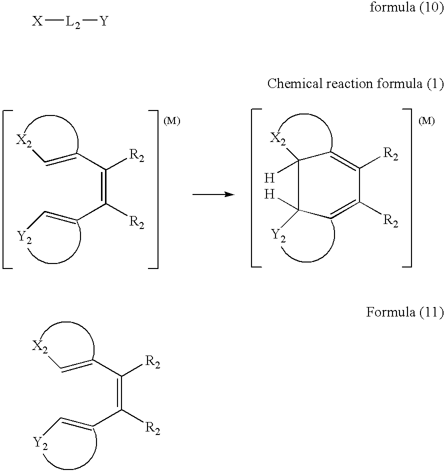

In the formulas, X represents a reducible group which can be subjected to one electron oxidation. Y represents a reactive group including a carbon-carbon double bond site, a carbon-carbon triple bond site, an aromatic group site or the non-aromatic heterocyclic group site of a benzo condensed ring capable of reacting with the one electron oxidant form by one electron oxidation of X to form a new bond. L₂ represents a connecting group which connects X and Y. R₂ represents a hydrogen atom or a substituent. In the case where plural R₂s are present within the same molecule, they may be the same or different. X₂ represents a group which forms a 5-membered heterocycle together with C═C. Y₂ represents a group which forms a 5- or 6-membered aryl or heterocyclic group together with C═C. M represents a radical, a radical cation or a cation.

Among the compounds of types 1 and 2, “a compound having, within the molecule, a group adsorptive to silver halide” or “a compound having, within the molecule, a partial structure of a spectral sensitizing dye” is preferable. Typical examples of the adsorptive group to silver halide include groups described in JP-A. No. 2003-156823, page 16, line 1 in right column to page 17, line 12 in right column. The partial structure of a spectral sensitizing dye is described in the same patent reference, page 17, line 34 in right column to page 18, line 6 in left column.

As the compound of types 1 and 2, “a compound having, within the molecule, at least a group adsorbable to silver halide” is more preferable, and “a compound having, within the molecule, two or more groups adsorptive to silver halide” is still more preferable. In the case where two or more adsorptive groups are present within a single molecule, such adsorptive groups may be the same or different.

The adsorbable group is preferably a mercapto-substituted nitrogen-containing heterocyclic group (such as a 2-mercaptothiadiazole group, a 3-mercapto-1,2,4-triazole group, a 5-mercaptotetrazole group, a 2-mercapto-1,3,4-oxadiazole group, a 2-mercaptobenzooxazole group, a 2-mercaptobenzothiazole group, or a 1,5-dimethyl-1,2,4-triazolium-3-thiolate group), or a nitrogen-containing heterocyclic group having an —NH— group capable of forming imino silver (>NAg) as a partial structure of the heterocycle (such as a benzotriazole group, a benzimidazole group, or an indazole group), particularly preferably a 5-mercaptotetrazole group, a 3-mercapto-1,2,4-triazole group or a benzotriazole group, and most preferably a 3-mercapto-1,2,4-triazole group or a 5-mercaptotetrazole group.

A compound having, as a partial structure of a molecule, two or more mercapto groups serving as the adsorptive groups is also particularly preferable. The mercapto group (—SH) may be converted into a thion group in the case where tautomerism is possible. Preferred examples of the adsorptive group having two or more mercapto groups as a partial structure (such as a dimercapto-substituted nitrogen-containing heterocyclic group) include a 2,4-dimercaptopyrinmidyl group, a 2,4-dimercaptotriazine group and a 3,5-dimercapto-1,2,4-triazole group.

Also a quaternary salt structure of nitrogen or phosphor is preferably employed as the adsorptive group. The quaternary salt structure of nitrogen can be an ammonio group (such as a trialkylammonio group, a dialkylaryl (or heteroaryl) ammonio group or an alkyldiaryl (or heteroaryl) ammonio group), or a group containing a nitrogen-containing heterocyclic group including a quaternary nitrogen atom. The quaternary salt structure of phosphor can be a phosphonio group (such as a trialkylphosphonio group, a dialkylaryl (or heteroaryl) phosphonio group, an alkyldiaryl (or heteroaryl) phosphonio group, or a triaryl (or heteroaryl)phosphonio group). A quaternary salt structure of nitrogen is more preferable, and a nitrogen-containing aromatic 5- or 6-membered heterocyclic group including a quaternary nitrogen atom is still more preferable. Particularly preferably a pyridinio group, a quinolinio group or an isoquinolinio group is utilized. Such a nitrogen-containing heterocyclic group including a quaternary nitrogen atom may have any substituent.

Examples of the counter anion of the quaternary salt include a halogen ion, a carboxylate ion, a sulfonate ion, a sulfate ion, a perchlorate ion, a carbonate ion, a nitrate ion, BF₄⁻, PF₆⁻ and Ph₄B⁻. In the case where a negatively charge group such as a carboxylate group within a molecule, the counter anion can form an intramolecular salt with such a group. A counter ion not present within the molecule is particularly preferably a chloride ion, a bromide ion or a mechanesulfonate ion.

A preferred structure of the compound of the type 1 or 2 having a quaternary salt structure of nitrogen or phosphor as the adsorptive group is represented by formula (X).
(P-Q₁)ᵢ-R(-Q₂-S)ⱼ Formula (X)

In formula (X), P and Q each independently represent a quaternary salt structure of nitrogen or phosphor, which is not a partial structure of a sensitizing dye. Q₁ and Q₂ each independently present a connecting group, and can be a single bond, an alkylene group, an arylene group, a heterocyclic group, —O—, —S—, —NR_{N}—, —C(═O)—, —SO₂—, —SO—, —P(═O)— or a group formed by a combination of these groups. R_{N} represents a hydrogen atom, an alkyl group, an aryl group or a heterocyclic group, and S represents a residue formed by eliminating an atom from the compound of type 1 or 2. i and j each represent an integer of 1 or more, and are selected so that i+j is within a range of 2 to 6. It is preferred that i is 1 to 3 and that j is 1 to 2. It is more preferable that i is 1 or 2 and tht j is 1. It is still more preferable that i is 1 and that j is 1. The compound represented by formula (X) preferably has 10 to 100 carbon atoms in total, more preferably 10 to 70 carbon atoms in total, and still more preferably 11 to 60 carbon atoms in total, and most preferably 12 to 50 carbon atoms in total.

The compound of type 1 or 2 may be used in any stage in the preparation of a photosensitive silver halide emulsion or in the producing process of a photothermographic material. For example, it may be used at the time that photosensitive silver halide grains are formed, in a desalting step, at the time of chemical sensitization or before coating. It may also be added plural times in such a process. A timing of addition of the compound is preferably within a period from the end of silver halide grain formation to a time before a desalting step, or at the time of chemical sensitization (from a time immediately before the start of chemical sensitization to a time immediately after the end of the chemical sensitization), or prior to coating, and more preferably within a period from the chemical sensitization to a time before mixing the compound with a non-photosensitive organic silver salt.

The compound of the type 1 or 2 is added preferably by dissolving it in water or a water-soluble solvent such as methanol or ethanol, or a mixture thereof. In the case where the compound is dissolved in water and shows a higher solubility at a high or low pH, it may be dissolved in a solvent with increased or decreased pH.

The compound of type 1 or 2 is preferably used in the image forming layer including a photosensitive silver halide and a non-photosensitive organic silver salt, however it may be added in a protective layer or an intermediate layer in addition to an image forming layer including a photosensitive silver halide and a non-photosensitive organic silver salt, and may be diffused at the time of coating. The compound of the invention may be added before or after the addition of a sensitizing dye, and is included in the silver halide emulsion layer (image forming layer) preferably in an amount of 1×10⁻⁹ to 5×10⁻¹ moles per mole of silver halide, and more preferably 1×10⁻⁸ to 5×10⁻² moles.
10) Adsorptive Redox Compound Having Adsorptive Group and Reducing Group

The photothermographic material of the invention preferably includes an adsorptive redox compound having an adsorptive group to silver halide and a reducing group within a molecule. Such an adsorptive redox compound is preferably a compound represented by formula (I):
A-(W)ₙ-B (I)

In the formula, A represents a group adsorptive to silver halide (hereinafter called an adsorptive group); W represents a divalent connecting group; n represents 0 or 1; and B represents a reducing group.

In formula (I), an adsorptive group represented by A is a group directly adsorptive to silver halide or a group capable of accelerating adsorption to silver halide, and is specifically a mercapto group (or a salt thereof), a thion group (—C(═S)—), a heterocyclic group containing at least one atom selected from a nitrogen atom, a sulfur atom, a selenium atom and a tellurium atom, a sulfide group, a disulfide group, a cationic group, or an ethynyl group.

The mercapto group (or a salt thereof) serving as the adsorptive group means not only a mercapto group (or a salt thereof) itself but also, more preferably, a heterocyclic group, an aryl group or an alkyl group substituted with at least one mercapto group (or a salt thereof). The heterocyclic group means a 5- to 7-membered, monocyclic or condensed-ringed, aromatic or non-aromatic heterocyclic group such as an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline group, a pyrimidine ring group or a triazine ring group. It can also be a heterocyclic group including a quaternary nitrogen atom, and, in such a case, a substituted, mercapto group may be dissociated to form a meso ion. In the case where the mercapto group forms a salt, the counter ion can be a cation of an alkali metal, an alkaline earth metal or a heavy metal (Li⁺, Na⁺, K⁺, Mg²⁺, Ag⁺, or Zn²⁺), an ammonium ion, a heterocyclic group containing a quaternary nitrogen atom, or a phosphonium ion.

The mercapto group serving as the adsorptive group may become a thion group by tautomerism.

The thion group serving as the adsorptive group can specifically be a linear or cyclic thioamide group, a thioureido group, a thiourethane group, or a dithiocarbamatic ester group.

The heterocyclic group containing at least one atom selected from a nitrogen atom, a sulfur atom, a selenium atom and a tellurium atom and serving as the adsorptive group is a nitrogen-containing heterocyclic group having an —NH— group capable of forming an imino silver (>NAg) as a partial structure of the hetero ring, or a heterocyclic group having —S—, —Se—, —Te— or ═N— capable of coordinating with a silver ion by a coordinate bond as a partial structure of the hetero ring. Examples of the former include a benzotriazole group, a triazole group, an indazole group, a pyrrazole group, a tetrazole group, a benzimidazole group, an imidazole group and a purine group. Examples of the latter include a thiophene group, a thiazole group, an oxazole group, a benzothiophene group, a benzothiazole group, a benzoxazole group, thiadiazole group, an oxadiazole group, a triazine group, a selenoazole group, a benzselenoazole group, a tellurazole group and a benztellurazole group.

The sulfide group or a disulfide group serving as the adsorptive group can be any group having a partial structure of —S— or —S—S—.

The cationic group serving as the adsorptive group means a group containing a quaternary nitrogen atom, and specific examples thereof include an ammonio group and a nitrogen-containing heterocyclic group containing a quaternary nitrogen atom. The nitrogen-containing heterocyclic group including a quaternary nitrogen atom can be, for example, a pyridinio group, a quinolinio group, an isoquinolinio group or an imiazolio group.

The ethynyl group serving as the adsorptive group means —C≡—CH, in which the hydrogen atom may be substituted.

The adsorptive group may have any substituent.

Specific examples of the adsorptive group also include those described in JP-A No. 11-95355, pages 4 to 7.

In formula (I), the adsorptive group represented by A is preferably a mercapto-substituted heterocyclic group (such as a 2-mercaptothiadiazole group, a 2-mercapto-5-aminothiadiazole group, a 3-mercapto-1,2,4-triazole group, a 5-mercaptotetrazole group, a 2-mercapto-1,3,4-oxadiazole group, a 2-mercaptobenzimidazole group, a 1,5-dimethyl-1,2,4-triazolium-3-thiolate group, a 2,4-dimercaptopyrimidine group, a 2,4-dimercaptotriazine group, a 3,5-dimercapto-1,2,4-triazole group, or a 2,5-dimercapto-1,3-thiazole group), or a nitrogen-containing heterocyclic group having an —NH— group capable of forming imino silver (>NAg) as a partial structure of the hetero ring (such as a benzotriazole group, a benzimidazole group, or an indazole group), and more preferably a 2-mercaptobenzimidazole group or a 3,5-dimercapto-1,2,4-triazole group.

In formula (I), W represents a divalent connecting group. Any connecting group can be used, as long as it does not exert a detrimental effect on the photographic characteristics. For example, it is possible to utilize a divalent connecting group whose atoms include a carbon atom, a hydrogen atom, an oxygen atom, a nitrogen atom, and/or a sulfur atom. More specifically there can be employed an alkylene group with 1 to 20 carbon atoms (for example a methylene group, an ethylene group, a trimethylene group, a tetramethylene group or a hexamethylene group), an alkenylene group with 2 to 20 carbon atoms, an alkynylene group with 2 to 20 carbon atoms, an arylene group with 6 to 20 carbon atoms (such as a phenylene group or a naphthylene group), —CO—, —SO₂—, —O—, —S—, —NR₁— or a combination thereof, wherein R₁ represents a hydrogen atom, an alkyl group, a heterocyclic group or an aryl group.

The connecting group represented by W may have any substituent.

In formula (I), the reducing group represented by B represents a group capable of reducing a silver ion, and can be, for example, a formyl group, an amino group, a triple bond group such as an acetylene group or a propargyl group, a mercapto group, or a residue group derived by eliminating a hydrogen atom from a compound selected from hydroxylamine, hydroxamic acid, hydroxyurea, hydroxyurethane, hydroxysemicarbazide, reductone (including reductone derivatives), aniline, phenol (including polyphenol such as chromanl, 2,3-dihydrobenzofuran-5-ol, aminophenol, sulfonamidophenol, hydroquinone, cathecol, resorcinol, benzenetriol, or bisphenol), acylhydrazine, carbamoylhydrazine, and 3-pyrazolidone and a derivative thereof. These compounds may have any substituent.

The oxidation potential of the reducing group represented by B in formula (I) can be measured by a method described in Akira Fujishima, “Denki Kagaku Sokutei-ho (Electrochemistry Measurements)” (p. 150-208, published by Giho-do) or “Jikken Kagaku Kouza (Experimental Chemistry Textbook)”, 4th edition, edited by Chemical Society of Japan (vol.9, p. 282-344, published by Maruzen). For example, it can be measured in accordance with a rotary disk voltammetry method. More specifically, a sample is dissolved in a solution of methanol and Britton-Robinson buffer having a pH of 6.5 at a volume % ratio of 10:90, nitrogen gas is introduced for 10 minutes, and the oxidation potential of the resultant solution is measured at a sweeping rate of 20 mV/sec at 25° C. at 1000 revolution/min while utilizing a glassy carbon rotary disk (RDE) as an operating electrode, a platinum wire as a counter electrode and a saturated calomel electrode as a reference electrode. A half-wave potential (E1/2) can be determined from an obtained voltammogram.

The reducing group represented by B preferably has an oxidation potential, measured in accordance with the above method, within a range of about −0.3 V to about 1.0 V, more preferably about −0.1 V to about 0.8 V, and still more preferably about 0 to about 0.7 V.

In formula (I), the reducing group represented by B is preferably a residue formed by eliminating a hydrogen atom from hydroxylamine, hydroxamic acid, hydroxyurea, hydroxysemicarbazide, reductone, phenol, acylhydrazine, carbamoylhydrazine or 3-pyrazolidone or a derivative thereof.

The compound of formula (I) may also include a ballast group or a polymer chain which is commonly utilized in an immobile photographic additive such as a coupler. The polymer can be one described for example in JP-A No. 1-100530.

The compound of formula (I) may form a bis structure or a tris structure. The compound of formula (I) preferably has a molecular weight within a range from 100 to 10,000, more preferably 120 to 1,000 and still more preferably 150 to 500.

In the following, examples of the compound of formula (I) are shown, but the invention is not limited by such examples.

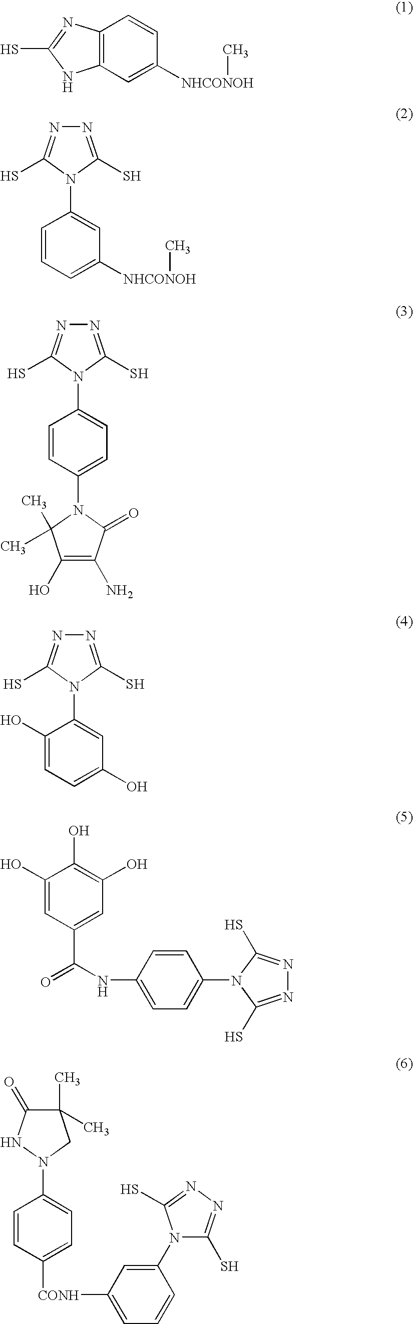

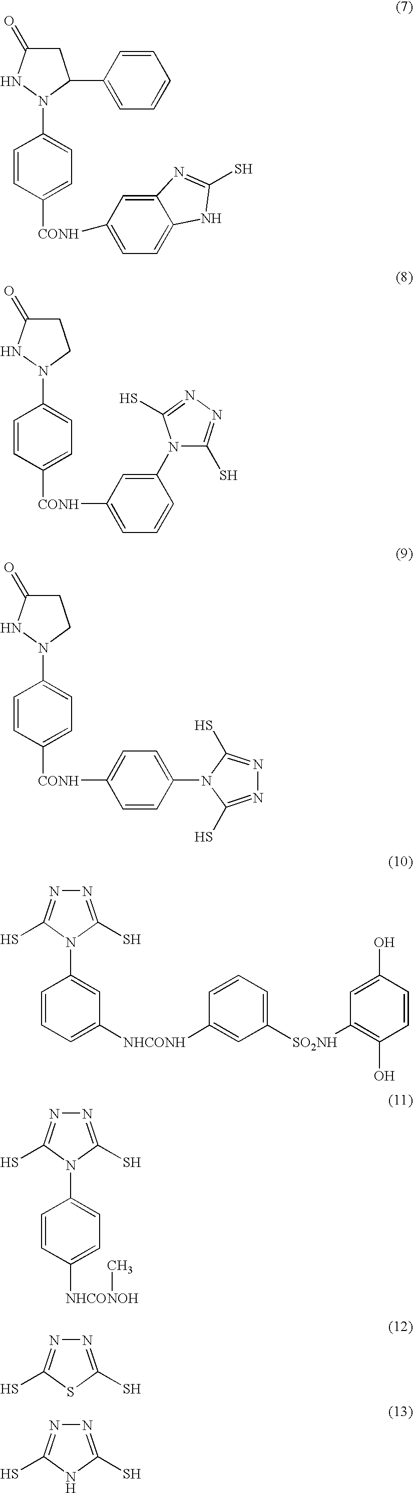

Also, compounds 1-30, 1″-1 - 1″-77 described in EP No. 1308776A2, pages 73-87, are preferable examples of the compound having the adsorptive group and the reducing group.

The compound can be easily synthesized in accordance with a known method. One compound of formula (I) may be employed, but it is also preferable to employ two or more compounds of formula (I). In the case where two or more compounds of formula (I) are used, they may be added in the same layer or in different layers, or may be added in accordance with different methods.

The compound of formula (I) is preferably contained a silver halide emulsion layer, and is more preferably added during the preparation of the emulsion. In the case where it is added at the time of preparation of the emulsion, it may be added in any stage in the preparation of the photosensitive silver halide emulsion, for example during forming silver halide grains, before the start of a desalting step, in the desalting step, before the start of a chemical ripening, during the chemical ripening, or before preparation of a completed emulsion. It may also be added plural times in such a process. It is preferably contained in an image forming layer, however it may be contained, in addition to an image forming layer, in a protective layer or an intermediate layer adjacent to the image forming layer, and may be diffused at the time of coating.

The preferred amount of the compound of formula (I) depends significantly on a method of addition and the type of the compound to be added, however it is generally within a range of 1×10⁻⁶ to 1 mole per mole of photosensitive silver halide, preferably 1×10⁻⁵ to 5×10⁻¹ moles, and more preferably 1×10⁻⁴ to 1×10⁻¹ moles.

The compound of formula (I) may be added after dissolving it in water or a water-soluble solvent such as methanol or ethanol, or a mixture thereof. In such a case, the pH of the solution may be suitably adjusted with an acid or a base, and a surfactant may be contained in the solution. It can also be added as an emulsified dispersion obtained by dissolving it in a high-boiling organic solvent. It may also be added as a solid dispersion.
11) Combined Use of Plural Silver Halides

A photosensitive silver halide emulsion to be used in the photosensitive material of the invention may be single emulsion, or a combination of two or more emulsions (for example emulsions having different average grain sizes, halogen compositions, crystallizing tendencies, and/or chemical sensitizing conditions). The gradation may be regulated by employing plural photosensitive silver halides of different sensitivities. Techniques relating thereto are described for example in JP-A Nos. 57-119341, 53-106125, 47-3929, 48-55730, 46-5187, 50-73627 and 57-150841. The emulsions are preferably used so that a difference in sensitivity of the emulsions are 0.2 logE or larger.
12) Coating Amount

In the first and second aspects, the addition amount of the photosensitive silver halide, in terms of a coated silver amount per m² of the photosensitive material, is preferably 0.03 to 0.6 g/m², more preferably 0.05 to 0.4 g/m², and most preferably 0.07 to 0.3 g/m². With respect to 1 mole of organic silver salt, the amount of the photosensitive silver halide is preferably within a range of 0.01 to 0.5 moles, more preferably 0.02 to 0.3 moles and still more preferably 0.03 to 0.2 moles.

In the third to sixth aspects, the coating amount of the silver halide grains, with respect to 1 mole of silver of the non-photosensitive organic silver salt, is generally within a range of 0.5 to 15 mol. %, preferably 0.5 to 12 mol. %, more preferably 10 mol. % or less, still more preferably 1 to 9 mol. % and most preferably 1 to 7 mol. %. In order to avoid significant suppression of development caused by the silver halide of a high silver iodide content and found by the inventors, the selection of such an addition amount is extremely important. The coated silver amount per m² of the photosensitive material is preferably within a range of 0.03 to 0.6 g/m², more preferably 0.05 to 0.4 g/m² and still more preferably 0.07 to 0.3 g/m².
13) Mixing of Photosensitive Silver Halide and Organic Silver Salt

As to a method of mixing the photosensitive silver halide and the organic silver salt prepared separately and contidions thereof, there may be employed a method of mixing the silver halide grains and the organic silver salt prepared separately with a high-speed agitator, a ball mill, a sand mill, a colloid mill, a vibration mill or a homogenizer, or a method of mixing the already prepared photosensitive silver halide in the course of preparation of the organic silver salt. However, the mixing method and the conditions are not particularly limited, as long as the effect of the invention can be sufficiently exhibited. To regulate the photographic characteristics, it is preferable to mix two or more aqueous dispersions of organic silver salts and two or more aqueous dispersions of photosensitive silver salts.
14) Adding of Silver Halide to Coating Liquid

The silver halide is added to a coating liquid for forming an image forming layer within a period starting at 180 minutes before coating and ending immediately before the coating, preferably within a period starting at 60 minutes before caoting and ending at 10 seconds before the coating. However, a mixing method and a mixing condition are not particularly restricted, as long as the effect of the invention can be sufficiently exhibited. Specific examples of the mixing method include a mixing method conducted in a tank so that an average residence time calculated from an addition flow rate and a rate at which liquid is supplied to a coater becomes a desired value, and a method using a static mixer described for example in N. Harnby, M. F. Edwards and A. W. Nienow, “Liquid mixing technique”, translated by Koji Takahashi and published by Nikkan Kogyo Shimbun, 1989, Chapter 8. Compound capable of substantially decreasing, after thermal development, visible light absorption caused by photosensitive silver halide

In a photothermographic material of the third to sixth aspects of the invention having image forming layers on both sides, it is preferable to employ silver halide of a high silver iodide content as explained before, and such a silver halide of a high silver iodide content is preferably used in combination with a compound capable of substantially decreasing, by a thermal development process, a spectral absorption intensity in the ultraviolet-visible wavelength range, caused by the photosensitive silver halide.

In the invention, as the compound capable of substantially decreasing, after thermal development, visible light absorption caused by the photosensitive silver halide, a silver iodide complex forming agent is particularly preferably employed.

Explanations Regarding Silver Iodide Complex Forming Agent

A silver iodide complex forming agent is capable of contributing to a Lewis base-acid reaction in which at least one of the nitrogen atom or the sulfur atom in the compound functions as a coordination atom (electron donating group or Lewis' base) conating an electron to a silver ion. Stability of a complex is defined by a successive stability constant or a total stability constant, and depends on a combination of a silver ion, an iodide ion and the silver complex forming agent. In general, a large stability constant can be obtained for example by a chelating effect through an intramolecular chelate ring or by an increase in an acid-base dissociation constant of a ligand.

The reaction mechanism of the silver iodide complex forming agent is not clarified, but it is supposed that silver iodide is solubilized by forming a stable complex composed of at least ternary components including a iodide ion and a silver ion. The silver iodide complex forming agent in the invention has a poor ability of solubilizing silver bromide or silver chloride but specifically functions on silver iodide.

The mechanism of improvement of image storability by the silver iodide complex forming agent is not yet clear, but it is supposed that a reaction between at least a part of the photosensitive silver halide and the silver iodide complex forming agent is cuased at the time of thermal development to form a complex, thereby reducing or eliminating photosensitivity, and contributing significantly to improve image storability under light irradiation. At the same time, turbidity in the film by silver halide is also reduced, whereby a clear image of a high image quality can be obtained. The decrease of the level of turbidity in the film can be confirmed by a decrease in ultraviolet-visible light absorption in an absorption spectrum.

In the invention, the ultraviolet-visible light absorption spectrum of the photosensitive silver halide can be measured in accordance with a transmission method or a reflective method. In the case where the absorption of photosensitive silver halide overlaps with absorption derived from other compound(s) contained in the photothermographic material, the ultraviolet-visible light absorption of the photosensitive silver halide can be observed by employing any of methods in which a differential spectrum is used and/or in which other compounds are removed with a solvent.

The silver iodide complex forming agent used in the invention is clearly different from a prior silver ion complex forming agent in that an iodide ion is essential to form a stable complex. While the prior silver ion complex forming agent exerts a dissolving function on a salt containing a silver ion, such as silver bromide, silver chloride or an organic silver salt such as silver behenate, the silver iodide complex forming agent used in the invention is characterized in that it does not function unless silver iodide is present.

The silver iodide complex forming agent used in the invention is preferably a 5- to 7-membered heterocyclic compound including at least one nitrogen atom. In the case where the compound does not have a mercapto group, a sulfide group or a thion group as a substituent, such 5-to 7-membered nitrogen-containing heterocycle may be saturated or unsaturated and may have another substituent. Substituents on the heterocycle may bond to each other to form a ring.

Preferred examples of the 5-to 7-membered heterocyclic compound include pyrrole, pyridine, oxazole, isooxazole, thiazole, isothiazole, imidazole, pyrazole, pyrazine, pyrimidine, pyridazine, indole, isoindole, indolizine, quinoline, isoquinoline, benzimidazole, 1H-imidazole, quinoxaline, quinazoline, cinnoline, phthalazine, naphthylidine, purine, puteridine, carbazole, acrydine, phenanthridine, phenanthroline, phenazine, phenoxazine, phenothiazine, benzothiazole, benzoxazole, benzimidazole, 1,2,4-triazine, 1,3,5-triazine, pyrrolidine, imidazolidine, pyrazolidine, piperidine, piperadine, morpholine, indoline, and isoindoline. The compound is more preferably pyridine, imidazole, pyrazole, pyrazine, pyrimidine, pyridazine, indole, isoindole, indolizine, quinoline, isoquinoline, benzimidazole, 1H-imidazole, quinoxaline, quinazoline, cinnoline, phthalazine, 1,8-naphthylidine, 1,10-phenanthroline, benzimidazole, benzotriazole, 1,2,4-triazine, or 1,3,5-triazine, and still more preferably pyridine, imidazole, pyrazine, pyrimidine, pyridazine, phthalazine, triazine, 1,8-naphthylidine or 1,10-phenanthroline.

The ring may have any substituent that does not detrimentally affect the photographic characteristics. Preferred examples of the substituent include a halogen atom (a fluorine atom, a chlorine atom, a bromine atom and an iodine atom), an alkyl group (a linear, branched or cyclic alkyl group including a bicycloalkyl group and an active methine group), an alkenyl group, an alkynyl group, an aryl group, a heterocyclic group (the substituting position being not limited), an acyl group, an alkoxycarbonyl group, an aryloxycarbonyl group, a heterocyclic oxycabonyl group, a carbamoyl group, an N-acylcarbamoyl group, an N-sulfonylcarbamoyl group, an N-carbamoylcarbamoyl group, an N-sulfamoylcarbamoyl group, a carbazoyl group, a carboxyl group and a salt thereof, an oxalyl group, an oxamoyl group, a cyano group, a carbonimidoyl group, a formyl group, a hydroxy group, an alkoxy group (including a group repeatedly containing an ethyleneoxy group or a propyleneoxy group), an aryloxy group, a heterocyclic oxy group, an acyloxy group, an (alkoxy or aryloxy)carbonyloxy group, a carbamoyloxy group, a sulfonyloxy group, an amino group, an (alkyl, aryl or heterocyclic)amino group, an acylamino group, a sulfonamide group, an ureido group, a thioureido group, an imide group, an (alkoxy or aryloxy)carbonylamino group, a sulfamoylamino group, a semicarbazide group, an ammonio group, an oxamoylamino group, an Nalkyl or aryl)sulfonylureido group, an N-acylureido group, an N-acylsulfamoylamino group, a nitro group, a heterocyclic group containing a quaternary nitrogen atom (such as a pyridinio group, an imidazolio group, a quinolinio group and an isoquinolinio group), an isocyano group, an imino group, an (alkyl or aryl)sulfonyl group, an (alkyl or aryl)sulfinyl group, a sulfo group and a salt thereof, a sulfamoyl group, an N-acylsulfamoyl group, an N-sulfonylsulfamoyl group and a salt thereof, a phosphino group, a phosphinyl group, a phosphinyloxy group, a phosphinylamino group and a silyl group.

The active methine group means a methine group substituted with two electron-attractive groups, and the electron-attractive group means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, or a carbonimidoyl group. The two electron-attractive groups may bond to each other to form a ring structure. Also, the salt includes, for example, a cation of an alkali metal, an alkaline earth metal or a heavy metal, or an organic cation such as an ammonium ion or a phosphonium ion. The substituent may be further substituted with any of the above-described substituents.

The heterocycle may be further condensed with another ring. In the case where the substituent is an anionic group (such as —CO₂⁻, —SO₃⁻, or —S⁻), the part of the nitrogen-containing heterocycle other than the substituent may be a cation (such as a pyridinium, or a 1,2,4-triazolium group) to form an intramolecular salt.

In the case where the heterocyclic compound is a derivative of pyridine, pyrazine, pyrimidine, pyridazine, phthalazine, triazine, naphthylidine or phenanthroline, the conjugate acid of the nitrogen-containing heterocyclic part of the compound has an acid dissociation constant (pKa) in a tetrahydrofuran/water mixture (3/2, 25° C.) preferably within a range of 3 to 8, and more preferably 4 to 7 in an acid dissociation equilibrium.

The heterocyclic compound is preferably a pyridin, pyridazine or phthalazine derivative, and more preferably a pyridine or phthalazine derivative.

When the heterocyclic compound has a mercapto group, a sulfide group or a thion group as a substituent, the compound is preferably a derivative of pyridine, thiazole, isothiazole, oxazole, isooxazole, imidazole, pyrazole, pyrazine, pyrimidine, pyridazine, triazine, triazole, thiadiazole or oxadiazole, and more preferably a derivative of thiazole, imidazole, pyrazole, pyrazine, pyrimidine, pyridazine, triazine, or triazole.

As the silver iodide complex forming agent, a compound represented by formula (1) or (2) can be utilized.

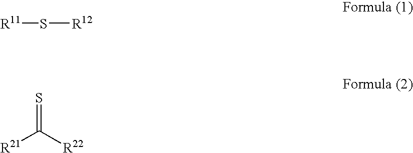

In formula (1), R¹¹ and R¹² each represent a hydrogen atom or a substituent. In formula (2), R²¹ and R²² each represent a hydrogen atom or a substituent. However, R¹¹ and R¹² are not hydrogen atoms at the same time, and R²¹ and R²² are not hydrogen atoms at the same time. Examples of the substituent can be the same as those described in the explanations regarding the nitrogen-containing 5- to 7-membered heterocyclic silver iodide complex forming agent.

Also, a compound represented by formula (3) can be advantageously employed.

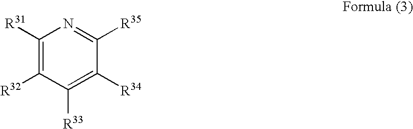

In formula (3), R³¹ to R³⁵ each independently represent a hydrogen atom or a substituent. Examples of the substituent can be the same as those described in the explanations for the nitrogen-containing 5- to 7-membered heterocyclic silver iodide complex forming agent. In the case where the compound represented by formula (3) has a substituent, a preferred substituting position is R³² to R³⁴. R³¹ to R³⁵ may bond to each other to form a saturated or unsaturated ring. The substituent is preferably a halogen atom, an alkyl group, an aryl group, a carbamoyl group, a hydroxyl group, a alkoxy group, an aryloxy group, a carbamoyloxy group, an amino group, an acylamino group, an ureido group, or an (alkoxy or aryloxy)carbonylamino group.

In the compound represented by formula (3), the conjugate acid of the pyridin ring has an acid dissociation constant (pKa) in a tetrahydrofuran/water mixture (3/2, 25° C.) preferably within a range of 3 to 8, and more preferably 4 to 7.

Also, a compound represented by formula (4) is preferable.

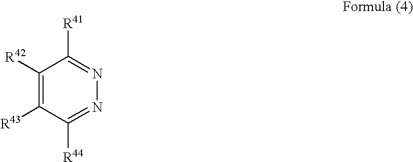

In formula (4), R⁴¹ to R⁴⁴ each independently represent a hydrogen atom or a substituent. R⁴¹ to R⁴⁴ may bond to each other to form a saturated or unsaturated ring. Examples of the substituent represented by R⁴¹ to R⁴⁴ can be the same as those described in the explanations regarding the nitrogen-containing 5- to 7-membered heterocyclic silver iodide complex forming agent. The substituent is preferably an alkyl group, an alkenyl group, an alkynyl group, an aryl group, a hydroxyl group, a alkoxy group, an aryloxy group, a heterocyclic oxy group or a phthalazine ring formed by benzo condensation. In the case where a hydroxyl group is a substituted on a carbon atom adjacent to the nitrogen atom of the compound represented by formula (4), equilibrium stands between the compound and pyridazinone.

The compound represented by formula (4) preferably forms a phthalazine ring represented by formula (5). It is preferred that the phthalazine ring has at least one substituent. Examples of the substituent represented by R⁵¹ to R⁵⁶ in formula (5) can be the same as those described in the explanations regarding the nitrogen-containing 5- to 7-membered heterocyclic silver iodide complex forming agent. The substituent can be an alkyl group, an alkenyl group, an alkynyl group, an aryl group, a hydroxyl group, a alkoxy group, or an aryloxy group, and is preferably an alkyl group, an alkenyl group, an aryl group, an alkoxy group or an aryloxy group, and more preferably an alkyl group, an alkoxy group or an aryloxy group.

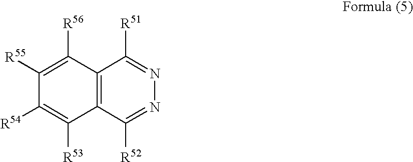

Also, a compound represented by formula (6) is preferable.

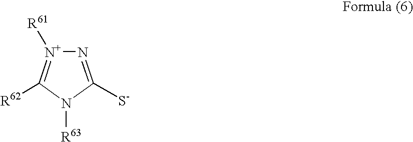

In formula (6), R⁶¹ to R⁶³ each independently represent a hydrogen atom or a substituent. Examples of the substituent represented by R⁶² can be the same as those described in the explanations regarding the nitrogen-containing 5-to 7-membered heterocyclic silver iodide complex forming agent.

A compound represented by formula (7) is also preferable.
R⁷¹—S-(L)ₙ-S—R⁷² Formula (7)

In formula (7), R⁷¹ to R⁷² each independently represent a hydrogen atom or a substituent; L represents a divalent connecting group; and n represents 0 or 1. The substituent represented by R⁷¹ to R⁷² can be an alkyl group (including a cycloalkyl group), an alkenyl group (including a cycloalkenyl group), an alkynyl group, an aryl group, a heterocyclic group, an acyl group, an aryloxycarbonyl group, an alkoxycarbonyl group, a carbamoyl group, an imide group or a composite substituent containing any combination of these groups. The divalent connecting group represented by L preferably has a length of 1 to 6 atoms, more preferably 1 to 3 atoms, and may further have a substituent.

A compound represented by formula (8) is also preferable.

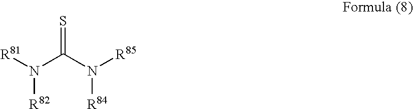

In formula (8), R⁸¹ to R⁸⁴ each independently represent a hydrogen atom or a substituent. The substituent represented by R⁸¹ to R⁸⁴ can be an alkyl group (including a cycloalkyl group), an alkenyl group (including a cycloalkenyl group), an alkynyl group, an aryl group, a heterocyclic group, an acyl group, an aryloxycarbonyl group, an alkoxycarbonyl group, a carbamoyl group, or an imide group.

Among the silver iodide complex forming agents mentioned above, compounds represented by formulas (3), (4), (5), (6), and (7) are preferable, and those represented by formulas (3) and (5) are particularly preferable.

In the following, preferred examples of the silver iodide complex forming agent used in the present invention are shown, but the invention is not limited by such examples.

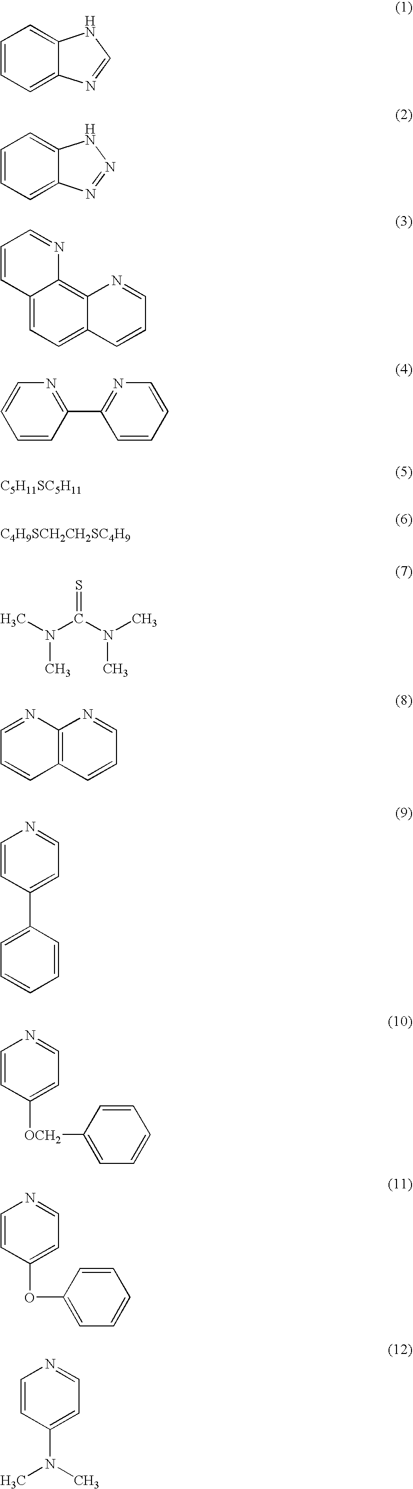

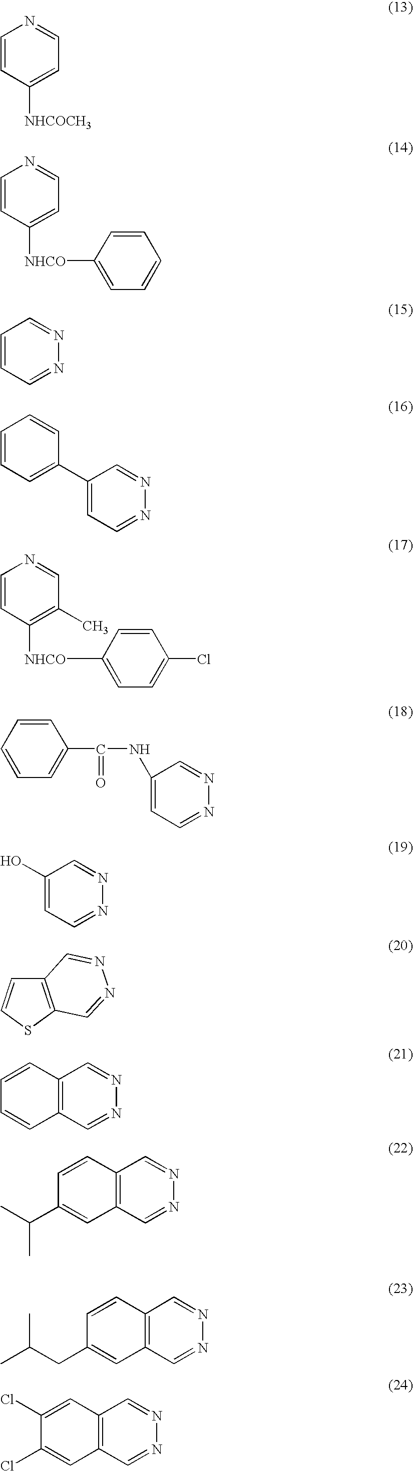

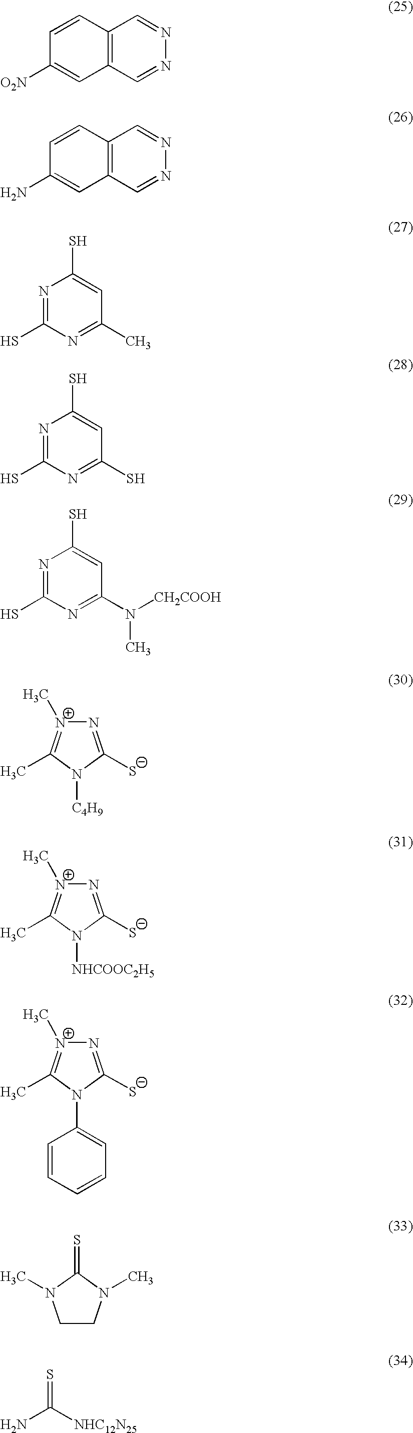

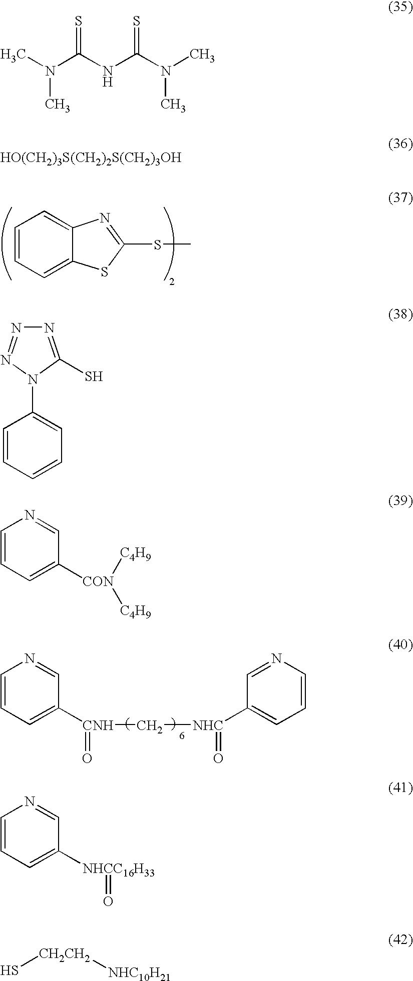

When the silver iodide complex forming agent used in the invention has a function of an already known color toning agent, a compound serving as the silver iodide complex forming agent and a color toning agent can be used. Alternatively, the silver iodide complex forming agent may be used in combination with a color toning agent. Two or more of the silver iodide complex forming agents may be used together.

The silver iodide complex forming agent is preferably contained in a film so that it is separated from the photosensitive silver halide by, for example, using solid compound as such in the film. It is also preferable to contain the agent in a layer adjacent to a layer including the silver halide. The melting point of the silver iodide complex forming agent is preferably regulated within a suitable range such that it can be fused when heated to a thermal developing temperature.

In the invention, the absorption intensity of the photosensitive silver halide which has been thermally developed in an ultraviolet-visible light absorption spectrum is preferably 80% or less of that of the photosensitive silver halide which has not been thermally developed, more preferably 40% or less, and still more preferably 10% or less.

The silver iodide complex forming agent may be contained in the coating liquid and in the photosensitive material in a form of a solution, an emulsified dispersion or a dispersion of fine solid particles.

In a well known method for preparing an emulsified dispersion, the agent is dissolved in oil such as dibutyl phthalate, tricresyl phosphate, glyceryl triacetate or diethyl phthalate, or an auxiliary solvent such as ethyl acetate or cyclohexanone, followed by mechanical preparation of an emulsified dispersion.

To disperse solid particles, there can be employed a method of dispersing powder of the silver iodide complex forming agent in a suitable solvent such as water with a ball mill, a colloid mill, a vibrating ball mill, a sand mill, a jet mill, a roller mill or an ultrasonic wave to obtain a solid dispersion. In such a method, there may be employed a protective colloid (such as polyvinyl alcohol) or a surfactant (for example, an anionic surfactant such as sodium triisopropylnaphthalenesulfonate (a mixture of compounds with different substituting positions of three isopropyl groups). In the above-mentioned mills, beads such as zirconia beads are usually employed as a dispersion medium, and the dispersion may be contaminated with zirconium dissolving out of such beads. Its content depends on the dispersing conditions, but is usually within a range of 1 to 1000 ppm. Its content in the photosensitive material of 0.5 mg or less per g of silver is at an practically acceptable level.

The aqueous dispersion preferably includes an antiseptic (such as sodium salt of benzoisothiazolinone).

The silver iodide complex forming agent is preferably employed as a solid dispersion.

The silver iodide complex forming agent is preferably employed in an amount of 1 to 5000 mol. % with respect to photosensitive silver halide, more preferably 10 to 1000 mol. % and still more preferably 50 to 300 mol. %.

Explanations Regarding Binder

As a binder of the image forming layer, any polymer can be employed. The binder is preferably transparent or translucent and is generally colorless, and can be a natural resin, polymer or copolymer, a synthetic resin, polymer or copolymer, or a film-forming material, such as gelatin, rubber, polyvinyl alcohol, hydroxyethyl cellulose, cellulose acetate, cellulose acetate butyrate, polyvinylpyrrolidone, casein, starch, polyacrylic acid, polymethyl methacrylate, polyvinyl chloride, polymethacrylic acid, styrene-maleic anhydride copolymer, styrene-acrylonitrile copolymer, styrene-butadiene copolymer, polyvinylacetal (such as polyvinylformal or polyvinylbutyral), polyester, polyurethane, phenoxy resin, polyvinylidene chloride, polyepoxide, polycarbonate, polyvinyl acetate, polyolefin, cellulose ester or polyamide. The binder may be dissolved in water or an organic solvent or used in a form of an emulsion in forming a coating.

In the invention, the binder usable in a layer containing an organic silver salt preferably has a glass transition temperature (Tg) within a range from 0 to 80° C. (hereinafter also referred to as a high Tg binder), more preferably 10 to 70° C. and still more preferably 15 to 60° C.

In the specification, the glass transition temperature (Tg) is calculated from the following equation:
1/Tg=Σ(Xi/Tgi)

It is assumed that the polymer is formed by copolymerizing n monomer components (i=1-n); Xi represents a weight fraction of an i-th monomer (ΣXi=1), and Tgi represents the glass transition temperature (absolute temperature) of a homopolymer of the i-th monomer. X indicates the sum of values when i is 1 to n. The glass transition temperature (Tgi) of a homopolymer of each monomer was obtained from Polymer Handbook (3rd edition) (J. Brandrup and E. H. Immergut (Wiley-Interscience, 1989)).

Two or more binders may be used, if necessary. It is also possible to employ a binder having a glass transition temperature equal to or higher than 20° C. and a binder having a glass transition temperature less than 20° C. In the case where two or more polymers with different Tgs are blended, it is preferred that a weight-averaged Tg is contained within the above-mentioned range.

In the invention, the image forming layer is formed as a film preferably by coating and drying a coating liquid in which 30 mass % or more of a solvent is water.

In the invention, in the case where the image forming layer is formed by coating and drying a coating liquid in which 30 mass % or more of the solvent is water, and in the case shere the binder of the image forming layer is soluble or dispersible in an aqueous solvent (water solvent), when the image forming layer is formed from a latex of a polymer showing an equilibrated moixture content of 2 mass % or less in an environment of 25° C. and 60% RH, the performance is improved. In the most preferable embodiment, the binder is so prepared as to have an ion conductivity of 2.5 mS/cm or less, and such preparation can be achieved for example by purification of a synthesized polymer with a separating, functional membrane.

The aforementioned aqueous solvent in which the polymer is soluble or dispersible is water or a mixture of water and 70 mass % or less of a watermiscible organic solvent. Examples of the watermiscible organic solvent include an alcohol solvent such as methyl alcohol, ethyl alcohol and propyl alcohol, a cellosolve solvent such as methyl cellosolve, ethyl cellosolve and butyl cellosolve, ethyl acetate and dimethylformamide.

The term “aqueous solvent” herein is also used for a system in which the polymer is not thermodynamically dissolved but is present in a so-called dispersion state.

The “equilibrated moisture content in an environment of 25° C. and 60% RH” can be represented as follows. Here, W1 is a polymer weight in a moisture equilibrium state in an environment of 25° C. and 60% RH and W0 is a polymer weight in an absolute dry state at 25° C. Equilibrated moisture content in an environment of 25° C., 60% RH=[(W1−W0)/W0]×100 (mass %)

For the definition of the moisture content and the measuring method thereof, for example to Kobunshi Kogaku Koza 14, Kobunshi Zairyo Shikenho (edited by Society of Polymer Science, published by Chijinshokan) can be seen.

The binder polymer preferably has an equilibrated moisture content in an environment of 25° C., 60% RH of 2 mass % or less, more preferably 0.01 to 1.5 mass %, and still more preferably 0.02 to 1 mass %.

In the invention, a polymer dispersible in an aqueous solvent is particularly preferable. The dispersion can be a latex in which fine particles of a water-insoluble hydrophobic polymer are dispersed, or a dispersion in which polymer molecules are dispersed in a molecular state, or form micelles and are dispersed, however particles dispersed as a latex are more preferable. The dispersed particles have an average particle size of 1 to 50,000 nm, preferably 5 to 1,000 nm, more preferably 10 to 500 nm and still more preferably 50 to 200 nm. The particle size distribution of the dispersed particles is not particularly limited, and can be a wide particle size distribution or a mono-disperse particle size distribution. To control the physical properties of the coating liquid, it is also preferable to use two or more dispersions each having a mono-disperse particle size distribution as a mixture.

The polymer dispersible in the aqueous solvent is preferably a hydrophobic polymer such as acrylic polymer, polyester, rubber (such as SBR resin), polyurethane, polyvinyl chloride, polyvinyl acetate, polyvinylidene chloride or polyolefin. The polymer can be a linear, branched or crosslinked polymer, or can be a so-called homopolymer formed by polymerizing a single monomer or a copolymer formed by polymerizing two or more monomers. In the case of a copolymer, it can be a random copolymer or a block copolymer. The polymer has a number-averaged molecular weight of 5,000 to 1,000,000, preferably 10,000 to 200,000. An excessively small molecular weight results in insufficient mechanical strength of the image forming layer, while an excessively large molecular weight provides an inferior film forming property. Also a crosslinkable polymer latex is particularly preferably employed.

Specific Examples of Latex

Specific examples of the preferable polymer latex include those listed below. The following examples are represented by monomers used as the raw material, with a parenthesized number indicating mass % and a molecular weight represented by a number-averaged molecular weight. Since the concept of molecular weight is not applicable to an example employing a polyfunctional monomer because of its crosslinked structure, it is represented as crosslinking and the description of the molecular weight is omitted. Tg indicates a glass transition temperature:
P-1: latex of -MMA(70)-EA(27)-MAA(3)-(molecular weight of 37,000, and Tg of 61° C.)
P-2: latex of -MMA(70)-2EHA(20)-St(5)-AA(5)-(molecular weight of 40,000, and Tg of 59° C.)
P-3: latex of -St(50)-Bu(47)-MAA(3)-(crosslinking, and Tg of −17° C.)
P-4: latex of -St(68)-Bu(29)-AA(3)-(crosslinking, and Tg of 17° C.)
P-5: latex of -St(71)-Bu(26)-AA(3)-(crosslinking, and Tg of 24° C.)
P-6: latex of -St(70)-Bu(27)-IA(3)-(crosslinking)
P-7: latex of -St(75)-Bu(24)-AA(1)-(crosslinking, and Tg of 29° C.)
P-8: latex of -St(60)-Bu(35)-DVB(3)-MAA(2)-(crosslinking)
P-9: latex of -St(70)-Bu(25)-DVB(2)-AA(3)-(crosslinking)
P-10: latex of -VC(50)-MMA(20)-EA(20)-AN(5)-AA(5)-(molecular weight of 80,000)
P-11: latex of -VDC(85)-MMA(5)-EA(5)-MAA(5)-(molecular weight of 67,000)
P-12: latex of -Et(90)-MMA(10)-(molecular weight of 12,000)
P-13: latex of -St(70)-2EHA(27)-AA(3)-(molecular weight of 130,000, and Tg of 43° C.)
P-14: latex of -MMA(63)-EA(35)-AA(2)-(molecular weight of 33,000, and Tg of 47° C.)
P-15: latex of -St(70.5)-Bu(26.5)-AA(3)-(crosslinking, and Tg of 23° C.)
P-16: latex of -St(69.5)-Bu(27.5)-AA(3)-(crosslinking, and Tg of 20.5° C.)
P-17: latex of -St(61.3)-isoprene(35.5)-AA(3)-(crosslinking, and Tg of 17° C.)
P-18: latex of -St(67)-isoprene(28)-Bu(2)-AA(3)-(crosslinking, and Tg of 27° C.).

In the foregoing, the abbreviations represent following monomers: MMA: methyl methacrylate, EA: ethyl acrylate, MMA: methacrylic acid, 2EHA: 2-ethylhexyl acrylate, St: styrene, Bu: butadiene, AA: acrylic acid, DVB: divinylbenzene, VC: vinyl chloride, AN: acrylonitrile, VDC: vinylidene chloride, Et: ethylene, and IA: itaconic acid.

The polymers mentioned above are also commercially available, and following ones can be utilized. Examples of acrylic polymer include CEBIEN A-4635, 4718, and 4601 (manufactured by Daicel Chemical Industries, Ltd.), and NIPOL Lx 811, 814, 821, 820, and 857 (manufactured by Zeon Corp.). Examples of polyester include FINETEX ES 650, 611, 675, and 850 (manufactured by Dainippon Ink and Chemicals Inc.), and WD-size, and WMS (manufactured by Eastman Chemical Co.). Examples of polyurethane include HYDRAN AP 10, 20, 30, and 40 (manufactured by Dainippon Ink and Chemicals Inc.). Examples of rubber include LACSTAR 7310K, 3307B, 4700H, and 7132C (manufactured by Dainippon Ink and Chemicals Inc.), and NIPOL Lx 416, 410, 438C., and 2507 (manufactured by Zeon Corp.). Examples of polyvinyl chloride include G351, and G576 (manufactured by Zeon Corp.). Examples of polyvinylidene chloride include L502, and L513 (manufactured by Asahi Chemical Industries Ltd.). Examples of polyolefin include CHEMIPAR S 120, and SA100 (manufactured by Mitsui Chemical Co.).

These polymer latexes may be employed alone or as a blend of two or more kinds according to the necessity.

Preferable Latex

The polymer latex to be employed in the invention is particularly preferably a latex of styrene-butadiene copolymer or styrene-isoprene copolymer. In the styrene-butadiene copolymer, the weight ratio of a styrene monomer unit and a butadiene monomer unit is preferably 40:60 to 95:5. The ratio of the sum of the styrene monomer unit and the butadiene monomer unit to all the monomers is preferably within a range of 60 to 99 mass %. The polymer latex preferably includes acrylic acid or methacrylic acid in an amount of 1 to 6 mass % with respect to the sum of styrene and butadiene, and more preferably 2 to 5 mass %. The polymer latex preferably includes acrylic acid. A preferred range of each monomer content is the same as that described above. Also in the styrene-isoprene copolymer, a preferred copolymerization ratio, an acrylic acid content and the like are the same as those in the styrene-butadiene copolymer.

Preferred examples of the styrene-butadiene copolymer latex employable in the invention include P-3 to P-9, and P-15 mentioned above and LACSTAR 3307B, and 7132C and NIPOL Lx 416 which are commercially available. Examples of the styrene-isoprene copolymer include P-16 and P-17 mentioned above.

The image forming layer of the photosensitive material of the invention may contain, if necessary, a hydrophilic polymer such as gelatin, polyvinyl alcohol, methyl cellulose, hydroxypropyl cellulose, and/or carboxymethyl cellulose. The amount of such a hydrophilic polymer is preferably 30 mass % or less with respect to the total binder amount in the image forming layer, and more preferably 20 mass % or less.

The organic silver salt-containing layer (namely image forming layer) is preferably formed from polymer latex. The amount of the binder in the image forming layer is such that the weight ratio of all the binders to the organic silver salt is preferably within a range from 1/10 to 10/1, more preferably 1/3 to 5/1, and still more preferably 1/1 to 3/1.

Such organic silver salt-containing layer is usually also a photosensitive layer (image forming layer) including a photosensitive silver halide which is a photosensitive silver salt. In such a case, the weight ratio of all the binders to the silver halide is preferably within a range of 400 to 5, and more preferably 200 to 10.

In the image forming layer, the total amount of the binders is preferably 0.2 to 30 g/m², more preferably 1 to 15 g/m², and still more preferably 2 to 10 g/m². The image forming layer may contain a crosslinking agent for crosslinking, and/or a surfactant for improving the coating property.

Preferable Solvent for Coating Liquid

In a coating liquid for the image forming layer of the photosensitive material of the invention, a solvent (including a solvent and a dispersion medium) is preferably an aqueous solvent containing water by 30 mass % or higher. A component other than water can be any water-miscible organic solvent, such as methyl alcohol, ethyl alcohol, isopropyl alcohol, methyl cellosolve, ethyl cellosolve, dimethylformamide or ethyl acetate. The water content of the solvent in the coating liquid is preferably 50 mass % or higher, and more preferably 70 mass % or higher. Examples of the preferred solvent composition include water, a mixture of water and methyl alcohol at a mass % of 90/10, a mixture of water and methyl alcohol at a mass % of 70/30, a mixture of water, methyl alcohol and dimethylformamide at a mass % of 80/15/5, a mixture of water, methyl alcohol amdethyl cellosolve at a mass % of 85/10/5, and a mixture of water, methyl alcohol and isopropyl alcohol at a mass % of 85/10/5.

Explanations Regarding Heat Solvent

In the invention, a heat solvent can also be included in the photothermographic material. The heat solvent is defined as a material which can enable the thermal development temperature of a photothermographic material containing the heat solvent to be lower than that of a photothermographic material containing no heat solvent by 1° C. or more. It is preferably a material which can enable the thermal development temperature of a photothermographic material containing the heat solvent to be lower than that of a photothermographic material containing no heat solvent by 2° C. or more, and more preferably a material which can enable the thermal development temperature of a photothermographic material containing the heat solvent to be lower than that of a photothermographic material containing no heat solvent by 3° C. or more. For example, given that a photothermographic material A contains the heat solvent, and a photothermographic material B contains no heat solvent, and the photothermographic materials A and B are exposed to light at the same exposure amount and thermally developed for 20 seconds, the heat solvent is defined as a material that makes heat development temperature of the photothermographic material A, which heat development temperature is necessary to provide an image density that is the same as when the photothermographic material B is developed at 120° C., 119° C. or less.

Addition of the heat solvent increases a developing speed and thereby improves an apparent sensitivity of the photothermographic material, but makes the photothermographic material more susceptible to external environment (for example, during storage). However, a layer structure recited in the invention reduces the susceptibility to the external environment.

The heat solvent has a polar group as a substituent, and is preferably represented by formula (1), but the formula is not restrictive.
(Y)ₙZ Formula (1)

In formula (1), Y represents an alkyl group, an alkenyl group, an alkynyl group, an aryl group or a heterocyclic group. Z represents a group selected from a hydroxyl group, a carboxyl group, an amino group, an amide group, a sulfonamide group, a phosphoric amide group, a cyano group, imide, ureido, sulfoxide, sulfone, phosphine, phosphinoxide and a nitrogen-containing heterocyclic group. n represents an integer from 1 to 3 and, when Z is a monovalent group, is 1, and, when Z has a valence of two or higher, is equal to the valence number of Z. In the case where n is 2 or higher, plural Ys may be the same or different. Y may further have a substituent, and can have a group represented by Z as the substituent.

Now Y will be explained in more details. In formula (1), Y represents a linear, branched or cyclic alkyl group (preferably with 1 to 40 carbon atoms, more preferably 1 to 30 carbon atoms and still more preferably 1 to 25 carbon atoms, such as a methyl, ethyl, n-propyl, iso-propyl, sec-butyl, t-butyl, t-octyl, n-amyl, t-amyl, n-dodecyl, n-tridecyl, octadecyl, eicosyl, docosyl, cyclopentyl or cyclohexyl group), an alkenyl group (preferably with 2 to 40 carbon atoms, more preferably 2 to 30 carbon atoms and still more preferably 2 to 25 carbon atoms, such as a vinyl, allyl, 2-butenyl, or 3-pentenyl group), an aryl group (preferably with 6 to 40 carbon atoms, more preferably 6 to 30 carbon atoms and still more preferably 6 to 25 carbon atoms, such as a phenyl, p-methylphenyl or naphthyl group), or a heterocyclic group (preferably with 2 to 20 carbon atoms, more preferably 2 to 16 carbon atoms and still more preferably 2 to 12 carbon atoms, such as a pyridyl, pyradyl, imidazoyl or pyrrolidyl group). These substituents may be further substituted with another substituent. The substituents may bond to each other to form a ring.

Y may further have a substituent, and examples of the substituent include a halogen atom (a fluorine atom, a chlorine atom, a bromine atom or an iodine atom), an alkyl group (a linear, branched or cyclic alkyl group including a bicycloalkyl group and an active methine group), an alkenyl group, an alkynyl group, an aryl group, a heterocyclic group (the substituting position being limited), an acyl group, an alkoxycarbonyl group, an aryloxycarbonyl group, a heterocyclic oxycabonyl group, a carbamoyl group, an N-acylcarbamoyl group, an N-sulfonylcarbamoyl group, an N-carbamoylcarbamoyl group, a thiocarbamoyl group, an N-sulfamoylcarbamoyl group, a carbazoyl group, a carboxyl group and a salt thereof, an oxalyl group, an oxamoyl group, a cyano group, a carbonimidoyl group, a formyl group, a hydroxy group, an alkoxy group (including a group repeatedly containing an ethyleneoxy group or a propyleneoxy group), an aryloxy group, a heterocyclic oxy group, an acyloxy group, an (alkoxy or aryloxy)carbonyloxy group, a carbamoyloxy group, a sulfonyloxy group, an amino group, an (alkyl, aryl or heterocyclic)amino group, an acylamino group, a sulfonamide group, an ureido group, a thioureido group, an imide group, an (alkoxy or aryloxy)carbonylamino group, a sulfamoylamino group, a semicarbazide group, a thiosemicarbazide group, an ammonio group, an oxamoylamino group, an N-(alkyl or aryl)sulfonylureido group, an N-acylureido group, an N-acylsulfamoylamino group, a nitro group, a heterocyclic group containing a quaternary nitrogen atom (such as a pyridinio group, an imidazolio group, a quinolinio group and an isoquinolinio group), an isocyano group, an imino group, a mercapto group, an (alkyl, aryl or heterocyclic)thio group, an (alkyl, aryl or heterocyclic)dithio group, an (alkyl or aryl)sulfonyl group, an (alkyl or aryl)sulfinyl group, a sulfo group and a salt thereof, a sulfamoyl group, an N-acylsulfamoyl group, an N-sulfonylsulfamoyl group and a salt thereof, a phosphino group, a phosphinyl group, a phosphinyloxy group, a phosphinylamino group and a silyl group. The active methine group means a methine group substituted with two electron-attractive groups, and the electron-attractive group means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, or a carbonimidoyl group. The two electron-attractive groups may bond to each other to form a ring structure. The salt includes, for example, a cation of an alkali metal, an alkaline earth metal or a heavy metal, or an organic cation such as an ammonium ion or a phosphonium ion. The substituent may be further substituted with such a substituent. Y may further have a group represented by Z as a substituent.

It is supposed that the reason why the heat solvent attains the effect of the invention is that the heat solvent fuses around a developing temperature, is compativle with a substance or substances involved in the development, and enables the reaction at a temperature lower than a temperature at which the reaction occurs in the absence of the heat solvent. As the thermal development is a reduction reaction involving a carboxylic acid of a relatively high polarity and a silver ion transporting substance, it is preferable to form a reaction field of a suitable polarity with the heat solvent having a polar group.

The heat solvent generally has a melting point of 50 to 200° C., and preferably 60 to 150° C. In particular, in a photothermographic material which is designed while importance is put on stability with respect to the external environment such as image storability, as intended in the invention, a heat solvent of a melting point of 100 to 150° C. is preferable.

In the following, specific examples of the heat solvent are shown, but the invention is not restricted by such examples. In the following, parenthesized number indicates a melting point. N-methyl-N-nitroso-p-toluenesulfonamide (61° C.), 1,8-octanediol (62° C.), phenyl benzoate (67-71° C.), hydroquinone diethyl ether (67-73° C.), ε-caprolactam (68-70° C.), diphenyl phosphate (68-70° C.), (±)-2-hydroxyoctanoic acid (68-71° C.), (±)-3-hydroxydodecanoic acid (68-71° C.), 5-chloro-2-methylbenzothiazole (68-71° C.), β-naphthyl acetate (68-71° C.), batyl alcohol (68-73° C.), (±)-2-hydroxydecanoic acid (69-72° C.), 2,2,2-trifluoroacetamide (69-72° C.), pyrrazole (69° C.), (±)-2-hydroxyundecanoic acid (70-73° C.), N,N-diphenylformamide (71-72° C.), dibenzyldisulfide (71-72° C.), (±)-3hydroxyundecanoic acid (71-74° C.), 2,2′-dihydroxy-4-methoxybenzophenone (71° C.), 2,4-dinitrotoluene (71 ° C.), 2,4-dimethoxybenzaldehyde (71° C.), 2,6-di-t-butyl-4-methylphenol (71° C.), 2,6-dichlorobenzaldehyde (71° C.), diphenylsulfoxide (71° C.), stearic acid (71° C.), 2,5-dimethoxynitrobenzene (72-73° C.), 1,10-decanediol (72-74° C.), (R)-(−)-3-hydroxytetradecanoic acid (72-75° C.), 2-tetradecylhexadecanoic acid (72-75° C.), 2-methoxynaphthalene (72-75° C.), methyl 3-hydroxy-2-naphthoate (72-76° C.), tristearin (73.5° C.), dotriacontane (74-75° C.), flavanone (74-78° C.), 2,5-diphenyloxazole (74° C.), 8-quinolinol (74° C.), o-chlorobenzyl alcohol (74° C.), oleylic acid amide (75-76° C.), (±)-2-hydroxydodecanoic acid (75-78° C.), n-hexatriacontane (75-79° C.), iminodiacetonitrile (75-79° C.), p-chlorobenzyl alcohol (75° C.), diphenyl phthalate (75° C.), N-methylbenzamide (76-78° C.), (±)-2-hydroxytridecanoic acid (76-79° C.), 1,3-diphenyl-1,3-propanedione (76-79° C.), N-methyl-p-toluenesulfonamide (76-79° C.), 3′-nitroacetophenone (76-80° C.), 4-phenylcyclohexanone (76-80° C.), eicosanoic acid (76° C.), 4-chlorobenzophenone (77-78° C.), (±)-3-hydroxytetradecanoic acid (77-80° C.), 2-hexadecyloctadecanoic acid (77-80° C.), p-nitrophenyl acetate (77-80° C.), 4′-nitroacetophenone (77-81° C.), 12-hydroxystearic acid (77° C.), α,α′-dibromo-m-xylene (77° C.), 9-methylanthracene (78-81° C.), 1,4-cyclohexadione (78° C.), m-diethylaminophenol (78° C), methyl m-nitrobenzoate (78° C.), (±)-2-hydroxytetradecanoic acid (79-82° C.), 1-(phenylsulfonyl)indole (79° C.), di-p-tolylmethane (79° C.), propionamide (79° C.), (+)-3-hydroxytridecanoic acid (80-83° C.), guaiacol glycerin ether (80-85° C.), octanoyl-N-methylglucamide (80-90° C.), o-fluoroacetanilide (80° C.), acetacetanilide (80° C.), docosanoic acid (81-82° C.), p-bromobenzophenone (81° C.), triphenylphosphine (81° C.), dibenzofuran (82.8° C.), (±)-2-hydroxypentadecanoic acid (82-85° C.), 2-octadecyleicosanoic acid (82-85° C.), 1,12-dodecanediol (82° C.), methyl 3,4,5-trimethoxybenzoate (83° C.), p-chloronitrobenzene (83° C.), (±)-3-hydroxyhexadecanoic acid (84-85° C.), o-hydroxybenzyl alcohol (84-86° C.), 1-triacontanol (84-88° C.), o-aminobenzyl alcohol (84° C.), 4-methoxybenzyl acetate (84° C.), (±)-2-hydroxyhexadecanoic acid (85-88° C.), m-dimethylaminophenol (85° C.), p-dibromobenzene (86-87° C.), methyl 2,5-dihydroxybenzoate (86-88° C.), (±)-3-hydroxypentadecanoic acid (86-89° C.), 4-benzylbiphenyl (86° C.), p-fluorophenylacetic acid (86° C.), 1,14-tetradecanediol (87-89° C.), 2,5-dimethyl-2,5-hexanediol (87-90° C.), p-pentylbezoic acid (87-91° C.), α-(trichloromethyl) benzyl acetate (88-89° C.), 4,4′-dimethylbenzoin (88° C.), diphenyl carbonate (88° C.), m-dinitrobenzene (89.57° C.), (3R,5R)-(±)-2,6-dimethyl-3,5-heptanediol (90-93° C.), (3S,5S)-(−)-2,6-dimethyl-3,5-heptanediol (90-93° C.), cyclohexanonoxime (90° C.), p-bromoiodobenzene (91-92° C.), 4,4′-dimethylbenzophenone (92-95° C.), triphenylmethane (92-95° C.), stearylic acid anilide (92-96° C.), p-hydroxyphenylethanol (92° C.), monoethylurea (92° C.), acenaphthylene (93.5-94.5° C.), m-hydroxyacetophenone (93-97° C.), xylitol (93-97° C.), p-iodophenol (93° C.), methyl p-nitrobenzoate (94-98° C.), p-nitrobenzyl alcohol (94° C.), 1,2,4-triacetoxybenzene (95-100° C.), 3-acetylbenzonitrile (95-103° C.), ethyl 2-cyano-3,3-diphenylacrylate (9547° C.), 16-hydroxyhexadecanoic acid (95-99° C.), D(−)-ribose (95° C.), o-benzoylbenzoic acid (95° C.), α,α′-dibromo-o-xylene (95° C.), benzil (95° C.), iodoacetamide (95° C.), n-propyl p-hydroxybenzoate (96-97° C.), flavone (96-97° C.), 2-deoxy-D-ribose (96-98° C.), lauryl gallate (96-99° C.), 1-naphthol (96° C.), 2,7-dimethylnaphthalene (96° C.), 2-chlorophenylacetic acid (96° C.), acenaphthene (96° C.), dibenzyl terephthalate (96° C.), fumaronitrile (96° C.), 4′-amino-2′,5′-diethoxybenzanilide (97-100° C.), phenoxyacetic acid (97-100° C.), 2,5-dimethyl-3-hexyne-2,5-diol (97° C.), D-sorbitol (97° C.), m-aminobenzyl alcohol (97° C.), diethyl acetamidemalonate (97° C.), 1,10-phenanthroline monohydrate (98-100° C.), 2-hydroxy-4-methoxy-4′-methylbenzophenone (98-100° C.), 2-bromo-4′-chloroacetophenone (98° C.), methylurea (98° C.), 4-phenoxyphthalonitrile (99-100° C.), o-methoxybenzoic acid (99-100° C.), p-butylbenzoic acid (99-100° C.), xanthene (99-100° C.), pentafluorobenzoic acid (99-101° C.), phenanthrene (99° C.), p-t-butylphenol (100.4° C.), 9-fluorenylmethanol (100-101° C.), 1,3-dimethylurea (100-102° C.), 4-acetoxyindole (100-102° C.), 1,3-cyclohexanedione (100° C.), stearylic acid amide (100° C.), tri-m-tolylphosphine (100° C.), 4-biphenylmethanol (101-102° C.), 1,4-cyclohexanediol (cis/trans mixture) (101° C.), α,α′-dichloro-p-xylene (101° C.), 2-t-butylanthraquinone (102° C.), dimethyl fumarate (102° C.), 3,3-dimethylglutaric acid (103-104° C.), 2-hydrdoxy-3-methyl-2-cyclopenten-1-one (103° C.), 4-chloro-3-nitroaniline (103° C.), N,N-diphenylacetamide (103° C.), 3(2)-t-butyl-4-hydroxyanisol (104-105° C.), 4,4′-dimethylbenzil (104-105° C.), 2,2-bis(hydroxymethyl)-2,2′,2″-nitrilotriethanol (104 ° C.), m-trifluoromethylbenzoic acid (104 ° C.), 3-pentanol (105-108° C.), 2-methyl-1,4-naphthoquinone (105° C.), α,α,α′,α′-tetrabromo-m-xylene (105° C.), 4-chlorophenylacetic acid (106° C.), 4,4′-difluorobenzophenone (107.5-108.5° C.), 2,4-dichloro-1-naphthol (107-108° C.), L-ascorbic acid palmitate ester (107-117° C.), 2,4-dimethoxybenzoic acid (108-109° C.), o-trifluoromethylbenzoic acid (108-109° C.), p-hydroxyacetophenone (109° C.), dimethylsulfone (109° C.), 2,6-dimethylnaphthalene (110-111° C.), 2,3,5,6-tetramethyl-1,4-benzoquinone (110° C.), tridecanedioic acid (110° C.), triphenylchloromethane (110° C.), fluoranthene (110° C.), laurylamide (110° C.), 1,4-benzoquinone (111° C.), 3-benzylindole (111° C.), resorcinol (111° C.), 1-bromobutane (112.3° C.), 2,2-bis (bromomethyl)-1,3-propanediol (112-114° C.), p-ethylbenzoic acid (113.5° C.), 1,4-diacetoxy-2-methylnaphthalene (113° C.), 1-ethyl-2,3-piperadinedion (113° C.), 4-methyl-2-nitroaniline (113° C.), L-ascorbic acid dipalmitate ester (113° C.), o-phenoxybenzoic acid (113° C.), p-nitrophenol (113° C.), methyl(diphenyl)phosphine oxide (113° C.), cholesterol acetate (114-115° C.), 2,6-dimethylbenzoic acid (114-116° C.), 3-nitrobenzonitrile (114° C.), m-nitroaniline (114° C.), ethyl alucoside (114° C.), acetanilide (115-116° C.), (±)-2-phenoxypropionic acid (115° C.), 4-chloro-1-naphthol (116-117° C.), p-nitrophenylacetonitrile (116-117° C.), ethyl p-hydroxybenzoate (116° C.), p-isopropylbenzoic acid (117-118° C.), D(+)-galactose (118-120° C.), o-dinitrobenzene (118° C.), benzyl p-benzyloxybenzoate (118° C.), 1,3,5-tribromobenzene (119° C.), 2,3-dimethoxybenzoic acid (120-122° C.), 4-chloro-2-methylphenoxyacetic acid (120° C.), meso-erythritol (121.5° C.), 9,10-dimethyl-1,2-benzanthracene (122-123° C.), 2-naphthol (122° C.), N-pohenylglycine (122° C.), bis(4-hydroxy-3-methylphenyl) sulfide (122° C.), p-hydroxybenzyl alcohol (124.5-125.5° C.), 2′,4′-dihydroxy-3′-propylacetophenone (124-127° C.), 1,1-bis(4-hydroxyphenyl)ethane (124° C.), m-fluorobenzoic acid (124° C.), diphenylsulfone (124° C.), 2,2-dimethyl-3-dihydroxypropionic acid (125° C.), 3,4,5-trimethoxycinnamic acid (125° C.), o-fluorobenzoic acid (126.5° C.), isonitrosoacetophenone (126-128° C.), 5-methyl-1,3-cyclohexanedione (126° C.), 4-benzoylbutyric acid (127° C.), methyl p-hydroxybenzoate (127° C.), p-bromonitrobenzene (127° C.), 3,4-dihydroxyphenylacetic acid (128-130° C.), 5α-cholestan-3-one (128-130° C.), 6-bromo-2-naphthol (128° C.), isobutylamide (128° C.), 1-naphthylacetic acid (129° C.), 2,2-dimethyl-1,3-propanediol (129° C.), p-diiodobenzene (129° C.), dodecanedioic acid (129° C.), 4,4′-dimethoxybenzil (131-133° C.), dimethylolurea (132.5° C.), o-ethoxybenzamide (132-134° C.), sebacic acid (132° C.), p-toluenesulfonamide (134° C.), salycilanilide (135° C.), β-citosterol (136-137° C.), 1,2,4,5-tetrachlorobenzene (136° C.), 1,3-bis(1-hydroxy-1-methylethyl)benzene (137° C.), phthalonitrile (138° C.), 4-n-propylbenzoic acid (139° C.), 2,4-dichlorophenoxyacetic acid (140.5° C.), 2-naphthylacetic acid (140° C.), methyl terephthalate (140° C.), 2,2-dimethylsuccinic acid (141° C.), 2,6-dichlorobenzonitrile (142.5-143.5° C.), o-chlorobenzoic acid (142° C.), 1,2-bis (diphenylphosphino)ethane (143-144° C.), α,α,α-tribromomethylphenyl sulfone (143° C.), D(+)-xylose (144-145° C.), phenylurea (146° C.), n-propyl gallate (146° C.), 4,4′-dichlorobenzophenone (147-148° C.), 2′,4′-dihydroxyacetophenone (147° C.), cholesterol (148.5° C.), 2-methyl-1-pentanol (148° C.), 4,4′-dichlorodiphenylsulfone (148° C.), diglycollic acid (148° C.), adipic acid (149-150° C.), 2-deoxy-D-glucose (149° C.), diphenylacetic acid (149° C.), and o-bromobenzoic acid (150° C.)

In the invention, the amount of the heat solvent is preferably 0.01 to 5.0 g/m², more preferably 0.05 to 2.5 g/m², and still more preferably 0.1 to 1.5 g/m². The heat solovent is preferably contained in the image forming layer.

One heat solvent may be employed or two or more heat solvents can be used together.

The heat solvent may be contained in the coating liquid and in the photosensitive material in any form, for example a solution, an emulsified dispersion or a dispersion of fine solid particles.

In a well known method for preparing an emulsified dispersion, the heat solvent is dissolved in oil such as dibutyl phthalate, tricresyl phosphate, glyceryl triacetate or diethyl phthalate, or an auxiliary solvent such as ethyl acetate or cyclohexanone, followed by mechanical preparation of an emulsified dispersion.

To disperse solid particles, there can be employed a method of dispersing powder of a heat solvent in a suitable solvent such as water with a ball mill, a colloid mill, a vibrating ball mill, a sand mill, a jet mill, a roller mill or ultrasonic wave to obtain a solid dispersion. In such method, there may be employed a protective colloid (such as polyvinyl alcohol) or a surfactant (for example an anionic surfactant such as sodium triisopropylnaphthalenesulfonate (a mixture of compounds with different substituting positions of three isopropyl groups). In the above-mentioned mills, beads such as zirconia beads are usually employed as a dispersion medium, and the dispersion may be contaminated with zirconium dissolving out of such beads. Its content depends on the dispersing conditions, but is usually within a range of 1 to 1000 ppm. A content thereof in the photosensitive material of 0.5 mg or less per g of silver is at practically acceptable level.

The aqueous dispersion preferably includes an antiseptic (such as sodium salt of benzoisothiazolinone). In the invention, the heat solvent is preferably employed as a solid dispersion.

Other Additives

1) Mercapto, Disulfide and Thion

In the invention, for the purposes of controlling development by suppression or acceleration, improving efficiency of spectral sensitization, improving preservability before and after the developmen, the photothermographic material may include a mercapto compound, a disulfide compound and/or a thion compound such as those described in JP-A No. 10-62899, paragraphs 0067-0069, those represented by formula (I) in JP-A No. 10-186572 and specific example described in paragraphs 0033-0052 thereof, and those described in EP-A No. 0803764A1, page 20, lines 36-56. Among these, particularly preferred is a mercapto-substituted heteroaromatic compound described for example in JP-A Nos. 9-297367, 9-304875, 2001-100358, and 2002-303954 and 2002-303951.
2) Color Toning Agent

The photothermographic material of the invention preferably contains a color toning agent. As the color toning agent to be employed in the invention, any color toning agent that has been employed in a photothermographic material utilizing an organic silver salt can be utilized without any particular restriction. The color toning agent may also be a so-called precursor which is a derived and functions only at the time of developing operation. Examples of the usable color toning agent include those described in JP-A Nos. 49-6077, 47-10282, 49-5019, 49-5020, 49-91215, 50-2524, 50-32927, 50-67132, 50-67641, 50-114217, 51-3223, 51-27923, 52-14788, 52-99813, 53-1020, 53-76020, 54-156524, 54-156525, 61-183642, and 4-56848, JP-B Nos. 49-10727 and 54-20333, U.S. Pat. Nos. 3,080,254, 3,446,648, 3,782,941, 4,123,282 and 4,510,236, BP No. 1,380,795 and Belgian Patent No. 841,910.

Specific examples of the color toning agent include phthalimide and N-hydroxyphthalimide; a cyclic imide such as succinimide, pyrazolin-5-one, quinazolinone, 3-phenyl-2-pyrazolin-5-one, 1-phenylurazol, quinazoline or 2,4-thiazolizinedione; naphthalimide (such as N-hydroxy-1,8-naphthalimide); a cobalt complex (such as cobalt hexamine trifluoroacetate); a mercaptane such as 3-mercapto-1,2,4-triazole, 2,4-dimercaptopyrimidine, 3-mercapto-4,5-diphenyl-1,2,4-triazole and 2,5-dimercapto-1,3,4-thiadiazole; N-aminomethyl)aryldicarboxyimide (such as (N,N-dimethylaminomethyl) phthalimide and N,N-dimethylaminomethyl)-naphthalene-2,3-dicarboxyimide); a block pyrazole, an isothiuronium derivative and a certain light-fading material (such as N,N′-hexamethylenebis(1-carbamoyl-3,5-dimethylpyrazole), 1,8-(3,6-diazaoctane)-bis (isothiuronium trifluoroacetate) or 2-(tribromomethylsulfonyl)benzothiazole); 3-ethyl-5-[(3-ethyl-2-benzothiazolinylidene)-1-methylethylidene]-2-thio-2,4oxazolidinedione; phthalazinone, a phthalazinone derivative and a metal salt thereof, and a derivative thereof such as 4-(1-naphthyl) phthalazinone, 6-chlorophthalazinone, 5,7-dimethoxyphthalazinone or 2,3-dihydro-1,4-phthalazinedione; a combination of phthalazinone and a phthalic acid derivative (such as phthalic acid, 4-methylphthalic acid, 4-nitrophthalic acid and tetrachlorophthalic anhydride); phthalazine, a phthalazine derivative (such as 4-(1-naphthyl)phthalazine, 6-chlorophthalazine, 5,7-dimethoxyphthalazine, 6-isobutylphthalazine, 6-tert-butylphthalazine, 5,7-dimethylphthalazine and 2,3-dihydrophthalazine) and a metal salt thereof; a combination of phthalazine and a derivative thereof and a phthalic acid derivative (such as phthalic acid, 4-methylphthalic acid, 4-nitrophthalic acid and tetrachlorophthalic anhydride); a derivative of quinazolinedione, benzoxazine or naphthooxazine; a rhodium complex functioning not only as a color toning agent but also as a halide ion source for in situ silver halide formation, such as ammonium hexachlororhodate (III), rhodium bromide, rhodium nitrate or potassium hexachlororhodate (III); an inorganic peroxide and a persulfate salt such as ammonium disulfide peroxide or hydrogen peroxide; benzoxazine-2,4-dione such as 1,3-benzoxazine-2,4-dione, 8-methyl-1,3-benzoxazine-2,4-dione and 6-nitro-1,3benzoxazine-2,4-dione; pyrimidine and asymmetric triazine (such as 2,4-dihydroxypyrimidine and 2-hydroxy-4-aminopyrimidine), azauracyl and a tetrazapentalene derivative (such as 3,6-dimercapto-1,4-diphenyl-1H,4H-2,3a,5,6a-tetrazapentalene and 1,4-di(o-chlorophenyl)-3,6-dimercapto-1H,4H-2,3a,5,6a-tetrazapentalene.

In the invention, it is particularly preferable to employ a phthalazine derivative represented by formula (1) as the color toning agent. In formula (1), R represents a substituent, and m represents an integer of 1 to 6. In the case of m≧2, plural Rs may be the same or different.

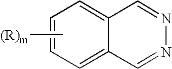

There can be employed any substituent represented by R as long as it does not have a detrimental effect on the photographic properties. Examples thereof include a halogen atom (such as a fluorine atom, a chlorine atom, a bromine atom or an iodine atom), a linear, branched or cyclic alkyl group (preferably with 1 to 20 carbon atoms, more preferably 1 to 16 carbon atoms and still more preferably 1 to 12 carbon atoms, such as methyl, ethyl, isopropyl, t-butyl, t-octyl, t-amyl, and cyclohexyl groups), an alkenyl group (preferably with 2 to 20 carbon atoms, more preferably 2 to 16 carbon atoms and still more preferably 2 to 12 carbon atoms, such as vinyl, allyl, 2-butenyl, and 3-pentenyl groups), an aryl group (preferably with 6 to 30 carbon atoms, more preferably 6 to 20 carbon atoms and still more preferably 6 to 12 carbon atoms, such as phenyl, p-methylphenyl and naphthyl groups), an alkoxy group (preferably with 1 to 20 carbon atoms, more preferably 1 to 16 carbon atoms and still more preferably 1 to 12 carbon atoms, such as methoxy, ethoxy, and butoxy groups), an aryloxy group (preferably with 6 to 30 carbon atoms, more preferably 6 to 20 carbon atoms and still more preferably 6 to 12 carbon atoms, such as phenyloxy and 2-naphthyloxy groups), an acyloxy group (preferably with 1 to 20 carbon atoms, more preferably 2 to 16 carbon atoms and still more preferably 2 to 12 carbon atoms, such as acetoxy and benzoyloxy groups), an amino group (preferably with 0 to 20 carbon atoms, more preferably 2 to 16 carbon atoms and still more preferably 12 carbon atoms, such as dimethylamino, diethylamino and dibutylamino groups), an acylamino group (preferably with 1 to 20 carbon atoms, more preferably 2 to 16 carbon atoms and still more preferably 2 to 12 carbon atoms, such as acetylamino and benzoylamino groups), a sulfonylamino group (preferably with 1 to 20 carbon atoms, more preferably 1 to 16 carbon atoms and still more preferably 1 to 12 carbon atoms, such as methanesulfonylamino and benzenesulfonylamino groups), an ureido group (preferably with 1 to 20 carbon atoms, more preferably 1 to 16 carbon atoms and still more preferably 1 to 12 carbon atoms, such as ureido, methylureido and phenylureido groups), a carbamate group (preferably with 2 to 20 carbon atoms, more preferably 2 to 16 carbon atoms and still more preferably 2 to 12 carbon atoms, such as methoxycarbonylamino and phenyloxycarbonylamino groups), a carboxyl group, a carbamoyl group (preferably with 1 to 20 carbon atoms, more preferably 1 to 16 carbon atoms and still more preferably 1 to 12 carbon atoms, such as carbamoyl, N,N-diethylcarbamoyl and N-phenylcarbamoyl groups), an alkoxycarbonyl group (preferably with 2 to 20 carbon atoms, more preferably 2 to 16 carbon atoms and still more preferably 2 to 12 carbon atoms, such as methoxycarbonyl and ethoxycarbonyl groups), an acyl group (preferably with 2 to 20 carbon atoms, more preferably 2 to 16 carbon atoms and still more preferably 2 to 12 carbon atoms, such as acetyl, benzoyl, formyl and pivaloyl groups), a sulfo group, a sulfonyl group (preferably with 1 to 20 carbon atoms, more preferably 1 to 16 carbon atoms and still more preferably 1 to 12 carbon atoms, such as mesyl and tosyl groups), a sulfamoyl group (preferably with 0 to 20 carbon atoms, more preferably 0 to 16 carbon atoms and still more preferably 0 to 12 carbon atoms, such as sulfamoyl, methylsulfamoyl, dimethylsulfamoyl and phenylsulfamoyl groups), a cyano group, a nitro group, a hydroxyl group, a mercapto group, an alkylthio group (preferably with 1 to 20 carbon atoms, more preferably 1 to 16 carbon atoms and still more preferably 1 to 12 carbon atoms, such as metylthio and butylthio groups), and a heterocyclic group (preferably with 2 to 20 carbon atoms, more preferably 2 to 16 carbon atoms and still more preferably 2 to 12 carbon atoms, such as pyridyl, imidazoyl and pyrrolidyl groups).

The substituent represented by R is preferably a halogen atom, a linear, branched or cyclic alkyl group, an aryl group, an alkoxy group, an aryloxy group, a cyano group, a nitro group, a hydroxyl group, a mercapto group, or an alkylthio group, more preferably a linear, branched or cyclic alkyl group, an alkoxy group, or an aryloxy group, and still more preferably a linear or branched alkyl group.

In the case where m is 2 or larger, the substituents represented by R may be the same or different, and the substituent may be further substituted with another substituent. Also, they may bond to each other to form a ring.

The compound represented by formula (1) preferably has a melting point of 130° C. or lower, and includes a material which is liquid at ordinary temperature (about 15° C.).

In the following, specific examples of the compound represented by formula (1) and having a melting point (m.p.) of 130° C. or lower are shown, but the invention is not limited by such examples.

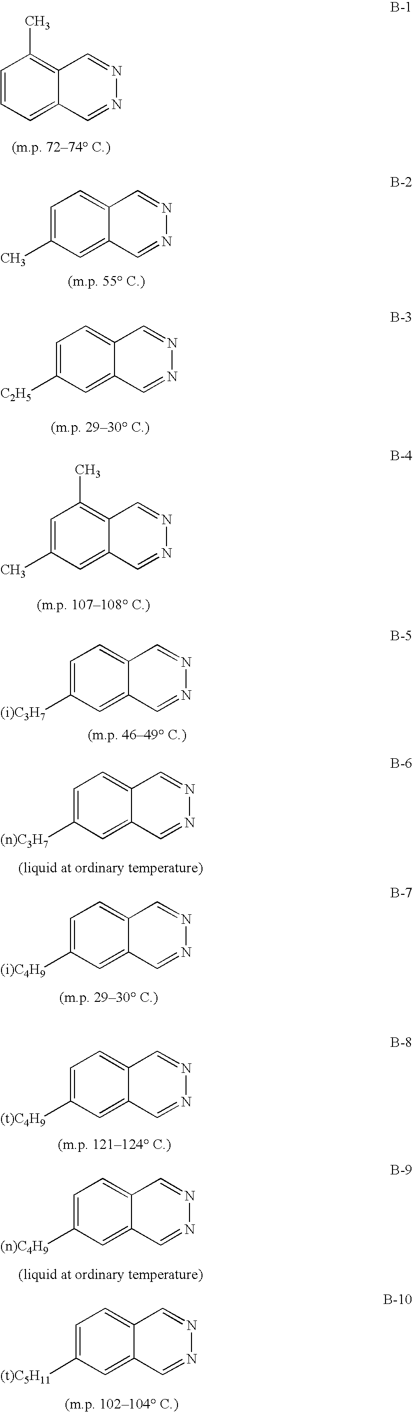

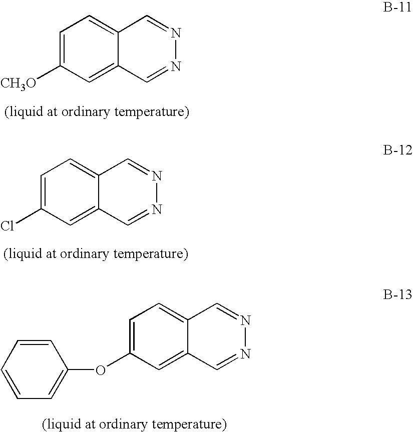

In the photothermographic material of the invention, the color toning agent is employed in an amount sufficient to improve image property to a desired level. The color toning agent of an appropriate amount is advantageous in increasing image density and in forming a black silver image. The color toning agent is preferably contained in a layer or layers disposed on a side having the image forming layer in an amount of 0.1 to 50 mol. % per mole of silver, and more preferably 0.5 to 20 mol. %.

The color toning agent may be contained in any layer on the side having the image forming layer, but is preferably contained in the image forming layer and/or a layer adjacent to the image forming layer, and more preferably contained in the image forming layer.
3) Color Tone Regulating Agent

The photothermographic material of the invention preferably contains a color tone regulating agent to regulate the color tone of developed silver. The color tone regulating agent is an additive for regulating the color tone of the developed silver to a desired color tone, and, for example, in the case where an image of a pure black tone is desired and in the case where the developed silver has a bluish color tone, is preferably a reducing compound generating a yellow oxidation product. In the case of a developed silver of a yellow-brown color tone, a compound generating a cyan color tone is preferred as the color tone regulating agent. The color tone regulating agent is employed such that the color tone generated by the color tone regulating agent can supplment the color tone of the developed silver to obtain a desired image color tone. The color tone regulating agent can preferably be a compound represented by formula (P), or a coupler which develops a color when coupling with the oxidant of a reducing agent in thermal development.
1) Color Tone Regulating Agent Represented by Formula (P)

The color tone regulating agents employable in the invention preferably includes a compound represented by formula (P).

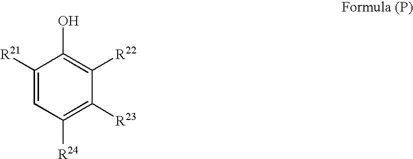

In the formula, R²¹ and R²² each independently represent a hydrogen atom, an alkyl group or an acylamino group. However, R²¹ and R²² are not 2-hydroxyphenylmethyl groups, nor, at the same time, hydrogen atoms. R²³ represents a hydrogen atom or an alkyl group, and R²⁴ represents a substituent substitutable on the benzene ring.

In the case where R²¹ is an alkyl group, it is preferably an alkyl group with 1 to 30 carbon atoms, and more preferably 1 to 10 carbon atoms.

The alkyl group may have a substituent. The unsubstituted alkyl group is preferably a methyl, ethyl, butyl, octyl, isopropyl, t-butyl, t-octyl, t-amyl, sec-butyl, cyclohexyl or 1-methyl-cyclohexyl group, more preferably a group sterically equal to or larger than an isopropyl group (such as an isopropyl group, an isononyl group, a t-butyl group, a t-amyl group, a t-octyl group, a cyclohexyl group, a 1-methyl-cyclohexyl group or an adamantyl group), and still more preferably a tert-alkyl group such as a t-butyl, t-octyl or t-amyl group.

In the case where the alkyl group has a substituent, the substituent can be a halogen atom, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group or a phosphoryl group.

In the case where R²² is an alkyl group, it is preferably an alkyl group with 1 to 30 carbon atoms, and more preferably an unsubstituted alkyl group with 1 to 24 carbon atoms.

The alkyl group may have a substituent. The unsubstituted alkyl group is preferably a methyl, ethyl, butyl, octyl, isopropyl, t-butyl, t-octyl, t-amyl, sec-butyl, cyclohexyl or 1-methyl-cyclohexyl group.

Examples of the substituent are the same as those when R²¹ is a substituted alkyl group.

In the case where R²¹ or R²² is an acylamino group, it is preferably an acylamino group with 1 to 30 carbon atoms, and more preferably with 1 to 10 carbon atoms.

The acylamino group may be unsubstituted or may have a substituent. Specific examples thereof include an acetylamino group, an alkoxyacetylamino group and an aryloxyacetylamino group.

R²¹ is preferably an alkyl group among a hydrogen atom, an alkyl group and an acylamino group.

On the other hand, R²², among a hydrogen atom, an alkyl group and an acylamino group, is preferably a hydrogen atom or an unsubstituted alkyl group with 1 to 24 carbon atoms, such as a methyl group, an isopropyl group or a t-butyl group.

R²¹ and R²² are not 2-hydroxyphenylmethyl groups, nor, at the same time, hydrogen atoms.

R²³ represents a hydrogen atom or an alkyl group, and is preferably a hydrogen atom or an alkyl group with 1 to 30 carbon atoms, and more preferably a hydrogen atom or an unsubstituted alkyl group with 1 to 24 carbon atoms. The explanations for R²² applies to the alkyl group represented by R²³. R²³ is, for example, a methyl group, an isopropyl group or a t-butyl group.

Either of R²² and R²³ is preferably a hydrogen atom.

R²⁴ represents a group substitutable on the benzene ring, and examples thereof are the same as those represented by R¹² or R^{12′} of the compound of formula (R). R²⁴ is preferably a substituted or unsubstituted alkyl group with 1 to 30 carbon atoms, or an oxycarbonyl group with 2 to 30 carbon atoms, and more preferably an alkyl group with 1 to 24 carbon atoms. The substituent of the substituted alkyl group can be an aryl group, an amino group, an alkoxy group, an oxycarbonyl group, an acylamino group, an acyloxy group, an imide group or an ureido group, and is preferably an aryl group, an amino group, an oxycarbonyl group or an alkoxy group.

The compound of formula (P) preferably has a structure represented by formula (P-2).

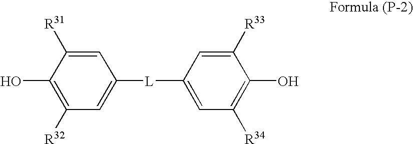

In the formula, R³¹, R³², R³³ and R³⁴ each independently represent a hydrogen atom, or a substituted or unsubstituted alkyl group with 1 to 20 carbon atoms. R³¹ and R³², or R³³ and R³⁴ are not hydrogen atoms at the same time. R³¹, R³², R³³ and R³⁴ each independently is preferably an alkyl group with 1 to 10 carbon atoms. The substituent of the substituted alkyl group is not particularly restricted, but is preferably an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group, or a halogen atom. It is preferable that at least one of R³¹, R³², R³³ and R³⁴ is at least a group sterically equal to or larger than an isopropyl group (such as an isopropyl group, an isononyl group, a t-butyl group, a t-amyl group, a t-octyl group, a cyclohexyl group, a 1-methyl-cyclohexyl group or an adamantyl group). It is more preferable that at least two of R³¹, R³², R³³ and R³⁴ are such groups. A tert-alkyl group sterically larger than an isopropyl group, such as t-butyl, t-octyl or t-amyl, is particularly preferable.

L has the same meaning as L in the compound of formula (R), and is preferably a —CHR¹³— group.

R¹³ preferably represents a hydrogen atom or an alkyl group with 1 to 15 carbon atoms, and, the alkyl group is preferably a chain alkyl group or a cyclic alkyl group. Also an alkyl group having a C═C bond can also be preferably employed as such. The alkyl group can be, for example, a methyl group, an ethyl group, a propyl group, an isopropyl group, a 2,4,4-trimethylpentyl group, a cyclohexyl group, a 2,4-dimethyl-3-cyclohexenyl group or a 3,5-dimethyl-3-cyclohexenyl group. R¹³ is particularly preferably a hydrogen atom, a methyl group, an ethyl group, a propyl group, an isopropyl group, or a 2,4-dimethyl-3-cyclohexenyl group.

In the case where R¹¹ and R^{11′} are tertiary alkyl groups and R¹² and R^{12′} are methyl groups, R¹³ is preferably a primary or secondary alkyl group with 1 to 8 carbon atoms (such as a methyl group, an ethyl group, a propyl group, an isopropyl group, or a 2,4-dimethyl-3-cyclohexenyl group).

In the case where R¹¹ and R^{11′} are tertiary alkyl groups and R¹² and R^{12′} are alkyl groups other than a methyl group, R¹³ is preferably a hydrogen atom.

In the case where R¹¹ and R^{11′} are not tertiary alkyl groups, R¹³ is preferably a hydrogen atom or a secondary alkyl group, and more preferably a secondary alkyl group. The secondary alkyl group for R¹³ is preferably an isopropyl group or a 2,4-dimethyl-3-cyclohexenyl group.

In the following, specific examples of the compounds represented by formulas (P) and (P-2) are shown, but these examples are not restrictive. 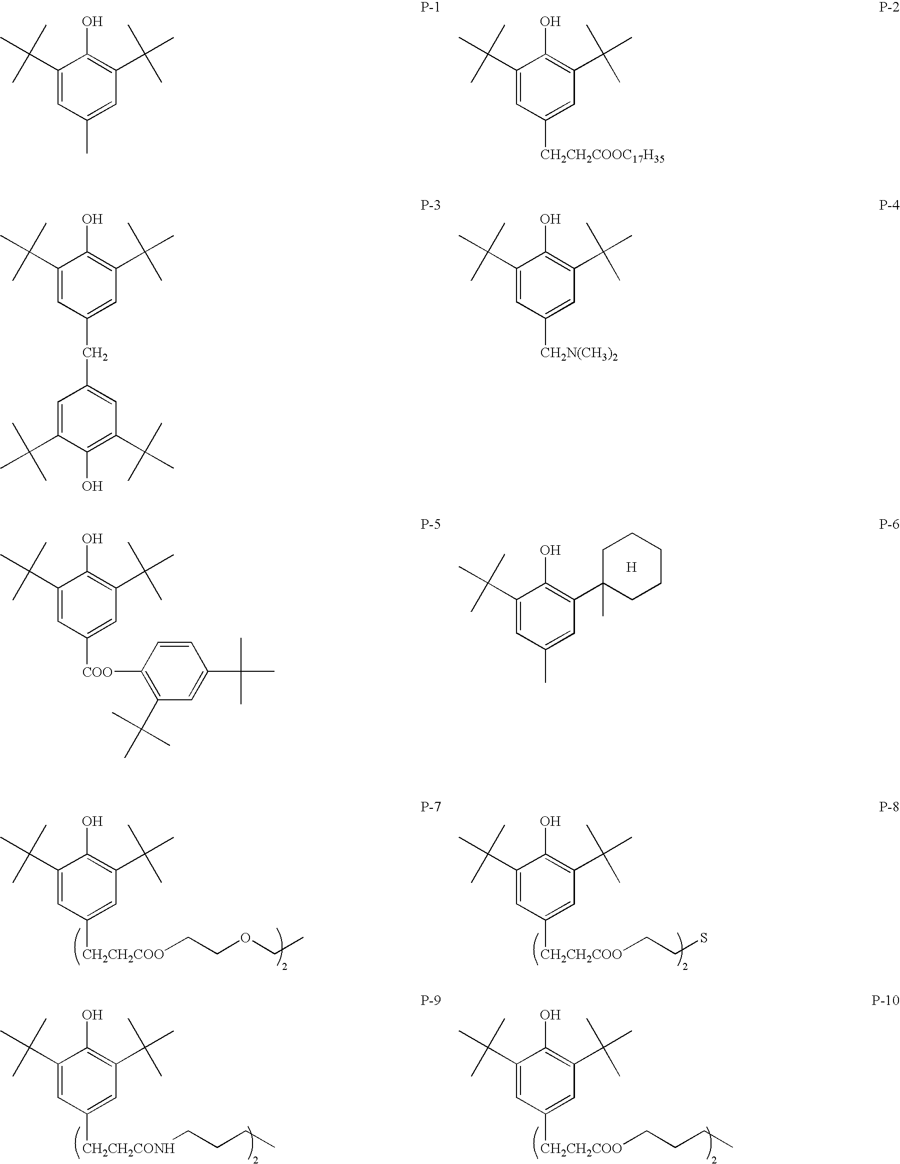 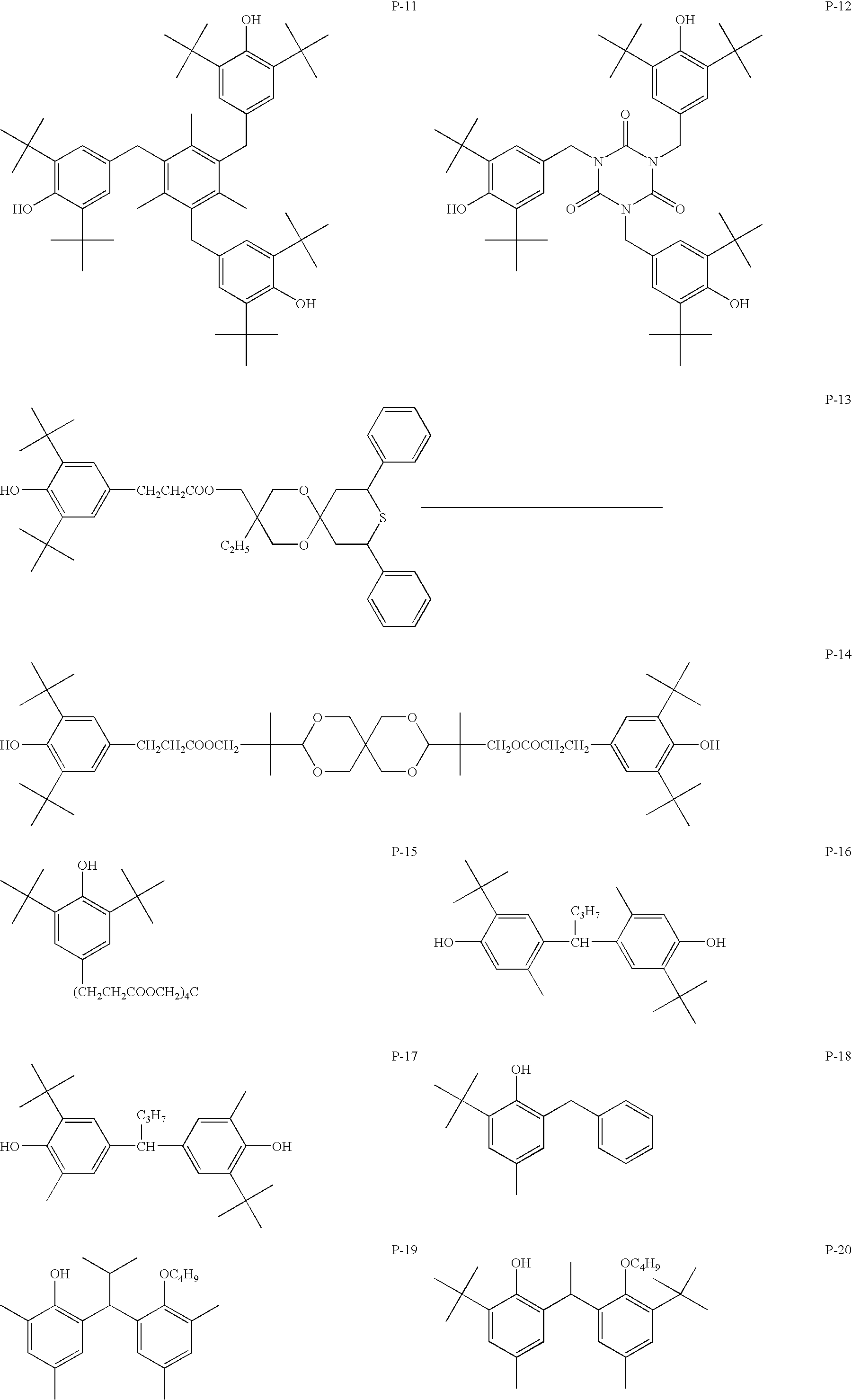 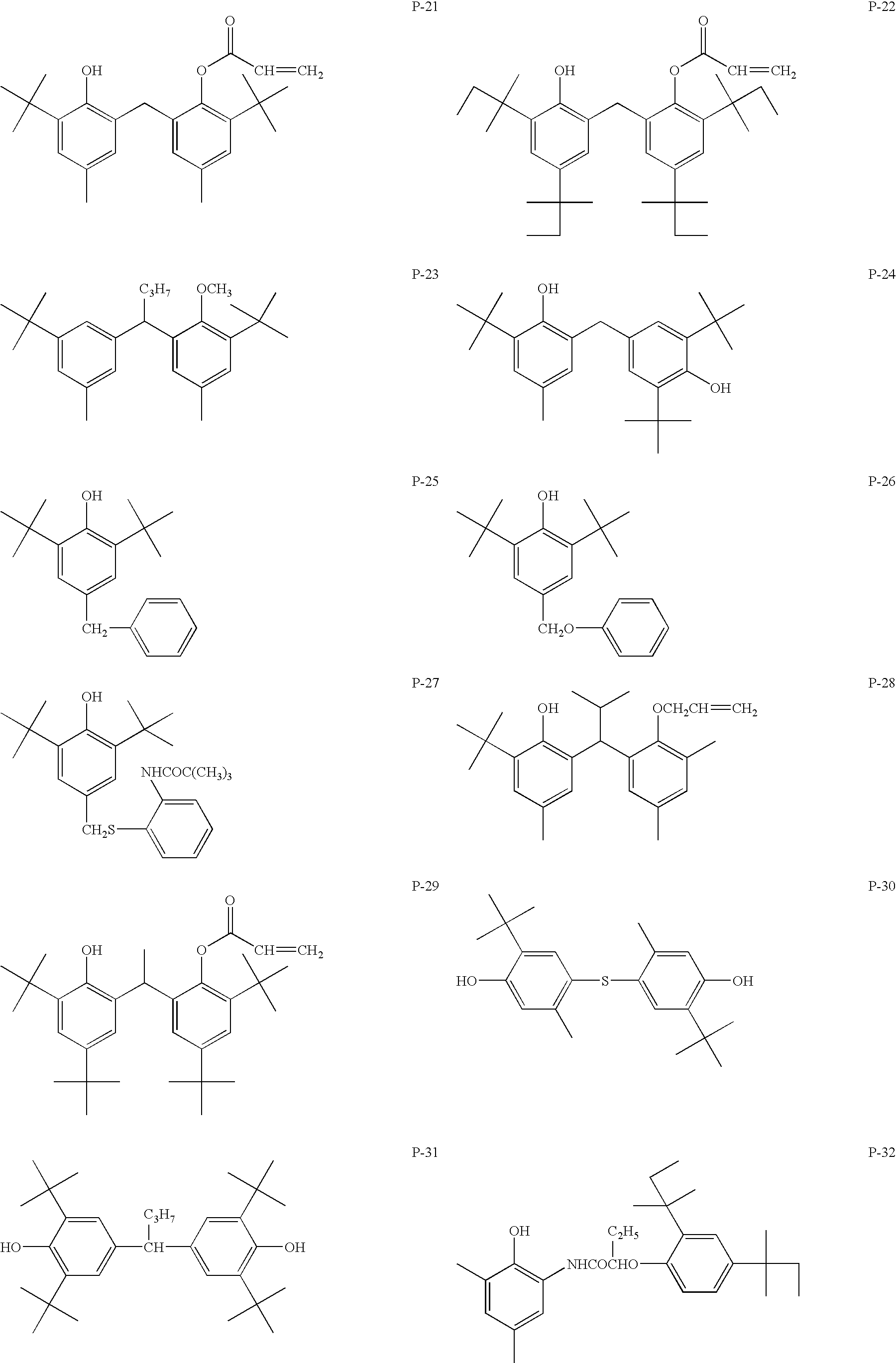 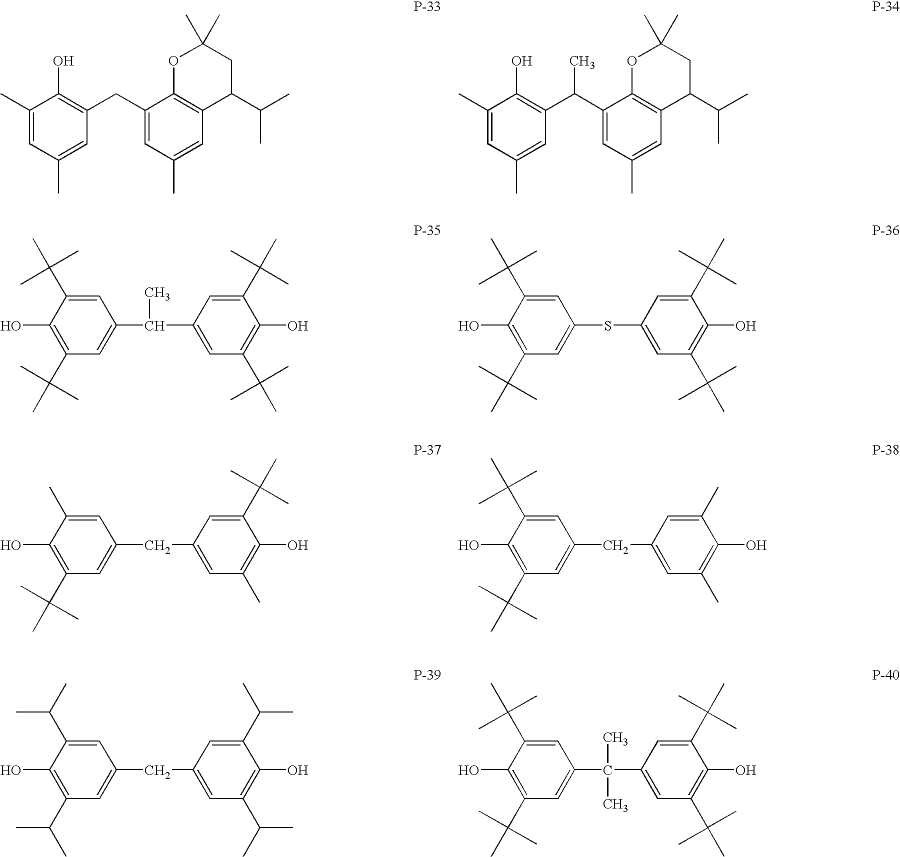
2) Coupler

Another color tone regulating agent is a coupler which develops a color when coupling with the oxidant of a reducing agent at the time of thermal development. The coupler is described in JP-A Nos. 2002-311533, 2002-328444, 2002-318432, 2002-221768, 2002-287296, and 2002-296731, and Japanese Patent Application No. 2001-067988. A desired color can be developed by a suitable combination of a reducing agent and a coupler.

The color tone regulating agent may be contained in the coating liquid and in the photosensitive material in any form, for example, a solution, an emulsified dispersion or a dispersion of fine solid particles.

One of methods for preparing an emulsified dispersion is executed by dissolving the color tone regulating agent in oil such as dibutyl phthalate, tricresyl phosphate, glyceryl triacetate or diethyl phthalate, or an auxiliary solvent such as ethyl acetate or cyclohexanone, followed by mechanical preparation of an emulsified dispersion.

To disperse solid particles, there can be employed a method of dispersing powder of a compound in a suitable solvent such as water with a ball mill, a colloid mill, a vibrating ball mill, a sand mill, a jet mill, a roller mill or ultrasonic wave to obtain a solid dispersion. In such method, there may be employed a protective colloid (such as polyvinyl alcohol) or a surfactant (for example an anionic surfactant such as sodium triisopropylnaphthalenesulfonate (a mixture of compounds with different substituting positions of three isopropyl groups). The aqueous dispersion can include an antiseptic (such as sodium salt of benzoisothiazolinone).

The color tone regulating agent is preferably included in the image forming layer containing the organic silver salt. In the case where the image forming layer is composed of plural layers, they may be included in different layers among the plural layers.

The ratio (molar ratio) of the color tone regulating agent added is preferably within a range of 0.001 to 0.2 with respect to the reducing agent represented by formula (R), more preferably 0.005 to 0.1 and still more preferably 0.008 to 0.05.
3) Plasticizer

The photothermographic material of the invention can contain a known plasticizer to improve physical properties of the films. The plasticizer employable in the image forming layer and in the non-photosensitive layer is preferably one described in JP-A No. 11-65021, paragraph 0117, JP-A No. 2000-5137, Japanese Patent Applications Nos. 2003-8015, 2003-8071 and 2003-132815.
4) Dye and/or Pigment

For the purposes of color tone improvement, prevention of interference fringes at the time of laser exposure and prevention of irradiation, the image forming layer may contain any dye and/or pigment (for example, C. I. Pigment Blue 60, C. I. Pigment Blue 64, or C. I. Pigment Blue 15:6). These are described in detail for example in WO98/36322, and JP-A Nos. 10-268465 and 11-338098.
5) Super High Contasting Agent

To form a super high contrast image suitable for printing plate-mnaking, the image forming layer preferably contain an ultra-hard gradation enhancing agent. The super high contasting agent, a method of addition thereof and an amount of addition thereof are described for example in JP-A No. 11-65021, paragraph 0118, JP-A No. 11-223898, paragraphs 0136-0193, JP-A No. 2000-284399, formulas (H), (1) to (3), (A) and (B), Japanese Patent Application No. 11-91652, formulas (III) to (V) (specific compounds in formulas 21-24), while a contrasting accelerating agent is described in JP-A No. 11-65021, paragraph 0102 and JP-A No. 11-223898, paragraphs 0194-0195.

In order to employ formic acid or formate as a strong fogging substance, it is preferably contained in a layer or layers disposed on a side having the image forming layer containing a photosensitive silver halide, in an amount of 5 mmol. or less per mole of silver, and more preferably 1 mmol. or less.

In the case where the ultra-hard gradation enhancing agent is included in the photothermographic material of the invention, it is preferable to use, in combination, an acid formed by hydration of phosphorous pentoxide or a salt thereof. Examples of the acid formed by hydration of phosphorous pentoxide and a salt thereof include metaphosphoric acid (and salts thereof), pyrophosphoric acid (and salts thereof), orthophosphoric acid (and salts thereof), triphosphoric acid (and salts thereof), tetraphosphoric acid (and salts thereof), and hexametaphosphoric acid (and salts thereof). An acid formed by hydration of phosphorous pentoxide or a salt thereof, which can be particularly preferably employed, is orthophosphoric acid (or a salt thereof), or hexametaphosphoric acid (or a salt thereof). Specific examples of the salt include sodium orthophosphate, sodium dihydrogen orthophosphate, sodium hexametaphosphate and ammonium hexametaphosphate.

The amount (coating amount per m² of the photosensitive material) of the acid formed by hydration of phosphorous pentoxide or the salt thereof may be suitably selected according to desired properties such as sensitivity or fog level, however is preferably 0.1 to 500 mg/m² and more preferably 0.5 to 100 mg/m².

Preparation and Application of Coating Liquid

A coating liquid for the image forming layer is preferably prepared at a temperature from 30° C. to 65° C., more preferably at a temperature not less than 35° C. but less than 60° C., and still more preferably a temperature from 35° C. to 55° C. The coating liquid for the image forming layer is preferably maintained, immediately after addition of polymer latex, at a temperature from 30° C. to 65° C.

(6) Other Layer Configuration and Components

1) Antihalation Layer

In the photothermographic material of the invention, an antihalation layer may be provided on a side farther than the image forming layer from the exposure light source.

The antihalation layer is described in JP-A No. 11-65021, paragraphs 0123-0124, JP-A Nos. 11-223898, 9-230531, 10-36695, 10-104779, 11-231457, 11-352625 and 11-352626.

The antihalation layer includes an antihalation dye having an absorption in the exposing wavelength. In the case where the exposure wavelength is in the infrared region, an infrared-absorbing dye may be employed as such. In such case, the dye preferably has no absorption in the visible region.

In the case where antihalation is prevented with a dye having an absorption in the visible region, it is preferable that the color of the dye does not substantially remain after image formation. It is preferable to eliminate the color with heat at the time of thermal development. It is particularly preferable to contain a dye whose color vanishes with heat and a base precursor in the non-photosensitive layer serving as an antihalation layer. Such technique is described for example in JP-A No. 11-231457.

The amount of the color-removable dye depends on the purpose thereof. In general, it is used in such an amount that the optical density (absorbance) measured at an objective wavelength is higher than 0.1. The optical density is preferably within a range from 0.15 to 2, and more preferably 0.2 to 1. The amount of the dye necessary to obtain an optical density in the above range is generally within a range of about 0.001 to 1 g/m².

By removing the color of the dye in this manner, it is possible to reduce the optical density after thermal development to 0.1 or less. It is also possible to use two or more color-removable dye in a thermally color-removable recording material or in a photothermographic material. Similarly, it is possible to use two or more base precursors in combination.

As described in JP-A No. 11-352626, it is preferable to use a substance that can lower the melting point by 3° C. or more when mixed with a base precursor, such as diphenylsulfon, 4-chlorophenyl (phenyl)sulfon or 2-naphthyl benzoate, in such thermal color removal utilizing a thermally color-removable dye and the base precursor from the viewpoint of thermal color-removing property.
2) Back Layer

A back layer that can be employed in the invention is described in JP-A No. 11-65021, paragraphs 0128-0130.

The photothermographic material of the invention may contain a coloring agent having an absorption maximum at 300 to 450 nm in order to improve the color tone of silver image and change of the image over time. The coloring agent is described for example in JP-A Nos.62-210458,63-104046, 63-103235, 63-208846, 63-306436, 63-314535, 01-61745 and 2001-100363.

The photothermographic material of the invention is preferably a so-called one-sided photosensitive material having at least one image forming layer containing a silver halide emulsion on one side of a substrate and a back layer on the other side.
3) Film Surface pH

The photothermographic material of the invention preferably has a film surface pH of 7.0 or less before thermal development, and more preferably 6.6 or less. The lower limit of the film surface pH is not particularly restricted but is generally about 3. The film surface pH is most preferably from 4 to 6.2. To decrease the film surface pH, there is preferably employed an organic acid such as a phthalic acid derivative, a non-volatile acid such as sulfuric acid, or a volatile base such as ammonia. In particular, ammonia is preferable in attaining a low film surface pH, as it is easily volatile and can be removed in a coating step or before thermal development.

It is also preferable to employ a non-volatile base such as sodium hydroxide, potassium hydroxide or lithium hydroxide in combination with ammonia. A method for measuring a film surface pH is described in JP-A No. 2000-284399, paragraph 0123.
4) Film Hardening Agent

A film hardening agent may be contained in the image forming layer, the protective layer, and/or the back layer. Examples of the film hardening agent are described in T. H. James, “The Theory of the Photographic Process Fourth Edition” (Macmillan Publishing Co. Inc., 1977) pp. 77-87, and chromium alum, sodium salt of 2,4-dichloroydroxy-s-triazine, N,N-ethylenebis (vinylsulfonacetamide), N,N-propylenebis(vinylsulfonacetamide), a polyvalent metal ion described in p. 78 of the aforementioned reference, a polyisocyanate described in U.S. Pat. No. 4,281,060, or JP-A No. 6-208193, an epoxy compound described in U.S. Pat. No. 4,791,042, and a vinylsulfone compound described in JP-A No. 62-89048 can be used as such.

The film hardening agent is added as a solution to a coating liquid for a protective layer, and a timing at which the solution is added to the coating liquid is generally within a period starting at 180 minutes before coating operation and ending immediately before the coating operation, and preferably within a period starting at 60 minutes before the coating operation and ending at 10 seconds before the coating operation. However, a mixing method and mixing conditions are not particularly restricted, as long as the effect of the invention can be sufficiently exhibited. Specific examples of the mixing method include a mixing method conducted in a tank so that an average residence time calculated from an addition flow rate and a rate at which liquid is supplied to a coater becomes a desired value and a method utilizing a static mixer described in N. Harnby, M. F. Edwards, A. W. Nienow, “Liquid Mixing Technique” (translated by Koji Takahashi, Nikkan Kogyo Shimbunsha, 1989), chapter 8.
5) Antistatic Agent

The photothermographic material of the invention preferably contains an electrically conductive layer including a metal oxide or an electrically conductive polymer or an antistatic layer. The antistatic layer may also serve as an undercoat layer, a back layer or a surface protective layer, or may be formed as a layer different from these layers.

As the electrically conductive polymer compound, there can be employed a polyvinylbenzenesulfonate, polyvinylbenzyl trimethylammonium chloride, a quaternary salt polymer described in U.S. Pat. Nos. 4,108,802, 4,118,231, 4,126,467 and 4,137,217, and/or a polymer latex described in U.S. Pat. No. 4,070,189, OLS 2,830,767, and JP-A Nos. 61-296352 and 61-62033.

However, the electrically conductive layer most preferably contains an electrically conductive metal oxide to sufficiently lower a side surface resistance of the photosensitive material. Preferable examples of the metal oxide include ZnO, TiO₂ and SnO₂, and there is preferred addition of Al and/or In to ZnO, addition of Sb, Nb, P and/or a halogen element to SnO₂, or addition of Nb, and/or Ta to TiO₂. SnO₂ including Sb added thereto is particularly preferable. The amount of the different element is preferably within a range of 0.01 to 30 mol. %, and more preferably 0.1 to 10 mol. %. The shape of the metal oxide can be spherical, acicular or plate-shaped, but, in consideration of the effect of providing electrical conductivity, is preferably an acicular shape with a longer axis/shorter axis ratio of 2.0 or higher, and preferably 3.0 to 50. The amount of the metal oxide is preferably within a range of 1 to 1000 mg/m², more preferably 10 to 500 mg/m², and still more preferably 20 to 200 mg/m². The antistatic layer may be provided on an emulsion side or a back side, but is preferably provided between the substrate and the back layer. Specific examples of the antistatic layer are described in JP-A No. 11-65021, paragraph 0135, JP-A Nos. 56-143430, 56-143431, 58-62646, and 56-120519, JP-A No. 11-84573, paragraphs 0040-0051, U.S. Pat. No. 5,575,957 and JP-A No. 11-223898, paragraphs 0078-0084.
6) Substrate

The substrate of the photothermographic material of the invention can be transparent. The transparent substrate is preferably a polyester, particularly polyethylene terephthalate, subjected to heat treatment at a temperature in the range of 130 to 185° C. in order to relax internal strain remaining in the film at the time of biaxial orientation and to thereby eliminate thermal shrinking strain occurding at the time of thermal development. In the case of a photothermographic material for medical use, the transparent substrate may be colored with a blue dye (for example a dye 1 described in Examples of JP-A No. 8-240877), or may be colorless. The substrate is preferably undercoated with, for example, a water-soluble polyester described in JP-A No. 11-84574, a styrene-butadiene copolymer described in JP-A No. 10-186565, or a vinylidene chloride copolymer described in JP-A No. 2000-39684 and Japanese Patent Application No. 11-106881, paragraphs 0063-0080. At the time of coating of an image forming layer or a back layer on the substrate, the substrate preferably has a moisture content of 0.5 mass % or less.
7) Other Additives

The photothermographic material may further contain an antioxidant, a stabilizer, a plasticizer, an ultraviolet absorbent or an auxiliary coating agent. These additives are contained in the image forming layer or in the non-photosensitive layer. As these additives, for example, WO No. 98/36322, EP No. 803764A1, JP-A Nos. 10-186567 and 10-18568 can be seen.
8) Coating Method

The photothermographic material of the invention may be prepared in accordance with any coating method. More specifically, various coating methods are applicable, including extrusion coating, slide coating, curtain coating, dip coating, knife coating, flow coating and extrusion coating utilizing a hopper described in U.S. Pat. No. 2,681,294, and there is preferably employed extrusion coating or slide coating described in Stephen F. Kistler and Petert M. Schweizer, “Liquid Film Coating” (Chapman & Hall, 1997), pp. 399-536. The coating is particularly preferably slide coating. The shape of a slide coater to be used in the slide coating is shown in FIG. 11b.1 in the above-mentioned reference, p. 427. If desired, two or more layers can be simultaneously formed in accordance with a method described in the above-mentioned reference, pp. 399-536, or a method described in U.S. Pat. No. 2,761,791 or BP No. 837,095. A coating method particularly preferable in the invention is a method described in JP-A Nos. 2001-194748, 2002-153808, 2002-153803, and 2002-182333.

The coating liquid for the image forming layer is preferably so-called thixotropic fluid. As for such technique, JP-A No.11-52509 can be seen. The coating liquid for the image forming layer preferably has a viscosity at a shear speed of 0.1 S⁻¹ within a range from 400 to 100,000 mPa·s, and more preferably 500 to 20,000 mPa·s. The viscosity at a shear speed of 1000 S⁻¹ is preferably within a range from 1 to 200 mPa·s, and more preferably 5 to 80 mPa·s.

When two liquids are mixed in preparing a coating liquid, there is preferably employed a known in-line mixer or in-plant mixer. An in-line mixer and an in-plant mixer preferred in the invention are described in JP-A Nos. 2002-85948 and 2002-40940, respectively.

A coating liquid is preferably defoamed in order to provide a satisfactory coated surface. A deforming process preferable in the invention is described in JP-A No. 2002-6643 1.

In coating a coating liquid, the charge of the substrate, if any, is preferably eliminated in order to prevent deposition of dusts on the substrate. A charge eliminating method preferable in the invention is described in JP-A No.2002-143747.

In the invention, it is important to precisely control a drying air and a drying temperature in drying a noneettable coating liquid for an image forming layer. A drying method preferred in the invention is described in detail in JP-A Nos. 2001-194749 and 2002-139814.

In order to improve a film forming property, heat treatment is preferably conducted immediately after coating and drying in preparing the photothermographic material of the invention. In the heat treatment, the film surface temperature is preferably within a range of 60 to 100° C. and the heating time is preferably 1 to 60 seconds. More preferably, the film surface temperature is within a range of 70 to 90° C., and the heating time is within a range of 2 to 10 seconds. A method of heat treatment preferred in the invention is described in JP-A No.2002-107872.

Also for continuous manufacture of the photothermographic material of the invention in stable manner, there is preferably employed a producing method described in JP-A Nos. 2002-156728 and 2002-182333.

The photothermographic material is preferably a mono-sheet type (capable of forming an image on the photothermographic material without the use of another sheet such as an image-receiving material).
9) Packaging Material

The photothermographic material of the invention is preferably packaged in a packaging material of a low oxygen permeation rate and/or a low moisture permeation rate in order to avoid fluctuation of the photographic properties during storage of an unprocessed stock or to improve curling or bending of the material. The oxygen permeation rate at 25° C. is preferably 50 ml/atm/m²·day or less, more preferably 10 ml/atm/m²·day or less, and still more preferably 1.0 ml/atm/m²·day or less. The moisture permeation rate is preferably 10 g/atm/m²·day or less, more preferably 5 g/atm/m² day or less, and still more preferably 1 g/atm/m²·day or less.

Specific examples of the packaging material of a low oxygen permeation rate and/or a low moisture permeation rate include those described in JP-A Nos. 8-254793 and 2000-206653.

In the invention, a cutting step of cutting a sheet-shaped recording material into a predetermined size and a packaging step of packaging the cut recording material in a packaging material are preferably executed in an environment whose cleanness is class 10,000 or less stipulated in the U.S. federal standard 209d. It is more effective to clean the packaging material prior to the packaging step.

The cleanness, measured in accordance with a measuring method stipulated in the U.S. standard 209d, in the cutting step is preferably class 7,000 or less, more preferably 4,000 or less, still more preferably 1,000 or less and most preferably 500 or less. The cleanness, measured in accordance with a measuring method stipulated in the U.S. standard 209d, in the packaging step is preferably class 7,000 or less, more preferably 4,000 or less, still more preferably 1,000 or less and most preferably 500 or less.

In the invention, executing the cutting step and/or the packaging step in an environment of a cleanness of class 10,000 or less stipulated in the U.S. federal standard 209d significantly reduces generation of image defects at the time of image recording on a sheet-shaped recording material. More specifically, it can minimize generation of white spots or scratch at the time of image recording on the sheet-shaped recording material.

In the invention, the packaging material for the sheet-shaped recording material is preferably selected from materials which do not easily generate dusts. It is preferable not to select a packaging material which generates dusts preventing the cleanness of the environment from being kept at class 10,000 or less stipulated in the U.S. federal standard 209d.
10) Other Applicable Techniques

Techniques applicable to the photothermographic material of the invention are described in, for example, EP No. 803764A1, EP No. 883022A1, WO No.98/36322, JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2001-200414, 2001-234635, 2002-020699, 2001-275471, 2001-275461, 2000-313204, 2001-292844, 2000-324888, 2001-293864, 2001-348546 and 2000-187298.

In a multi-color photothermographic material, the image forming layers are separated from each other, as described in U.S. Pat. No. 4,460,681, by disposing a functional or non-functional barrier layer between the photosensitive layers (image forming layers).

In a multi-color photothermographic material, a combination of these two layers may be provided for each color, or all the components may be included in a single layer as described in U.S. Pat. No. 4,708,928.

3. Image Forming Method

1) Exposure

The photothermographic material of the first aspect of the invention forms an image by X-ray irradiation. The image formation method using X-ray includes the following steps.
(1) step of obtaining an image forming assembly by disposing a photothermographic material having image forming layers on both sides between a pair of X-ray intensifying screens, or bring a photothermographic material having an image forming layer on only one side into contact with a X-ray intensifying screen;
(2) step of positioning an inspected object between the image forming assembly and an X-ray source;
(3) step of irradiating the inspected object with an X-ray of an energy level of 25 to 125 kVp;
(4) step of extracting the photothermographic material from the assembly; and
(5) step of heating the photothermographic material at a temperature within a range of 90 to 180° C.

The photothermographic material for use in the assembly is preferably such that an image obtained by stepwise exposing the photothermographic material with X-rays followed by thermal development thereof has a characteristic curve that is drawn on an orthogonal coordinate in which the coordinate axis unit lengths of optical density (D) and light exposure logarithm (log E) are equal to each other, and in which characteristic curve an average gamma (γ) formed by a point, whose density is the sum of a minimum density (Dmin) and 0.1, and a point, whose density is the sum of the minimum density (Dmin) and 0.5, is from 0.5 to 0.9, and in which characteristic curve an average gamma (γ) formed by a point, whose density is the sum of the minimum density (Dmin) and 1.2, and a point, whose density is the sum of the minimum density (Dmin) and 1.6, is from 3.2 to 4.0. When the photothermographic material with the characteristic curve is used in an X-ray photographing system, an X-ray image having excellent photographic properties such as a remarkably extended leg and high gamma at a medium density area can be obtained. Thanks to the photographic properties, depiction becomes good in a low density region in which an X-ray transmission amount is small such as a mediastinum region or heart shadow, and an image of a lung field region where an X-ray transmission amount is large have a density which can be easily seen, and contrast becomes good.

The photothermographic material having the above-described preferable characteristic curve can be easily produced by, for example, a method in which each of the image-forming layers on both sides is constructed by two or more layers of silver halide emulsion layers having different sensitivities. In particular, it is preferable to form the image-forming layers by using an emulsion having a high sensitivity in an upper layer and an emulsion having a low sensitivity and contrasty photographic characteristics in a lower layer. When the image-forming layer including such two layers is employed, the ratio (sensitivity difference) of the sensitivity of the silver halide emulsion of the upper layer to that of the lower layer is from 1.5 to 20, and preferably from 2 to 15. The ratio of the amount of the emulsion contained in the upper layer to that in the lower layer depends on sensitivity difference and covering power of emulsions to be used. Generally, the larger the sensitivity difference, the smaller the percentage of the amount of the emulsion having a high sensitivity. For example, when the sensitivity difference is two and the covering powers of the two emulsions are approximately the same, the ratio of the amount of the emulsion having a high sensitivity to that of the emulsion having a low sensitivity is in the range of 1:20 to 1:50 in terms of silver amount.

For crossover cut (double-sided photosensitive material) and antihalation (single-sided photosensitive material), a dye, or a combination of a dye and a mordant described in JP-A No. 2-68539, page 13, left lower column, line 1 to page 14, left lower column, line 9, may be employed.

The basic structure of the X-ray intensifying screen has a support and a phosphor layer disposed on one side of the support. In the phosphor layer, a phosphor is dispersed in a binder. A transparent protective coat is provided on the surface of the phosphor layer opposite to the support (the surface not facing the support) to protect the phosphor layer from chemical change or mechanical shock.

In the invention, typical examples of the phosphor include tungstate phosphor (e.g., CaWO₄, MgWO₄, and CaWO₄:Pb), terbium-activated rare earth oxysulfide phosphor (e.g., Y₂O₂S:Tb, Gd₂O₂S:Tb, La₂O₂S:Tb, (Y,Gd)₂O₂S:Tb, and (Y,Gd)O₂S:Tb,Tm), terbium-activated rare earth phosphate phosphor (e.g., YPO₄:Tb, GdPO₄:Tb, and LaPO₄:Tb), terbium-activated rare earth oxyhalide phosphor (e.g., LaOBr:Tb, LaOBr:Tb,Tm, LaOCl:Tb, LaOCl:Tb,Tm, LaOBr:Tb, GdOBr:Tb, and GdOCl:Tb), thulium-activated rare earth oxyhalide phosphor (e.g., LaOBr:Tm, and LaOCl:Tm), barium sulfate phosphor (e.g., BaSO₄:Pb, BaSO₄:Eu²⁺, and (Ba,Sr)SO₄:Eu²⁺), bivalent europium-activated alkaline earth metal phosphate phosphor (e.g., (Ba₂PO₄)₂:Eu²⁺, and (Ba₂PO₄)₂:Eu²⁺), bivalent europium-activated alkaline earth metal fluorohalide phosphor (e.g., BaFCl:Eu²⁺, BaFBr:Eu²⁺, BaFCl:Eu²⁺,Tb, BaFBr:Eu²⁺,Tb, BaF₂.BaCl.KCl:Eu²⁺, and (Ba,Mg)F₂.BaCl.KCl:Eu²⁺), iodide phosphor (e.g., CsI:Na, CsI:T1, NaI, and KI:T1), sulfide phosphor (e.g., ZnS:Ag(Zn,Cd)S:Ag, (Zn,Cd)S:Cu, and (Zn,Cd)S:Cu,Al), hafnium phosphate phosphor (e.g., HfP₂O₇:Cu), YTaO₄, and YTaO₄ into which any activator is incorporated as an emission center. However, the phosphor for use in the invention is not restricted to them, and any phosphor which can emit light in the visible or near ultraviolet region due to irradiation of radiation may be employed.

The X-ray intensifying screen is preferably phosphor intensifying paper, and more preferably has phosphor filled with a graded particle size structure. In particular, it is preferable to coat phosphor particles of a large particle size on the side of the surface protective layer and those of a small particle size on the side of the substrate. It is preferable that the small particles have a size of 0.5 to 2.0 μm and that the large particles have size of 10 to 30 μm.

An image forming method utilizing a photothermographic material of the first aspect of the invention preferably utilizes a phosphor having a principal peak at 400 nm or less. More preferably the image forming method utilizes a phosphor having a principal peak at 380 nm or less. Either of the double-sided photosensitive material and the one-sided photosensitive material can be utilized as an assembly. A screen having a principal light emission peak at 400 nm or less is described in JP-A No. 6-11804 and WO 93/01521, but such example is not restrictive. For ultraviolet crossover cut (double-sided photosensitive material) and antihalation (one-sided photosensitive material), technologies described in JP-A No. 8-76307 can be utilized. As an ultraviolet absorbing dye, a dye described in JP-A No. 2001-144030 is particularly preferable.

A silver halide emulsion of a high silver iodide content as employed in the third aspect of the invention has been difficult to use because of its low sensitivity. It is however found that recording with a high illumination intensity such as recording with laser light can avoid problems regarding low sensitivity and can achieve image recording with lower energy. A desired sensitivity can be attained by recording an image with such strong light within a short time.

To obtain an exposure amount providing a maximum density (Dmax), the amount of light on the surface of the photosensitive material is preferably 0.1 to 100 W/mm², more preferably 0.5 to 50 W/mm², and most preferably 1 to 50 W/mm².

As the laser light source in the invention, a semiconductor laser can be utilized. It is also possible to utilize a semiconductor laser and a second harmonic wave generator. The laser to be employed is preferably a blue light-emitting semiconductor laser.

A laser output apparatus of a short wavelength region has recently attracted particular attention, with the development of an integrated module of an SHG (second harmonic generator) element and a semiconductor laser, and of a blue light-emitting semiconductor laser. Demand for the blue light-emitting semiconductor laser is anticipated to increase hereafter, since such laser is capable of recording a high-definition image, achieving increased recording density and providing stable output with a long service life.

The peak wavelength of the laser light is generally 300 to 500 nm, and preferably 350 to 450 nm.

Laser light oscillating in a vertical multi mode, for example, by a high frequency superposing method can also be preferably employed.
2) Thermal Development

The photothermographic material of the invention may be developed in any method, but the development is usually executed by heating the photothermographic material which has been exposed imagewise. The developing temperature is prefearbly 80 to 250° C., more preferably 100 to 140° C., and still more preferably 110 to 130° C. The developing time is preferably 1 to 60 seconds, more preferably 3 to 30 seconds, still more preferably 5 to 25 seconds, and most preferably 7 to 16 seconds.

The photothermographic material of the invention can be developed even at a high transporting speed of 23 mm/sec or higher at the time of thermal development. Even if the photothermographic material has a composition suitable for rapid processing, it provides satisfactory storability because of the layer structure recited in the invention. The photothermographic material of the invention can be developed at 27 mm/sec or higher (28 mm/min or higher in the third aspect).

For thermal development, a drum heater or a plate heater can be employed, however a plate heater method is preferable. For thermal development with the plate heater method, a method described in JP-A No. 11-133572 is preferable, employing a thermal development apparatus which brings a photothermographic material with a latent image into contact with a heating means in a thermal development zone to obtain a visible image, wherein the heating means is a plate heater, and plural pressing rollers are positioned along a surface of the plate heater, and the photothermographic material passes through a nip portion formed between the pressing rollers and the plate heater to execute thermal development. It is preferable to divide the plate heater into 2 to 6 stages and to set the temperature of the first stage to a value lower than that of the other stages by 1 to 10° C. An example utilizes four plate heaters whose temperatures can be independently controlled and are respectively kept at 112, 119, 121 and 120° C. Such a method is also described in JP-A No. 54-30032, and can eliminate moisture or an organic solvent contained in the photothermographic material and can discharge it from the system, and can suppress change in the shape of the substrate of the photothermographic material which change usually results from rapid heating of a material.

To miniaturize the thermal developing apparatus and reduce the thermal developing time, stabler heater control is preferable. An imager capable of rapid processing preferable for the invention is described for example in Japanese Patent Application Nos. 2001-088832 and 2001-091114. Such imager can conduct thermal development at 14 seconds with three stage plate heaters kept at 107, 121 and 121° C. and can reduce output time for a first sheet to about 60 seconds. For such rapid processing, it is preferable to use the photothermographic material-2 of the invention having a high sensitivity and not susceptible to the environmental temperature together with such an apparatus.

A reduction in the distance between an exposure portion and a development portion results in an extremely short processing time for exposure and development. Such distance is preferably short in order to make a thermal development apparatus compact. The photothermographic material of the invention can provide an image without unevenness even when the distance between the exposure portion and the development portion is 50 cm or less, and the obtained image has satisfactory storability. The effects of the invention can also be obtained in the case where such distance is 3 to 40 cm.

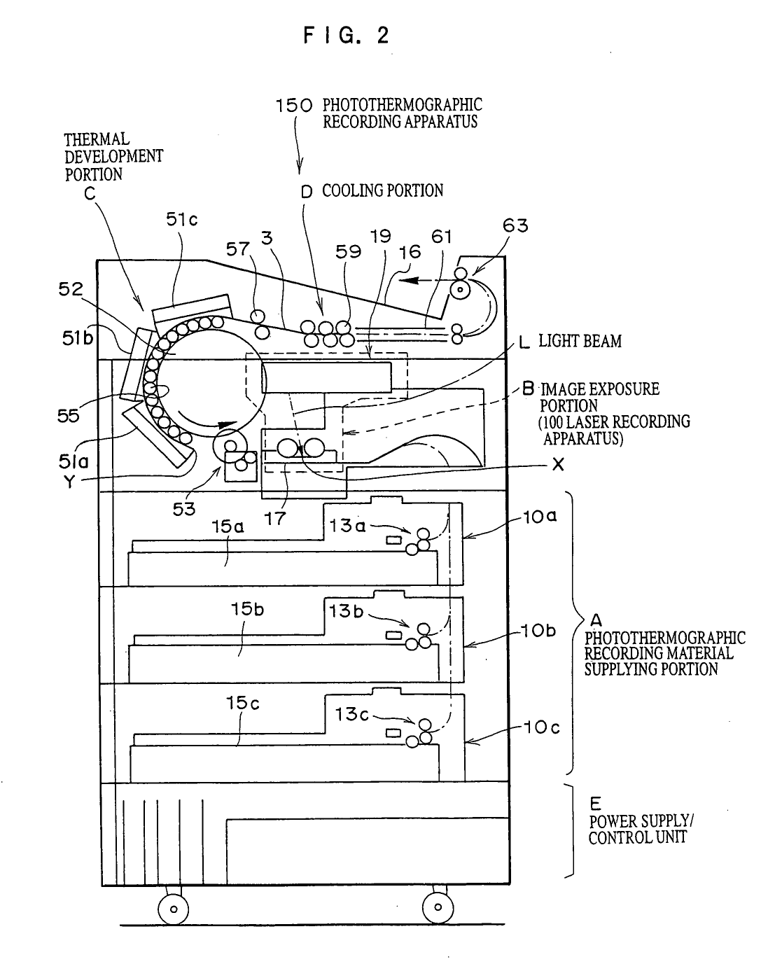

The exposure portion means a position where the photothermographic material is irradiated with light from an exposing light source. The development portion means a position where the photothermographic material is heated for the first time for thermal development. In FIG. 2, X indicates the exposure portion, and Y is the development portion where the photosensitive material transported from 53 in FIG. 1 comes into first contact with a plate 51a. The effects of the invention are obtained in a developing apparatus with the distance of 50 cm or less by employing the photothermographic material of the invention.

In particular, even when a part of a sheet-shaped photosensitive material is being exposed to light and an already exposed part of the photosensitive material is being developed, the photothermographic material of the invention eliminates a drawback in which the exposed part is contaminated by a volatile substance. Also, this method can shorten processing time.

In the case where the power supply of the thermal development apparatus is turned off during a night, the temperature of the thermal development portion is the same as room temperature. It is therefore difficult to obtain a stable output image immediately after the power supply is turned on, because the temperature of the portion has not reached a desired development temperature or because the hunching width of temperature is large. Thus, in order to attain the aforementioned preferable developing conditions, a time used to elevate the temperature of the thermal development portion and to stabilize the temperature is required.

Since the photothermographic material of the invention is less susceptible to the influence of external environment and has stable image output, it can provide a stable image even in severe developing conditions of starting development within a short time after the power supply is turned on.

For example, even in the case where the front end of the photothermographic material reaches the thermal development portion within 15 minutes after the power supply of the thermal development apparatus is turned on, the obtained image has satisfactory storage stability. The “front end of the photothermographic material” means a portion of the photothermographic material exposed and transported which portion reaches at first the heating part of the thermal development apparatus. The “thermal development portion” means such heating part.
3) System

Examples of a laser imager system for medical use having an exposure unit and a thermal development unit include Fuji Medical Dry Imager FM-DPL and DRYPIX 7000. The FM-DPL is described in Fuji Medical Review No. 8, p. 39-55, and such described technology is applicable to a laser imager for the photothermographic material of the invention. Also the photothermographic material of the invention can be utilized as a photothermographic material for a laser imager in an AD Network proposed by Fuji Medical Co. as a network system meeting the DICOM standard.

4. Application of Invention

The photothermographic material of the invention forms a black and white image by a silver image, and is preferably utilized as a photothermographic material for medical diagnosis, a photothermographic material for industrial photography, a photothermographic material for printing and a photothermographic material for COM.

### EXAMPLES

In the following, the present invention will be further clarified by examples thereof, but the invention is not limited by such examples.

### Example 1

1. Preparation of PET Substrate and Undercoat

1-1. Film Formation

PET was made of terephthalic acid and ethylene glycol in an ordinary manner and had an intrinsic viscosity IV of 0.66 (measured in a mixture of phenol and tetrachloroethane at a weight ratio of 6/4 at 25° C.). This was pelletized, and the resultant was dried at 130° C. for 4 hours. This pellet was colored with a blue dye, 1,4-bis(2,6,-diethylanilinoanthraquinone) and the resultant was extruded out from a T-die, and rapidly cooled. Thus, a non-oriented film was prepared.

The film was longitudinally oriented by rolls rotating at different circumferencial speeds at 110° C. so that the longitudinal length thereof after the orientation was 3.3 times as long as the original longitudinal length thereof. Next, the film was laterally oriented by a tenter at 130 ° C. so that the lateral length thereof after the orientation was 4.5 times as long as the original lateral length thereof. Next, the oriented film was thermally fixed at 240° C. for 20 seconds, and then laterally relaxed by 4% at the same temperature. Next, the chuck portion of the tenter was slitted, and the both edges of the film were knurled, and the film was rolled up at 4 kg/cm². The rolled film having a thickness of 175 μm was obtained.

1-2. Corona Discharging Processing of Surface

Both surfaces of this substrate were processed at a rate of 20 m/minute at room temperature by using a solid state corona processing machine (6 KVA model manufactured by Pillar Company). From values of current and voltage read at this time, it was found that the substrate had been processed at 0.375 kV.A.min/m². At this time, the processing frequency was 9.6 kHz, and a gap clearance between an electrode and a dielectric roll was 1.6 mm.

1-3. Preparation of Undercoated Substrate

(1) Preparation of Coating Liquid for Undercoat Layer

Formulation (1) for the undercoat layer on the photosensitive layer side

| | | |
|---|---|---|
| PESRESIN A-520 | 46.8 | g |
| (manufactured by Takamatsu Oil and Fats Co., Ltd.; | | |
| 30 mass % solution) | | |
| VYLONAL MD-1200 | 10.4 | g |
| (manufactured by Toyobo Co., Ltd.) | | |
| Polyethylene glycol monononyl phenyl ether | 11.0 | g |
| (average ethylene oxide number = 8.5, 1 mass % solution) | | |
| MP-1000 | 0.91 | g |
| (manufactured by Soken chemical & Engineering Co., Ltd.; | | |
| fine particles of PMMA polymer, average particle size: | | |
| 0.4 μm) | | |
| Distilled water | 931 | mL |

Each surface of the biaxially-oriented polyethylene terephthalate substrate having a thickness of 175 μm which had been subjected to the above-described corona discharge treatment was coated with the coating liquid for an undercoat having formulation (1) with a wire bar such that a wet coating amount became 6.6 ml/m² (per one side). Each of the resultant coatings was dried at 180 ° C. for 5 min. Thus, an undercoated substrate was prepared.

2. Preparation of Coating Materials

1) Silver Halide Emulsion
<<Preparation of Silver Halide Emulsion A>>

4.3 mL of a 1 mass % potassium iodide solution, 3.5 mL of 0.5 mol/L sulfuric acid, 36.5 g of phthalated gelatin and 160 mL of a 5 mass % methanol solution of 2,2′-ethylenedithio)diethanol were added to 1421 mL of distilled water. The resulting solution was kept at 75 ° C. in a stainless steel reaction pot while it was being stirred. Solution A was prepared by diluting 22.22 g of silver nitrate with distilled water such that the total volume of the resultant mixture was 218 mL. Soution B was prepared by diluting 36.6 g of potassium iodide with distilled water such that the total volume of the resultant mixture was 366 mL. These solutions A and B were added to the content in the reaction pot. At this time, the whole of solution A was added at a constant flow rate over 16 minutes. Moreover, solution B was added in accordance with a controlled double jet method while pAg was kept at 10.2. Then, 10 mL of a 3.5 mass % aqueous solution of hydrogen peroxide, and 10.8 mL of a 10 mass % aqueous solution of benzimidazole were added to the system. Solution C was prepared by diluting 51.86 g of silver nitrate with distilled water such that the total volume of the resultant mixture was 508.2 mL. Moreover, Solution D was prepared by diluting 63.9 g of potassium iodide with distilled water such that the total volume of the resultant mixture was 639 mL. These solutions C and D were added to the system. At this time, the whole of Solution C was added at a constant flow rate over 80 minutes. Moreover, Solution D was added in accordance with a controlled double jet method while pAg was kept at 10.2. When ten minutes had lapsed since staring of addition of Solutions C and D, potassium hexachloroiridate (III) was added to the system in an amount of 1×10 mol per mol of silver. Further, when five seconds had lapsed since completion of addition of Solution C., an aqueous solution of potassium hexacyanoiron (II) was added to the system in an amount of 3×10⁻⁴ mol per mol of silver. 0.5 mol/L sulfuric acid was added to the system so as to adjust pH of the system to 3.8. Then stirring was stopped, and precipitating/desalting/washing steps were carried out. One mol/L sodium hydroxide was added to the system so as to adjust pH of the system to 5.9 and then a silver halide dispersion having pAg of 11.0 was prepared.

Silver halide grains in the obtained silver halide dispersion A were made of pure silver iodide, and included tabular grains having an average projected area diameter of 0.93 μm, a coefficient of variation of the average projected area diameter of 17.7%, an average thickness of 0.057 μm, and an average aspect ratio of 16.3. The entire projected area of the tabular grains corresponded to 80% or more of the entire projected area of all the silver halide grains. The sphere-corresponding diameter thereof was 0.42 μm. A result of X-ray powder diffraction analysis showed that 90% or more of the silver iodide had gamma phase.
<<Preparation of Silver Halide Emulsion B>>

One mole of the tabular grain AgI emulsion prepared as the silver halide emulsion A was put into a reaction pot. A pAg value measured at 38° C. was 10.2. Then a 0.5 mol/L KBr solution and a 0.5 mol/L AgNO₃ solution were added to the content of the pot in accordance with a double jet method over 20 minutes at a rate of 10 ml/minute to cause an epitaxial precipitation of silver bromide of substantially 10 mol. % on the AgI host emulsion (grains). During this operation, pAg was maintained at 10.2. Then pH value of the system was adjusted to 3.8 with sulfuric acid having a concentration of 0.5 mol/L. Then the agitation was terminated and precipitation/desalting/washing steps were executed. The pH value of the system was adjusted to 5.9 with sodium hydroxide having a concentration of 1 mol/L, thereby obtaining a silver halide dispersion having a pAg value of 11.0.

Five ml of a 0.34 mass % methanol solution of 1,2-benzoisothiazolin-3-one was added to the aforementioned silver halide dispersion which was agitated and maintained at 38° C. 40 minutes later, the resultant was heated to 47° C. When 20 minutes lapsed after the temperature elevation, sodium benzenethiosulfonate in a methanol solution was added to the system in an amount of 7.6×10⁻⁵ moles per mole of silver. Five minutes later, a tellurium sensitizer C in a methanol solution was added in an amount of 2.9×10⁻5 moles per mole of silver, and the resultant was ripened for 91 minutes. Thereafter, 1.3 ml of a 0.8 mass % methanol solution of N,N′-dihydroxy-N″-diethylmelamine were added to the system. Four minutes later, 5-methyl-2mercaptobenzimidazole in a methanol solution in an amount of 4.8×10⁻³ moles per mole of silver, 1-phenyl-2-heptyl-5mercapto-1,3,4-triazole in a methanol solution in an mount of 5.4×10⁻³ moles per mole of silver, and 1-(3-methylureidophenyl)-5-mercaptotetrazole i n an aqueous solution in an amount of 8.5×10⁻³ moles per mole of silver were added to the system to prepare a silver halide emulsion B.

<<Preparation of Silver Halide emulsion C>>

A silver halide emulsion C was prepared in the same manner as the silver halide emulsion A, except that the amounts of the 5 mass % methanol solution of 2,2′-(ethylenedithio)diethanol, the temperature at the time of grain formation and the addition time of the solution A were suitably regulated. Silver halide grains in the obtained silver halide dispersion C were made of pure silver iodide, and included tabular grains having an average projected area diameter of 1.369 μm, a coefficient of variation of the average projected area diameter of 19.7%, an average thickness of 0.130 μm, and an average aspect ratio of 11.1. The entire projected area of the tabular grains corresponded to 80% or more of the entire projected area of all the silver halide grains. The sphere-corresponding diameter thereof was 0.71 μm. A result of X-ray powder diffraction analysis showed that 90% or more of the silver iodide had gamma phase.

<<Preparation of Silver Halide Emulsion D>>

A silver halide emulsion D containing epitaxial silver bromide by 10 mol. % was prepared in the same manner as the silver halide emulsion B, except that the silver halide emulsion A was replaced with the silver halide emulsion C.

<<Preparation of Mixed Emulsion for Coating Liquid>>

The silver halide emulsion B and the silver halide emulsion D were mixed so that the silver molar ratio was 5:1. The resultant was fused, and a 1 mass % aqueous solution of benzothiazolium iodide was added thereto in an amount of 7×10⁻³ moles per mole of silver.

As compounds capable of undergoing one-electron oxidation to form a one-electron oxidant that can release one or more electrons”, each of compounds 1, 2 and 3 was added to the resultant mixture in an amount of 2×10⁻³ moles per mole of silver of silver halide.

Each of adsorptive redox compounds 1 and 2 each including an adsorptive group and a reducing group was added to the mixture in an amount of 8×10⁻³ moles per mole of silver halide.

Then, water was added to the mixture so that the content of silver of silver halide was 15.6 g per liter of the mixed emulsion for a coating liquid.
2) Preparation of Fatty Acid Silver Salt Dispersion A
   <Preparation of Recrystallized Behenic Acid>

100 kg of behenic acid manufactured by Cognis Inc. (trade name of product: Edenor C22-85R) was dissolved in 1200 kg of isopropyl alcohol at 50° C., and the resultant solution was filtered through a filter having a pore size of 10 μm and then cooled down to 30° C. to recrystallize behenic acid. The cooling rate in the recrystallization was controlled to 3° C./hour. The solution was centrifugally filtered to collect recrystallized crystals, and the crystals were washed with 100 kg of isopropyl alcohol and then dried. The obtained crystals were esterified and the resultant was measured by GCID. The resultant had a behenic acid content of 96 mol % and, in addition, included 2 mol % of lignoceric acid, 2 mol% of archidic acid and 0.001 mol% of erucic acid.

<Preparation of Fatty Acid Silver Salt Dispersion A>

88 kg of recrystallized behenic acid, 422 L of distilled water, 49.2 L of a 5 mol/L aqueous NAOH solution and 120 L of tbutyl alcohol were mixed and reacted at 75° C. for one hour while the resultant system was being stirred. Thus, a sodium behenate solution B was obtained. Separately, 206.2 L of an aqueous solution (pH 4.0) containing 40.4 kg of silver nitrate was prepared and kept at 10° C. A reaction vessel containing 635 L of distilled water and 30 L of t-butyl alcohol was kept at 30° C. The entire amount of the sodium behenate solution and the entire amount of the aqueous solution of silver nitrate were added to the content of the vessel at constant flow rates over 93 minutes and 15 secconds and over 90 minutes, respectively, while the content in the vessel was being sufficiently stirred. At this time, only the aqueous solution of silver nitrate was added for 11 minutes after starting the addition of the aqueous solution of silver nitrate, addition of sodium behenate solution was started subsequently, and only the sodium behenate solution was added for 14 minutes and 15 seconcds after completion of the addition of the aqueous solution of silver nitrate. At this time, the internal temperature of the reaction vessel was kept at 30° C. The external temperature was controlled such that the liquid temperature was constant. The pipe line for the sodium behenate solution was a double-walled pipe and thermally insulated by circulating hot water through the interspace of the double-walled pipe, and the temperature of the solution at the outlet of the nozzle tip was adjusted at 75° C. The pipe line for the aqueous silver nitrate solution was also a double-walled pipe and thermally insulated by circulating cold water through the interspace of the double-walled pipe. The position at which the sodium behenate solution was added to the reaction system and that at which the aqueous silver nitrate solution was added thereto were disposed symmetrically relative to the shaft of the stirrer disposed in the reactor, and the nozzle tips of the pipes were spaced apart from the reaction solution level in the reactor.

After adding the sodium behenate solution was finished, the reaction system was stirred for 20 minutes at that temperature, and then heated to 35° C. over 30 minutes. Thereafter, the system was ripened for 210 minutes. Immediately after completion of the ripening, the system was centrifugally filtered to collect a solid component, which was washed with water until the conductivity of the washing waste reached 30 μS/cm. The solid thus obtained was a silver salt of a fatty acid and was stored as wet cake without drying it.

The shapes of the silver behenate particles obtained were analyzed on the basis of their images taken through electronmicroscopic photography. Average values of a, b, and c were 0.21 μm, 0.4 μm and 0.4 μm, respectively (a, b and c are defined hereinabove). The average aspect ratio was 2.1. The coefficient of variation of sphere-corresponding diameters of the particles was 11%.

19.3 kg of polyvinyl alcohol (trade name PVA-217) and water were added to the wet cake whose amount corresponded to 260 kg of the dry weight thereof so that the total amount of the resultant became 1000 kg. The resultant was formed into slurry with a dissolver wing, and then pre-dispersed with a pipe-line mixer (Model PM-10 available from Mizuho Industry Co.).

Next, the pre-dispersed stock slurry was processed three times in a disperser (MICROFLUIDIZER M-610 obtained from Microfluidex International Corporation, and equipped with a Z-type interaction chamber) at a controlled pressure of 1150 kg/cm². A silver behenate dispersion was thus prepared. To cool it, corrugated tube type heat exchangers were disposed before and behind the interaction chamber. The temperature of the coolant in these heat exchangers was so controlled that the system could be processed at a dispersion temperature of 18° C.
3) Preparation of Reducing Agent Dispersion
<<Preparation of Reducing Agent-1 Dispersion>>

10 kg of a reducing agent-1 (2,2′-methylenebis-(4-ethyl-6-tert-butylphenol)), 16 kg of a 10 mass % aqueous solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) including zirconia beads which had a mean diameter of 0.5 mm, and dispersed therewith for 3 hours. Then, 0.2 g of sodium salt of benzoisothiazolinone and water were added thereto to adjust the reducing agent concentration of the resultant to 25% by mass. The dispersion was heated at 60° C. for 5 hours. A reducing agent-1 dispersion was thus prepared. The reducing agent particles in the dispersion had a median diameter of 0.40 μm, and a maximum particles size of at most 1.4 μm. The reducing agent dispersion was filtered through a polypropylene filter having a pore size of 3.0 μm to remove foreign objects such as dirt from it, and then stored.
<<Preparation of Reducing Agent-2 Dispersion>>

10 kg of a reducing agent-2 (6,6′-di-t-butyl-4,4′-dimethyl-2,2′-butylidenediphenol), 16 kg of a 10 mass % aqueous solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) including zirconia beads which had a mean diameter of 0.5 mm, and dispersed therewith for 3 hours and 30 minutes. Then, 0.2 g of sodium salt of benzoisothiazolinone and water were added thereto to adjust the reducing agent concentration of the resultant to 25% by mass. The dispersion was then heated at 40° C. for 1 hour, and then at 80° C. for 1 hour. A reducing agent-2 dispersion was thus prepared. The reducing agent particles in the dispersion had a median diameter of 0.50 μm, and a maximum particle size of at most 1.6 μm. The reducing agent dispersion was filtered through a polypropylene filter having a pore size of 3.0 μm to remove foreign objects such as dirt from it, and then stored.
4) Preparation of Hydrogen Bonding Compound Dispersion
<<Preparation of Hydrogen Bonding Compound-1 Dispersion>>

10 kg of a hydrogen bonding compound-1 (tri(4-t-butylphenyl)phosphine oxide), 16 kg of a 10 mass % aqueous solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Coeporation) containing zirconia beads which had a mean diameter of 0.5 mm, and dispersed therewith for 4 hours. Then, 0.2 g of sodium salt of benzoisothiazolinone and water were added thereto to adjust the hydrogen bonding compound concentration of the resultant to 25% by mass. The dispersion was heated at 40° C. for 1 hour and then at 80° C. for 1 hour. A hydrogen bonding compound-1 dispersion was thus prepared. The hydrogen bonding compound particles in the dispersion had a median diameter of 0.45 μm, and a maximum particle size of at most 1.3 μm. The hydrogen bonding compound dispersion was filtered through a polypropylene filter having a pore size of 3.0 μm to remove foreign objects such as dirt from it, and then stored.
5) Preparation of Dispersions of Development Accelerator and Color Toning Agent
<<Preparation of Development Accelerator-1 Dispersion>>

10 kg of a development accelerator-1, 20 kg of a 10 mass % solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) containing zirconia beads which had a mean diameter of 0.5 mm, and dispersed therewith for 3 hours and 30 minutes. Then, 0.2 g of sodium salt of benzoisothiazolinone and water were added thereto to prepare a development accelerator-1 dispersion having a development accelerator concentration of 20% by mass. The development accelerator particles in the dispersion had a median diameter of 0.48 μm, and a maximum particle size of at most 1.4 μm. The development accelerator dispersion was filtered through a polypropylene filter having a pore size of 3.0 μm to remove foreign objects such as dirt from it, and then stored.

Development accelerator-2 and color toning agent-1 solid dispersions respectively having concentrations of 20 mass % and 15 mass % were prepared in the same manner as the development accelerator-1 dispersion.
6) Preparation of Polyhalogen Compound Dispersion
<<Preparation of Organic Polyhalogen Compound-1 Dispersion>>

10 kg of an organic polyhalogen compound-1 (tribromomethanesulfonylbenzene), 10 kg of a 20 mass % aqueous solution of modified polyvinyl alcohol (POVAL MP203 available from Kuraray Co., Ltd.), 0.4 kg of a 20 mass % aqueous solution of sodium triisopropylnaphthalenesulfonate, and 14 kg of water were sufficiently mixed to prepare slurry. The slurry was fed by a diaphragm pump into a horizontal sand mill (UVM-2 available from Imex Corporation ) including zirconia beads which had a mean diameter of 0.5 mm, and dispersed therewith for 5 hours. Then, 0.2 g of sodium salt of benzoisothiazolinone and water were added thereto to prepare an organic polyhalogen compound-1 dispersion having an ogranic polyhalogen compound content of 30 mass %. The organic polyhalogen compound particles in the dispersion had a median diameter of 0.41 μm, and a maximum particle size of at most 2.0 μm. The organic polyhalogen compound dispersion was filtered through a polypropylene filter having a pore size of 10.0 μm to remove foreign objects such as dirt from it, and then stored.
<<Preparation of Organic Polyhalogen Compound-2 Dispersion>>

10 kg of an organic polyhalogen compound-2 (N-butyl-3-tribromomethanesulfonylbenzamide), 20 kg of a 10 mass % aqueous solution of modified polyvinyl alcohol (POVAL MP203 available from Kuraray Co., Ltd.), and 0.4 kg of a 20 mass % aqueous solution of sodium triisopropylnaphthalenesulfonate were sufficiently mixed to prepare slurry. The slurry was fed by a diaphragm pump into a horizontal sand mill (UVM-2 available from Imex Corporation) including zirconia beads which had a mean diameter of 0.5 mm, and dispersed therewith for 5 hours. Then, 0.2 g of sodium salt of benzoisothiazolinone and water were added thereto to adjust the organic polyhalogen compound content of the resultant to 30 mass %. The dispersion was heated at 40° C. for 5 hours. An organic polyhalogen compound-2 dispersion was thus obtained. The organic polyhalogen compound particles in the dispersion had a median diameter of 0.40 μm, and a maximum particle size of at most 1.3 μm. The organic polyhalogen compound dispersion was filtered through a polypropylene filter having a pore size of 3.0 μm to remove foreign objects such as dirt from it, and then stored.
7) Preparation of Silver Iodide Complex Forming Agent

8 kg of modified polyvinyl alcohol (MP203 manufactured by Kuraray Co., Ltd.) was dissolved in 174.57 kg of water, and 3.15 kg of a 20 mass % aqueous solution of sodium triisopropylnaphthalenesulfonate and 14.28 kg of a 70 mass % aqueous solution of 6-isopropylphthalazine were added to the resultant solution to obtain a 5 mass % solution of a silver iodide complex forming agent.
8) Preparation of Mercapto Compound
   Preparation of Mercapto Compound
<<Preparation of Aqueous Solution of Mercapto Compound-1>>

7 g of mercapto compound-1 (1-(3-sulfophenyl)-5-mercaptotetrazole sodium salt) was dissolved in 993 g of water to obtain a 0.7 mass % aqueous solution.
<<Preparation of Aqueous Solution of Mercapto Compound-2>>

20 g of mercapto compound-2 (1-(3-methylureidophenyl)-5-mercaptotetrazole) was dissolved in 980 g of water to obtain a 2.0 mass % aqueous solution. 3
9) Preparation of SBR Latex Liquid
<<Preparation of SBR Latex Liquid>>

An SBR latex was prepared as follows.

287 g of distilled water, 7.73 g of a surfactant (PIONIN A-43-S produced by Takemoto Yushi Corporation and having a solid content of 48.5 mass %), 14.06 ml of 1 mol/liter NaOH, 0.15 g of tetrasodium ethylenediaminetetraacetate, 255 g of styrene, 11.25 g of acrylic acid, and 3.0 g of tert-dodecylmercaptan were put into the polymerization reactor of a gas monomer reaction apparatus (TAS-2J Model available from Taiatsu Techno Corporation). The reactor was sealed off, and the content therein was stirred at 200 rpm. The internal air was exhausted via a vacuum pump, and replaced a few times repeatedly with nitrogen. Then, 108.75 g of 1,3-butadiene was introduced into the reactor under pressure, and the internal temperature of the reactor was raised to 60° C. A solution in which 1.875 g of ammonium persulfate was dissolved in 50 ml of water was added to the system, and the system was stirred for 5 hour. It was further heated to 90° C. and stirred for 3 hours. After the reaction was completed, the internal temperature was lowered to room temperature. Then, NaOH and NH₄OH (both 1 mol/liter) were added to the system at a molar ratio of Na⁺ and NH₄⁺ of 1/5.3 so as to adjust the pH of the system to 8.4. Next, the system was filtered through a polypropylene filter having a pore size of 1.0 μm to remove foreign objects such as dirt from it, and then stored. 774.7 g of SBR latex was thus obtained. Its halide ion content was measured through ion chromatography, and the chloride ion concentration of the latex was 3 ppm. The chelating agent concentration thereof was measured through high-performance liquid chromatography, and was 145 ppm.

The mean particle size of the latex was 90 nm, Tg thereof was 17° C., the solid content thereof was 44 % by mass, the equilibrium moisture content thereof at 25° C and 60% RH was 0.6 mass %, and the ion conductivity thereof was 4.80 mS/cm. To measure the ion conductivity, a conductivity meter CM-30S manufactured by Toa Denpa Kogyo K. K. was used. In the device, the 44 mass % latex was measured at 25° C. Its pH was 8.4.
10) Preparation of Pigment-1 Dispersion

64 g of C. I. Pigment blue 60, 6.4 g of DEMOL N (manufactured by Kao Corp.) and 250 g of water were sufficiently mixed to obtain slurry. The slurry was placed in a vessel together with 800 g of zirconia beads having an average diameter of 0.5 mm, then dispersed for 25 hours with a disperser (1/4G sand grinder mill manufactured by Imex Co.) and water was added to the system to adjust the pigment concentration of the system to 5 mass %, thereby obtaining a pigment-1 dispersion. The pigment particles contained in thus obtained pigment dispersion had an average particle size of 0.21 μm.

1-3-2 Preparation of Coating Liquid

1) Preparation of Coating Liquid-1 for Image Forming Layer (Photosensitive Layer)

The organic polyhalogen compound-1 dispersion, the organic polyhalogen compound-2 dispersion, the SBR latex (Tg: 17° C.) liquid, the reducing agent-1 dispersion, the reducing agent-2 dispersion, the hydrogen bonding compound-1 dispersion, the development accelerator-1 dispersion, the development accelerator-2 dispersion, the color toning agent-1 dispersion, the aqueous solution of mercapto compound-1, and the aqueous solution of mercapto compound-2 were successively added to 1,000 g of the dispersion of the silver salt of the fatty acid and 276 ml of water. Then, the silver iodide complex-forming agent was added to the resultant. Just before coating, the silver halide emulsion for coating liquid was added to and sufficiently mixed with the above mixture so that the amount of silver of the emulsion became 0.22 mol per mol of silver salt of fatty acid. A coating liquid-1 for an image-forming layer was thus prepared and was fed as it is to a coating die.

The image forming layer coating liquid had a viscosity, measured with a B-type viscosimeter (manufactured by Tokyo Keiki Co.), of 25 [mPa·s] at 40° C. (No. 1 rotor, 60 rpm).

The coating liquid had viscosities at 25° C., measured with RFS fluid spectrometer (manufactured by Rheometrics Far East Inc.) of 242, 65, 48, 26 and 20 [mPa·s] respectively at shear speeds of 0.1, 1, 10, 100 and 1000 [l/sec].

The zirconium amount in the coating liquid was 0.52 mg per g of silver.
2) Preparation of Intermediate Layer-A Coating Liquid
<<Preparation of Intermediate Layer-A Coating Liquid-1>>

27 ml of a 5 mass % aqueous solution of AEROSOL OT (available from American Cyanamid Company), 135 ml of a 20 mass % aqueous solution of diammonium phthalate and water were added to 1000 g of polyvinyl alcohol (PVA-205 available from Kuraray Co., Ltd.), 163 g of the pigment-1 dispersion, 33 g of a 18.5 mass % aqueous solution of a blue dye compound-1 (KAYAFECT TURQUOISE RN LIQUID 150 manufactured by Nippon Kayaku Co.), 27 ml of a 5 mass % aqueous solution of sodium di(2-ethylhexyl) sulfosuccinate, and 4200 ml of a 19 mass % latex of a methyl methacrylate/styrene/butyl acrylate/hydroxyethyl methacrylate/acrylic acid copolymer (copolymerization weight ratio: 57/8/28/5/2) so that the total amount of the resultant mixture became 10000 g. The pH of the mixture was adjusted to 7.5 by adding NaOH to the mixture. An intermediate layer-A coating liquid-1 was thus obtained. This was fed into a coating die so that the amount of the coating liquid was 8.9 ml/m².

The viscosity of the coating liquid was 58 mPa·S when measured with a B-type viscometer (rotor No. 1, 60 rpm) at 40° C.
<<Preparation of Intermediate Layer-A Coating Liquids-2 to 8>>

Intermediate layer-A coating liquids-2 to 8 were prepared in the same manner as the intermediate layer-A coating liquid-1, except that PVA-205 and the methyl methacrylate/styrene/butyl acrylate/hydroxyethyl methacrylate/acrylic acid copolymer were respectively replaced with binders shown in Table 2.
3) Preparation of Intermediate Layer-B Coating Liquid
<<Preparation of Intermediate Layer-B Coating Liquid-1>>

100 g of inert gelatin and 10 mg of benzoisothiazolinone were dissolved in 840 ml of water. The resultant solution was mixed with 180 g of a 19 mass % latex of methyl methacrylate/styrene/butyl acrylate/hydroxyethyl methacrylate/acrylic acid copolymer (copolymerizing weight ratio: 57/8/28/5/2), 46 ml of a 15 mass % methanol solution of phthalic acid, and 5.4 ml of a 5 mass % aqueous solution of sodium di(2-ethylhexyl) sulfosuccinate. 40 ml of a 4 mass % solution of chromium alum was mixed with the resultant mixture with a static mixer immediately before coating. The resultant coating liquid was supplied to a coating die at a rage of 26.1 ml/m².

The viscosity of the coating liquid, measured with a B-type viscosimeter (rotor No. 1, 60 rpm), was 20 mPa·s at 40° C.
<<Preparation of Intermediate Layer-B Coating Liquid-2>>

An intermediate layer-B coating liquid-2 was prepared in the same manner as the intermediate layer coating liquid-1 except that the inert gelatin and the methyl methacrylate/styrene/butyl acrylate/hydroxyethyl methacrylate/acrylic acid copolymer were replaced with binders shown in Table 2. The intermediate layer-B was composed of one layer or two layers as shown in Table 2. In Table 2, a layer shown at the left side of the table is a layer adjacent to the outermost layer.
4) Preparation of Coating Liquid for Outermost Layer
<<Preparation of Coating Liquid-1 for Outermost Layer>>

100 g of inert gelatin and 10 mg of benzoisothiazolinone were dissolved in 800 ml of water. The resultant solution was mixed with 40 g of a 10 mass % emulsion of liquid paraffin, 40 g of a 10 mass % emulsion of dipentaerythrityl hexaisostearate, 180 g of a 19 mass % latex of methyl methacrylate/styrene/butyl acrylate/hydroxyethyl methacrylate/acrylic acid copolymer (copolymerizing weight ratio: 57/8/28/5/2), 40 ml of a 15 mass % methanol solution of phthalic acid, 5.5 ml of a 1 mass % solution of a fluorinated surfactant (FF-1), 5.5 ml of a 1 mass % solution of a fluorinated surfactant (FF-2), 28 ml of a 5 mass % aqueous solution of sodium di(2-ethylhexyl) sulfosuccinate, 4 g of polymethyl methacrylate fine particles (average particle size of 0.7 μm, and a volume-weighted average distribution of 30%) and 21 g of polymethyl methacrylate fine particles (average particle size of 3.6 μm, and a volume-weighted average distribution of 60%) to obtain a coating liquid for a surface protective layer, which was supplied to a coating die at a rate of 8.3 ml/m².

The viscosity of the coating liquid, measured with a B-type viscosimeter (rotor No. 1, 60 rpm), was 19 mPa·s at 40° C.
<<Preparation of Coating Liquids-2 to 4 for Outermost Layer>>

Outermost layer coating liquids-2 to 4 were prepared in the same manner as the outermost layer coating liquid-1 except that the inert gelatin and the latex of methyl methacrylate/styrene/butyl acrylate/hydroxyethyl methacrylate/acrylic acid copolymer (copolymerizing weight ratio: 57/8/28/5/2) were replaced with binders shown in Table 2.
3. Preparation of Photothermographic Material
   1) Preparation of Photothermographic Material-1

The image forming layer coating liquid-1, the intermediate layer-A coating liquid-1, the intermediate layer-B coating liquid-1, and the outermost layer coating liquid A were simultaneously applied to the undercoat layer of the substrate in that order in accordance with a slide bead coating method to form superimposed layers. These coatings were formed on both surfaces of the substrate. Thus, a sample of a photothermographic material was prepared. In this operation, the temperature of the coating liquids of an image forming layer and an intermediate layer was controlled at 31 ° C. for, that of the coating liquid of a first surface protective layer was controlled at 36° C. and that of the coating liquid of a second surface protective layer was controlled at 37° C. The coated silver amount of one image forming layer which was the sum of silver of fatty acid silver and silver halide was 0.821 g/m².

The coating amount of each of the compounds contained in the image forming layer were as follows (g/m²):

| | |
|---|---|
| Fatty acid silver | 2.80 |
| Polyhalogen compound-1 | 0.028 |
| Polyhalogen compound-2 | 0.094 |
| Silver iodide complex forming agent | 0.46 |
| SBR latex | 5.20 |
| Reducing agent-1 | 0.33 |
| Reducing agent-2 | 0.13 |
| Hydrogen bonding compound-1 | 0.15 |
| Development accelerator-1 | 0.005 |
| Development accelerator-2 | 0.035 |
| Color toning agent-1 | 0.002 |
| Mercapto compound-1 | 0.001 |
| Mercapto compound-2 | 0.003 |
| Silver halide (in terms of silver amount) | 0.146 |

Coating and drying conditions were as follows.

The coating speed was 160 mn/minute. The distance between the coating die tip and the substrate was between 0.10 and 0.30 mm. The pressure in the decompression chamber was lower by 196 to 882 Pa than the atmospheric pressure. Before coating, the static electricity of the substrate was eliminated by blowing an ionic blow to the substrate.

In the subsequent chilling zone, the coated substrate was chilled with an air blow (its drybulb temperature was 10 to 20° C.). The substrate was transported in a contless manner to the helix type contactless drying zone, and dried with a dry air blow (its dry-bulb temperature was 23 to 45° C., and its wet-bulb temperature was 15 to 21° C.) there.

After the drying, the substrate was conditioned at 25° C. and 40 to 60% RH, and then heated so that the surface temperature was between 70 and 90° C. After thr heating, the substrate was cooled to have a surface temperature of 25° C.

The degree of matting, in terms of the Bekk's smoothness, of the photothermographic photosensitive material thus prepared was 550 seconds. The pH of the surface of the sample was measured and was found to be 6.0.
2) Preparation of Photothermographic Materials 2 to 15

Photothermographic materials-2 to -15 were prepared in the same manner as the photothermographic material-1, except that the materials of the intermediate layer-A coating liquid, the intermediate layer-B coating liquid and the outermost layer coating liquid were replaced with those shown in Table 2 and except that layers shown in this table were formed. Coating amounts (g/m²) of the compounds contained in the image forming layer of each of these materials were the same as those of the photothermographic material-1.

The chemical structures of the compounds employed in the examples of the invention are shown below.

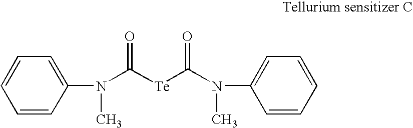

Compound-1 capable of undergoing one-electron oxidation to form one-electron oxidant that can release one or more electrons

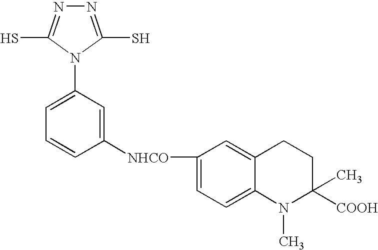

Compound-2 capable of undergoing one-electron oxidation to form one-electron oxidant that can release one or more electrons

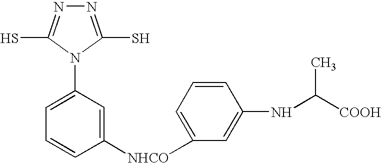

Compound-3 capable of undergoing one-electron oxidation to form one-electron oxidant that can release one or more electrons

Adsorptive redox compound-1 having an adsorptive group and a reducing group

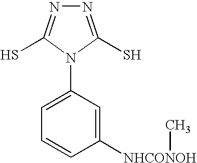

Adsorptive redox compound-2 having an adsorptive group and a reducing group 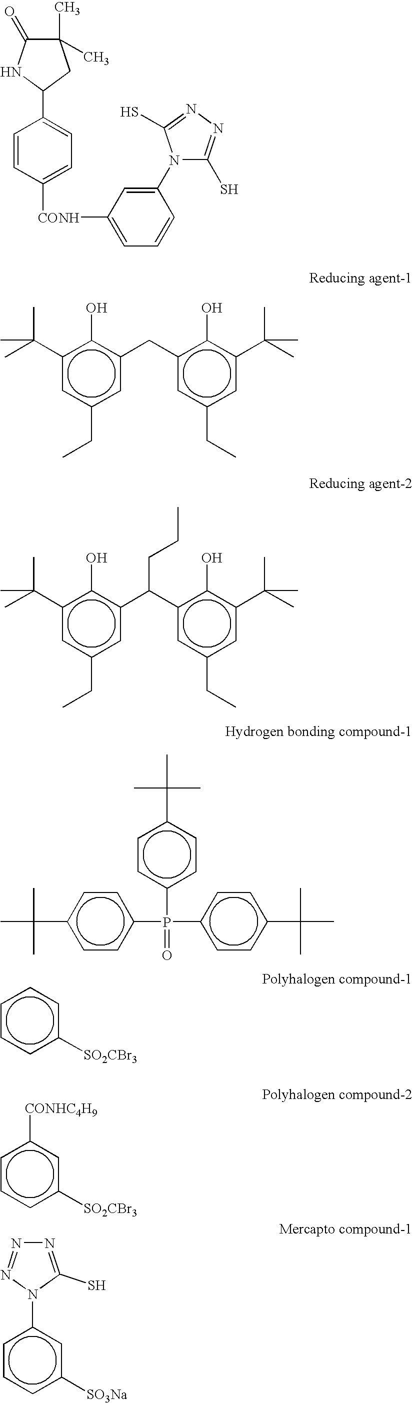 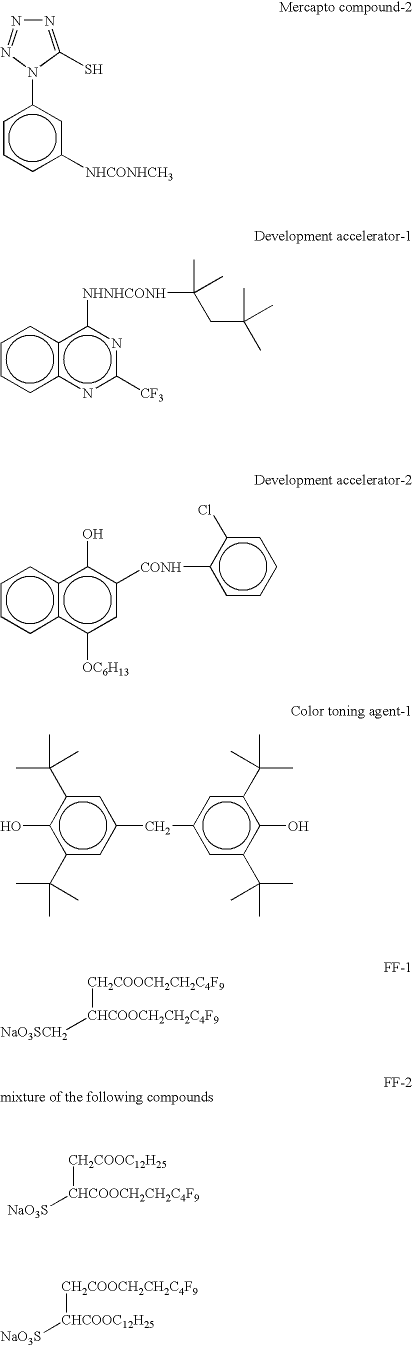
4. Evaluation of Photographic Performance
1) Preparation

Each of the samples was cut into pieces of a half-size, packaged with the following packaging material at 25° C. and 50% RH, stored at ordinary temperature for two weeks, and tested according to a test method mentioned below.

Packaging Material

The packaging material used herein was a film including a PET film having a thickness of 10 μm, a PE film having a thickness of 12 μm, an aluminium foil having a thickness of 9 μm, a nylone film having a thickness of 15 μm, and a 3 mass % carbon-containing polyethylene film having a thickness of 50 μm.

The packaging material had an oxygen permeability of 0.02 ml/atm·m²·25° C.day and a moisture permeability of 0.10 g/atm·m^{2·}25° C.day.
2) Exposure and Development

The sample was sandwiched between two X-ray regular screens (HI-SCREEN B3 manufactured by Fuji Photo Film Co., Ltd., containing CaWO₄ as a phosphor and having a peak emission wavelength of 425 nm) to form an assembly for image formation. The assembly was exposed to X-rays for 0.05 seconds and subjected to X-ray sensitometry. The X-ray apparatus used was DRX-3724HD (trade name) manufactured by Toshiba Corporation and having a tungsten target. A voltage of 80 KVp was applied to three phases with a pulse generator to generage X-rays and the X-rays were made to pass through a filter of water having a thickness of 7 cm, which filter absorbed X-rays in nearly the same amount as that of X-rays which the human body absorbes, to form an X-ray source. While an X-ray exposure amount was varied by varying the distance between the assmbly and the X-ray source, the material was exposed stepwise at an interval of logE=0.15. After exposure, the material was thermally developed under the following thermal development conditions. The density of the obtained image was measured with a densitometer.

A heat developing apparatus shown in FIG. 1 was prepared, and the installation temperature of the heat roller was set at 100° C. and the temperatures of the two panel heaters were set in the range of 118° C. to 120° C. The developing time was set at 14 seconds in total.

On the other hand, a regular photosensitive material RXU for wet development manufactured by Fuji Photo Film Co. Ltd. was exposed to X-rays under the same conditions and was processed with an automatic developing processor CEPROS-M2 and a processing liquid CED1, which are manufactured by Fuji Photo Film Co. Ltd. for 45 seconds
4) Evaluation of Photographic Performance
<Evaluation of White Spot in Fingerprint Sticking part>

Saline was used to simulate a fingerprint sticking part. Saline was prepared by dissolving 7.5 g of NaCl in water and precisely diluting te resultant solution to 500 mL. Filter paper impregnated with the saline was pressed against the lowest density area of the image formed on each sample which had been exposed and thermally developed for 5 seconds in a dark place. After the filter paper was removed, a half of the sample was stored under conditions of 50° C. and 50% RH for 3 days and then compared with another half of the sample.

Filter paper impregnated with the saline was pressed against the highest density area of the image formed on each sample which had been exposed and thermally developed for 5 seconds in a dark place. After the filter paper was removed, a half of the sample was stored under conditions of 50° C. and 50% RH for 3 days and then compared with another half of the sample.

The obtained samples were disposed on a view box having an illumination intensity of 10,000 lux and visually checked.

A check was made to determine whether the saline sticking part showed any difference from other parts in the lowest density area or the highest density area, and determine the degree of such difference on the basis of the following criteria.
AA: There was no difference both in the lowest density area and in the highest density area;
A: There was a difference between the saline sticking part and other parts in the lowest density area and/or the highest density area, but the difference was not recognized in the case of transmitted light;
B: There was a difference between the saline sticking part and other parts in the lowest density area and/or the highest density area, and the difference was recognized in the case of transmitted light and adversely affected image reading in some cases;
C: There was a difference between the saline sticking part and other parts in the lowest density area and/or the highest density area, and the difference was recognized in the case of transmitted light and adversely affected image reading.

Results of evaluation are shown in Table 2.

TABLE 2

| | Outermost | | | Intermediate | | |
|---|---|---|---|---|---|---|
| Photothermographic | layer | Intermediate layer B | | layer A | White spot | |
| material | binder | binder | | binder | in image | Remarks |
| 1 | gelatin/latex = 100/ | gelatin/latex = 100/34.2 | | PVA/latex = 10/8 | C | comp. |
| | 34.2 | | | | | Example |
| 2 | none | none | | P-17 = 100 | B | Comp |
| | | | | | | example |
| 3 | gelatin/latex = 100/ | gelatin/latex = 100/34.2 | | P-17 = 100 | A | Invention |
| | 34.2 | | | | | |
| 4 | latex LP6 = 100 | gelatin/latex = 100/34.2 | | P-17 = 100 | AA | Invention |
| 5 | gelatin/latex = 100/ | gelatin/latex = 100/34.2 | | PVA/P-17 = 60/ | B | comp. |
| | 34.2 | | | 40 | | Example |
| 6 | gelatin/latex = 100/ | PVA/latex = 100/80 | | P-17 = 100 | A | Invention |
| | 34.2 | | | | | |
| 7 | latex LP6 = 100 | gelatin/latex = 100/ | PVA/latex = 100/ | P-17 = 100 | AA | Invention |
| | | 34.2 | 80 | | | |
| 8 | latex LP6 = 100 | gelatin/latex = 100/ | PVA/latex = 100/ | P-8 = 100 | AA | Invention |
| | | 34.2 | 80 | | | |
| 9 | gelatin/latex = 100/ | gelatin/latex = 100/ | PVA/latex = 100/ | P-17 = 100 | AA | Invention |
| | 34.2 | 34.2 | 80 | | | |
| 10 | gelatin/latex = 100/ | gelatin/latex = 100/ | PVA/latex = 100/ | P-8 = 100 | AA | Invention |
| | 34.2 | 34.2 | 80 | | | |
| 11 | latex | gelatin/latex = 100/ | PVA/latex = 100/ | P-17 = 100 | AA | Invention |
| | LP6/gelatin = 100/ | 34.2 | 80 | | | |
| | 10 | | | | | |
| 12 | gelatin = 100 | gelatin/latex = 100/ | PVA/latex = 100/ | P-4 = 100 | AA | Invention |
| | | 34.2 | 80 | | | |
| 13 | gelatin = 100 | gelatin/latex = 100/ | PVA/latex = 100/ | P-7 = 100 | AA | Invention |
| | | 34.2 | 80 | | | |
| 14 | gelatin = 100 | gelatin/latex = 100/ | PVA/latex = 100/ | P-8 = 100 | AA | Invention |
| | | 34.2 | 80 | | | |
| 15 | gelatin = 100 | gelatin/latex = 100/ | PVA/latex = 100/ | P-10 = 100 | AA | Invention |
| | | 34.2 | 80 | | | |

As shown in Table 2, when a photothermographic material had a non-photosensitive intermediate layer A which contained a binder including a hydrophobic polymer by 50 mass % or more between an image forming layer and an outermost layer and was exposed with an X-ray intensifying screen, an image with little white spot was obtained.

Also when the binder of at least one of the outermost layer and the non-photosensitive intermediate layer B contained a hydrophilic polymer, derived from an animal protein, by 50 mass % or more, the coated surface state was extremely good.

In particular, when a latex was contained in the outermost layer of a photothermographic material, a change in the image quality due to stickiness or due to fingerprinting did not occur and the storage stability was excellent.

### Example 2

### Preparation of Fatty Acid Silver Salt Dispersion B

<Purification of Recrystallized Stearic Acid>

100 kg of stearic acid (manufactured by Cognis Inc.) were mixed with 1200 kg of isopropyl alcohol, and dissolved therein at 50° C. The resultant solution was filtered with a 10 μm filter and cooled to 20° C. to recrystallize stearic acid. The cooling speed at the time of recrystallization was controlled at 3° C./hr. The obtained crystals were separated by centrifuging, and washed by pouring 100 kg of isopropyl alcohol. The recrystallization, separation and washing was repeated twice. The precipitate in the early stage of recrystallization was filtered off to eliminate carboxylic acids having chains longer than that of stearic acid and the remaining crystals were dried. The crystals were esterified and the resultant was subjected to GC-FID measurement and the content of stearic acid in the crystals was found to be 99 mol. %. The crystals contained behenic acid by 1 mol. % as an impurity.
<Preparation of Fatty Acid Silver Salt Dispersion B>

A fatty acid silver salt dispersion B was prepared in the same manner as in Example 1, except that 88 kg of recrystallized behenic acid A was replaced with 75 kg of recrystallized behenic acid and 10.7 kg of recrystallized stearic acid.

The obtained crystals contained silver behenate by 82 mol. %, silver stearate by 16 mol. %, silver arachidate by 1 mol. % and silver lignoserate by 1 mol. %.
<<Preparation of Reducing Agent-3 Dispersion>>

10 g of a reducing agent-3, 4 g of hydroxypropyl cellulose and 86 g of water were thoroughly mixed to form slurry, which was allowed to stand for 10 hours. Then, the slurry was put into a vessel together with 168 g of zirconia beads having an average diameter of 0.5 mm, dispersed for 10 hours with a disperser the same as that employed in the preparation of the organic acid silver salt fine crystal dispersion to obtain a solid particle dispersion liquid. Particles having a size of 1.0 μm accounted for 70 mass % of all the particles in the dispersion. 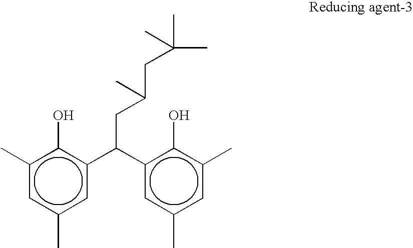
<<Preparation of Image Forming Layer Coating Liquids-2 to -5>>

Image forming layer coating liquids-2 to -5 were prepared in the same manner as the image forming layer coating liquid-1 in Example 1, except that the organic silver salt dispersion, the reducing agent, and the organic polyhalogen compound were replaced with those shown in Table 3.

Preparation of Photothermographic Materials-201 to -204

Photothermographic materials-201 to -204 were prepared in the same manner as the photothermographic material-9 in Example 1, except that the image forming layer coating liquid-1 was replaced with one of the image forming coating liquids-2 to -5. The coating amounts (g/m²) of the compounds contained in the image forming layer of each of these materials were the same as those in the photothermographic material-1.

The obtained photothermographic materials-201 to -203 were exposed to light, developed and evaluated in the same manner as in Example 1. Results are shown in Table 3.

TABLE 3

| | Image forming layer | | | | | | |
|---|---|---|---|---|---|---|---|
| | silver | | | | | | |
| | behenate | | hydrogen | | | White | |
| Photothermographic | content | reducing | bonding | polyhalogen | development | spot in | |
| material | (mol. %) | agent (type) | compound | compound | accelerator | image | Remarks |
| 9 | 96 | red. agent-1 | present | polyhalogen-1 | present | AA | Invention |
| | | red. agent-2 | | polyhalogen-2 | | | |
| 201 | 82 | red. agent-1 | present | polyhalogen-1 | present | AA | Invention |
| | | red. agent-2 | | polyhalogen-2 | | | |
| 202 | 96 | red. agent-3 | present | polyhalogen-1 | present | AA | Invention |
| | | | | polyhalogen-2 | | | |
| 203 | 96 | red. agent-1 | present | polyhalogen-2 | present | AA | Invention |
| | | red. agent-2 | | | | | |

Alhough the photothermographic materials of Example 2 were designed to adapt to rapid processing, they had a non-photosensitive intermediate layer A which contained a binder including a hydrophobic polymer by 50 mass % or more between the image forming layer and the outermost layer, and was exposed with an X-ray intensifying screen, and therefore provided an image with little white spot.

### Example 3

A photothermographic material 301 was prepared in the same manner as the photothermographic material-6 in Example 1, except that the intermediate layer-B coating liquid-2 was replaced with an intermediate layer-B coating liquid-3 which was the same as the intermediate layer-B B coating liquid-2 except that it further contained 120 g of a crosslinking agent-i (EPOCROSS K- 2020E manufactured by Nippon Shokubai Co.). The photothermographic material was evaluated in the same manner as in Example 1. Results are shown in Table 4.

TABLE 4

| | | | | | White | |
|---|---|---|---|---|---|---|
| | Outermost | Intermediate layer B | | Intermediate | spot | |
| Photothermographic | layer | | crosslinking | layer A | in | |
| material | binder | binder | agent | binder | image | Remarks |
| 6 | gelatin/latex = 100/ | PVA/latex = 100/ | none | P-17 = 100 | AA | invention |
| | 34.2 | 80 | | | | |
| 301 | gelatin/latex = 100/ | PVA/latex = 100/ | crosslinking | P-17 = 100 | AA | Invention |
| | 34.2 | 80 | agent-1 | | | |

The addition of the crosslinking agent further reduced white spot in the photothermographic material.

### Example 4

1. Substrate

1-1 Preparation of PET Substrate

PET was made of terephthalic acid and ethylene glycol in an ordinary manner and had an intrinsic viscosity IV of 0.66 (measured in a mixture of phenol and tetrachloroethane at a weight ratio of 6/4 at 25° C.). This was pelletized, and the resultant was dried at 130° C. for 4 hours, fused at 300° C., extruded out from a T-die, and rapidly cooled. Thus, a non-oriented film having a thickness corresponding to a thickness after thermal fixing of 175 μm was prepared.

The film was longitudinally oriented by rolls rotating at different circumferencial speeds at 110° C. so that the longitudinal length thereof after the orientation was 3.3 times as long as the original longitudinal length thereof. Next, the film was laterally oriented by a tenter at 130° C. so that the lateral length thereof after the orientation was 4.5 times as long as the original lateral length thereof. Next, the oriented film was thermally fixed at 240° C. for 20 seconds, and then laterally relaxed by 4% at the same temperature. Next, the chuck portion of the tenter was slitted, and the both edges of the film were knurled, and the film was rolled up at 4 kg/cm². The rolled film having a thickness of 175 μm was obtained.

1-2 Preparation of Undercoated Substrate

(1) Preparation of Coating Liquid for Undercoat Layer

Formulation (1) (for undercoat layer on side of image forming layer)

| | | |
|---|---|---|
| PESRESIN A-520 (30 mass % solution) | 59 | g |
| (manufactured by Takamatsu Yushi Co. Ltd.) | | |
| Polyethylene glycol monononylphenyl ether (average | 5.4 | g |
| number of ethylene oxide of 8.5), 10 mass % solution | | |
| MP-1000 (polymer particles, average particle size of.4 μm) | 0.91 | g |
| (manufactured by Soken Chemical Co. Ltd.) | | |
| Distilled water | 935 | ml |

Formulation (2) (for first layer on back side)

| | | |
|---|---|---|
| Styrene-butadiene copolymer latex (solid content of 40 mass | 158 | g |
| %, styrene/butadiene weight ratio of 68/32) | | |
| 8 mass % aqueous solution of | 20 | g |
| 2,4-dichloro-6-hydroxy-S-triazine sodium salt | | |
| 1 mass % aqueous solution of sodium laurylbenzenesulfonate | 10 | ml |
| Distilled water | 854 | ml |

Formulation (3) (for second layer on back side)

| | | |
|---|---|---|
| SnO₂/SbO (mass ratio of 9/1, average particle size of | 84 | g |
| 0.038 μm, 17 mass % dispersion) | | |
| Gelatin (10 mass % aqueous solution) | 89.2 | g |
| METLOSE TC-5 (2 mass % aqueous solution) (manufactured | 8.6 | g |
| by Shin-etsu Chemical Ltd.) | | |
| MP-1000 (manufactured by Soken Chemical Co. Ltd.) | 0.01 | g |
| 1 mass % aqueous solution of sodium | 10 | ml |
| dodecylbenzenesulfonate | | |
| NaOH (1 mass %) | 6 | ml |
| PROXEL (manufactured by ICI Ltd.) | 1 | ml |
| Distilled water | 805 | ml |

One side (side on which an image forming layer will be formed, or front surface) of the aforementioned biaxially oriented polyethylene terephthalate substrate having a thickness of 175 μm and subjected to the corona discharge treatment was coated with the undercoat layer coating liquid having the above formulation (1) with a wire bar so that the wet coating amount became 6.6 ml/m². The resultant coating was dried for 5 minutes at 180° C. Then, the undercoat layer coating liquid having the above formulation (2) was coated on the rear side (back surface) of the substrate with a wire bar so that the wet coating amount became 5.7 ml/m². The resultant coating was dried for 5 minutes at 180° C., and the undercoat layer coating liquid having the above formulation (3) was coated on the resultant layer formed on the back surface with a wire bar so that the wet coating amount became 7.7 ml/m². The resultant coating was dried for 6 minutes at 180° C. to obtain an undercoated substrate.
2) Back Layer
Preparation of Coating Liquid for Antihalation Layer

32.7 g of lime-processed gelatin, 0.77 g of mono-disperse polymethyl methacrylate particles (average particle size of 8 μm, a standard deviation of particle size of 0.4 μm), 0.08 g of benzoisothiazolinone, 0.3 g of sodium polystyrenesulfonate, 0.06 g of a blue dye compound-1, 1.5 g of an ultraviolet absorbent-1, 5.0 g of an acrylic acid/ethyl acrylate copolymer latex (copolymerizatiion ratio: 5/95), and 1.7 g of N,N-ethylenebis(vinylsulfonacetamide) were mixed with water kept at 40° C. A 1 mol/l sodium hydroxide solution was added to the resultant mixture to adjust the pH of the mixture to 6.0. Water was added to the mixture so that the total amount of the mixture became 818 ml. A coating liquid for an antihalation layer was thus obtained.

Preparation of Coating Liquid for Back Protective Layer

66.5 g of lime-processed gelatin, 5.4 g of liquid paraffin emulsified in a liquid paraffin emulsion, 0.10 g of benzoisothiazolinone, 0.5 g of sodium di(2-ethylhexyl)sulfosuccinate, 0.27 g of sodium polystyrenesulfonate, 13.6 ml of a 2% aqueous solution of a fluorinated surfactant (FF-1), and 10.0 g of an acrylic acid/ethyl acrylate copolymer (copolymerization ratio: 5/95) were mixed with water kept at 40° C. A 1 mol/l sodium hydroxide solution was added to the resultant mixture to adjust the pH of the mixture to 6.0. Water was added to the mixture so that the total amount of the mixture became 1000 ml. A coating liquid for a back protective layer was thus obtained.

Coating of Back Layer

The rear surface of the undercoated substrate was simultaneously coated with the coating liquid for an antihalation layer and the coating liquid for a back protective layer to form superposed layers. At this time, the amount of gelatin contained in the coating liquid for an antihalation layer and the coating liquid for a back protective layer are 0.88 and 1.2 g/m², respectively. These layers were dried to obtain a back layer.

3. Image Forming Layer, Intermediate Layer and Surface Protective Layer

3-1 Preparation of Coating Materials

1) Silver Halide Emulsion
Preparation of Silver Halide Emulsion 1

4.3 mL of a 1 mass % potassium iodide solution, 3.5 mL of 0.5 mol/L sulfuric acid, and 36.7 g of phthalated gelatin were added to 1420 mL of distilled water. The resulting solution was put into a stainless steel reaction pot. The solution was kept at 42° C. while it was being stirred. Solution A was prepared by diluting 22.22 g of silver nitrate with distilled water such that the total volume of the resultant mixture was 195.6 mL. Soution B was prepared by diluting 21.8 g of potassium iodide with distilled water such that the total volume of the resultant mixture was 218 mL. The whole of these solutions A and B were added to the content in the reaction pot at constant flow rates over 9 minutes. Then, 10 mL of a 3.5 mass % aqueous solution of hydrogen peroxide, and 10.8 mL of a 10 mass % aqueous solution of benzimidazole were added to the system.

Solution C was prepared by diluting 51.86 g of silver nitrate with distilled water such that the total volume of the resultant mixture was 317.5 mL. Moreover, Solution D was prepared by diluting 60 g of potassium iodide with distilled water such that the total volume of the resultant mixture was 600 mL. These solutions C and D were added to the system. At this time, the whole of Solution C was added at a constant flow rate over 120 minutes. Moreover, Solution D was added in accordance with a controlled double jet method while pAg was kept at 8.1. When ten minutes had lapsed since staring of addition of Solutions C and D, potassium hexachloroiridate (III) was added to the system in an amount of 1×10⁻⁴ mol per mol of silver. Further, when five seconds had lapsed since completion of addition of Solution C., an aqueous solution of potassium hexacyanoiron (II) was added to the system in an amount of 3×10⁻⁴ mol per mol of silver. 0.5 mol/L sulfuric acid was added to the system so as to adjust pH of the system to 3.8. Then stirring was stopped, and precipitating/desalting/washing steps were carried out. One mol/L sodium hydroxide was added to the system so as to adjust pH of the system to 5.9 and then a silver halide dispersion having pAg of 8.0 was prepared.

The silver halide dispersion was kept at 38° C. while it was being agitated. 5 ml of a 0.34 mass % methanol solution of 1,2-benzoisothiazolin-3-one was added to the dispersion, and the resultant mixture was heated to 47° C. When 20 minutes had lapsed since the temperature elevation, sodium benzenethiosulfonate contained in a methanol solution was added to the mixture in an amount of 7.6×10⁻⁵ moles per mole of silver. Five minutes Iter, a tellurium sensitizer B contained in a methanol solution was added to the mixture in an amount of 2.9×10⁻⁴ moles per mole of silver, and the resultant was ripened for 91 minutes.

Thereafter, 1.3 ml of a 0.8 mass % methanol solution of N,N′-dihydroxy-N″-diethylmelamine were added to the mixture. Four minutes later, 5-methyl-2-mercaptobenzimidazole contained in a methanol solution in an amount of 4.8×10⁻³ moles per mole of silver, and 1-phenyl-2-heptyl-5-mercapto-1,3,4-triazole contained in a methanol solution in an mount of 5.4×10⁻³ moles per mole of silver were added to the mixture to prepare a silver halide emulsion 1.

Thus prepared silver halide emulsion contained pure silver iodide grains having an average sphere-corresponding diameter of 0.040 μm and a variation coefficient of the sphere-corresponding diameter of 18%. The grains were tetradecahedral grains having (001), {100} and {101} planes, having a γ-phase rate of 30% measured by X-ray powder diffractometry. The grain size and the like were determined by measuring those of 1000 grains from their electron microscopic images and averaging the measured deta.
Preparation of Silver Halide Emulsion 2

A silver halide emulsion 2 was prepared in the same manner as the emulsion 1, except that the temperature of the reaction solution was changed to 65° C., except hat 5 ml of a 5% solution of 2,2′-(ethylenedithio) diethanol were added to the system after the addition of the solutions A and B, except that the solution D was added in accordance with a controlled double jet method while pAg was kept at 10.5 and except that that, when three minutes had elapsed since the addition of the tellurium sensitizer at the time of chemical sensitization, bromoauric acid in an amount of 5×10⁻⁴ moles per mole of silver and potassium thiocyanate in an amount of 2×10⁻³ moles per mole of silver were added to the system.

The prepared silver halide emulsion contained pure silver iodide tabular grains whose average of diameters of circles having the same area as the projected areas of grains was 0.164 μm, whose thickness was 0.032 μm, whose average aspect ratio was 5, whose average sphere-corresponding diameter was 0.11 μm and whose variation factor of the average sphere-corresponding diameter was 23%. A powder X-ray diffractometry showed that the grains had a γ-phase rate of 80%. The particle size and the like were determined by measuring those of 1000 grains from their electron microscopic images and averaging the measured deta.
Preparation of Silver Halide Emulsion 3

A silver halide emulsion 3 was prepared in the same manner as the silver halide emulsion 1, except that the temperature of the reaction solution was changed to 27° C., and except that the solution D was added in accordance with a controlled double jet method while pAg was kept at 10.2.

The prepared silver halide emulsion contained pure silver iodide grains having an average sphere-corresponding diameter of 0.022 μm and a variation coefficient of the average sphere-corresponding diameter of 17%. The grains were dodecahedral grains having (001), {1(−1)0} and {101} planes, and powder X-ray diffractometry proved that allmost all of the silver iodide grains had β-phase. The particle size and the like were determined by measuring those of 1000 grains from their electron microscopic images and averaging the measured deta
Preparation of Mixed Emulsion A for Coating Liquid

The silver halide emulsion 1, the silver halide emulsion 2 and the silver halide emulsion 3 were mixed at a silver molar ratio of 5:2:3, and fused, and benzothiazolium iodide contained in a 1 mass % aqueous solution was added to the resultant emulsion in an amount of 7×10⁻³ moles per mole of silver. Then water was added to the emulsion so that the amount of silver of silver halide became 38.2 g per kg of mixed emulsion. 1-(3-methylureido)-5-mercaptotetrazole sodium salt was added to the emulsion in an amount of 0.34 g per kg of the mixed emulsion.

As compounds capable of undergoing one-electron oxidation to form a one-electron oxidant that can release one or more electrons”, each of compounds 1, 2 and 3 was added to the resultant mixture in an amount of 2×10⁻³ moles per mole of silver of silver halide.

Each of adsorptive redox compounds 1 and 2 each including an adsorptive group and a reducing group was added to the mixture in an amount of 5×10⁻³ moles per mole of silver halide.

Then, water was added to the mixture so that the content of silver of silver halide was 38.2 g per kg of the mixed emulsion for a coating liquid. 1-(3-methylureidophenyl)-5-mercaptotetrazole was added to the emulstion in an amount of 0.34 g per kg of the mixed emulsion for a coating liquid.
2) Preparation of Organic Silver Salt Dispersion
<Purification of Recrystallized Behenic Acid A>

100 kg of behenic acid (EDENOR C22-85R (trade name) manufactured by Cognis Inc.) was mixed with 1200 kg of isopropyl alcohol, and dissolved therein at 50° C. The resultant solution was filtered with a 10 μm filter and cooled to 30° C. to recrystallize behenic acid. The cooling speed at the time of recrystallization was controlled at 3° C./hr. The obtained crystals were separated by centrifuging, and washed by pouring 100 kg of isopropyl alcohol. The recrystallization was further repeated twice. The precipitate in the early stage of recrystallization was filtered off to eliminate lignoseric acid and the remaining crystals were dried. The crystals was esterified and the resultant was subjected to GC-FID measurement. As a result, the content of behenic acid in the crystals was found to be 99.99 mol. %. The erucic acid content was 0.000001 mol. % or less.
<Purification of Recrystallized Stearic Acid>

100 kg of stearic acid (manufactured by Tokyo Kasei) were mixed with 1200 kg of isopropyl alcohol, and dissolved therein at 50° C. The resultant solution was filtered with a 10 μm filter and cooled to 20° C. to recrystallize stearic acid. The cooling speed at the time of recrystallization was controlled at 3° C./hr. The obtained crystals were separated by centrifuging, and washed by pouring 100 kg of isopropyl alcohol. The recrystallization was further repeated twice. The precipitate in the early stage of recrystallization was filtered off to eliminate carboxylic acids having chains longer than that of stearic acid and the remaining crystals were dried. The crystals was esterified and the resultant was subjected to GC-FID measurement. As a result, the content of stearic acid in the crystals was found to be 99.99 mol. %. The erucic acid content was 0.000001 mol. % or less.
Preparation of Organic Silver Salt Dispersion A

40 g of recrystallized behenic acid, 7.3 g of recrystallized stearic acid and 500 ml of water were agitated for 15 minutes at 90° C., 187 ml of 1N-NaOH were added to the resultant mixture over 15 minutes, 61 ml of a 1N aqueous solution of nitric acid were added to the mixture and the mixture was cooled down to 50° C. Then 124 ml of a 1N aqueous solution of silver nitrate were added to the mixture over 2 minutes, and the resultant mixture was agitated for 30 minutes. Thereafter, the mixture was suction-filtrated to collect a solid. The solid was rinsed with water until the conductivity of the filtrate reached 30 μS/cm. The obtained solid was stored as a wet cake without drying it.

The obtained crystals had a behenic acid content of 82 mol. % and a stearic acid content of 18 mol. %.

19.3 kg of polyvinyl alcohol (trade name PVA-217) and water were added to the wet cake whose amount corresponded to 260 kg of the dry weight thereof so that the total amount of the resultant became 1000 kg. The resultant was formed into slurry with a dissolver wing, and then pre-dispersed with a pipe-line mixer (Model PM-10 available from Mizuho Industry Co.).

Next, the pre-dispersed stock slurry was processed three times with a disperser (MICROFLUIDIZER M-610 obtained from Microfluidex International Corporation, and equipped with a Z-type interaction chamber) at a controlled pressure of 1150 kg/cm². A silver behenate dispersion was thus prepared. To cool it, corrugated tube type heat exchangers were disposed before and behind the interaction chamber. The temperature of the coolant in these heat exchangers was so controlled that the system could be processed at a dispersion temperature of 18° C.

Thus, preparation of an organic solver salt dispersion A was completed. Electron microscopic observation showed that the organic silver salt dispersion A included acicular particles having an average shorter diameter of 0.04 μm, an average longer diameter of 0.8 μm and a variation coefficient of projected areas of 30%.
3) Preparation of Reducing Agent Dispersion
Preparation of Reducing Agent-1 Dispersion

10 kg of a reducing agent-1 (2,2′-methylenebis-(4-ethyl-6-tert-butylphenol)), 16 kg of a 10 mass % aqueous solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) including zirconia beads which had a mean diameter of 0.5 mm, and dispersed therewith for 3 hours. Then, 0.2 g of sodium salt of benzoisothiazolinone and water were added thereto to adjust the reducing agent concentration of the resultant to 25% by mass. The dispersion was heated at 60° C. for 5 hours. A reducing agent-1 dispersion was thus prepared. The reducing agent particles in the dispersion had a median diameter of 0.40 μm, and a maximum particles size of at most 1.4 μm. The reducing agent dispersion was filtered through a polypropylene filter having a pore size of 3.0 μm to remove foreign objects such as dirt from it, and then stored.
Preparation of Reducing Agent-2 Dispersion

10 kg of a reducing agent-2 (6,6′-di-t-butyl-4,4′-dimethyl-2,2′-butylidenediphenol), 16 kg of a 10 mass % aqueous solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) including zirconia beads which had a mean diameter of 0.5 mm, and dispersed therewith for 3 hours and 30 minutes. Then, 0.2 g of sodium salt of benzoisothiazolinone and water were added thereto to adjust the reducing agent concentration of the resultant to 25% by mass. The dispersion was then heated at 40° C. for 1 hour, and then at 80° C. for 1 hour. A reducing agent-2 dispersion was thus prepared. The reducing agent particles in the dispersion had a median diameter of 0.50 μm, and a maximum particle size of at most 1.6 μm. The reducing agent dispersion was filtered through a polypropylene filter having a pore size of 3.0 μm to remove foreign objects such as dirt from it, and then stored.
4)Preparation of Hydrogen Bonding Compound Dispersion

10 kg of a hydrogen bonding compound-1 (tri(4-t-butylphenyl)phosphine oxide), 16 kg of a 10 mass % aqueous solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Coeporation) containing zirconia beads which had a mean diameter of 0.5 mm, and dispersed therewith for 4 hours. Then, 0.2 g of sodium salt of benzoisothiazolinone and water were added thereto to adjust the hydrogen bonding compound concentration of the resultant to 25% by mass. The dispersion was heated at 40° C. for 1 hour and then at 80° C. for 1 hour. A hydrogen bonding compound-1 dispersion was thus prepared. The hydrogen bonding compound particles in the dispersion had a median diameter of 0.45 μm, and a maximum particle size of at most 1.3 μm. The hydrogen bonding compound dispersion was filtered through a polypropylene filter having a pore size of 3.0 μm to remove foreign objects such as dirt from it, and then stored.
5) Preparation of Dispersions of Development Accelerator and Color Toning Agent
Preparation of Development Accelerator-1 Dispersion

10 kg of a development accelerator-1, 20 kg of a 10 mass % solution of modified polyvinyl alcohol (POVAL MP203 available from Kuraray Co., Ltd.) and 10 kg of water were sufficiently mixed to form slurry. The slurry was fed by a diaphragm pump into a horizontal sand mill (UVM-2 available from Imex Corporation) containing zirconia beads which had a mean diameter of 0.5 mm, and dispersed therewith for 3 hours and 30 minutes. Then, 0.2 g of sodium salt of benzoisothiazolinone and water were added thereto to prepare a development accelerator-1 dispersion having a development accelerator concentration of 20% by mass. The development accelerator particles in the dispersion had a median diameter of 0.48 μm, and a maximum particle size of at most 1.4 μm. The development accelerator dispersion was filtered through a polypropylene filter having a pore size of 3.0 μm to remove foreign objects such as dirt from it, and then stored.

Solid Dispersions of a Development Accelerator-2 and a Color Toning Agent-1

Development accelerator-2 and color toning agent-1 solid dispersions respectively having concentrations of 20 mass % and 15 mass % were prepared in the same manner as the development accelerator-1 dispersion.
6) Preparation of Polyhalogen Compound Dispersion
Preparation of Organic Polyhalogen Compound-1 Dispersion

10 kg of an organic polyhalogen compound-1 (tribromomethanesulfonylbenzene), 10 kg of a 20 mass % aqueous solution of modified polyvinyl alcohol (POVAL MP203 available from Kuraray Co., Ltd.), 0.4 kg of a 20 mass % aqueous solution of sodium triisopropylnaphthalenesulfonate, and 14 kg of water were sufficiently mixed to prepare slurry. The slurry was fed by a diaphragm pump into a horizontal sand mill (UVM-2 available from Imex Corporation ) including zirconia beads which had a mean diameter of 0.5 mm, and dispersed therewith for 5 hours. Then, 0.2 g of sodium salt of benzoisothiazolinone and water were added thereto to prepare an organic polyhalogen compound-1 dispersion having an ogranic polyhalogen compound content of 30 mass %. The organic polyhalogen compound particles in the dispersion had a median diameter of 0.41 μm, and a maximum particle size of at most 2.0 μm. The organic polyhalogen compound dispersion was filtered through a polypropylene filter having a pore size of 10.0 ∞m to remove foreign objects such as dirt from it, and then stored.
Preparation of Organic Polyhalogen Compound-2 dispersion

10 kg of an organic polyhalogen compound-2 (N-butyl-3-tribromomethanesulfonylbenzamide), 20 kg of a 10 mass % aqueous solution of modified polyvinyl alcohol (POVAL MP203 available from Kuraray Co., Ltd.), and 0.4 kg of a 20 mass % aqueous solution of sodium triisopropylnaphthalenesulfonate were sufficiently mixed to prepare slurry. The slurry was fed by a diaphragm pump into a horizontal sand mill (UVM-2 available from Imex Corporation) including zirconia beads which had a mean diameter of 0.5 mm, and dispersed therewith for 5 hours. Then, 0.2 g of sodium salt of benzoisothiazolinone and water were added thereto to adjust the organic polyhalogen compound content of the resultant to 30 mass %. The dispersion was heated at 40° C. for 5 hours. An organic polyhalogen compound-2 dispersion was thus obtained. The organic polyhalogen compound particles in the dispersion had a median diameter of 0.40 μm, and a maximum particle size of at most 1.3 μm. The organic polyhalogen compound dispersion was filtered through a polypropylene filter having a pore size of 3.0 μm to remove foreign objects such as dirt from it, and then stored.
7) Preparation of Phthalazine Compound Solution

8 kg of modified polyvinyl alcohol (MP203 manufactured by Kuraray Co., Ltd.) was dissolved in 174.57 kg of water, and 3.15 kg of a 20 mass % aqueous solution of sodium triisopropylnaphthalenesulfonate and 14.28 kg of a 70 mass % aqueous solution of a phthalazine compound-1 (6isopropylphthalazine) were added to the resultant solution to obtain a 5 mass % solution of the phthalazine compound-1.
8) Preparation of Mercapto Compound
Preparation of Aqueous Solution of Mercapto Compound-1

7 g of mercapto compound-1 (1-(3sulfophenyl)-5-mercaptotetrazole sodium salt) was dissolved in 993 g of water to obtain a 0.7 mass % aqueous solution.

Preparation of Aqueous Solution of Mercapto Compound-2

20 g of mercapto compound-2 (1-(3-methylureidophenyl)-5-mercaptotetrazole) was dissolved in 980 g of water to obtain a 2.0 mass % aqueous solution. 9) Preparation of Pigment-1 Dispersion

64 g of C. I. Pigment blue 60, 6.4 g of DEMOL N (manufactured by Kao Corp.) and 250 g of water were sufficiently mixed to obtain slurry. The slurry was placed in a vessel together with 800 g of zirconia beads having an average diameter of 0.5 mm, then dispersed for 25 hours with a disperser (1/4G sand grinder mill manufactured by Imex Co.) and water was added to the system to adjust the pigment concentration of the system to 5 mass %, thereby obtaining a pigment-1 dispersion. The pigment particles contained in thus obtained pigment dispersion had an average particle size of 0.21 μm.
10) Preparation of SBR Latex Liquid

An SBR latex was prepared as follows.

287 g of distilled water, 7.73 g of a surfactant (PIONIN A-43-S produced by Takemoto Yushi Corporation and having a solid content of 48.5 mass %), 14.06 ml of 1 mol/liter NaOH, 0.15 g of tetrasodium ethylenediaminetetraacetate, 255 g of styrene, 11.25 g of acrylic acid, and 3.0 g of tert-dodecylmercaptan were put into the polymerization reactor of a gas monomer reaction apparatus (TAS-2J Model available from Taiatsu Techno Corporation). The reactor was sealed off, and the content therein was stirred at 200 rpm. The internal air was exhausted via a vacuum pump, and replaced a few times repeatedly with nitrogen. Then, 108.75 g of 1,3-butadiene was introduced into the reactor under pressure, and the internal temperature of the reactor was raised to 60° C. A solution in which 1.875 g of ammonium persulfate was dissolved in 50 ml of water was added to the system, and the system was stirred for 5 hour. It was further heated to 90° C. and stirred for 3 hours. After the reaction was completed, the internal temperature was lowered to room temperature. Then, NaOH and NH₄OH (both 1 mol/liter) were added to the system at a molar ratio of Na⁺ and NH₄⁺ of 1/5.3 so as to adjust the pH of the system to 8.4. Next, the system was filtered through a polypropylene filter having a pore size of 1.0 μm to remove foreign objects such as dirt from it, and then stored. 774.7 g of SBR latex was thus obtained. Its halide ion content was measured through ion chromatography, and the chloride ion concentration of the latex was 3 ppm. The chelating agent concentration thereof was measured through high-performance liquid chromatography, and was 145 ppm.

The mean particle size of the latex was 90 nm, Tg thereof was 17° C., the solid content thereof was 44% by mass, the equilibrium moisture content thereof at 25° C. and 60% RH was 0.6 mass %, and the ion conductivity thereof was 4.80 mS/cm. To measure the ion conductivity, a conductivity meter CM-30S manufactured by Toa Denpa Kogyo K. K. was used. In the device, the 44 mass % latex was measured at 25° C. Its pH was 8.4.

An SBR latex having a different Tg can be prepared in the same manner except that the ratio of styrene and butadiene is suitably changed.
3-2 Preparation of Coating Liquid
1) Preparation of Coating Liquid-1 for Image Forming Layer The pigment-1 dispersion, the organic polyhalogen compound-1 dispersion, the organic polyhalogen compound-2 dispersion, the phtalazine compound-1 solution, the SBR latex (Tg: 17° C.) liquid, the reducing agent-1 dispersion, the reducing agent-2 dispersion, the hydrogen bonding compound-1 dispersion, the development accelerator-1 dispersion, the development accelerator-2 dispersion, the color toning agent-1 dispersion, the aqueous solution of mercapto compound-1, and the aqueous solution of mercapto compound-2 were successively added to 1,000 g of the dispersion of the silver salt of the fatty acid and 276 ml of water. Just before coating, the silver halide emulsion A for coating liquid was added to and sufficiently mixed with the above mixture. A coating liquid for an image-forming layer was thus prepared and was fed as it is to a coating die applied to the substrate.

The image forming layer coating liquid had a viscosity, measured with a B-type viscosimeter (manufactured by Tokyo Keiki Co.), of 25 [mPa·s] at 40° C. (No. 1 rotor, 60 rpm).

The coating liquid had viscosities at 25° C., measured with RFS fluid spectrometer (manufactured by Rheometrics Far East Inc.) of 242, 65, 48, 26 and 20 [mPa·s] respectively at shear speeds of 0.1, 1, 10, 100 and 1000 [l/sec].

The zirconium amount in the coating liquid was 0.52 mg per g of silver.
2) Preparation of Intermediate Layer-A Coating Liquid
<<Preparation of Intermediate Layer-A Coating Liquid-1>>

27 ml of a 5 mass % aqueous solution of AEROSOL OT (available from American Cyanamid Company), 135 ml of a 20 mass % aqueous solution of diammonium phthalate and water were added to 1000 g of polyvinyl alcohol (PVA-205 available from Kuraray Co., Ltd.), 272 g of the pigment-1 dispersion, and 4200 ml of a 19 mass % latex of a methyl methacrylate/styrene/butyl acrylate/hydroxyethyl methacrylate/acrylic acid copolymer (copolymerization weight ratio: 64/9/20/5/2) so that the total amount of the resultant mixture became 10000 g. The pH of the mixture was adjusted to 7.5 by adding NaOH to the mixture. An intermediate layer-A coating liquid-1 was thus obtained. This was fed into a coating die so that the amount of the coating liquid was 9.1 ml/m².

The viscosity of the coating liquid was 58 mPa·S when measured with a B-type viscometer (rotor No. 1, 60 rpm) at 40° C.
<<Preparation of Intermediate Layer-A Coating Liquids-2 - 8>>

Intermediate layer-A coating liquids-2 to 8 were prepared in the same manner as the intermediate layer-A coating liquid-1, except that polyvinyl alcohol PVA-205 and the methyl methacrylate/styrene/butyl acrylate/hydroxyethyl methacrylate/acrylic acid copolymer were respectively replaced with binders shown in Table 5.
3) Preparation of Intermediate Layer-B Coating Liquid
<<Preparation of Intermediate Layer-B Coating Liquid-1>>

64 g of inert gelatin were dissolved in water. 112 g of a 19 mass % latex of methyl methacrylate/styrene/butyl acrylate/hydroxyethyl methacrylate/acrylic acid copolymer (copolymerizing weight ratio: 64/9/20/5/2), 30 ml of a 15 mass % methanol solution of phthalic acid, 23 ml of a 10 mass % aqueous solution of 4-methylphthalic acid, 28 ml of sulfuric acid of a concentration of 0.5 mol/L, 5 ml of a 5 mass % aqueous solution of AEROSOL OT (manufactured by American Cyanamide Inc.), 0.5 g of phenoxyethanol, 0.1 g of benzothiazolinone were added to the resultant solution. Water was added to the resultant mixture so that the total amount of the mixture became 750 g. 26 ml of a 4 mass % solution of chromium alum was mixed with the mixture by a static mixer immediately before coating, and the resultant coating liquid was supplied to a coating die at a rate of 18.6 ml/m².

The viscosity of the coating liquid, measured with a B-type viscosimeter (rotor No. 1, 60 rpm), was 20 mPa·s at 40° C.
<<Preparation of Intermediate Layer-B Coating Liquids-2 to 4>>

An intermediate layer-B coating liquids-2 to 4 were prepared in the same manner as the intermediate layer coating liquid-1 except that the inert gelatin and the methyl methacrylate/styrene/butyl acrylate/hydroxyethyl methacrylate/acrylic acid copolymer were replaced with binders shown in Table 5.
4. Preparation of Coating Liquid for Outermost Layer
<<Preparation of Coating Liquid-1 for Outermost Layer>>

80 g of inert gelatin was dissolved in water. The resultant solution was mixed with 102 g of a 27.5 mass % latex of methyl methacrylate/styrene/butyl acrylate/hydroxyethyl methacrylate/acrylic acid copolymer (copolymerizing weight ratio: 64/9/20/5/2), 5.4 ml of a 2 mass % solution of a fluorinated surfactant (FF-1), 5.4 ml of a 2 mass % solution of a fluorinated surfactant (FF-2), 23 ml of a 5 mass % aqueous solution of AEROSOL OT (manufactured by American Cyanamide Inc.), 4 g of polymethyl methacrylate fine particles (average particle size of 0.7 gm), 21 g of polymethyl methacrylate fine particles (average particle size of 4.5 μm), 1.6 g of 4-methylphthalic acid, 4.8 g of phthalic acid, 44 ml of sulfuric acid of a concentration of 0.5 milL, 10 mg of benzothiazolinone. Water was added to the resultant mixture so that the total amount of the resultant became 650 g. 445 ml of an aqueous solution containing 4 mass % of chromium alum and 0.67 mass % of phthalic acid were mixed with the resultant mixture by a static mixer immediately before coating to obtain a coating liquid for a surface protective layer, which was fed to a coating die at a rate of 8.3 ml/m².

The viscosity of the coating liquid, measured with a B-type viscosimeter (rotor No. 1, 60 rpm), was 19 mPa·s at 40° C.
<<Preparation of Coating Liquids-2 to 3 for Outermost Layer>>

Outermost layer coating liquids-2 to 3 were prepared in the same manner as the outermost layer coating liquid-1 except that the inert gelatin and the latex of methyl methacrylate/styrene/butyl acrylate/hydroxyethyl methacrylate/acrylic acid copolymer (copolymerizing weight ratio: 57/8/28/5/2) were replaced with binders shown in Table 5.

Outermost layer coating liquids-2 - 3 were prepared by changing the inert gelatin and latex of
4. Preparation of Photothermographic Material
1) Preparation of Photothermographic Material-401

The image forming layer coating liquid-1, the intermediate layer-A coating liquid-1, the intermediate layer-B coating liquid-1, and the outermost layer coating liquid-1 were simultaneously applied to the undercoat layer formed on the front surface of the substrate in that order in accordance with a slide bead coating method to form superimposed layers. Thus, a sample of a photothermographic material was prepared. In this operation, the temperature of the coating liquids of an image forming layer and an intermediate layer A was controlled at 31° C. for, that of the coating liquid of an intermediate layer B was controlled at 36° C. and that of the coating liquid of an outermost layer was controlled at 37° C.

The coating amount of each of the compounds contained in the image forming layer were as follows (g/m²):

| | |
|---|---|
| Silver behenate | 5.27 |
| Pigment (C. I. Pigment Blue 60) | 0.036 |
| Polyhalogen compound-1 | 0.09 |
| Polyhalogen compound-2 | 0.14 |
| Phthalazine compound-1 | 0.18 |
| SBR latex | 9.43 |
| Reducing agent-1 | 0.55 |
| Reducing agent-2 | 0.22 |
| Hydrogen bonding compound-1 | 0.28 |
| Development accelerator-1 | 0.025 |
| Development accelerator-2 | 0.020 |
| Color toning agent-1 | 0.008 |
| Mercapto compound-1 | 0.002 |
| Mercapto compound-2 | 0.006 |
| silver halide (in terms of silver amount) | 0.046 |

Coating and drying conditions were as follows.

The coating speed was 160 m/minute. The distance between the coating die tip and the substrate was between 0.10 and 0.30 mm. The pressure in the decompression chamber was lower by 196 to 882 Pa than the atmospheric pressure. Before coating, the static electricity of the substrate was eliminated by blowing an ionic blow to the substrate.

In the subsequent chilling zone, the coated substrate was chilled with an air blow (its dry-bulb temperature was 10 to 20° C.). The substrate was transported in a contless manner to the helix type contactless drying zone, and dried with a dry air blow (its dry-bulb temperature was 23 to 45° C., and its wet-bulb temperature was 15 to 21° C.) there.

After the drying, the substrate was conditioned at 25° C. and 40 to 60% RH, and then heated so that the surface temperature was between 70 and 90° C. After thr heating, the substrate was cooled to have a surface temperature of 25° C.
2) Preparation of Photothermographic Materials-402 to 412.

Photothermographic materials-402 to -410 were prepared in the same manner as the photothermographic material-401, except that the materials of the intermediate layer-A coating liquid, the intermediate layer-B coating liquid and the outermost layer coating liquid were replaced with those shown in Table 5.

A photothermographic material-411 was prepared in the same manner as the photothermographic material-408, except that the intermediate layer B was replaced with two layers one of which was made of a liquid having a composition similar to that of the intermediate layer A as shown in Table 5 and disposed on a side closer to the image forming layer, and the other of which was made of a liquid having a formulation the same as that of the outermost layer except that it did not contain the fluorinated surfactants and the polymethyl methacrylate particles and disposed on a side closer to the outermost layer. A photothermographic matrial-412 was prepared in the same manner as the photothermographic material-411, except that the mterial of the outermost layer was changed as shown in Table 5.

The chemical structures of the compounds employed in the examples of the invention are shown below. 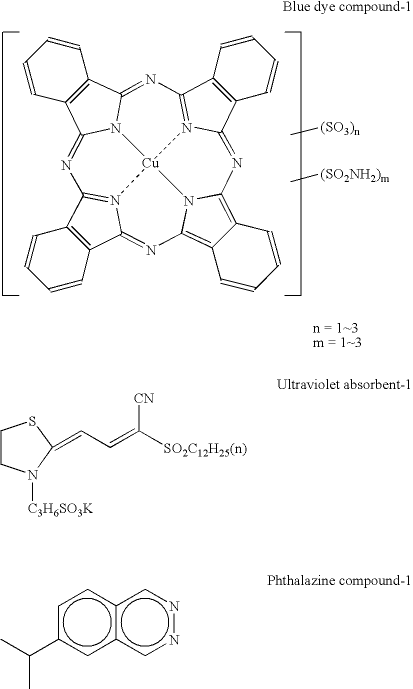
4. Evaluation of Photographic Performance
1) Preparation

Each of the samples was cut into pieces of a half-size, packaged with the following packaging material at 25° C. and 50% RH, stored at ordinary temperature for two weeks, and tested according to a test method mentioned below.
2) Packaging Material

The packaging material used herein was a film including a PET film having a thickness of 10 μm, a PE film having a thickness of 12 μm, an aluminium foil having a thickness of 9 μm, a nylone film having a thickness of 15 μm, and a 3 mass % carbon-containing polyethylene film having a thickness of 50 μm.
3) Exposure and development of photothermographic material

A semiconductor laser NLHV3000E manufactured by Nichia Chemical Industries Co., Ltd. was set in the exposure unit of a Fuji medical dry laser imager FM-DP L as a laser light source and a beam diameter was narrowed to 100 μm. Each sample was exposed to laser light for 10⁻⁶ seconds while an illumination intensity of the laser light at the surface of the photothermographic material was controlled at 0 and a value within a range of 1 to 1000 mW/mm². The laser had an oscillation wavelength of 405 nm. Thermal development was executed with four panel heaters respectively set at 112C., 118C., 120° C., and 120° C. At this time, the total development time was adjusted to 14 seconds which was attained by accelerating the transportation speed. The density of an obtained image was measured with a densitometer. The transportation speed of the photothermographic material at the time of thermal development was 28 mm/sec.
4) Evaluation of Photographic Performance
<Evaluation of Density Unevenness>

Laser output was so controlled as to form an image on each sample having a density of 1.2. Each sample was exposed to light emitted from the controlled laser and developed to form a solid image. The densities of four corners and the center of the obtained image were measured with a Macbeth densitometer, and the density unevenness was evaluated from density fluctuations on the basis of the following criterion. Ranks A and B are practically acceptable but ranks C., D and E are practically unacceptable:
A: The densities of the five points included within a range of 1.2±0.05;
B: The densities of four points amoung the five points included within the range of 1.2±0.05;
C: The densities of three points among the five points included within the range of 1.2±0.05;
D: The densities of two points among the five points included within the range of 1.2±0.05;
E: The density of one point among the five points included within the range of 1.2±0.05.

Results of evaluation are shown in Table 5.

TABLE 5

| | Outermost layer | | | Intermediate layer A | | |
|---|---|---|---|---|---|---|
| Photothermographic | binder (coated wt. | Intermediate layer B | | binder (coated wt. | Density | |
| material | ratio) | binder (coated wt. ratio) | | Ratio) | unevenness | Remarks |
| 401 | (1) gelatin/latex = 100/ | (1) gelatin/latex = 100/33.3 | | (1) PVA/latex = 100/8 | D | comp. |
| | 34.2 | | | | | ex. |
| 402 | (1) gelatin/latex = 100/ | (1) gelatin/latex = 100/33.3 | | (2) PVA-205/latex | B | invention |
| | 34.2 | | | (com.^{*1}LP-51) = 2/100 | | |
| 403 | (2) PVA-205/latex of | (2) PVA-205/latex of | | (2) PVA-205/latex | B | invention |
| | sample 1 = 100/35.1 | sample 1 = 100/33.3 | | (com. LP-51) = 2/100 | | |
| 404 | (3) PVA-205/latex of | (1) gelatin/latex of sample | | (2) PVA-205/latex | B | invention |
| | sample 1 = 10/100 | 1 = 100/33.3 | | (com. LP-51) = 2/100 | | |
| 405 | (1) gelatin/latex of | (1) gelatin/latex of sample | | (3) latex | B | invention |
| | sample 1 = 100/34.2 | 1 = 100/33.3 | | (com. LP-51) = 100 | | |
| 406 | (1) gelatin/latex of | (1) gelatin/latex of sample | | (4) latex | B | invention |
| | sample 1 = 100/34.2 | 1 = 100/33.3 | | (com. LP-28) = 100 | | |
| 407 | (1) gelatin/latex of | (1) gelatin/latex of sample | | (5) latex | B | invention |
| | sample 1 = 100/34.2 | 1 = 100/33.3 | | (com. LP-26) = 100 | | |
| 408 | (1) gelatin/latex of | (1) gelatin/latex of sample | | (6) PVA-205/latex | B | invention |
| | sample 1 = 100/34.2 | 1 = 100/33.3 | | (com. LP- | | |
| | | | | 28) = 0.5/100 | | |
| 409 | (1) gelatin/latex of | (1) gelatin/latex of sample | | (7) PVA-205/latex | B | invention |
| | sample 1 = 100/34.2 | 1 = 100/33.3 | | (com. LP- | | |
| | | | | 28) = 15/100 | | |
| 410 | (1) gelatin/latex of | (1) gelatin/latex of sample | | (8) PVA-205/latex | B | invention |
| | sample 1 = 100/34.2 | 1 = 100/33.3 | | (com. LP- | | |
| | | | | 51) = 15/100 | | |
| 411 | (1) gelatin/latex of | (1) gelatin/ | (3) PVA- | (6) PVA-205/latex | B | invention |
| | sample 1 = 100/34.2 | latex of | 205/latex | (com. LP- | | |
| | | sample 1 = 100/33.3 | of sample | 28) = 0.5/100 | | |
| | | | 1 = 100/15 | | | |
| 412 | (1) gelatin/latex of | (1) gelatin/ | (4) PVA- | (3) latex = 100 | A | invention |
| | sample 1 = 100/34.2 | latex of | 205/latex | (com. LP-51) | | |
| | | sample 1 = 100/ | of sample | | | |
| | | 33.3 | 1 = 100/30 | | | |

Note:
In the table, parenthesized numbers indicate numbers of coating liquids.
Com.: Exemplified Compound No.

As shown in Table 5, when a photothermographic material included a photosensitive silver halide containing silver iodide by 40 to 100 mol % and had a non-photosensitive intermediate layer A which contained a binder including a hydrophobic polymer by 50 mass % or more between an image forming layer and an outermost layer, the image formed on the photothermographic material had extremely little density unevenness.

In particular, when a latex was contained in the outermost layer of a photothermographic , a change in the image quality due to stickiness or due to fingerprinting did not occur and the stability was excellent.

### Example 5

### Preparation of Organic Silver Salt Dispersions B and C

Organic silver salt dispersions B and C were prepared in the same manner as the organic silver salt dispersion A in Example 4 except that the ratio of recrystallized behenic acid and recrystallized stearic acid was changed. The dispersions B and C having silver behenate contents different from that of the dispersion A.
<<Preparation of Reducing Agent-3 Dispersion>>

10 g of a reducing agent-3, 4 g of hydroxypropyl cellulose and 86 g of water were sufficiently mixed to obtain slurry, and the slurry was allowed to stand for 10 hours. Then, the slurry was put into a vessel together with 168 g of zirconia beads having an average diameter of 0.5 mm, and dispersed for 10 hours with a disperser the same as that employed in the preparation of the organic acid silver salt fine crystal dispersion to obtain a solid particle dispersion liquid. Particles having a size of 1.0 Hm accounted for 70 mass % of all the particles in the dispersion.
<<Preparation of Image Forming Layer Coating Liquids-2 to -5>>

Image forming layer coating liquids-2 to -5 were prepared in the same manner as the image forming layer coating liquid-1 in Example 4 except that the organic silver salt dispersion, the reducing agent, the organic polyhalogen compound, the hydrogen bonding compound, the color toning agent and the development accelerator were changed as shown in Table 6.
Preparation of Photothermographic Materials-501 to -507

Photothermographic materials-501 to -507 were prepared in the same manner as the photothermographic material-402 in Example 4, except that the image forming layer coating liquid-1 was replaced with one of the image forming layer coating liquids-2 to -6. The coating amounts (g/cm²) of the components contained in the image forming layer of these photothermographic materials were the same as those of the photothermographic material-1.

The photothermographic materials-501 to -507 were exposed to light, developed and evaluated in the same manner as in Example 4. Results are shown in Table 6.

TABLE 6

| | Image forming layer | | | | | | | | |
|---|---|---|---|---|---|---|---|---|---|
| | | Organic | | | | | | | |
| | | silver salt | | | | | | | |
| | | dispersion | | | | | | | |
| | | (type)/ | | | | | | | |
| | | (silver | | hydrogen | | | | | |
| | | behenate | reducing | bonding | | | | | |
| Photothermographic | | content, | agent | compd. | polyhalogen | development | color toning | density | |
| material | binder | mol. %) | (type) | (type) | compound | accelerator | agent | uneveness | Remarks |
| 402 | SBR | A/82 | 1 + 2 | 1 | 1 + 2 | 1 + 2 | 6-isopropyl | B | invention |
| | | | | | | | phthalazine | | |
| 501 | SBR | B/92 | 1 + 2 | 1 | 1 + 2 | 1 + 2 | 6-isopropyl | B | invention |
| | | | | | | | phthalazine | | |
| 502 | SBR | C/96 | 1 + 2 | 1 | 1 + 2 | 1 + 2 | 6-isopropyl | B | invention |
| | | | | | | | phthalazine | | |
| 503 | SBR | C/96 | 3 | 1 | 1 + 2 | 1 + 2 | 6-isopropyl | B | invention |
| | | | | | | | phthalazine | | |
| 504 | SBR | C/96 | 1 + 2 | D-2 | 1 + 2 | 1 + 2 | 6-isopropyl | B | invention |
| | | | | | | | phthalazine | | |
| 505 | SBR | C/96 | 1 + 2 | 1 | 2 | 1 + 2 | 6-isopropyl | B | invention |
| | | | | | | | phthalazine | | |
| 506 | SBR | C/96 | 1 + 2 | 1 | 1 + 2 | 2 | 6-isopropyl | B | invention |
| | | | | | | | phthalazine | | |
| 507 | SBR | C/96 | 1 + 2 | 1 | 1 + 2 | 1 + 2 | phthalazine | B | Invention |

Alhough the photothermographic materials of Example 5 were designed to adapt to rapid processing, they contained a photosensitive silver halide including silver iodide by 40 to 100 mol. % and had a non-photosensitive intermediate layer A which contained a binder including a hydrophobic polymer by 50 mass % or more between the image forming layer and the outermost layer, and therefore provided an image with little density unevenness.

### Example 6

An intermediate layer-A coating liquids were prepared in the same manner as the intermediate layer-A coating liquid-2 of Example 4, except that it further contained a crosslinking agent shown in Table 7 in an amount of 20 mass % with respect to the binder of the intermediate layer A. Photothermographic materials-601 to -604 were prepared and evaluated in the same manner as the photothermographic material-402 in Example 4, except that one of these intermediate layer-A coating liquids was used. Results are shown in Table 7.

TABLE 7

| | | | | Intermediate | | |
|---|---|---|---|---|---|---|
| Photothermographic | Outermost layer | Intermediate layer A | | layer B | Density | |
| material | Binder | binder | crosslinking agent | binder | unevenness | Remarks |
| 402 | (1) gelatin/latex = 100/ | (2) PVA-205/ | none | (1) gelatin/ | B | invention |
| | 34.2 | latex(com. LP- | | latex = 100/ | | |
| | | 51) = 2/100 | | 3.33 | | |
| 601 | (1) gelatin/latex = 100/ | (2) PVA-205/ | DICFINE EM-60 | (1) gelatin/ | A | invention |
| | 34.2 | latex(com. LP- | (Dai-Nippon Ink | latex = 100/ | | |
| | | 51) = 2/100 | & Chemicals Co., | 33.3 | | |
| | | | Ltd) | | | |
| 602 | (1) gelatin/latex = 100/ | (2) PVA-205/ | DURANATE | (1) gelatin/ | A | invention |
| | 34.2 | latex(com. LP- | WB40-100 (Asahi | latex = 100/ | | |
| | | 51) = 2/100 | Kasei Co., Ltd.) | 33.3 | | |
| 603 | (1) gelatin/latex = 100/ | (2) PVA-205/ | CARBODILITE | (1) gelatin/ | A | invention |
| | 34.2 | latex(com. LP- | E-01 (Nisshinbo | latex = 100/ | | |
| | | 51) = 2/100 | Co., Ltd.) | 33.3 | | |
| 604 | (1) gelatin/latex = 100/ | (2) PVA-205/ | EPOCROSS K- | (1) gelatin/ | A | invention |
| | 34.2 | latex(com. LP- | 2020E (Nippon | latex = 100/ | | |
| | | 51) = 2/100 | Shokubai Co. | 33.3 | | |
| | | | Ltd.) | | | |

Density unevenness was further improved by the addition of a crosslinking agent.

1. A photothermographic material having, at least on a surface of a substrate, an image forming layer including a photosensitive silver halide, a non-photosensitive organic silver salt, a reducing agent, and a binder, and configured to be exposed with an X-ray intensifying screen, the material comprising:
a non-photosensitive intermediate layer A on a surface of the substrate at the side having the image forming layer and between an outermost layer farthest from the substrate and the image forming layer;
wherein a binder of the non-photosensitive intermediate layer A includes a hydrophobic polymer by 50 mass % or more.

2. A photothermographic material according to claim 1, wherein the non-photosensitive intermediate layer A is provided adjacent to the image forming layer.

3. A photothermographic material according to claim 1, further comprising a non-photosensitive intermediate layer B containing a binder between the non-photosensitive intermediate layer A and the outermost layer, wherein a binder of at least one of the outermost layer and the non-photosensitive intermediate layer B includes a hydrophilic polymer derived from an animal protein by 50 mass % or more.

4. A photothermographic material according to claim 1, wherein the binder of the non-photosensitive intermediate layer A contains a polymer formed by copolymerizing a monomer represented by formula (M) by 10 to 70 mass %:
CH₂═CR⁰¹—CR⁰²═CH₂ formula (M)
wherein R⁰¹ and R⁰² each independently represents a hydrogen atom, an alkyl group with 1 to 6 carbon atoms, a halogen atom, or a cyano group.

5. A photothermographic material according to claim 1, wherein the X-ray intensifying screen includes a phosphor material.

6. A photothermographic material according to claim 1, wherein a binder of the non-photosensitive intermediate layer B includes a hydrophilic polymer derived from an animal protein by 50 mass % or more and a binder of the outermost layer includes a hydrophobic polymer.

7. A photothermographic material according to claim 1, wherein the non-photosensitive intermediate layer B is constituted of two or more sub-layers, and a non-photosensitive intermediate sub-layer closer to the non-photosensitive intermediate layer A includes a binder containing a hydrophilic polymer, not derived from an animal protein, by 50 mass % or more, and a non-photosensitive intermediate sub-layer closer to the outermost layer includes a binder containing a hydrophilic polymer, derived from an animal protein, by 50 mass % or more.

8. A photothermographic material according to claim 7, wherein the binder of the outermost layer includes a hydrophilic polymer derived from an animal protein.

9. A photothermographic material according to claim 7, wherein the binder of the outermost layer includes a hydrophobic polymer.

10. A photothermographic material according to claim 7, wherein the binder of the outermost layer includes a hydrophilic polymer derived from an animal protein and a hydrophobic polymer.

11. A photothermographic material according to claim 1, wherein the image forming layer is provided on both sides of the substrate.

12. A photothermographic material according to claim 1, wherein the photosensitive silver halide includes silver iodide by 40 to 100 mol. %.

13. A photothermographic material according to claim 1, wherein the photosensitive silver halide includes silver iodide by 80 to 100 mol. %.

14. A photothermographic material according to claim 1, wherein the reducing agent is a compound represented by formula (RI): 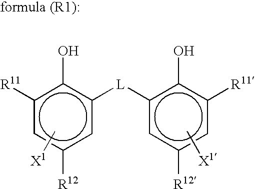
wherein R¹¹ and R^{11′} each independently represents a secondary or tertiary alkyl group with 1 to 15 carbon atoms; R¹² and R^{12′} each independently represents a hydrogen atom or a substituent substitutable on the benzene ring; L represents an —S— group or a —CHR¹³— group; R¹³ represents a hydrogen atom or an alkyl group with 1 to 20 carbon atoms; and X¹ and X^{1′} each independently represents a hydrogen atom or a group substitutable on the benzene ring.

15. A photothermographic material according to claim 1, wherein the image forming layer further includes a development accelerator.

16. A photothermographic material according to claim 1, wherein the image forming layer further includes a compound represented by formula (D): 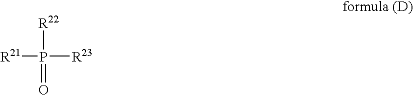
wherein R²¹ to R²³ each independently represents an alkyl group, an aryl group, an alkoxy group, an aryloxy group, an amino group or a heterocyclic group.

17. A photothermographic material according to claim 1, wherein the image forming layer further includes a compound represented by formula (H):
Q-(Y)ₙ(Z₁)(Z₂)X formula (H)
wherein Q represents an alkyl group, an aryl group or a heterocyclic group; Y represents a divalent connecting group; n represents 0 or 1; Z₁ and Z₂ each independently represents a halogen atom; and X represents a hydrogen atom or an electron-attractive group.

18. A photothermographic material according to claim 17, wherein the image forming layer includes two or more compounds represented by formula (H).

19. A photothermographic material according to claim 1, wherein the image forming layer further includes a compound represented by formula (I): 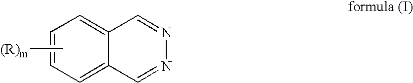
wherein R represents a substituent and m represents an integer from 1 to 6.

20. A photothermographic material according to claim 19, wherein the image forming layer further includes a color toning agent.

21. A photothermographic material according to claim 1, wherein the non-photosensitive organic silver salt includes silver behenate by 90 mol. % or more.

22. A photothermographic material according to claim 1, wherein a coated silver amount is 1.8 g/m² or less.

23. A photothermographic material according to claim 1, wherein any of the layers on a surface of the substrate at the side of the image forming layer includes a crosslinking agent.

24. An image forming method for a photothermographic material comprising:
obtaining an image forming assembly by positioning a photothermographic material according to claim 1 between a pair of X-ray intensifying screens;
positioning an inspected object between the image forming assembly and an X-ray source;
irradiating the inspected object with an X-ray of an energy level from 25 to 125 kVp;
extracting the photothermographic material from the image forming assembly; and
heating the extracted photothermographic material within a temperature of 90 to 1 80° C.

25. A photothermographic material having, at least on a surface of a substrate, an image forming layer including a photosensitive silver halide, a non-photosensitive organic silver salt, a reducing agent, and a binder, the material comprising:
a silver iodide content in the photosensitive silver halide of 40 to 100 mol %; and
a non-photosensitive intermediate layer A on a surface of the substrate at a side having the image forming layer and between an outermost layer farthest from the substrate and the image forming layer;
wherein a binder of the non-photosensitive intermediate layer A includes a hydrophobic polymer by 50 mass % or more.

26. A photothermographic material according to claim 25, wherein the silver iodide content is 90 to 100 mol. %.

27. A photothermographic material according to claim 25, wherein the photosensitive silver halide has a grain size of 0.01 to 0.10 μm.

28. A photothermographic material according to claim 25, wherein the photosensitive silver halide has a grain size of 0.02 to 0.04 μm.

29. A photothermographic material according to claim 25, wherein the non-photosensitive intermediate layer A is provided adjacent to the image forming layer.

30. A photothermographic material according to claim 25, further comprising a non-photosensitive intermediate layer B containing a binder between the non-photosensitive intermediate layer A and the outermost layer, wherein a binder of at least one of the outermost layer and the non-photosensitive intermediate layer B includes a hydrophilic polymer derived from an animal protein by 50 mass % or more.

31. A photothermographic material according to claim 25, wherein the binder of the non-photosensitive intermediate layer A contains a polymer formed by copolymerizing a monomer represented by formula (M) by 10 to 70 mass %:
CH₂═CRO⁰¹—CR⁰²═CH₂ formula (M)
wherein R⁰¹ and R⁰² each independently represents a hydrogen atom, an alkyl group with 1 to 6 carbon atoms, a halogen atom, or a cyano group.

32. A photothermographic material according to claim 25, wherein a binder of the non-photosensitive intermediate layer B includes a hydrophilic polymer derived from an animal protein by 50 mass % or more and a binder of the outermost layer includes a hydrophobic polymer.

33. A photothermographic material according to claim 25, wherein the non-photosensitive intermediate layer B is constituted of two or more sub4ayers, and a non-photosensitive intermediate sub-layer closer to the non-photosensitive intermediate layer A includes a binder containing a hydrophilic polymer, not derived from an animal protein, by 50 mass % or more, and a non-photosensitive intermediate subayer closer to the outermost layer includes a binder containing a hydrophilic polymer, derived from an animal protein, by 50 mass % or more.

34. A photothermographic material according to claim 33, wherein the binder of the outermost layer includes a hydrophilic polymer derived from an animal protein.

35. A photothermographic material according to claim 33, wherein the binder of the outermost layer includes a hydrophobic polymer.

36. A photothermographic material according to claim 33, wherein the binder of the outermost layer includes a hydrophilic polymer derived from an animal protein and a hydrophobic polymer.

37. A photothermographic material according to claim 25, wherein the reducing agent is a compound represented by formula (R1): 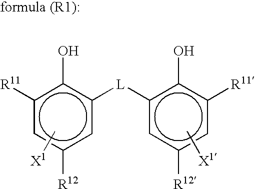
wherein R¹¹ and R^{11′} each independently represents a secondary or tertiary alkyl group with 1 to 15 carbon atoms; R¹² and R¹²′ each independently represents a hydrogen atom or a substituent substitutable on the benzene ring; L represents an —S— group or a —CHR¹³— group; R¹³ represents a hydrogen atom or an alkyl group with 1 to 20 carbon atoms; and X¹ and X^{1′} each independently represents a hydrogen atom or a group substitutable on the benzene ring.

38. A photothermographic material according to claim 25, wherein the image forming layer further includes a development accelerator.

39. A photothermographic material according to claim 37, wherein the image forming layer further includes a compound represented by formula (D): 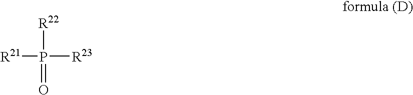
wherein R²¹ to R²³ each independently represents an alkyl group, an aryl group, an alkoxy group, an aryloxy group, an amino group or a heterocyclic group.

40. A photothermographic material according to claim 25, wherein the image forming layer further includes a compound represented by formula (H):
Q-(Y)ₙ-C(Z₁)(Z₂)X formula (H)
wherein Q represents an alkyl group, an aryl group or a heterocyclic group; Y represents a divalent connecting group; n represents 0 or 1; Z₁ and Z₂ each independently represents a halogen atom; and X represents a hydrogen atom or an electron-attractive group.

41. A photothermographic material according to claim 40, wherein the image forming layer includes two or more compounds represented by formula (H).

42. A photothermographic material according to claim 25, wherein the image forming layer further includes a compound represented by formula (I): 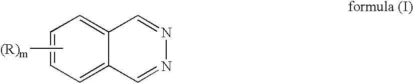
wherein R represents a substituent and m represents an integer from 1 to 6.

43. A photothermographic material according to claim 42, wherein the image forming layer further includes a color toning agent.

44. A photothermographic material according to claim 25, wherein the non-photosensitive organic silver salt includes silver behenate by 90 mol. % or more.

45. A photothermographic material according to claim 25, wherein any of the layers on a surface of the substrate at the side of the image forming layer includes a crosslinking agent.

46. An image forming method for a photothermographic material comprising an exposure step and a thermal development step, wherein:
in the exposure step, an image is formed on a photothermographic material according to claim 25, by a semiconductor laser having a light emission peak intensity within a wavelength range of 350 to 450 nm.

47. An image forming method for a photothermographic material comprising an exposure step and a thermal development step, wherein:
in the thermal development step, a photothermographic material according to claim 25 is heated for 16 seconds or less.

48. An image forming method for a photothermographic material comprising an exposure step and a thermal development step, wherein:
in the thermal development step, a photothermographic material according to claim 25 is transported at a speed of 23 mm/sec or higher.

49. An image forming method for a photothermographic material according to claim 46, wherein: in the thermal development step, the photothermographic material is transported at a speed of 23 mm/sec or higher.

50. An image forming method for a photothermographic material according to claim 47, wherein: in the thermal development step, the photothermographic material is transported at a speed of 23 mm/sec or higher.

51. An image forming method for a photothermographic material according to claim 48, wherein: in the thermal development step, the photothermographic material is transported at a speed of 23 mm/sec or higher.
